(19) United States
(12) Patent Application Publication
(10) Pub. No.: US 2020/0067861 A1
(43) Pub. Date: Feb. 27, 2020

(54) SCAM EVALUATION SYSTEM

(71) Applicant: ZapFraud, Inc., Portola Valley, CA (US)

(72) Inventors: William J. Leddy, Lakeway, TX (US); Christopher J. Schille, San Jose, CA (US); Bjorn Markus Jakobsson, Portola Valley, CA (US)

(21) Appl. No.: 14/963,116

(22) Filed: Dec. 8, 2015

Related U.S. Application Data
(60) Provisional application No. 62/089,663, filed on Dec. 9, 2014.
(60) Provisional application No. 62/154,653, filed on Apr. 29, 2015.

(51) Int. Cl. H04L 12/58; G06F 21/62; G06N 99/00; G06Q 30/00

(52) U.S. Cl. CPC H04L 51/12; G06Q 30/0185; G06N 99/005; G06F 21/6245

(57) ABSTRACT

Dynamically updating a filter set includes: obtaining a first message from a first user; evaluating the obtained first message using a filter set; determining that the first message has training potential; updating the filter set in response to training triggered by the first message having been determined to have training potential; obtaining a second message from a second user; and evaluating the obtained second message using the updated filter set.

### CROSS REFERENCE TO OTHER APPLICATIONS

This application claims priority to U.S. Provisional Patent Application No. 62/089,663 entitled SCAM EVALUATION SYSTEM filed Dec. 9, 2014 and to U.S. Provisional Patent Application No. 62/154,653 AUTOMATED TRAINING AND EVALUATION OF FILTERS TO DETECT AND CLASSIFY SCAM filed Apr. 29, 2015, both of which are incorporated herein by reference for all purposes.

### BACKGROUND OF THE INVENTION

Electronic communication such as email is increasingly being used by businesses and individuals over more traditional communication methods. Unfortunately, it is also increasingly being used by nefarious individuals, e.g., to defraud email users. Since the cost of sending email is negligible and the chance of criminal prosecution is small, there is little downside to attempting to lure a potential victim into a fraudulent transaction or to expose personal information (scam).

Perpetrators of scams (scammers) use a variety of evolving scenarios including fake charities, fake identities, fake accounts, promises of romantic interest, and fake emergencies. These scams can result in direct immediate financial loss, credit or debit account fraud, and/or identity theft. It is often very difficult for potential victims to identify scams because the messages are intended to invoke an emotional response such as “Granddad, I got arrested in Mexico”, “Can you help the orphans in Haiti?” or “Please find attached our invoice for this month.” In addition, these requests often appear similar to real requests so it can be difficult for an untrained person to distinguish scam messages from legitimate sources.

There therefore exists an ongoing need to protect users against such evolving scams.

### BRIEF DESCRIPTION OF THE DRAWINGS

Various embodiments of the invention are disclosed in the following detailed description and the accompanying drawings.

FIG. 1A illustrates an example embodiment of a system for dynamic filter updating.

FIG. 1B is a flow diagram illustrating an embodiment of a process for dynamic filter updating.

FIG. 1C illustrates an example embodiment of a scam evaluation system.

FIG. 2 illustrates an example embodiment of an analytics engine.

FIG. 3 illustrates an embodiment of a system for turning real traffic into honeypot traffic.

FIG. 4 illustrates an example embodiment of a system for detecting scam phrase reuse.

FIG. 5 illustrates an example embodiment of the creation of Vector Filter rules.

FIG. 6 illustrates an example embodiment in which messages are processed.

FIG. 7 illustrates an embodiment of a system for training a storyline filter.

FIG. 8 illustrates an embodiment of a system for pruning or removing signature matches.

FIG. 9 illustrates an embodiment of a system for testing vectors.

FIG. 10 illustrates an example embodiment of a message.

FIG. 11 illustrates an embodiment of a system for performing automated training and evaluation of filters to detect and classify scam.

FIG. 12 illustrates an embodiment of a system for automated training and evaluation of filters to detect and classify scam.

FIG. 13 illustrates an example of a walk-through demonstrating how test messages are matched in a training environment.

FIG. 14 illustrates an example embodiment of plot.

FIG. 15 illustrates an embodiment of an environment in which users of computer and other devices are protected from communications sent by unscrupulous entities.

FIG. 16 depicts an embodiment of a communication classification platform.

FIG. 17 depicts an example of a set of score thresholds used in an embodiment of a tertiary communication classification system.

FIG. 18 illustrates an embodiment of a process for classifying communications.

FIG. 19A illustrates an example of an electronic communication.

FIG. 19B illustrates an example of an interface for classifying an electronic communication.

FIG. 20 depicts an example of a review performed by multiple reviewers.

FIG. 21 illustrates an example of a process for classifying communications.

FIG. 22 illustrates an example of a legitimate message.

FIG. 23 illustrates an example of a scam message.

FIG. 24 illustrates an example of a scam message.

FIG. 25 illustrates an example of a scam message.

FIG. 26 illustrates an embodiment of a platform.

FIG. 27 illustrates an embodiment of portions of a platform.

FIG. 28 illustrates an example of processing performed on a communication in some embodiments.

FIG. 29 illustrates components of an embodiment of a platform.

FIG. 30 illustrates an example embodiment of a workflow for processing electronic communications in accordance with various embodiments.

FIG. 31 illustrates an example term watch list.

FIG. 32 illustrates an example rule list.

FIG. 33 illustrates an embodiment of an environment in which message classification is coordinated between a verification system and an agent.

FIG. 34 illustrates an embodiment of a process that includes three tasks.

FIG. 35 illustrates an example message.

FIG. 36 illustrates an example message.

FIG. 37 illustrates two example rules.

FIG. 38 illustrates an example embodiment of a process for classifying a message.

FIG. 39 illustrates an example content portion of an email that is a phishing email.

FIG. 40 illustrates a second example content portion of an email that is a phishing email.

FIG. 41A illustrates an example of a collection of terms.

FIG. 41B illustrates an example of a fraudulent message.

FIG. 42 illustrates an example embodiment of a process for classifying communications.

FIG. 43 illustrates an example of an interface configured to receive feedback usable to create collections of terms.

FIG. 44 illustrates an example of a sequence of messages.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Described herein is a system that is configured to pre-validate electronic communications before they are seen by users. In some embodiments, the system described herein is an automated adaptive system that can protect users against evolving scams.

Throughout this application, references are made to email, message, message address, inbox, sent mail, and similar terms. A variety of technology/protocols can be used in conjunction with the techniques described herein adapted accordingly (e.g., any form of electronic message transmission, not just the types used in the various descriptions).

As used herein, the term ‘domain’ refers to a virtual region aggregating or partitioning users, without restriction toward a particular communication channel. For example, for some communication technologies, virtual regions may be less provider- and channel-centric, and more user-centric, while other virtual regions may be otherwise-centric.

As used herein, “spam” refers to unwanted message, and “scam” refers to unwanted and potentially harmful message.

Dynamic Filter Updating

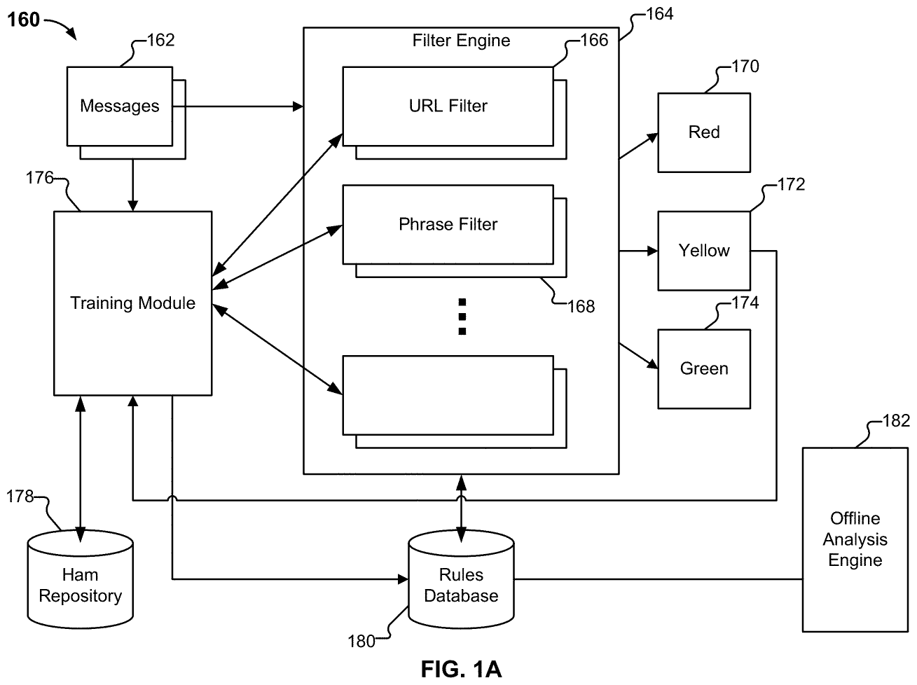

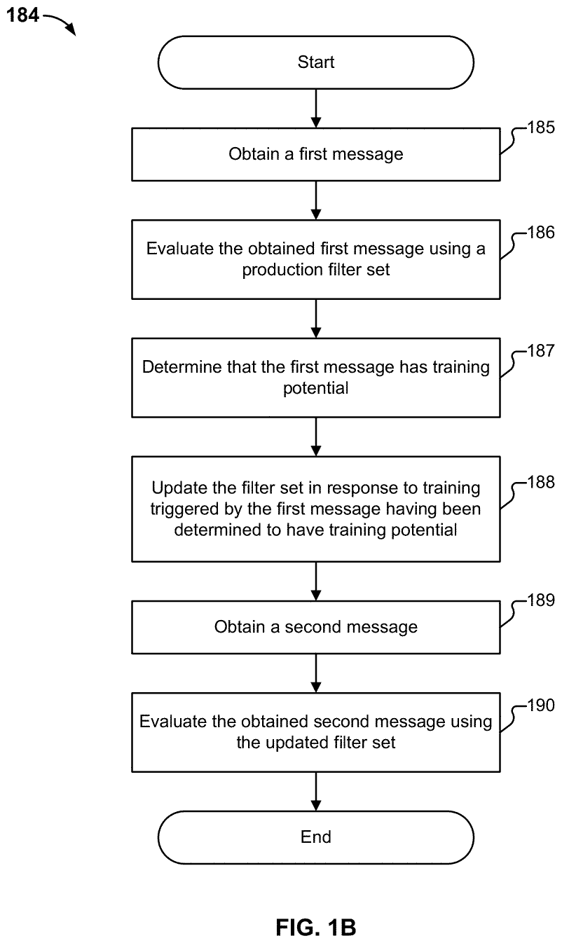

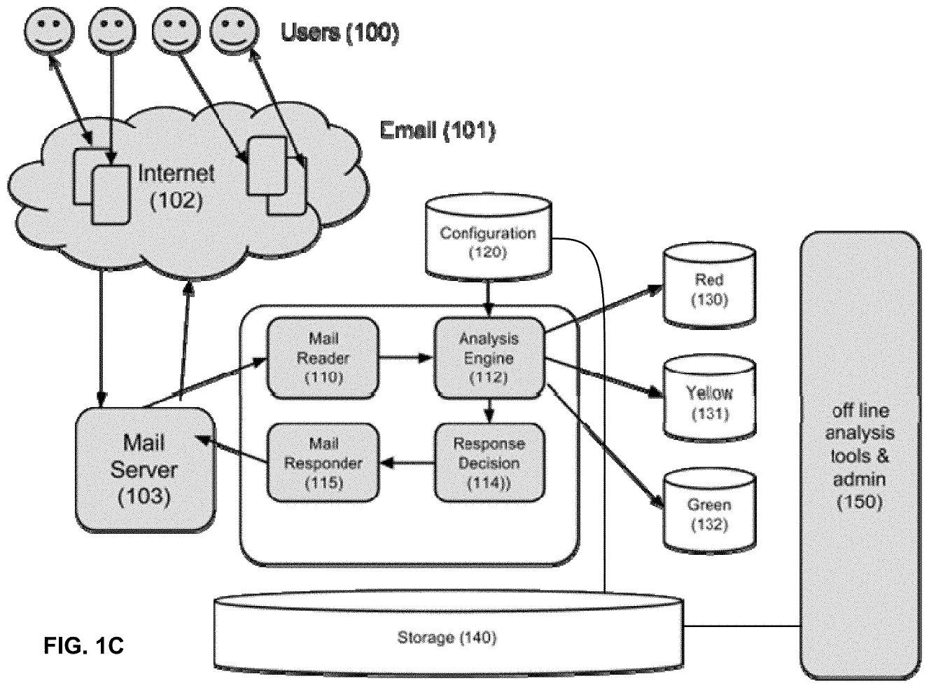

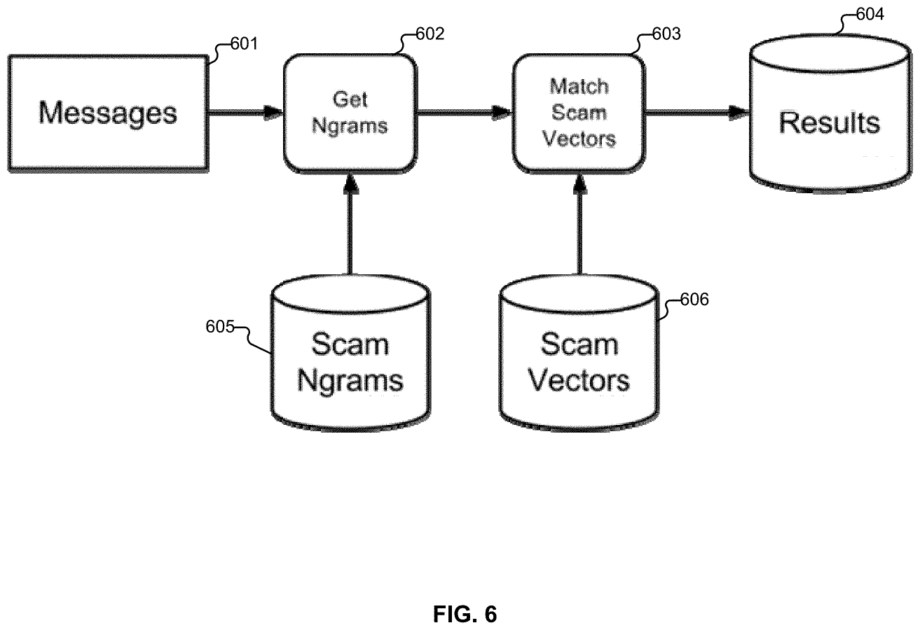

FIG. 1A illustrates an example embodiment of a system for dynamic filter updating. In some embodiments, dynamic filter updating system 160 is an alternative view of the scam evaluation system described in FIG. 1C. In some embodiments, dynamic filter updating system 160 is an alternative view of communication classification platform 1600 of FIG. 6.

Messages 162 are obtained. The messages can include email, SMS, social network posts (e.g., Tweets, Facebook® messages, etc.), or any other appropriate type of communication. The messages can be obtained in a variety of ways. For example, messages can be forwarded from users who have indicated that the forwarded messages are suspicious and potentially scam. As another example, messages can be obtained using honeypots, which are configured to obtain scam messages from nefarious users (e.g., scammers). As yet another example, emails can be accessed directly from the users' email boxes, or be processed on the delivery path (e.g., by a mail server of the organization of the recipient). Emails can also be processed by a user device, or forwarded to a centralized server from such a device. Further details regarding messages and obtaining messages are described below. In some embodiments, the messages are passed to filter engine 164 for evaluation/classification.

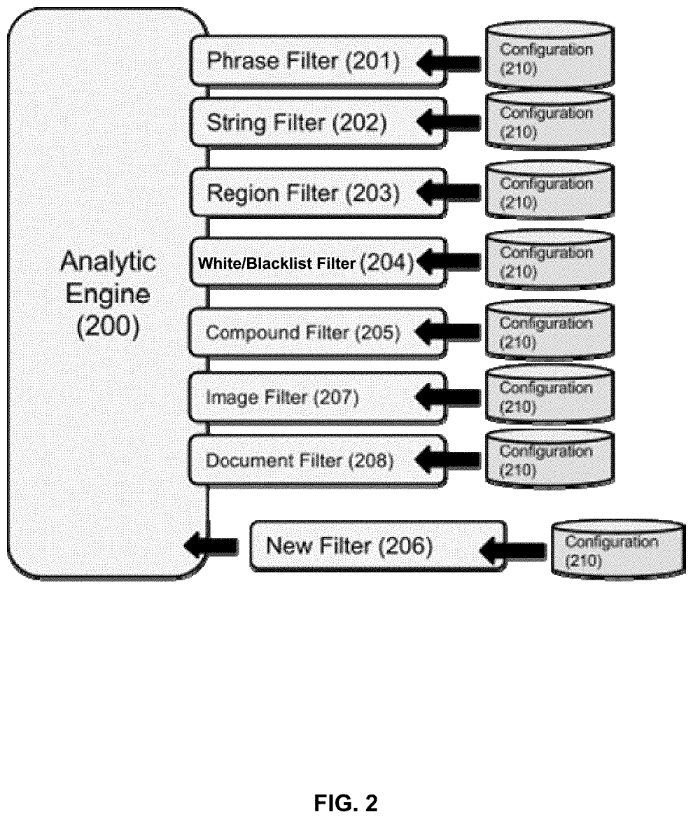

Filter engine 164 is configured to filter incoming messages. In some embodiments, the filter engine is configured to filter incoming messages using an array of filters. In some embodiments, filtering the messages includes parsing incoming messages and extracting components/features/elements (e.g., phrases, URLs, IP addresses, etc.) from the message for analysis and filtering. In some embodiments, this is done to detect generic fraud-related threats, such as traditional 419 scams or phishing attacks; in other embodiments, it is done to detect specialized attacks, such as business email compromise (BEC), which is also commonly referred to as “CEO scams”. In some embodiments, filter engine 164 is an example of analytics engine 200 of FIG. 2.

The filter engine can be run in a production mode (e.g., for analyzing messages in a commercial context) or in a test mode (e.g., for performing training). Messages that are processed through the production mode can also be used to perform training/updating.

In some embodiments, the filter array includes multiple filters, such as URL filter 166 and phrase filter 168. Examples and details of filters are described below. Each filter is potentially associated with multiple rules, where multiple rules may fire for a particular filter. In some embodiments, rules for a filter are obtained and loaded from rules database 180. In some embodiments new rules can be incrementally loaded without restarting the system.

One example of a filter is a universal resource locator (URL) filter (166), which is configured to filter messages based on URLs included in or otherwise associated with the message. The URL filter can be associated with multiple URLs, where each rule indicates whether a specific/particular URL is good or bad (e.g., each URL of interest is associated with a corresponding distinct rule). Another example is a phrase filter (168), which is configured with rules for different phrases that may be indicative of scam. Messages can be evaluated on whether they include or do not include phrases specified in the rules configured for the phrase filter. Another example of a filter is an IP address filter, where messages are filtered based on the IP address from which they originated. Yet another example of a filter is one that detects deceptive email addresses, display names, or domain names. This is done, for example, by comparing data in the headers and content portion of a scrutinized email to data associated with trusted brands and headers. In one embodiment, such a comparison is made with an approximate string-matching algorithm, such as Jaro-Winkler. Substantially similar email addresses that are not equal are an indication of potential deceptive practices; identical or substantially similar Display Names are also indicative of potential deception; as are substantially similar but not equal URLs or domain names. Yet another example filter is one that detects the presence of a reply-to address other than the sender, especially if the reply-to address is deceptively similar to the sender address. Another beneficial filter is referred to herein as “a trust filter.” The trust filter assigns a trust score to an email based on whether the recipient has sent, received, and/or opened a sufficient number of emails to the sender of the email in the not-too-recent past; for example, whether the recipient has sent at least two emails to him or her at least three weeks ago, or whether the sender has sent emails to the recipient for at least two years. Based on the interaction relationship between the two parties, a score can be assigned; for example, in the first trust example above, a trust score of 35 may be assigned, whereas in the second trust example, a trust score of 20 may be assigned. For a party that matches neither of these descriptions, the trust score may be zero. In some embodiments, filters such as these are combined by evaluating them on messages such as emails and determining whether the combination of filter outputs is indicative of a high risk email. Thus, in one embodiment, a rule comprises one or more filters along with a threshold or other decision selection method. In some embodiments, each rule is associated with a distinct score. Further details regarding scoring of messages are discussed below. The rules may also be included in one or more rules families, which will be described in further detail below. In some embodiments, the filter set includes overlapping filters. A single filter may also include overlapping rules.

In some embodiments, the results returned by individual filters can be combined in a variety of ways. For example, Boolean logic or arithmetic can be used to combine results. As one example, suppose that for a message, a rule from a romance scam family fired/hit, as well as a rule from a Nigeria family of scam rules. The results of rules/filters from both those families having been fired can be combined to determine an overall classification of the message. Thus, the results of individual filters or rules can be combined. Compound rules, counting, voting, or any other appropriate techniques can also be used to combine the results of filters and/or rules. The above techniques can also be used to reconcile any filter disagreements or overlap that might result in, for example, counting the same hit multiple times. Further details regarding combining the results of multiple filters/rules, resolving filter disagreement, etc. are described below.

In some embodiments, the filtering performed by the filter engine is used to classify a message into “red” (170), “yellow” (172), and “green” (174) buckets/bins. In some embodiments, “green” messages are determined to be “good,” “red” messages are determined to be “bad,” and those messages that are neither “good” nor “bad” are flagged as “yellow,” or “undetermined.” Additional categories and color-codings can be used, such as a division of the yellow bucket into sub-buckets of different types of threats, different severities, different ease of analysis, different commonality, etc. Similarly, the green bucket can be subdivided into messages of different priority, messages corresponding to different projects, messages associated with senders in different time zones, etc. For illustrative purposes, examples in which three such classification categories are used are described herein. In some embodiments, buckets/bins 170-174 are implemented as directories in file a file system. Messages can be placed inside the directories intact as files. Further details regarding classification are described below.

As will be described in further detail below, the classification of a communication under such a tertiary classification scheme can be based on the results of the filtering performed on the communication. For example, the communication can be classified based on a score for the communication outputted by the filter engine. As one example, messages that receive a score of 15 or below are considered to be “good” messages that fall in the green bucket, while messages with a score about 65 or above are “bad” messages that fall in the red bucket, with messages in between falling into the “yellow” or “undetermined” bucket. Any appropriate thresholds can be used. In some embodiments, multiple filters/rules may fire. Techniques for combining the results from multiple filters/rules are described in further detail below.

Further actions can be taken based on the classification by the engine. For example, responses can be sent to users who forwarded messages regarding the status of the message. For those messages that have inconclusive/undetermined results (e.g., that fall in the “yellow” band), retraining can be performed to update the filters so that the message (or future messages) can be conclusively/definitely classified as either good or bad. Further details regarding actions such as responses are described below.

In some embodiments, based on the results of the filter, messages are designated/flagged as having training potential. For example, messages that were classified in the “yellow” bucket, or messages for which filter disagreement occurred can be designated as having training potential. In some embodiments, messages that are flagged as having training potential are included in a training bucket. In some embodiments, the “yellow” bucket is the training bucket.

Filtering can be done in multiple phases. In one embodiment, there is a first filter round, followed by a conditional second filter round, followed by a conditional training round.

In one embodiment, the first filter round consists of the following steps:

1. Is an email internal (i.e., sent from a mail server associated with the same enterprise as the recipient)?
a. If yes to (1), then does the email have a reply-to?
   i. If yes to (1a), then is it deceptive?
      1. If yes to (1ai), then perform a first action, such as blocking.
      2. If no to (1ai), then perform a second action, such as marking up.

2. If no to (1) then is the email from a friend?
a. If yes to (2), then does the email have a reply-to?
   i. If yes to (2a), then is it deceptive?
      1. If yes to (2ai), then perform a first action, such as blocking.
      2. If no to (2ai), then perform a second action, such as marking up.
   ii. If no to (2a) then has this sender previously used this address in a reply-to?
      1. If no to (2aii) then perform in-depth filtering to it as described below, with a score set for new reply-to, and perform a conditional action. (Note: skip the check for deceptive address, as that has already been performed.)
b. If no to (2), then does the email have high-risk content (an attachment, presence of high-risk key-words, etc)?
   If yes to (2b), then perform in-depth filtering to it as described below, and perform a conditional action.

In many common settings, approximately 25% of enterprise traffic is internal. Approximately 17% of the traffic in 2b is from a future friend. This is traffic that is not yet known to be safe, but is.

In one embodiment, the second filter round consists of the following steps:

1. Does the message have an attachment?
a. If yes to (1), does the attachment have a high-risk word in its name?
   i. If yes to (1a), then add a score for that.
b. If yes to (1), was the attachment generated using a free service?
   If yes to (1b), then add a score for that.
   If yes to (1a) or (1b), then scan the contents of the attachment and add a score related to the result.

2. Does the message have a high-risk word in its subject line?
If yes to (2), then add a score for that.

3. Does the message match a vector filter rule?
a. If yes to (3) then add a score for that.
b. Does the vector filter rule correspond to a whitelisted brand?
   i. If yes to (3b) then add a score for that.
   ii. If yes to (3b) then is the whitelisted brand associated with URLs?
      1. If yes, then determine whether the message contains any URL not associated with the whitelisted brand, and add a score for that.

4. Is the message sender or reply-to address deceptive?
a. If yes to (4) then add a score for that.
b. If yes to (4) then does the deceptive address match a whitelisted brand associated with URLs?
   i. If yes to (4b) then determine whether the message contains any URL not associated with the whitelisted brand, and add a score for that.
5. Is there presence of obfuscation in the message (e.g., mixed or high-risk charsets)?
If yes to (5), then add a score for that.

6. Is there a likely presence of spam poison? (Optional check—see notes below.)
If yes to (6) then add a score for that.

7. Does the message match a storyline?
If yes to (7), then add a score for that.

Spam poison can be detected in a variety of manners. In one embodiment, it is determined whether the message has two text parts, each containing, for example, at least 25 characters, and these are separated, for example, by at least 15 linefeeds.

In the training round, rules are updated as described in more detail below.

Training module 176 is configured to perform training/dynamic updating of filters. In some embodiments, the training module is configured to perform training in response to messages having been flagged as having training potential, as described above. Further example scenarios of triggering (or not triggering) training are described below. In some embodiments, the training module is configured to train based on messages selected from a training bucket. For example, the training module is configured to select messages from “yellow” bucket 172.

In some embodiments, the training module is configured to generate/author new filter rules. In some embodiments, the training module is configured to determine what new rules should be authored/generated.

In some embodiments, in addition to obtaining a message for evaluation, other information associated with the message, such as individual filter results are also passed to the training module for analysis (or the filters can be polled by the training module to obtain the information). For example, the score generated by the filter engine can be passed to the training engine. Finer granularity information can also be passed to the training module, such as information regarding what filters did or did not hit. This corresponds, in one embodiment, to their scores exceeding or not exceeding a threshold specific to the rule, where one such threshold may, for example, be 65. As another example, it can also correspond to Boolean values resulting from the evaluation of rules, e.g., may correspond to the value “true”, as in the case of a rule that determines the presence of a reply-to entry. Such rule output information can be used by the training module to determine what filter(s) should be updated and/or what new rule(s) should be generated.

In some embodiments, the filters in the filter set are configured to search for new filter parameters that are candidates for new rules. For example, a URL filter, when evaluating URLs in a message, will look for new URLs that it has not seen before. Another example URL filter identifies URLs that appear to be trustworthy (e.g., by being associated with emails that are determined to be low-risk), in order to later identify URLs that are substantially similar to the commonly trusted URLs. Such URLs are deceptive, for example, if used in a context in which a filter identifies text evocative of the corresponding trusted brand. Similarly, a phrase filter searches for new phrases that have not been previously encountered. The new components of interest are used by the training module to author new corresponding rules. Existing rules can also be modified. Derivative rules can be created and compared with their predecessor to determine which rule is more applicable over time and various data sets.

In some embodiments, when authoring new rules, the training module is also configured to determine whether the rule will result in false positives. In some embodiments, false positives are determined based on a check against a ham repository, such as ham repository 178. In other embodiments, emails between long-term contacts are assumed to be safe, and used in lieu of a ham database. In some embodiments, during a complete retraining cycle (where, for example, the entire system is retrained), rules are tested against all ham messages to ensure that there are no false positives. In some embodiments, in an incremental retraining (where, for example, only changes to rules/filters are implemented), the rule is tested against a subset (e.g., random subset) of ham. In other embodiments, the false-positive testing/testing against ham can be bypassed (e.g., based on the urgency/priority of implementing the rule). In some embodiments, the false positive testing of the rule against ham is based on a measure of confidence that messages including the parameter for which the rule will filter for will be spam or scam.

In some embodiments, the training module is provided instructions on what filters/rules should be trained/updated/generated. For example, analysis engine 182 is configured to analyze (e.g., offline) the results of past message processing/evaluation. The past message results can be analyzed to determine, for example, optimizations, errors, etc. For example, the offline analysis engine can determine whether any rules are falsely firing, whether to lower the score for a rule, whether a rule is in the wrong family, etc. Based on the analysis, the analysis engine can instruct the training module to retrain/update particular filters/rules.

As another example, a message that is classified as yellow or undetermined (i.e., the results of the filtering are inconclusive) can be subjected to higher scrutiny by a human reviewer. The human reviewer can determine whether the message is spam, scam, or ham. Other classifications can also be made, such as 419 scam, phishing, Business Email Compromise (BEC) scam, malware-associated social engineering, etc. If it is some form of scam or other unwanted message, the human reviewer can also specify the type of feature for which new rule(s) should be created. For example, if the human reviewer, after reviewing a message in further detail, determines that there is a suspicious URL or phrase, the reviewer can instruct the training module to generate/author new corresponding rule(s) of the appropriate type. In some embodiments, the message passed to the reviewer for review is redacted (e.g., to remove any personal identifying information in the message). Further details regarding subjecting messages to heightened scrutiny are described below.

There are several technical variations of BEC scams. A first example variant is referred to herein as “Mimicking known party.” As an example, suppose that a company A has a business relationship with a company B. An attacker C claims to A to represent B, and makes a demand (typically for a funds transfer, sometimes for information). C's email is not sent from B's domain. C often register a domain that is visually related to B, but in some cases may simply use a credible story based on information about A and B. The following are several example cases of this:

1a. The recipient A1 is not a “friend” with sender C1.

1b. No recipient Ai in A is a “friend” with sender C1.

1c. The recipient A1 is not a “friend” with any sender Ci in C. (In some embodiments, this only applies for domains C that are not available to the public.)

1d. No recipient Ai in A is a “friend” with any sender Ci in C. (In some embodiments, this only applies to domains C that are not available to the public.)

A second example variant of the BEC scam is referred to herein as “Continually corrupted known party.” As one example, an attacker C corrupts an email account of entity B, determines that B has a relationship with A, creates a targeted email sent from B, monitors the response, if any, to B. A common special case is the following example: The account of a CEO is corrupted, for example, and used to send a wire request to CFO, secretary, etc. Another version of this is that a personal account of an employee is compromised and used for a payment request.

A third example variant of BEC scams is referred to herein as “Temporarily corrupted known party.” This is similar to “continually corrupted known party”, but where the attacker typically does not have the ability to monitor responses to B. The attacker typically uses a reply-to that is closely related to B's address. (For example “suzy123@ymail.com” instead of “suzy123@gmail.com”; “suzy@company-A.com” instead of “suzy@companyA.com”.) A common special case is when the account of a CEO is corrupted, used to send a wire request to CFO, secretary, etc. Another example version of this is that a personal account of an employee is compromised and used for a payment request.

A fourth example variant of BEC scams is referred to herein as “Fake private account.” For example, C emails a party A1 at company A, claiming to be party A2 at company A, but writing from his/her private email address (e.g., with the message “I lost my access token”, “my enterprise email crashed, and I need the presentation”). The account used by C was created by C.

A fifth example variant is “Spoofed sender.” For example, an email is sent to company A, and using spoofing appears to come from a party at company B. An optional reply-to address reroutes responses.

BEC attacks can be detected and addressed by the technology described herein, in many instances, for example, using composite rules. For example, the fourth variant of BEC scams, as described above, can be detected using a combination of filters: By detecting that the email comes from an untrusted sender (i.e., not from a friend); that the sender address is deceptive (e.g., it is a close match with a party who is trusted by the recipient); and that the subject line, email body, or an attachment contain high-risk keywords or a storyline known to correspond to scam—by detecting such a combination of properties, it is determined that this email is high-risk, and should not be delivered, or should be marked up, quarantined, or otherwise processed in a way that limits the risk associated with the email.

Similarly, the third variant of BEC scams can be detected by another combination of filters. These messages are sent from trusted senders (i.e., the email address of a party who the recipient has previously corresponded with in a manner that is associated with low risk); they typically have a reply-to address; and this reply-to address is commonly a deceptive address; and the message commonly contains high-risk keywords or matches a storyline. Note that it is not necessary for a message to match all of these criteria to be considered high-risk, but that some combination of them selected by an administrator, the user, or another party, may be sufficient to cause the message to be blocked, quarantined, etc. Each of these variants correspond to such composite rules, as is described in further detail below.

In some embodiments, authoring a new rule includes obtaining parameters (e.g., new URLs, phrases, etc.), and placing them into an appropriate format for a rule. In some embodiments, the new generated rules are stored in rules database 180. The rule is then loaded back into its appropriate, corresponding filter (e.g., a new URL rule is added to the URL filter, a new phrase rule is added to the phrase filter, etc.). In some embodiments, an update is made to an in-memory representation by the filter. Thus, filters can be dynamically updated.

In some embodiments, each filter in the filter set is associated with a corresponding separate thread that polls (e.g., periodically) the rules database for rules of the corresponding compatible rule type (e.g., URL filter looks for new URL-type rules, phrase filter looks new phrase-type rules, etc.). New rules are then obtained from the rules database and stored in an in-memory table associated with its corresponding filter (e.g., each filter is associated with a corresponding in-memory table). Thus, new rules can be loaded to filters and made available for use to filter subsequent messages (in some embodiments, without restarting the system).

In some embodiments, the training module is configured to use machine learning techniques to perform training. For example, obtained messages/communications can be used as training/test data upon which authored rules are trained and refined. Various machine learning algorithms and techniques, such as support vector machines (SVMs), neural networks, etc. can be used to performing the training/updating.

Example scenarios in which rules/filters are dynamically updated/trained are described in further detail below.

As shown in FIG. 1A, platform 160 can comprise a single device, such as standard commercially available server hardware (e.g., with a multi-core processor, 4+ Gigabytes of RAM, and one or more Gigabit network interface adapters) and run a typical server-class operating system (e.g., Linux). Platform 160 can also be implemented using a scalable, elastic architecture and may comprise several distributed components, including components provided by one or more third parties.

Phrase Filter Update Examples

In this example, suppose that a phrase filter is to be retrained. As will be described below, the phrase filter can be retrained automatically, as well as incrementally. Other types of filters can be similarly retrained, with the techniques described herein adapted accordingly.

Suppose, for example, that a message has been passed through the filter engine, and is classified in the “yellow,” “undetermined” bucket. The message, based on its classification, is subjected to additional/higher scrutiny. For example, the message is reviewed by a human reviewer, who determines that the message is scam.

In this example, the human reviewer determines that the message is scam because the word “million” in the message has had the letter “o” replaced with a Swedish character “ö” which, while not the same as “o” is visually similar. A phrase filter can be written quickly to specify a rule that filters out messages with the word “million.” Similarly, scammers may use Cyrillic, or may use the Latin-looking character set included in some Japanese character sets, a user-defined font or any other character or character set that is deceptive to typical users.

In some embodiments, the phrase filter can be automatically updated. For example, code can be rewritten that evaluates messages for the use of non-Latin characters, such as numbers or other visually similar characters in the middle of words, and automatically add rules for each new observed phrase.

At a subsequent time, any other messages (which can include new incoming messages or previous messages that are re-evaluated) that are processed by the filter can be evaluated to determine whether they include the phrase “million,” with an “ö.” Similarly, code can be written to detect personalized or custom fonts, and determine, based on the pixel appearance of these what personal font characters are similar to what letters, and perform a mapping corresponding to this, followed by a filtering action commonly used on Latin characters only, and if the same custom font is detected later on, the same mapping can be automatically performed. Examples of custom fonts are described in http://www.w3schools.com/css/css3_fonts.asp. A partial example list of confusable characters is provided in http://www.w3schools.com/css/css3 fonts.asp. An example technique to automatically create look-alike text strings using ‘confusable’ characters is shown in http://www.irongeek.com/homoglyph-attack-generator.php.

Alternatively, custom fonts that do not include deceptive-looking characters can be added to a whitelist of approved fonts, allowing a fast-tracking of the screening of messages with those fonts onwards.

The following is another example of dynamically updating a phrase filter. Suppose, for example, that the rules database includes a set of rule entries for characters that are visually similar. For example, the database includes, for each letter in the English alphabet, a mapping of characters that are visually similar. For example, the letter “o” is mapped to [“ò,” “ó,” “ô,” “õ,” “ö,” etc.]. Similarly, the letter “u” is mapped to [“ù,” “ú,” “û,” “ü,” etc.]. Other mappings can be performed, for example, to upper and lowercase letters, to digits, or any other space, as appropriate.

When evaluating phrases in a message, the phrase filter determines, based on the mappings and the corresponding reverse mappings, whether there are words that include non-standard characters, and what the reverse mappings of these are; that corresponds to what these characters “look like” to typical users. In some embodiments, if a character (or phrase including the character) has not been previously seen before (i.e., is not an existing character in the mappings), the message can be flagged as having training potential. For example, because something new has been encountered, the filter engine may not be able to definitively conclude whether it is indicative of scam or not. The message can then be subjected to a higher level of scrutiny, for example, to determine what the non-standard character visually maps to, and what the phrase including the non-standard character might appear as to a user. In some embodiments, a previously un-encountered phrase is normalized according to the mapping. As another example, a spell-check/autocorrect could be automatically performed to determine what normalized phrase that the extracted/identified phrase of interest maps to. A new phrase filter rule can then be created to address the new non-standard character/phrase including the non-standard character.

The newly created rule can then be added to the rules database and/or loaded to the phrase filter for use in classifying further messages.

URL Filter Update Example

In this example, suppose that an obtained message has been classified into the “yellow” bucket, and is thus flagged as having training potential. Suppose, for example, that the message includes/has embedded a URL of “baddomain.com.” The message is parsed, and the URL extracted. The URL is evaluated by the URL filter of the filter engine.

In this example, the message was placed in the yellow bin because the “baddomain.com” was not recognized. For example, the URL in the message is compared to a URL list in the rules database (which includes URL rules), and it is determined that no rule for that URL is present. Because the URL was not recognized, the message is placed in the yellow bin. Similarly, a URL with an embedded domain “g00ddomain.com” is determined to be different from, yet still visually similar to “gooddomain.com”, and therefore deemed deceptive. This determination can be performed, for example, using a string matching algorithm configured to map, for example, a zero to the letter “O,” indicating that these are visually similar. This can be done, for example, using Jaro-Winkler and versions of this algorithm. When a domain is determined to be deceptive, it is placed in the red bin, or if it is determined to be only somewhat deceptive (e.g., has a lower similarity score, such as only 65 out of 100, as opposed to 80 or more out of 100) then it is placed in the yellow bin.

Techniques for detecting deceptive strings, such as display names, email addresses, domains, or URLs are also described herein. The deceptive string detection techniques are configured to be robust against adversarial behavior. For example, if a friend's display name is “John Doe”, and the incoming email's display name is “Doe, John”, then that is a match. Similarly, if a friend's display name is “John Doe” . . . then “J. Doe” is a match. As another example, if a friend's display name is “John Doe” . . . then “John Doe ______” is a match. Here, the notion of a friend corresponds to a party the recipient has a trust relationship with, as determined by previous interaction. Trust can also be assessed based on commonly held trust. For example, a user who has never interacted with PayBuddy, and who receives an email with the display name “Pay-Buddy” would have that email flagged or blocked since the deceptive similarity between the display name and the well-recognized display name of a well-recognized brand. In one embodiment, the blocking is conditional based on content, and on whether the user sending the email is trusted. Thus, if a person has the unusual first name “Pey” and the unusual last name “Pal”, and uses the display name “Pey Pal”, then this would not be blocked if the recipient has a trust relationship with this person, or if the content is determined to be benevolent.

The analysis of potentially deceptive strings can also done on the full email address of the sender, on the portion of the email address before the @ sign, on the domain of the email address. In some embodiments, it is also done on URLs and domains.

In one embodiment, it is determined whether one of these strings is deceptive based on a normalization step and a comparison step. In an example normalization step, the following sub-steps are performed:

1. Identify homograph attacks. If any sender has a display name that uses non-Latin characters that look like Latin characters then that is flagged as suspect, and an optional mapping to the corresponding Latin characters is performed.

2. Identify different components and normalize. Typical display names consist of multiple “words” (i.e., names). These are separated by non-letters, such as commas, spaces, or other characters. We can sort these words alphabetically. This would result in the same representation for the two strings “Bill Leddy” and “Leddy Bill”.

3. Identify non-letters and normalize. Anything that is not a letter is removed, while keeping the “sorted words” separated as different components.

4. Optionally, normalization is performed with respect to common substitutions. For example, “Bill”, “William” and “Will” would all be considered near-equivalent, and either mapped to the same representation or the remainder of the comparison performed with respect to all the options. Similarly, the use of initials instead of a first name would be mapped to the same representation, or given a high similarity score.

After the normalization is performed, the normalized and sorted list of components is compared to all similarly sorted lists associated with (a) trusted entities, (b) common brands, and (c) special words, such as “IT support”. This comparison is approximate, and is detailed below. Analogous normalization processing is performed on other strings, such as email addresses, URLs, and domains.

5. After optional normalization is performed, a comparison is performed. Here, we describe an example in which the two elements to be compared are represented by lists. In this example, we want to compare two lists of components, say (a1, a2) with (b1, b2, b3), and output a score.

Here, (a1, a2) may represent the display name of a friend e.g., (a1,a2)=(“Doe”,“John”), and (b1, b2, b3) the display name of an incoming non-friend email, e.g., (b1,b2,b3)=(“Doe”, “Jonh”, “K”). Here, we use the word “friend” as short-hand for a trusted or previously known entity, which could be a commercial entity, a person, a government entity, a newsletter, etc, and which does not have to be what is commonly referred to as a friend in common language. We compare all friend-names to the name of the incoming non-friend email. For each one, the following processing is performed in this example embodiment:

5.1. Compare one component from each list, e.g., compare a1 and b1, or a1 and b2.

5.2. Are two components the same? Add to the score with the value MATCH, and do not consider this component for this list comparison anymore.

5.3 Is the “incoming” component the same as the first letter of the friend component? Add to the score with the value INITIAL, but only if at least one “MATCH” has been found, and do not consider this component for this list comparison any more.

5.4 Is the similarity between two components greater than a threshold, such as 0.8? Then add to the score (potentially weighted by the length of the string to penalize long matching strings more than short matching strings) with the value SIMILAR and do not consider this component for this list comparison any more.

5.5 If there is any remaining components of the incoming message, add to the score by the value MISMATCH, but only once (i.e., not once for each such component)

If the resulting score is greater than a threshold MATCH, then there is a match.

Each of the results could be represented by a score, such as:

MATCH: 50

INITIAL: 10

SIMILAR: 30

MISMATCH: −20

These scores indicate relative similarity. A high relative similarity, in many contexts, corresponds to a high risk since that could be very deceptive, and therefore, a high similarity score will commonly translate to a high scam score, which we also refer to as a high risk score.

Alternatively, each of the results could be a binary flag.

As an option, the processing before the actual comparison can be performed as follows: First combine the components within a list by concatenating them. Then use the string comparison algorithm on the resulted two concatenated results.

In some embodiments, the comparison of two elements is performed using a string-matching algorithm, such as Jaro-Winkler or versions of this. Sample outputs of the Jaro-Winkler algorithm are as follows, where the two first words are the elements to be compared and the score is a similarity score.

JOHNSTON,JOHNSON, 0.975

JOHNSON,JOHNSTON, 0.975

KELLY,KELLEY, 0.9666666666666667

GREENE,GREEN, 0.9666666666666667

WILLIAMSON,WILLIAMS, 0.96

Bill,Bob, 0.5277777777777778

George,Jane, 0.47222222222222215

Andy,Annie, 0.6333333333333333

Andy,Ann, 0.7777777777777778

Paypal,Payment, 0.6428571428571429

Bill,Will, 0.8333333333333334,

George,Goerge, 0.9500000000000001

Ann,Anne, 0.9416666666666667

Paypai,Paypal, 0.9333333333333333

A reference implementation of the Jaro-Winkler algorithm is provided in http://web.archive.org/web/20100227020019/http://www.census.gov/geo/msb/stand/strcmp.c

Modifications of the reference implementation of the Jaro-Winkler algorithm can be beneficial. For example, it is beneficial to stop the comparison of two sufficiently different elements as early on as is possible, to save computational effort. This can be done, for example, by adding the line “If Num_com*2<search_range then return(0.1)” after the first Num_com value has been computed. This results in a low value for poor matches.

Another beneficial modification of the Jaro-Winkler algorithm is to assign high similarity scores to non-Latin characters that look like Latin characters, including of characters of user-defined fonts. These can be determined to look similar to known Latin characters using optical character recognition (OCR) methods.

Based on the analysis of headers and contents, rules can be written to detect common cases associated with fraud or scams. We will describe some of these rules as example rules. We will use the following denotation to describe these example rules:

E: received email

f: a party who is a friend of the recipient, or a commonly spoofed brand

A(x): email address of email x or email address of friend x

R(x): reply-to address of email x or associated with friend x (NULL if none)

D(x): display name of email x or of friend x (may be a list for the latter)

U(x): set of domains of URLs found in email x or associated with friend x

S(x): storyline extracted from email x or associated with friend x

O(x): the “owner” of a storyline x or URL x

H(E): {subject, attachment name, hyperlink word, content} of email E is high-risk

F(E): attachment of E generated by free tool

x˜y: x is visually similar to y

x !=y:x is not equal to y

Using this denotation, rules can be described as follows:

For some f:

1. If D(E)˜D(f) and A(E) !=A(f) then MIMICKED-DISPLAY-NAME

2. If A(E)˜A(f) and A(E) !=A(f) then MIMICKED-EMAIL-ADDRESS

3. If O(S(E))=A(f) and A(E) !=A(f) then MIMICKED-CONTENT

4. If O(U(E)) !=A(f) and (D(E)˜D(f) or A(E)˜A(f)) then URL-RISK

5. If O(U(E)) !=A(f) and (O(S(E))=A(f) and A(E) !=A(f)) then URL-RISK

6. If H(E) and (<any of the above results in rules 1-5>) then EXTRA-RISK

7. If F(E) and (<any of the above results in rules 1-5>) then EXTRA-RISK

8. If R(E) !=A(f) and (D(E)˜D(f) or A(E)˜A(f)) then ATO-RISK

9. If R(E) !=A(f) and (O(S(E))=A(f) and A(E) !=A(f)) then ATO-RISK

Here, the results, such as MIMICKED-DISPLAY-NAME, correspond to risk-associated determinations, based on which emails can be blocked, quarantined, marked up, or other actions taken. The determination of what action to take based on what result or results are identified by the rules can be a policy that can be adjusted based on the needs of the enterprise user, email service provider, or individual end user.

The message can also be placed in the yellow bin based on analysis of the URL according to a set of criteria/conditions. For example, the extracted URL can be analyzed to determine various characteristics. For example, it can be determined when the extracted URL was formed/registered, for example by performing a “whois” query against an Internet registry, whether the URL is associated with a known brand, whether the URL links to a good/bad page, etc. As one example, if the URL was recently formed/registered and is not associated with a known brand, then the training module can determine that a new rule should be generated for that URL. Any other appropriate URL analysis techniques (which may include third party techniques) can be used to determine whether a new rule should be generated for a URL. Thus, based on the analysis of the URL, the message is placed in the yellow bin.

Because the message was placed in the yellow bin, it is flagged for training potential. The training module is configured to select the message from the yellow bucket. In some embodiments, the results of the filtering of the message are passed to the training module along with the message. For example, the score of the filtering is passed with the message. Additional, finer granularity information associated with the evaluation of the message can also be passed to the training module. In this example, information indicating that the message was placed in the yellow bin due to an unrecognized URL (or a URL that was recently formed and/or not associated with a known brand) is also passed with the message. In some embodiments, the training module uses this information to determine that the URL filter should be updated with a new URL rule for the unrecognized URL.

A new rule for “baddomain.com” is generated/authored. The new rule is added to a rules database (e.g., as a new entry), which is loaded by the URL filter. The new URL filter rule can then be used to filter out messages that include the “baddomain.com” URL.

In some embodiments, the training module determines whether a new rule should be generated for the extracted URL.

Example Dynamic Training/Updating Triggering Scenarios

The following are example scenarios in which dynamic filter updating is triggered (or not triggered). In some embodiments, the example scenarios below illustrate example conditions in which messages are flagged (or not flagged) for training potential.

No Filters Trigger

In this example scenario, no filters in a filter set triggered. The message is passed to the training module 176 for further evaluation. In some embodiments, a manual evaluation is performed, and a filter update is performed. In other embodiments, the filter update is performed automatically.

All Filters Trigger

In some embodiments, in this scenario, no filter update is performed.

Subset of Filters Trigger

In this scenario, some, but not all of the filters in the filter set trigger (e.g., two out of three filters trigger). The message may or may not be classified as spam or scam as a result of the evaluation. In some embodiments, those filters that did not trigger are further evaluated to determine whether they should have been triggered based on the contents of the message. If the filter should have been triggered, then training is performed to update the filter.

For example, suppose that an email message includes both text and a universal resource locator (URL). The message has been detected and classified based on the text of the message, but not the URL. Based on a further inspection of the message (e.g., by a human reviewer, or automatically), it is determined that the URL in the message is indicative of scam, and that the URL filter should be updated to recognize the URL. The URL filter is then trained to filter out messages including the identified URL. An example of updating a URL filter is described above.

FIG. 1B is a flow diagram illustrating an embodiment of a process for dynamic filter updating. In some embodiments, process 184 is executed using platform 160 of FIG. 1A. The process begins at 185, when a first message is obtained. In various embodiments, the message includes electronic communications communicated over various channels, such as electronic mail (email), text messages such as short message service (SMS) messages, etc.

The message can be obtained in a variety of ways, as described below in conjunction with FIG. 1C. In some embodiments, the message is received from a user. For example, the message is forwarded from a user that is a subscriber of a scam evaluation system such as that described in FIG. 1C. In other embodiments, the message is obtained from a nefarious/malicious person/user (e.g., scammer), who, for example, is communicating with a honeypot established by a scam evaluation system. As another example, the message is obtained from a database of scam messages (obtained from users such as those described above).

At 186, the obtained first message is evaluated using a production filter set. Examples of filters include URL filters, phrase filters, etc., such as those described above. In some embodiments, each filter is configured using one or more rules. Further details and examples of filters/rules are also described below.

At 187, the first message is determined to have training potential. Messages can be determined to have training potential in a variety of ways. For example, messages that are classified in the “yellow” band, as described above, can be designated as having training potential. Those messages in the “yellow” band, which are not determined to be either scam or not scam (i.e., its status as scam or ham is inconclusive), can be flagged for further scrutiny. In some embodiments, the classification of a message in the “yellow” band indicates that the results of the evaluation of the message are inconclusive (i.e., the message has not been definitively classified as “good” or “bad”). The flagging of the message as having training potential can be used as a trigger to perform training/dynamic updating of filters.

As another example, messages whose evaluation results in a filter disagreement can be designated as having training potential. For example, while the filter set, as a whole, may have concluded that a message is scam or not scam, individual filters may have disagreed with each other (with the overall result determined based on a vote, count, or any other appropriate technique). The message that resulted in the filter disagreement can then be determined/flagged as having training potential. Further details regarding filter disagreement (and its resolution) are described in further detail below.

As another example, a message can be determined to have training potential based on a determination that some filters in the filter set did not fire. Those filters that did not fire can be automatically updated/trained. In the case where some filters may not have fired, the message may still have been conclusively classified as scam or not scam (e.g., voting/counting can be used to determine that a message should be classified one way or the other). For example, one type of filter may decide with 100% certainty that the message is scam, thereby overriding the decisions of other filters. However, the indication that a filter did not fire is used to perform a new round of training on the unfired filter.

At 188, the filter set is updated in response to training triggered by the first message having been determined to have training potential.

In some embodiments, machine learning techniques are used to perform the training. In some embodiments, the training progresses through a cycle of test (where the message that passed through the test process is determined to have training potential), enters a training phase, performs re-training, etc. Various machine learning techniques such as support vector machines (SVMs), neural networks, etc. can be used. In order to create a fast system with manageable memory footprint and high throughput, it can be useful to run fast rules on most messages, and then, when needed, additional but potentially slower rules for some messages that require greater scrutiny. In some embodiments, it is also beneficial to run slow rules in batch mode, to analyze recent traffic, and produce new configurations of fast rules to catch messages that are undesirable and which would otherwise only have been caught by slower rules. For example, the storyline filter described herein may potentially be, in some implementations, slower than the vector-filter described herein. In some embodiments, the storyline filter is more robust against change in strategy, however, and so, can be used to detect scams in batch mode, after which vector filter rules are automatically generated and deployed. Alternatively, instead of running slow filters in batch mode, they can be run on a small number of suspect messages, probabilistically on any messages, or according to any policy for selecting messages to receive greater scrutiny, e.g., to select messages from certain IP ranges.

The training can be performed using training data obtained from various sources. As one example, the training data is obtained from a honeypot. Further details regarding honeypots are described below. As another example, the training data is obtained from an autoresponder. Further details regarding autoresponders are described below. As another example, the training data is obtained from performing website scraping. Further details regarding collection of (potentially) scam messages are described below. Ham messages (e.g., messages known to not be spam or scam) can also be similarly collected.

In some embodiments, updating the filter set includes resolving an inconclusive result. As one example, an inconclusive result can be resolved by a human user. For example, a human reviewer can determine that a previously unseen element of a certain type (e.g., URL, phrase, etc.) in a message is indicative of scam, and that new rule for the element should be authored (resulting in the corresponding filter being updated). In some embodiments, the resolution is performed automatically. For example, in the example phrase and URL filter scenarios described above, URL analysis and automated normalization techniques can be used to identify whether rules should be authored for previously never before seen elements. This allows filter rules to be updated as scam attack strategies evolve.

In some embodiments, updating the filter set includes a complete retraining of the entire filter set/dynamic updating system/platform. In some embodiments, updating the filter set includes performing an incremental retrain. In some embodiments, the incremental retrain is an optimization that allows for only new changes/updates to be made, thereby reducing system/platform downtime.

In some embodiments, the updating/training process is performed asynchronously/on-demand/continuously (e.g., as new messages with training potential are identified). The updating/training process can also be performed as a batch-process (e.g., run periodically or any other appropriate time driven basis). For example, a script/program can be executed that performs retraining offline. In some embodiments, old rules for a filter can be replaced with new improved versions in a rule database, and the old rule is marked for deletion. A separate thread can read these database changes and modify the rules in memory for the filter without restarting the system.

In some embodiments, other actions can be taken with respect to the obtained message. For example, if the message is forwarded to a scam evaluation system/service by a user, then the user can be provided a response based on the evaluation/classification result of the message. Example responses are described in further detail below with respect to the autoresponder. In some embodiments, the actions can be taken independently of the training.

At 189, a second message is obtained. For example, at a subsequent time, another message is obtained by the platform. At 190, the second obtained message is evaluated using the updated filter set. In some embodiments, the message is conclusively classified (e.g., as scam or not scam) using the updated filter set. For example, a message is obtained that includes a URL for which a new rule was previously created and used to update a URL filter. The URL in the message, when passed through a filter set, is caught by the new rule of the updated filter set. Thus, the second user's message is filtered using the filter that was updated at least in part based on the first user's message having been resolved/used for training.

Further details regarding filter updating and training are described below, for example, in the sections “tuning and improving filters” and “automated training and evaluation of filters to detect and classify scam.”

Example Use of Technology—Scam Evaluation Autoresponder

One example use of technology described herein is an automated system that evaluates the likelihood of scam in a forwarded communication and sends a response automatically. In one embodiment, the communication channel is email. Another example of a communication channel is short message service (SMS). A user Alice, who has received an email she finds potentially worrisome, forwards this email to an evaluation service that determines the likelihood that it is scam, and generates a response to Alice, informing Alice of its determination.

Auto Evaluator & Responder System Overview

FIG. 1C illustrates an example embodiment of a scam evaluation system. The scam evaluation system is also referred to herein as an automated detection and response system. In some embodiments, users 100 include users that communicate over a network such as Internet 102. The users use various communications channels, such as email, SMS, etc. Examples of mail server 103 include Microsoft® Exchange servers, Microsoft® exchange online servers, Gmail® servers, SMTP servers, etc. In various embodiments, analysis engine 112, mail responder 115, and response decision 114 are implemented using Java, C, C++, or any other appropriate language. In some embodiments, mail reader 110 is a mail client, such as Microsoft Outlook on a PC, a mobile client such as the Gmail mobile client on mobile devices, etc. For example, the mail reader can be implemented in iOS, on Android, or can be pulled from a server. In various embodiments, mail reader 110 can be implemented in objective C, Java, C, C++, PHP, Python, Perl, Ruby, or any other appropriate language.

In some embodiments, configuration 120 is implemented as a database, a flat file, or any other appropriate data storage. In some embodiments, red 130, yellow 131, and green 132 are repositories implemented as files in a directory system. As another example, the repositories can be implemented using a database. In other embodiments, repositories 130-132 are implemented as database tables or markers on a record in a database indicating how results are to be segmented. In some embodiments, a directory service, such as LDAP, is used to implement the repositories. In some embodiments, repositories 130-132 are included in storage 140.

In various embodiments, storage 140 is implemented as a flat file, a database such as MySQL, or as any other appropriate type of data store. In some embodiments, offline analysis tools and admin 150 is implemented using JAVA, PHP, or any other appropriate language. The offline analysis tools and admin 150 can include various statistical analysis packages. As one example, PHP pages are implemented that connect to storage 140. The PHP pages can be implemented, for example, in a web browser front end/browser-based interface that runs PHP scripts or other tools against obtained data, allowing various results to be displayed. In other embodiments, the offline analysis tools and admin 150 is implemented using third-party services (e.g., remote third-party services).

As described above, users can send emails over a network such as the Internet (102), which are maintained at the mail server 103. The mail reader 110 reads/obtains new incoming messages, which are then passed to analysis engine 112. As described above, and will be described in further detail below, in some embodiments, the analysis engine includes a series of filters which are configured by rules that are read from configuration 120. The incoming messages are segmented into red, yellow, and green categories 130-132. In some embodiments, based on policies, some messages are retained based on their classification (e.g., retain red and yellow messages, or retain red, yellow, and green messages). In some embodiments, messages classified in the yellow category 131 are made available for further analysis. In some embodiments, a decision is made whether a message is spam (e.g., a scam) or not, and response decision 114 is configured to determine a response that is provided to mail responder 115, which in turns passes the response back to mail server 103, which sends the response (e.g., email response, SMS response, etc.) over a network such as Internet 102 to users 100 (e.g., sends a response decision for a message to the user that forwarded/otherwise provided the message initially). As used herein, “spam” refers to unwanted message, and “scam” refers to unwanted and potentially harmful message. In some cases, it can be difficult to determine whether a message is spam or scam. In some embodiments, a distinction between spam and scam is not made. The systems described herein are designed to block some spam, and in particular, to block scam. They may also block spam messages that are not scam.

In some embodiments, information associated with the results of message evaluation (e.g., as a result of the evaluation using analysis engine 112) is collected and stored to storage 140. The collected information can be used for future processing (e.g., for dynamic filter updating/training, as described above).

Further details regarding the scam evaluation system are described below.

Refer to FIG. 1C for the following sections. Users (100) send emails (101) to one or more receiving accounts such as scam@zapfraud.com.

Receiving email accounts at (103) can provide variations on the service. For example, paying users can use subscriber@zapfraud.com to get faster responses or more detailed analysis. Some classes of users can require specialized protection through a different account. For example, attorney@zapfraud.com can focus on scams targeting attorneys by using configuration (120) specific to the email address to which the suspect email was forwarded by a user (100).

The mail reader can regularly check for new emails at the mail server and pass them to the Analysis Engine AE (112).

The AE (112) is configured to analyze the email using a variety of filters that can be customized by configuration (120), which includes rules as discussed herein. The AE (112) can perform the analysis in a single pass, or can use multiple passes. For example, the AE (112) can immediately determine that a message is a scam because it is an exact match for other attempts from the same sender, or the message is valid because the sender and contents are on a whitelist. In other cases, the message can be queued for more detailed analysis by more complex Filters. This analysis can be performed in real time or within a specific window of time.

As described in more detail below, a system can be used to read Rules that are used as data to control the behavior of email Filters for the purpose of detecting scam email. AE (112) can use a similar system, and can use different Rules or variations on the same Rules.

A user receiving an email message may harbor suspicion that it is a scam email. In this case, since the user already believes it is suspicious enough to forward, the system can omit some standard checks and focus on aspects that are harder for a user to manually verify, such as header information, from which the sender's probable geographic location can be ascertained, for example, by looking up the IP address, for example. Paying users can receive a more detailed analysis of the messages they send than unpaid users. In some embodiments, a subset of the Rules can be applied to incoming messages; when the system is under heavy load, for example.

After emails are obtained, each email can be scored. AE (112) can retain email messages in storage (140) depending, for example, on how messages are triaged. The system can retain all or a subset of emails for subsequent analysis and testing of new Filters and Rule variations. Results can be tallied and written to storage (140). For example, AE (112) can detect that more than one user has forwarded an email from a sender “possible.scammer@hostingservice.com” and increment a total of such recipients for this sender. This total can be considered by Rules run on messages forwarded by other recipients of messages from “possible.scammer@hostingservice.com.”

Configuration (120) includes data that can be stored to, or read from, storage (140) that controls the behavior of AE (112), for example, by influencing the behavior of Filters as described herein. In one embodiment, configuration (120) includes the following types of data: (Additional example types of data are also described below).

Rules—In some embodiments, the Filters used by the AE (120) are customized by Rules that can be adjusted as new scams patterns are identified;

Equivalent terms—Messages such as emails (101) may contain common words and phrases that can are interchangeable with similar terms. For example, “lawyer” and “attorney” can be treated as equivalent concepts. By translating equivalent terms into a common set, the definition of Rules can be simplified;

Thresholds—In some embodiments, the AE (120) evaluates each message (101) for potential scam by scoring the suspicious elements. Each message can be checked against a threshold to determine the disposition of the message; and

Geolocation Data—The latitude and longitude of the email sender can be determined from the sender's internet address.

The configuration data can be specific to enterprises or users.

Storage (140) is configured to store and retrieve data, for example, in secondary storage. Storage (140) can include, but is not limited to, file systems, version control systems, and databases. Storage (140) can be used to store and retrieve communications received by a user and forwarded to the system for analysis, such as email messages (101). Storage (140) can also store and retrieve configuration (120).

The Response Decision (RD, 114) component is configured to compare the score from the AE (112) with thresholds, an example type/form of configuration (120), and select the appropriate message to pass to the mail responder. The thresholds are established based on a variety of factors including, but not limited to, the sender's email address, sender's domain, or whether the sender is a paying user.

The Message Responder (MR, 115) is configured to send the response message to the user through a mail server (103) or other communication channels. In one embodiment, the user is able to select a preferred channel or channels through which to receive a response message.

Electronic messages sent to a user and forwarded to embodiments of the system described herein for analysis can come from any sender who knows the receiver's identity. In various embodiments of the system shown in the environment of FIG. 1C, other types of communication are processed, instead of or in addition to email (100), such as those received by the user through any of a variety of channels including, but not limited to, email, SMS, instant messenger, Skype, voice mail, etc.

The message is processed in the AE (112) by a series of Filters whose function is controlled by configuration (120). Configuration (120) can include Rules, term equivalents, thresholds, geolocation data, and customer- or customer-class-specific data, etc. as described herein. Such configuration data can be read from storage (140) as applicable.

The evaluation of the likelihood of scam is based on a variety of available factors including, but not limited to, the content of the message, the original sender information, and links in the message as described herein. They are also based on factors such as the similarity between the sender and a sender trusted by the recipient; similarity of display names of the sender and a sender trusted by the recipient, or the domain of the sender and the similarity of this to the domain associated with a sender trusted by the recipient. Thus, the determination is made not only based on the information associated with the message, but also based on its context, provided data associated with the recipient of the message.

In various embodiments, the scam evaluation is correlated across a variety of factors including, but not limited to, message content, message channels, users that have received and/or forwarded the messages, and message originators. For example, if alice@somewhere.edu receives a message containing the phrase “your assistance is needed immediately to breach this crisis” from damon@evilguy.net and it is determined to be a scam, then all emails from the sender damon@evilguy.com, all emails from anyone at evilguy.com, or any message containing this phrase can be considered more suspicious. These can be used as a single factor or in combination with other factors in determining the likelihood of a fraud attempt.

In one embodiment, messages are classified as red (130), yellow (131), or green (132), as described in further detail below. In some embodiments, messages classified as red are retained permanently without restriction for further analysis. Messages classified as yellow can be retained temporarily and can be subjected to additional Filtering or analysis. In some embodiments, messages classified as green are not retained in storage (120). Retained messages saved in storage (140) can be used, for example, for offline analysis by entities such as security analysts and researchers. The results can be reviewed to determine where changes to configuration (120) can be made to improve the accuracy of classification.

In some embodiments, the system described herein analyzes incoming email and uses the results of analysis to modify configuration (120). This is described further below.

Response Messages

Response messages are configurable to be sent in variety of ways including but not limited to:

No response messages—For example, the results can be simply logged or discarded;

Response is sent back on the same communication channel as the message originated;

Response is sent on an alternate channel;

Response is sent to the message sender, multiple third parties, or both; and

Response is sent on multiple channels. For example, when a scam attempt is detected in an email, a response could be sent to the user back on the same channel (email) but an SMS could also be sent to the user.

In some embodiments, the response options are configurable where a user or administrator determines where and how responses should be sent.

As described herein, in some embodiments, the system is able to dynamically vary the response content and rate if it determines that a scammer is testing the system or if the system is under heavy load.

Example response types (for each of these responses, a portion (or all) of the original email can be, but need not be included):

### Example 1: (High Score. The System Concludes it is a Scam.)

TABLE 1
Thank you for sending us potential scam emails. The email you sent us
appears to be a scam. Please be careful to *not* respond to scammers, and
do not click on links in their emails.
Please continue sending suspect emails to scam@zapfraud.com. We report
fraudsters to the authorities. Wealso use emails you send us to improve our
automated scam detection tools. To sign up for our free service, go to
<URL>.
Thank you again for helping us fight fraud!
<component of original email here, optionally>

### Example 2: (Medium Score. Inconclusive Scam Determination by System.)

TABLE 2
Thank you for sending us potential scam emails The email you sent us has some indications that it might
be a scam, but it is not certain. We will add the potential scam email to our list of things to analyze in more
depth.
Please continue sending suspect emails to scam@zapfraud.com. We report fraudsters to the authorities. We
also use emails you send us to improve our automated scam detection tools. To sign up for our free service,
go to <URL>.
Thank you again for helping us fight fraud!
<component of original email here, optionally>

### Example 3: (Very Low Score. The System Concludes the Message is not a Scam.)

TABLE 3
Thank you for sending us potential scam emails It does not match any existing scam profile in our
database. Since this email made you concerned, we will add it to our list of messages to analyze in more
depth.
Please continue sending suspect emails to scam@zapfraud.com. We report fraudsters to the authorities. We
also use emails you send us to improve our automated scam detection tools. To sign up for our free service,
go to <URL>.
Thank you again for helping us fight fraud!
<component of original email here, optionally>

The response can include a qualitative statement such as “seems likely”, a quantitative statement such as “83.7% likely,” or a description of why it is or is not likely to be scam. The following are example responses:

“The message you forwarded on November 18 at 9:48 PT titled “You've won the Facebook Lottery” is a known confirmed scam. You can read more about it by following this link. There is no Facebook Lottery and you did not win. Please delete the message from your inbox. You can also sign up for ZapFraud's scam Filter service, and we will help you block scam messages like this one.”

“The message you recently forwarded about “Unpaid Texas Toll Tags” appears to be a scam because the email was sent from a system in Russia. This is very likely a scam and you should not click on any links or open any attachments to this email. If you have questions about unpaid tolls, then please look up your local toll authority and contact them using contact information you have verified. It's important that you don't trust any links, email addresses or phone numbers found in the email itself. We suggest you delete this message from your inbox.”

“The message you recently forwarded about “Hi, there . . . ” is very likely a scam. Similar message content has been sent to many users. The image of the person in the email has been linked to other internet scams. Please delete the message from your inbox and do not respond to this person.”

“The message you recently forwarded about “Disaster in Haiti” is very likely a scam. The link in the message is to a suspect scam site that steals credit card numbers. Please delete the message and do not respond to the sender. To contribute to charities, we recommend that you review a vetted list of approved charities maintained by (name of organization here).”

“ZapFraud believes your recent forwarded message “Introduction” is a scam because our models have identified suspicious patterns in it. Please delete the message and do not respond to the sender.”

“ZapFraud believes your recent forwarded message “Help! I've been mugged” is a likely a scam because our models have some suspicious patterns in it. Please delete the message and do not respond to the sender. It appears to come from a friend of yours, so it is likely that your friend's email account has been hacked. Please give your friend a call to alert him or her that somebody is likely to have gained access to his or her email, and sent out messages to contacts. Your friend should find a way of alerting his or her contacts so that they do not fall for the scam.”

“ZapFraud believes your recent forwarded message “Ebay: Item Sold” is likely not a scam because it does not match any of the scam patterns we monitor. If you still believe that it might be a scam, you should contact the sender directly by phone or other communication channel.”

“ZapFraud did not immediately find any direct evidence that your recent forwarded message “I need help” is scam but it has some suspicious characteristics so it has been queued for further review with other tools. It will take a bit longer but we'll let you know if we find something. If you do act on this message please proceed with caution.”

The response can be immediate and automated. In other embodiments, the response can be delayed (e.g., if additional tools, offline analysis, human analysis or enhancements to the automated system is needed). It can also be delayed as a result of Quality of Service (QoS) policies, e.g., based on the number of requests sent by a particular user, the domain of the user, and based on whether the user's reputation score is high or low. The reputation score may correspond to the portion of emails the user sent that were found to be scam, thereby giving a low reputation score to somebody who sends many legitimate messages to the service.

In some embodiments, the address of the sender who forwards the message to the server is analyzed. If the sender is a subscriber to the service, then additional information can be provided, such as numeric scam scores or explanations of why the message is or is not scam. If the sender's email service provider is supported by the scam blocking, then the response, in some embodiments, includes an offer to sign up, potentially including an offer, a discount, an invitation code, or an advertisement associated with the profile of the sender (or user, if, for example, the person is a service subscriber). In some embodiments, the profile of the sender/user is determined by the traffic observed associated with this user. For example, if a large portion of scam messages associated with the user are identified by rules belonging to a malware family, then the user is determined to have increased vulnerability to malware, and an anti-virus advertisement can be sent to her. Similarly, if a large portion of scam messages are determined to be related to rules that are in a romance scam family of rules, then it is determined that the user may have increased vulnerability to these types of scams, and appropriate security products and publications can be suggested to the user. In another example, suppose that a large amount of non-scam traffic associated with classified advertisements website such as Craigslist is observed with a user account, and as a result, the system determines that the user is at increased risk of scams normally targeting Craigslist users; as a result, a secure payment service is advertised to the user, the benefits of which in the context of Craigslist transactions, for example, can be explained in the advertisement. In some embodiments, this applies to users of the filtering service, in which case advertisements can be either included in existing traffic or additional messages sent to the user, where these may either be of the same type as the filtered traffic. In other embodiments, another channel is used, e.g., hardcopy mail or SMS advertisements, for a user whose emails are protected.

Rate Limiting Scammers

The use of the disclosed technology can impact scammers' ability to get scams delivered to victims, and scammers may potentially attempt to adjust their tactics. Scammers may want to avoid systems with the described detection capabilities, and attempt to reverse-engineer them. For example, scammers may attempt to mine the automated system to pre-determine what will or will not be caught before they attempt a large scale distribution of their scam communications.

In some embodiments, to prevent scammers from gaining too much insight in how the scam evaluation is performed, the responses can be throttled based on various characteristics including but not limited to the following:

The sender's identifier, such as an email address;

The sender's channel identifier such as an Internet Address;

The message subject or body contents—The message contents may be only slight variations on similar previous messages to determine the bounds of the ZapFraud detection; and

The rate at which messages are arriving.

Messages can be correlated across senders, channels and content to determine if scammers are attempting access from many paths, for example, using a “horizontal” approach, which includes many attempts from many senders. The content and rate can be evaluated for each single path to determine if a “vertical” approach, which includes many attempts from the same sender, is being used to mine the system.

The response to potential scam messages can be varied by characteristics including but not limited to the email address, email domain, IP address, IP address range, country, internet hosting service, phone number, phone number blocks, instant messenger ID, message contents, or send rate. These can be used individually or in combination. For example, if alice@evil.com and bob@evil.com are sending email messages with variations of the phrase “you have won the lottery” at a sustained rate, then the message contents, the channel, and the rate can be combined to modify the response to these messages.

When attempts to mine the system are detected or suspected, the system can modify its responses in a variety of ways including but not limited to:

Temporarily or permanently block the sender based on their ID, like email or instant message ID;

Temporarily or permanently block the channel identifier like an IP address;

Tell the user that their access has been permanently or temporarily blocked because they have sent too many requests or too many suspicious requests;

Slow response—Queue requests based on various correlated factors including but not limited to sender ID, sender channel ID, or content then wait increasing periods of time before responding to each item in the queue. For example, the more requests or suspicious requests sent during an interval the longer the responses will take with each response delay being as long as or greater than the prior response;

No response—quietly drop the request without telling the sender;

Simple Puzzle—The user can be asked to solve a simple puzzle like a CAPTCHA before sending a response; This puzzle can be hosted on a web page that captures the sender's IP address to confirm that the email IP and web IP correlate.

Ask the user why they think it might be a scam—Send the user a question about the message they sent like “What makes you suspect that this is a scam?”. Then evaluate whether the response is consistent with their initial email. Also, evaluate how long it takes the user to respond;

Evaluate a different candidate scam—The user can be shown a different scam email and asked whether they think the email is a scam; and

Misinformation—When the system is reasonably certain that it is being mined, it can provide vague or even incorrect results to the sender.

This can be applied both to the standard Filtering methods that block offending emails from the inboxes of subscribers, and the above-described auto-response technology that does not require users to be registered subscribers.

Rate Limiting Organizations

The automated detection and response system described above can be limited to certain classes of user, such as registered users, or only consumers. The system can limit the number of attempts per period based on various characteristics including but not limited to sender's id, sender's country, sender's communication channel, or sender's organization.

For example, a corporation, “we_r_cheapskates.com,” may tell their employees to use what is intended as a free consumer-only version of the system instead of paying for a corporate subscription. When the system detects that 10 messages have been checked in a 24 hour period, we_r_cheapskates.com is blocked from additional valid responses and receives one of the response options listed above. The time window can automatically reset after a delay.

In another example, an individual may attempt to forward all his incoming emails to the described system to discover scams, but in some embodiments this is an abuse of the service and the user stops receiving responses after the user has sent messages exceeding a threshold rate (e.g., 12 messages in one hour).

Scam Detection Filters

Overview

FIG. 2 illustrates an example embodiment of an analytics engine. In some embodiments, analytics engine 200 is an example of analysis engine 112 of FIG. 1C. In some embodiments, the analytics engine is configured to sequence through a set/array of filters 201-208. The filters can be applied sequentially or in parallel. Each filter can be configured by a set of rules. In some embodiments, the configuration for filters 201-208 are obtained from configuration 210 (which in some embodiments, is an example of configuration 120 of FIG. 1C). The configurations can be fed to the filters at startup. The configurations can also be fed to the filters at runtime. For example, incremental updating can be performed as new rules are authored/configured, for example, using the training described above. This allows retraining and updating to be performed without stopping the scam evaluation system. As described above, complete retraining of the system can also be performed.

In some embodiments, scores are generated based on the filtering. The scores can be used to indicate the likelihood that the message is scam. Further details regarding scoring are described below.

Phrase filter 201 is configured to search for distinct phrases/sets of phrases within a message. In some embodiments, each individual filter within the phrase filter is associated with a corresponding rule. For example, each rule matches to a particular phrase. Examples of three rules are “I am the,” “happy and cheerful,” and “decent girl.” Messages that contain those three phrases are determined to be a match to the phrase filter. Phrases can be mixed to determine different matches. Additional phrases can also be added. In some embodiments, the configuration of the phrase filter is obtained from configuration 210. The configurations are fed to the phrase filter. For example, as described above, authored rules for additional phrases can be added to the phrase filter, either as part of a complete retrain, or as part of incremental training/updating (e.g., where the phrase filter is refreshed at runtime). Further details regarding phrase filters are described below.

String filter 202 is configured to identify strings within a message. Further details regarding string filters are described below.

Region filter 203 is configured to filter messages based on associated geographic region(s). In some embodiments, the geographic regions can be overlapping. Logical regions can also be configured for filtering messages. Further details regarding the region filter are described below.

Whitelist/blacklist filter 204 is configured to filter messages according to a whitelist/blacklist of sender entities. As one example, known/trusted domains can be added to a whitelist, where messages from such sender domains are assumed to be non-scam. As another example, whitelists can be configured for senders known to the recipient of messages. Similarly, blacklists of senders can be implemented. Messages from those senders on the blacklist can, for example, be blocked. In some embodiments, different scores can be assigned to different senders based on various characteristics (e.g., whether the sender is a business or a friend). White/blacklist filters will be described in further detail below.

Image filter 207 is configured to identify potential scams by processing images that are embedded or attached to messages. For example, rather than having text in a message, scammers may instead place the entire message text into an image (e.g., a text message). As another example, messages may be received that include text with images, text with pictures in the image, etc. In some embodiment optical character recognition (OCR) is used to extract text from embedded/attached images. The extracted text can then be further processed using text filters.

As another example, scammers, such as romance scammers, may include pictures of attractive women and men, and in targeting victims, reuse the some pictures multiple times. In some embodiments, such images are captured and then detected by the image filter. Further details regarding image filters are described below.

Document filter 208 is configured to filter messages based on documents attached to messages. For example, scammers, similarly to messages, may include the scam as an attachment to a message, while keeping the message body short. Thus, the scam is primarily included in the attachment, rather than the message. The document filter is configured to process the attached documents, which may be in various forms, such as Microsoft® Word .doc files, Adobe® .pdf files, etc. Further details regarding document filters will be described below.

New filter 206 include new filters that are added to the analytics engine over time (e.g., as new scam strategies are observed). For example, the new filters can be added based on the dynamic filter updating/training described above. For example, a subject line filter that processes and evaluates subject lines can be added to the analytics engine 200. Further details regarding new filters are described below.

Compound filter 205 is configured to combine together the results of the other filters. As will be described in further detail below, while rules configure filters, rules can also belong to families. For example, a romance family of rules could be configured. As another example, a 419 scam family of rules can be established. As another example, a set of rules under an “esophageal cancer” family could be configured. Families of rules can also be configured based on other attributes/characteristics, such as regions. For example, rules related to Nigerian scams, Eastern European scams, etc. can be configured. Thus, a single family can include multiple rules, with multiple rules potentially firing within a family for a given message. In some embodiments, the compound filter is configured to combine the scores so that they do not exceed a threshold bound. For example, if multiple rules fire within a family, the highest score for any rule in the family is used for that family. As another example, if there are three bad URLs in a message, then the URL with the highest score is taken and used to calculate a final, overall score for the message.

As one example, in order to calculate a final score, if no compound rule(s) apply, then the scores of the individual filters are summed together. If a compound rule is to be applied, for example, because there is both a romance scam and a bad sender, the two families of rules are combined together, where the highest score from each family are taken and used to determine the resulting overall score.

As another example, suppose that the message is determined to be a romance scam that is also from Nigeria. In this example, the message is given a maximum score of 100 (e.g., the highest score possible indicating that the message is scam), regardless of whatever the individual romance or Nigeria region score might have been. This provides additional flexibility. For example, suppose that a message body appears to be exactly like a message from a known entity, Acme Payments. Based on an evaluation of the message body, the message would be given a low score. However, based on an evaluation using the whitelist/blacklist filter, it is determined that the sender is not associated with Acme Payments. If such a combination of an Acme Payment message from a non-Acme Payment sender has not been seen before, a compound rule can then be written to give the message a high scam score. This will negate/substitute/replace the individual scores determined based on the message body and the sender.

In some embodiments, the filters are implemented in a language such as Java. The filters can also be implemented in hardware, for example, using a field-programmable array (FPGA), application-specific integrated circuit (ASIC), a hardware pipeline type architecture such as a graphics pipeline processor, etc.

In some embodiments, the analytics engine is implemented as a Ubuntu process that has loaded a Java virtual machine. The filters can be implemented as .Java classes. Configuration 210 can be implemented as a flat file or rows of a database table, where each row in the table is a rule.

In various embodiments, the Analytics Engine described above is configured to wait for new messages to arrive on a variety of communication channels including, but not limited to, email, SMS, or voice message. In other embodiments, the system polls a message source for new messages. For example, an email account or a voice mail inbox can be regularly or randomly checked for new messages.

The polling can be initiated by various external triggers including, but not limited to:

User movement—The movement of a user's device such as a phone/mobile device can indicate that she is about to check messages. The inertial sensors in a mobile device such as a smartphone can monitor and report this movement;

User's location changed or stopped changing—The user may check messages while moving to a new location or when he arrives at a new location. A mobile device such as a smartphone can monitor the user's location and report changes to the system;

Different Device—When a user is recognized on a different device, a poll can be initiated;

User starts checking messages—If a user begins to check her messages, a poll can be initiated. For example, in some embodiments, messages can be checked just after a user opens a mail reading application on her smartphone and the message check can be completed before the user is shown any messages;

Cross channel checking—When a user begins checking messages on one channel, a poll of messages on other channels can be initiated. For example, if a user starts checking voice mail, he will likely check email next, so the system reviews emails for potential scam even before the user opens the email application; and

Cross Account Checking—Accessing messages on one account can be used as a trigger to poll other accounts. For example, users frequently have multiple email accounts, so when a user starts reading emails on one account, the user's other email accounts can be polled as well.

In some embodiments, a separate computational thread is used for each distinct receiving account which can include, but is not limited to, an email account, a voice mailbox, or a phone number receiving SMS. The thread can sleep for a short interval if polling is used, for example, for a duration of one to 300 seconds.

In some embodiments, the channel supports “notification events,” where a request is sent to the message service requesting a notification when there is a new message. The requesting thread can sleep without polling and be woken up only when there is a new message. For example, using the Gmail mail service, a third party requests a notification by sending an IMAP IDLE request to the service and then waits for new mail. This removes the polling overhead at the message service and the requester.

New messages are retrieved from a message server and passed through a series of Filters. Each Filter runs a set of Rules for that Filter. The Filters (see FIG. 2) can include, but are not limited to the following examples:

Phrase Filter (201)—Detects specific phrases in a message that tend to indicate potential scam. For example, the phrase “I am the widow of a Nigerian minister” is a strong scam indicator. In one embodiment, the Phrase Filter uses both Rules and Equivalent Phrases as described below.

String Filter (202)—Detects specific strings or regular expressions in a message that indicate potential scam. For example, HTTP links to internet domains that are used to host scam content can be identified.

Region Filter (203)—This Filter is configured to detect the geolocation of the message source. Messages from some locations, such as Nigeria, are much more likely to be scam. Cross border messages are also more likely to be scam. For example, an email or phone call from Nigeria to someone in the United States is more likely to be a scam.

WhiteList/Blacklist (204)—This Filter is configured to compare the sender's identifier, which can include email address or phone number, with a whitelist of good senders known to the user, and/or compares it to a blacklist of known scam sources. For example, Amazon.com is unlikely to send scam emails but suppose that badguy@evil_intent.org has been previously detected as a scammer. The Whitelist/Blacklist Filter can be applied to specific sender email addresses or to entire domains. For example, everyone at evil_intent.org can be blacklisted, not just badguy@evil_intent.org.

Image Filter (207)—This Filter is configured to detect images that are used by scammers. For example, in romance scams, the same image of a pretty woman is often used across many different scam sending email accounts. These images can be embedded in the message, attached to the message or could be HyperLink references.

Document Filter (208)—This Filter is configured to detect document attachments, such as DOC, DOCX, PDF, RTF, XLS, XLSX, PPTX and others that are used by scammers. These can include but are not limited to fake identity documents, fake business agreement, invoices or contracts. In some embodiments, the Document Filter can detect previously seen documents or can extract the text content to process for suspicious words like the Phrase Filter. The Document Filter can extract text from image attachments such as PNG, JPG, GIF and others to process for suspicious words.

Compound (205)—Compound Filters are configured to allow the combination of other Filters using, for example, Boolean or arithmetic expressions to refine the Filtering capabilities of the system.

Each of these Filters is described in more detail below.

Additional Filters (206) can be defined and incorporated into the Analytics engine. Filters can be configured to focus on a single component of a message or can combine factors across message parts. For example, a Filter can be configured to detect messages that come from a suspect country based on header IP information and contain the phrases “Nigerian widow” and “send money.”

In some embodiments, each Filter is configured through one or more Rules that are found in Configuration (210). In some embodiments, each Rule has a distinct ScamScore indicating the likelihood of scam. If a message matches one of the Filters, it is recorded as “a hit”. Additional information, such as Equivalents, described in more detail below, can be used to configure Filters as well.

If a Rule hits, the ScamScore associated with the Rule is associated with the message. ScamScores can be tallied after all Filters have been run and compared with thresholds to determine the disposition of each message. In some embodiments, each Rule has its own ScamScore. In some embodiments, the higher the ScamScore, the more certain that it is a scam.

In some embodiments, all messages are passed through every Filter. In other embodiments, Filters are prioritized so the biggest catchers are run first, for example, as a performance optimization to minimize system loading or response latency. Here, a Filter corresponds to one or more Rules. Rules are described further below. In some embodiments, the relative quality of all Filters is constantly evaluated and accordingly, all Filters are run. In such a scenario, the optimization of running fewer Filters or Rules can be used selectively, for example, depending on loading conditions.

Further details regarding filters, including additional examples of filters are described below.

### EQUIVALENTS

In one embodiment, equivalent terms are a component of configuration (120) as shown in FIG. 1C. Similar to other configurations (120), equivalents can be used to control the behavior of Filters. Before messages are passed through the Filters, equivalent terms can be substituted. This simplifies the definition of the Rules and makes it easier to define Rules at the concept level, instead of at the word level. This has the benefit of reducing the number of Rules needed, and the overlap of similar Rules.

In the following example, any word or phrase found in the right box in a message will be replaced by the term in the left column.

TABLE 4

| | |
|---|---|
| death | dead, died, late, murdered, killed, live, die, passed |
| | away, dying, deceased |

TABLE 5

| | |
|---|---|
| attorney | attourney, barrister, lawyer, legal practitioner |

Equivalents can also be used to replace spelling errors, contractions, abbreviations, grammatical errors or language variations, as shown in the following examples:

isn't: isnt, aint

color: colour

Equivalents need not have the same meaning. For example, the following words and phrases are equivalents in some embodiments:

money: dollar, usd, money, gold, western union, yen, pounds, euro, personal check, wire transfer, cash, millions, rich, you won the lottery

Referring to FIG. 1C, in some embodiments, these equivalences are stored and retrieved from storage (120) to be replaced with the equivalent terms. In other embodiments, the equivalences are implemented as different paths in a graph such as an Aho-Corasick graph. The Aho-Corasick graph is an algorithm capable of comparing large data sets to one or more patterns to be identified in the input. In some embodiments, the Aho-Corasick graph is used to incorporate the equivalent terms, and in other embodiments, the graph is constructed from the equivalent terms which are stored in, and retrieved from, configuration (120). One type of equivalence is any geographic location (city, state, country) in Africa, which can be generated using a large look-up table of all African cities, states and countries. Since such a lookup is computationally costly, in some embodiments, it is performed only in cases where the score of the email is sufficiently high to warrant extra work, but not yet sufficiently high to determine that it is a scam. Thus, the evaluation of some rules may be conditional on the result of the evaluation of other rules. Similarly, it is believed that many scammers have poorer spelling than typical enterprise users, but it is very computationally costly to scan all messages for spelling errors. This can be done in batch mode to identify likely common misspellings. Since many scammers commonly reuse text, such misspellings can be used to identify scam messages.

Rules and Filters

Filters are implemented to perform a particular check on each message. In some embodiments, Filters are controlled through configuration (210) as shown in FIG. 2. For example, the Phrase Filter discussed below is given a set of phrases through configuration (210) that includes Rules.

Rules can be provided to the Filter when the described system is started, and they can be updated while the system is running as needed (i.e., at runtime). Rules can be adjusted very quickly in response to changing system conditions, such as heavy or light load, or in response to changes in scam patterns. In addition, Rules can be adjusted slowly over time to improve overall system message classification and/or to reduce the impact of inaccurate classification by newly introduced Rules.

In one embodiment, Rules that detect messages that are not scam are associated with negative scores.

In some embodiments, New Rules are deployed with a low ScamScore and their ScamScore is increased as their value is verified. A total Message ScamScore can be computed for each message by combining Rule ScamScores from the results of one or more Filters, in turn corresponding to one or more Rules. All Rule ScamScores need not be combined. Instead, for example, Rules can be grouped into Families of related Rules, and for each Family, the highest value of all the ScamScores hit within a Family is output, after which these output Family ScamScores are combined. One way of combining such ScamScores is by adding them together. Another way of combining such Family ScamScores is through an algebraic or Boolean logic expression using the ScamScores. The combined Message ScamScore associated with a message is compared to at least one threshold, and a disposition decision is made accordingly. For example, if the combined Message ScamScore exceeds a first threshold T1, which as one example is set to 80, then the corresponding message is considered scam. If the combined Message ScamScore does not exceed threshold T1, but exceeds threshold T2, which as one example is set to 65, then the corresponding message is considered suspect. If the combined Message ScamScore is below a third threshold T3, which as one example is set to 8, then the message is considered safe. Additional thresholds can be used to classify messages into various degrees of certainty and risk.

Configuration

In some embodiments, configuration includes data in a data-driven interface for programming and improving the system. Together with versioning and change management, configuration provides the system with several properties:

system behavior can be altered easily;

system behavior is deterministic;

system behavior can easily be restored to a prior, known good state; and

researchers can share experimental environments.

In some embodiments, sensitivity of system performance to configuration can be tuned (e.g., such that it is extremely sensitive to configuration). For example, substantial change to a single Rule's thresholds, or addition or removal of a single term or phrase from a phrase Rule, can result in very different classification for a given message.

Consider the following three example Rules:

TABLE 6

| Rule | Phrases/Terms | Family | Score |
|---|---|---|---|
| Rule1 | collect, jackpot | lottery | 40 |
| Rule2 | pleased to announce | lottery | 40 |
| Rule3 | Lagos, Nigeria | country | 40 |

If, for example, the threshold for deleting a scam message from a user's account is 80, then a lottery Rule firing in conjunction with a country Rule will cause the scam to be deleted. In some embodiments, a country Rule fires when the sender's IP address can be mapped back to a region named in the Rule's terms field—in this case, Lagos or Nigeria.

Suppose, for example, that user Mary sends Bob a message that says, “I'd be pleased to announce to your parents that I will buy you that Ferarri when I collect that $80M SuperLotto jackpot”. Although two Rules will fire (Rule1 and Rule2), only one Rule will be counted by the corresponding filter because they both belong to the “lottery” Family (e.g. in the Rule 2 row, the content appearing in the “family” column). In this example, the ScamScore for the message is 40. In this example, it is not deleted from Bob's account.

Now assume, for example, that a system operator changes the Family value for Rule 2 (e.g. the value shown in the Rule 2 row in the “family” column) to “Announcement”. Mary's message will now trigger the same two Rules, but both Rules will be counted by the filter because they are in different families. The message's score is now 80, and Mary's message is deleted from Bob's account.

Scoping

In some embodiments, configuration can be set system-wide. Configuration can also be scoped to different stakeholders or users of the system, or to specific operators or classes of operators of the system. As an example of the latter, suppose that Fred and Dave are both system administrators, and each experimentally tests new Rules. Suppose that Janette is a researcher interested in real estate scams. In some embodiments, she can test her Rules in a sandbox that allows her to run prescribed datasets through the system. In some embodiments, any changes she wishes to make that would influence the behavior of the system as it processes user messages is required to be reviewed and integrated into the system by Fred or Dave.

In one embodiment, certain Rules or Families of Rules are only applied to communications received by users who have enrolled into a service at the behest of an organization. An enrollment step for potential new users of the system can require entry of a code which corresponds to an organization. This code can be used to look up an identifier corresponding to the organization, and this identifier is then added to a database record representing the user's enrollment data. This organization identifier can be used to determine which configuration data (e.g., enterprise-specific Rules) should be used to detect scams in the user's communications. Similarly, threshold values for Rules can be set at an organizational level.

Suppose, for example, that Jared is a senior citizen to whom a service based on the system described herein was recommended by an organization such as Acme Retired Persons Association (referred to herein as “ARPA”) newsletter. While enrolling, Jared supplies the enrollment code “arpa2015” as described in the newsletter. His enrollment record is now associated with the ARPA organization. Rules specifically crafted for ARPA, such as called “retired”, “fixed income”, and “personal safety” are loaded for him, in addition to other Rules shared by most other users. In this example, Rules from the Rule Family “romance” are specifically removed from the set of Rules that will be used to monitor Jared's account, as he is believed to be statistically less vulnerable to that class of scam.

In another embodiment, as a member of the ARPA, the email address Jared supplied to the ARPA when he joined would be enrolled automatically by the ARPA. This enrollment could occur through an interface made available to organizations such as the ARPA that can include, but would not be limited to, any of the following example implementations:

an email sent from an ARPA server to a mail server within the system. The system maps the sender's email address (an ARPA mail server) to the ARPA, a registered organization;

an HTTP POST request containing Jared's email address and the organization code for the ARPA; and

a similar message encoded using the SOAP protocol

TABLE 7

| Org/Partner ID | Action | parameter |
|---|---|---|
| 556 | Enroll | jaredh@mailservice.com |

Suppose that Mary has heard, from a friend, about a scam evaluation system based on the techniques described herein. She visits a site associated with the system and clicks a web link captioned “Enroll.” In some embodiments, her enrollment is associated with a default configuration. Days later, she receives a targeted email purporting to be from Run Bank, which is her bank. The message claims that a security breach has occurred, and urges her to change her account password immediately, and supplies web links to do so. These web links lead to very realistic pages. She forwards the email to a scam email evaluation service described further below and is not surprised to learn that the email message was indeed a scam. She re-enrolls herself in the service, this time electing to subscribe to a higher level of service that, in one embodiment, presents her with a menu of scam types for which she would like elevated monitoring. She chooses a scam type entitled “financial.” In this example, her choice lowers the delete threshold for all Rules belonging to the Rule families “financial” and “fishing”. As one example, the Rule Family “financial” includes phrase Rules with the terms and equivalents (discussed further below) such as “security breach, account, compromised, re-confirm, password, username”. In some embodiments, the Rule Family “fishing” is a collection of pattern matching Rules (discussed further below) that examine web links and match them against both blacklisted and whitelisted web addresses. In some embodiments, the fishing Rule collects all unrecognized web links for further analysis.

In various embodiments, scopes for configuration data can include, but are not limited to:

Organization—The configuration protects the organization from exploits to which it (or their users) are judged to be likely targets. This could include Rules specific to the elderly for the ARPA, or Rules for advance fee fraud scams for digital payment platforms, etc.;

User—Configuration attached to a specific user. In the example above, Mary has paid for premium service and has indicated areas of concern to her for which she receives enhanced protection;

system administrator, researcher, or other operator classification—System administrators and researchers require “sandboxing” to allow them to experiment without impacting the monitoring of user communication accounts; and

Rule families or classifications of scams—configuration data can be set targeting only specific classifications of scams (see “scam types”, farther below), or specific Rule families. For example, vulnerabilities, discussed further below, can serve to modify the behavior of only certain families of Rules.

Configurations so scoped can be influenced by factors including, but not limited to:

user communication history—for example, information derived from SMS folders or email folders such as inbox, sent mail, spam, trash, etc. The ability to inspect past mail in the user's inbox, for example, permits the construction of communication graphs to support Rules that detect unfolding scam plots, as discussed further below. In some embodiments, individual communications in an unfolding plot may be insufficient to detect a scam when considered individually, but when considered together, are sufficient to recognize a scam plot; and

vulnerability scores (discussed below) maintained on a per-organization, per-enterprise, and/or per-user, basis.

Vulnerabilities

Certain classes of users may be more vulnerable than the general public to certain classes of scams. For example, retirees may be more vulnerable to home equity fraud or threats of physical violence, while singles may be more vulnerable to romance scams. Enrollments obtained through an organization can support useful assumptions about such enrollees in aggregate. However, specific information about individuals supports more accurate message classification and scam recognition. The bases for this classification can include, but are not limited to:

information the system is able to glean from the Internet—For example, for SMS enrolled users, the system can use a yellow pages service to look up phone numbers and correlate them to names. As another example, using social security data, names can be correlated to probable gender. With this information, the system can load gender-specific Rules for more optimized protection. For example, romance scams targeted toward male victims feature pictures of attractive women; romance scams targeting women stress financial security or wealth.

The system can maintain per-user vulnerability values in with categories such as “romance_male_for_female”. Filters can be designed for new Rule types with behavior based on thresholds for relevant vulnerability values. In the case of romance_male_for_female, an image recognition Rule (as described herein)—(which may be potentially too computationally expensive to run for all users)—can attempt to match images to a gallery of photos of attractive women collected from different dating sites, from previous scam attempts, or from other sources;

from public records—Recorded liens and judgments, for example, can be used to provide indications of an individual's financial strength; lack of financial strength can correlate with vulnerability to more overt forms of financial fraud, such as pyramid marketing schemes. A user with more than one lien or judgment against them can have a vulnerability of category “financial” (vulnerability: financial) associated with their enrollment record. With this vulnerability set, any yellow (mildly suspicious; see farther below) Rule hit can initiate an examination of the user's inbox for prior communications from the sender;

user opt-in—The system can present choices and users may elect to be protected from certain categories of scams, which in some embodiments can correspond to raising or lowering per-user thresholds for Rules or Rule families, or to altering a per-user and/or per-category threshold (for example, per Rule Family) which is then considered by Rules. In one embodiment, these thresholds are the ScamScores for the Rules themselves, which are loaded into the current processing context when messages for corresponding user are being processed. In another embodiment, the Rules remain the same, and threshold data is read from the user's enrollment record to modify the behavior of the Rules:

The user opt-in basis further allows changes to the user's enrollment record can be made, for example:

by the user him/herself, at enrollment or subsequently. For example, a user can decide that they would like to be more protected due to some incident like possible identity theft;

by a third party enrolling the user with or without his/her knowledge or consent, such as a parent or guardian;

by the user, post-enrollment, for example, in response to feedback provided to the user by the system; and

by a third party service that notifies the system that an account requires a change in the level of protection. For example, a corporate email account can require additional protection because a recent spate of targeted phishing emails has been detected.

The user opt-in basis further allows for protection of emotional well-being can also be provided. For example, following critical or bad life experiences, users may appreciate or benefit from not being exposed to certain types of messages. For example, a recent romance scam fraud victim may appreciate a respite from dating site solicitations and/or updates. When a particular vulnerability is established for a user, e.g, vulnerability: romance, senders such as online dating services such as match.com and okcupid.com are added to a per-user blacklist. In addition to users opting themselves into such protection, organizations and enterprises may set such protection for its users.

The user opt-in basis further allows for temporal/temporary protection—Protection Rules such as the emotional well-being Rules like those described above may be set with expirations, so that their functionality is automatically disabled after T units of time have passed (example: T=10 days) or until date D (example: Jul. 15, 2015), or after a specified event takes place (no scam messages of a certain type or Family is received by the user within a specified number of days, e.g., 21 days).

The bases for the classification can further include, but are not limited to:

data gathered from organizations encouraging or managing an enrollment campaign into a service implementing the system described herein. For example, an organization supporting victims of romance scams, by encouraging enrollment in a service implemented with the system described herein, may thereby provide classification of corresponding enrollments as users potentially vulnerable to future romance scams;

history of prior user communications, for example, a user's email inbox folder, sent mail folder, spam folder, trash folder, etc.;

history of user communications collected by the system while processing communications and detecting scams; and

history of communications from, or with, whitelisted or blacklisted senders.

In some embodiments, vulnerabilities can be implemented as a flexible data structure with variable syntax. For example, representing a binary value:

vulnerability: “no_romance”

In some embodiments, setting this causes to be blacklisted all known dating sites for this user. In another case, a vulnerability can be implemented with one or with one or more threshold values; for example

vulnerability: financial, 20

This can be used to indicate that the delete threshold for any Rule-hit in the Rule Family called “financial” is set to 20 for this user, whereas previously, it may have been 80.

Alternatively,

vulnerability: financial, 1, 20

This can be used to indicate that the system will categorize any communication for this user from the financial Rule Family triggering a Rule hit with Message ScamScore between 1 and 19 as yellow, and delete (categorize as red) any such communication with a Message ScamScore 20 or greater. Message classification is described in further detail below.

Versioning and Change Management

As described above, system performance can be configured to be sensitive to configuration. For example, either a substantial change to a single Rule's thresholds or the addition or removal of a single term or phrase from a phrase Rule can result in very different classification for thousands or even tens of thousands of communications. If this is not what is intended, it may be desirable to revert to a known earlier state quickly and with precision. For example, in the worst case, legitimate communications could potentially be misclassified and deleted before they are seen by users. Thus, changes with unanticipated outcomes should be identified and corrected quickly.

In one embodiment of configuration change management for the system described herein, all discrete configuration data are stored to a file system called a repository.

In some embodiments, a repository is implemented in a manner similar to a traditional file system, but with the following example properties:

file versions are immutable—A previous version of a file can always be recovered. Data is never destroyed;

the repository contents (files and their versions) are immutable—For example, new file versions are added, but previous versions are never changed or deleted. Therefore, files deleted from the repository can be recovered;

files can be selected by version;

the repository state (files and their state) can be selected by version; and

repositories themselves can be cloned and merged. For example, a master repository can be implemented. For example, suppose that Alice clones it to create a copy for herself. She makes private changes. Bob clones the master repository. He also makes changes. Alice merges her changes back to the master repository. Bill clones the master repository. He sees Alice's changes. Bob merges his changes. Now Bob and Alice's changes are visible to anyone who clones the master repository. Bill fetches the changes from the master repository, which merges his private work (if any) with Alice and Bob's changes.

The following is an example of discrete configuration data for an equivalence term definition:

TABLE 8

| Term/Phrase | Equivalents |
|---|---|
| your profile | your picture, your pic |

The following is an example Rule definition (abbreviated for clarity):

TABLE 9

| UUID | Name | Type | parameters | Family |
|---|---|---|---|---|
| 475b2741 . . . | years old | Phrase 1.0 | years old | romance |

Discrete configuration data can be stored to and retrieved from the repository as source files authored in, for example, a markup language such as YAML. Configuration data can be consumed by Filters to detect specific patters in message traffic. For example, a Region Filter implemented to identify the geolocation origin of a message, can be configured to look for messages from Bosnia and Herzegovina, and assign a ScamScore equal to 20 if it matches. In various embodiments, each Rule file can contain one of more of the following:

id—a record identifier so the record can be uniquely identified locally. For example, a record index in a database table;

UUID—A Universal Unique Identifier that allows this record to be uniquely identified in any context;

Rule Type—The Filter Type that is configured by this Rule. For example, a Rule for a Phrase Filter can have a type equal to Phrase. The Rule Type can contain a version number to allow for changes in how a rule is interpreted by a Filter. For example, a Rule with type equal to “Phrase 2.0” can be configured to interpret and understand the use of wildcard or regular expressions, such that a ‘*’ in a rule will be used in a wildcard match, but a ‘*’ found in a “Phrase 1.0” rule will not be treated as a wildcard;

Name—A common name that can be used by users to reference the rule. For example, a rule could be called “mugged” rather than by its UUID;

Autho—The name of the person or system that created the rule;

Parameters—The parameters include values that are used by the Filter. For example, the parameters “introduce myself, inheritance, contact, immediately” are used by the Phrase Filter to identify possible inheritance scams;

State—The state of the Rule indicates how a Filter should treat a rule. In various embodiments, the state includes one or more of the following: enabled, disabled, test mode, retired, or deleted;

Language—The language that this Rule can be applied against. For example, some Phrase Filter Rules are applied only to specific languages. As one example, a particular rule can be configured to only apply to messages that are in German because the words are only German words;

Score—The ScamScore that is applied to any message that matches this Rule;

Created At—The date or timestamp that this Rule was initially created;

Update At—The date or timestamp that this Rule was last updated;

Family—The logical group or groups that this Rule is included in, as described below; and

Predecessor—When a Rule is a derivative of previous Rules, their UUIDs can be added to the Predecessor field. This field permits the tracking of Rule evolution over time. For example, if the Phrase Rule “introduce myself, inheritance, contact, immediately” is an augmentation of the Rule “introduce myself, inheritance, contact” the former Rule is identified in the Predecessor field. The performance of these two Rules can be compared through the linkage by the Predecessor field.

The following is an example of contents of a source file d14e62e2-45a8-11e4-9a17-000c29aa4068:

−−− !ruby/object:Rule

attributes:
id: 1695
uuid: d14e62e2-45a8-11e4-9a17-000c29aa4068
Rule_type: Country 1.0
name: Bosnia and Herzegovina
description: Bosnia and Herzegovina
author:
parameters: ba
state: 1
language:
score: 20
created_at: 2014-11-20 18:25:11.000000000 Z
updated_at: 2014-11-20 18:25:11.000000000 Z
Family: country
predecessor:

In some embodiments, each configuration file is then given a version identifier representing a globally unique digest of its current contents. An example file version identifier (here, a SHA-256 digest) can be shown by, for example, interrogating the repository:

$ git ls-files -s d115ae61-6208-11e4-bf10-000c291bdd72

100644 6e0b18daf42a0a54f310e48c79d760d1505bfa44 0 d115ae61-6208-11e4-bf10-000c291bdd72

Where git is a utility for accessing the repository and is-files is a command to list the information. Here, “d115ae61-6208-11e4-bf10-000c291bdd72” is both the UUID (universal, unique identifier) of the Rule, and also its file name. “6e0b18daf42a0a54f310e48c79d760d1505bfa44” is the SHA2 digest of the file's contents. SHA2 is a Family of well-known encryption algorithms that can be used for generating unique digests (hashing codes). Together, the filename (here, the UUID) and the file version identifier (the SHA2 value) uniquely specify a version of the file that can be retrieved at any time from the repository.

In some embodiments, when a system operator (or the system itself) wishes to introduce a new state to the repository, the system generates a version identifier. This version identifier can be a digest computed from the digests for all the individual files in the repository. As such, it guarantees that it can be distinguished from any different state by simply running the algorithm again, and comparing the new result to the identifier.

The system can supply the history of the creation of all such identifiers upon demand. In addition, this identifier can be saved elsewhere—for example, in the operator's user record—to record the operator's current configuration (in the case of operation within a sandboxed environment, for example), or it can be recorded as the system configuration used to process arriving (or system-fetched) user messages.

In some embodiments, the system stores the versioned contents of each file's data where it can be specified uniquely by, and retrieved with, a tuple comprising the version identifier of the file (truncated below), plus the filename. The following example shows an example content retrieval where ‘git’ is a tool to access a repository and ‘cat-file’ is a command to inspect the contents of a file named ‘8a56502’:

$ git cat-file -p 8a56502

−−− !ruby/object:Rule

attributes:
id: 1695
uuid: d14e62e2-45a8-11e4-9a17-000c29aa4068
Rule_type: Country 1.0
name: Bosnia and Herzegovina
description: Bosnia and Herzegovina
author:
parameters: ba
state: 1
language:
score: 20
created_at: 2014-11-20 18:25:11.000000000 Z
updated_at: 2014-11-20 18:25:11.000000000 Z
Family: country
predecessor:

The file can also be accessed with the repository version number plus filename. Here, in the following example, the version is first extracted with the command ‘git show’ as it existed in the repository identified by repository version ID “80d5cd37dfac38b2a6590a20ea73f98ced4a55bd.” The Unix utility “cat” can then be used to print the file's contents to the screen. For example:

$ git show 80d5cd37dfac38b2a6590a20ea73f98ced4a55bd-d14e62e2-45a8-11e4-9a17-000c29aa4068

$ cat d14e62e2-45a8-11e4-9a17-000c29aa4068

−−− !ruby/object:Rule

attributes:
id: 1695
uuid: d14e62e2-45a8-11e4-9a17-000c29aa4068
Rule_type: Country 1.0
name: Bosnia and Herzegovina
description: Bosnia and Herzegovina
author:
parameters: ba
state: 1
language:
score: 20
created_at: 2014-11-20 18:25:11.000000000 Z
updated_at: 2014-11-20 18:25:11.000000000 Z
Family: country
predecessor:

If a particular repository version is designated the active repository version, then the configuration file can be identified and accessed with a command like ‘git checkout’ and a filename such as ‘80d5cd37dfac38b2a6590a20ea73f98ced4a55bd’. The resulting file can be viewed with other tools like the Unix command ‘cat’:

$ git checkout 80d5cd37dfac38b2a6590a20ea73f98ced4a55bd

Note: checking out ‘80d5cd37dfac38b2a6590a20ea73f98ced4a55bd’.

$ cat d14e62e2-45a8-11e4-9a17-000c29a4068

−−− !ruby/object:Rule

attributes:
id: 1695
uuid: d14e62e2-45a8-11e4-9a17-000c29aa4068
Rule_type: Country 1.0
name: Bosnia and Herzegovina
description: Bosnia and Herzegovina
author:
parameters: ba
state: 1
language:
score: 20
created_at: 2014-11-20 18:25:11.000000000 Z
updated_at: 2014-11-20 18:25:11.000000000 Z
Family: country
predecessor:

In some embodiments, a repository version identifier such as “80d5cd37dfac38b2a6590a20ea73f98ced4a55bd” (or any unique shorter form) is sufficient to identify all the configuration files to be loaded into a newly started, or currently running, system. The configuration identified by this repository version identifier, subsequently loaded and used to process a prescribed input set of communications, yields a deterministic outcome. Therefore, a “rollback” of the configuration through the change management system will completely restore the scam detection behavior of the system to a prior state. (in some embodiments, because the system may make changes to the contents of the user's mail folders, the system may not necessarily restore the user's communication account—e.g., email—to its earlier state when a configuration is rolled back.)

Isolating Configuration Changes

In some embodiments, when an unanticipated change is discovered, the system can be queried for the history of changes. In one embodiment, the history of changes is a list of the new repository states. In the following example, the repository utility ‘git’ is passed the command ‘log’ to view the log of changes made across all files:

$ git log

commit 80d5cd37dfac38b2a6590a20ea73f98ced4a55bd

Merge: 06a3c5d fff828e

Author: <omitted>

Date: Sat Nov 29 08:16:50 2014-0800
Merge branch bob
*bob:
added reconfirm, re-confirm as equivs for contact

commit ffTh28e4a3419f9ebb5096a21c702cc8a4dc4452

Author: <omitted>

Date: Sat Nov 29 08:16:03 2014-0800
added reconfirm, re-confirm as equivs for contact

commit 06a3c5d06122ccd154a34f7c772ac8e1bab50632

. . . .

The system can be further queried to determine which configuration elements (files) changed between any repository state and its predecessor. In the following example the repository utility ‘git’ is passed the command ‘show’ to view the log of changes made to a specific file ‘fff828e4a34f9f9ebb5096a21c702cc8a4dc4452’:

$ git show fff828e4a34f9f9ebb5096a21c702cc8a4dc4452

commit ffTh28e4a34P9f9ebb5096a21c702cc8a4dc4452

Author: <omitted>

Date: Sat Nov 29 08:16:03 2014-0800
added reconfirm, re-confirm as equivs for contact

diff—git a/Equivs/contact b/Equivs/contact

index 3fda707 . . . fc94dca 100644

−−− a/Equivs/contact

+++b/Equivs/contact

@@−2,6+2,6 @@

attributes:
id: 163
term: contact

− equivalent: contacting,contacted,reply,response,respond,answer,get back

+ equivalent: contacting,contacted,reply,response,respond,answer,get back,## reconfirm,re-confirm ##
updated_at: 2014-11-03 16:09:17.000000000 Z
created_at: 2014-11-03 16:09:17.000000000 Z

Here, in the examples shown, the difference in the two configuration states, e.g. “reconfirm,re-confirm” (delimited with ##) is the term ‘contact’: it has had an equivalent, consisting of two single-word phrases, added: reconfirm, and re-confirm. If a body of test messages is run through the system using this configuration (“80d5cd . . . ”) and the prior one (“fff828 . . . ”), and the outcome for this one was judged to be inferior to its predecessor (for example, a lower percentage of scam messages were classified correctly, or a higher percentage of “good” messages were classified incorrectly) then it is determined that the addition of the equivalents “reconfirm”, and/or “re-confirm” for the term “contact” is responsible.

In some embodiments, the system can be run in parallel with two different configurations loaded, and the outcomes can be compared to determine the efficacy of one configuration versus the other. When the input consists of previously classified communications (for example, classified using TFIDF tables (described in further detail below) or through analysis of users' spam folders), the outputs can be analyzed to determine the percentage of scam messages allowed to pass (or the percentage blocked) or the percentage of non-scam (ham) allowed to pass (or the percentage blocked). The ratio of ham to scam for each configuration can be calculated. New system configurations can be tested and analyzed with metrics such as these before being put into production (e.g., deployed to process real users' accounts). For example, proposed configurations that do not improve upon the latest configuration's metrics can be rejected rather than deployed.

If scams (red communications) are deleted from the user's inbox as a result of system operation, green communications are not retained, and yellow communications are temporarily retained, then the outcome of the system's execution with a user's account as input is not, in some embodiments, reversible. However, if message deletion is journaled and all messages are retained, deleted messages can be restored.

In some embodiments, two configurations can be run serially on a single dataset. For example, serial operations can be implemented so that communications designated red (scam) by the first configuration serve as the input set for the second configuration. Alternatively, the second run can apply to only green messages (ham), or only yellow messages (suspect).

In one embodiment of change management for configuration data, the underlying version control behavior is provided by open source version control software, such as git. For faster and more convenient access to configuration data, the configuration state corresponding to a repository version identifier can be loaded into a database, such as a relational database such as mysql. Similarly, to answer questions about the relevant or available configuration data that can be applied to the system, one, several or all versions of all files constituting configuration data can be loaded into a database which can be implemented, for example, mysql. This catalog can then be used to select new or alternative configuration data with which to provision the system.

Phrase Filter (201)

The Phrase Filter (201) is configured to compare a set of phrases with a message. In some embodiments, each set of phrases is defined by a Rule. For example the Rule:

lottery,lotsofmoney,inform you,congrats

can be used to match a message containing all the words in the Rule, such as:

“We are happy to inform you that you have won the lottery. You will receive lotsofmoney after you fill out the forms. Congrats on your good fortune!”

But would not match:

“We are happy to inform you that you have won the lottery. Congrats on your good fortune!”

because it does not contain “lotsofmoney”.

In some embodiments, each one of the phrases (terms) corresponds to one or more words or an Equivalent term, as described above, and the combination of terms is used to define a Rule. The phrases are 5 words or less in one embodiment. In another embodiment, a phrase is one to ten words, and in yet another, there is no limit on the length. Phrases of any appropriate number of words can be specified/configured. In the above examples, in the parameters for the Rule, the phrases are separated by commas. Alternative representations can also be used. In some embodiments, all phrases in a Rule must be present in the message for it to be a match or “hit.” In some embodiments, rules to configure the phrase Filter are stored in, referring to FIG. 2, configuration (210).

As described above, in some embodiments, before the phrases are compared to a message, an equivalent word substitution is performed on the message. For example, “lawyer,” “barrister,” and “attorney” can all be equated to “lawyer.” Alternatively, the substitution can be performed dynamically/on the fly, for example, by encoding a multiplicity of Rules, each using a multiplicity of equivalence classes, using a graph.

In one embodiment, the phrases can contain wildcards to match up to N intervening words. For example, the phrase rule: “I am *4* girl” would match any zero to four words between “am” and “girl”. So, “I am girl”, “I am the girl”, “I am the decent girl”, and “I am the decent and cheerful girl” would be matched by this phrase. This allows a broader set of patterns to be matched with fewer rules.

The parsing of an input message can be performed in a variety of ways including, but not limited to, Aho-Corasick matching, which is used to represent multiple Rules in a condensed manner, and to perform parsing on messages in a rapid manner.

String Filter (202)

In various embodiments of the described system, a String Filter is configured to look for an exact string match or a regular expression in a message. For example, hyperlinks using internet domains jigsy.com or mow.so that have been previously linked to scam can be detected in a message. A String Filter can be configured with Rules, as described above, that are read from, referring to FIG. 2, configuration (210). A regular expression can also be used to match words or phrase using wildcards. For example, in the expression “i am the * and sociable girl” the ‘*’ can be a wildcard character that matches an arbitrary set of characters. This wildcard expression can then match a variety of phrases including “i am the decent and sociable girl” or “i am the cheerful and sociable girl.” More general complex regular expressions can be used to configure even more precise Rules for Filters.

Sender ID Whitelist and Blacklist (204)

In various embodiments of the described system, each sender's identifier, such as an email address or phone number, is associated with a score so that trusted associates and known good senders are not blocked, while known scammers are not permitted.

In one embodiment, a list of known contacts is put onto a Whitelist that is distinct for each monitored account identifier by one or more of the following techniques:

Reading the user's phone contact list when it is available—For example, on a smartphone the user's phone contact numbers can be accessed (if accessible);

Reading the user's email contact list—For example, a mail user's contacts lists on various mail services can be read through a programmatic interface;

Reading old emails in the user's inbox folder or other inbound folders and retaining the email addresses that did not send scam—For example, more frequent messages from a user tend to indicate a stronger association between the sender and the receiver so a stronger association is made. In one embodiment, a minimum number, such as 5, of non-scam messages from a sender is required before the sender is added to the Whitelist. For example, using an IMAP interface, the prior emails to the account can be read programmatically;

Reading old emails in the users sent folder retaining the email addresses—Since the monitored email address sent mail to the account, it is determined that there is a prior relationship. The more emails sent to the other, the stronger association between the sender and the receiver. In one embodiment, a minimum number, such as 3, of messages from a monitored account to another account is required before the account is added to the Whitelist. For example, using an IMAP interface, the prior emails to the account can be read programmatically;

In some embodiments, the Whitelist is built by recording the message addresses sent to a monitored account over time and how the receiver handles the messages. For example, if Alice receives and opens 5 emails from Bob, then Bob is determined to be a friend that is added to the Alice's Whitelist, but if Alice receives 5 emails from Carl and deletes them immediately or never opens them, Carl is not added to Alice's Whitelist; and

In some embodiments, the Whitelist is built by recording the message addresses to which the monitored account sends messages. For example, if Alice sends a message to Bob, then Bob is determined to be a friend that should be added to Alice's whitelist.

In one embodiment, each Whitelist entry is a Rule with an identifier such as an email address or a domain, and a Rule Score that indicates the strength of the association with the user. The Rule Score for each associated identity can be adjusted over time as additional messages are received and evaluated as described above.

In some embodiments, the Whitelist and Blacklists lists are built automatically, over time, based on the scam content of the sending message address and email domains. Each sender's channel address (for example, email address) is scored for scam, and each domain is scored for scam. In some embodiments, these Rule Scores are continuously updated each time a new message is received and evaluated. Alternative embodiments include:

Scheduled updates to the Rule Scores—For example, all Whitelist and Blacklist Rule Scores are re-calculated every hour;

Update of Rule Scores—For example, based on a trigger event which could include, but is not limited to, an administrator requesting an update, an increase in volume of messages from a user, a scam detected on a sender's account; and

The update of Rule Scores can be applied to one, some or all Whitelist and Blacklist entries.

In addition to each account having a user specific Whitelist, in some embodiments, good domains such as reputable internet commerce sites are put on a broader Whitelist that spans all users. Known scammer ids are put on a blacklist that spans all users.

In some embodiments, a WhiteList/Blacklist Filter looks only at the sender's ID, or the validity of the sender's id can be validated with channel information, like an Internet IP address. In some embodiments, when available, Internet IP addresses are gathered from the email message header. IP addresses can also be obtained by sending an image link to the suspect scammer as described below. For example, a valid email from a U.S. internet site should not have a sender's IP address in Nigeria.

In various embodiments, Whitelist and Blacklist entries can be individual sender's IDs or can be broader groups. For example, email addresses can include domains or specific email addresses. The following are examples of such email addresses/entries:

bob_smith@zapfraud.com—This single email address is whitelisted because Bob is known to be trusted. By giving Bob a negative Rule Score on the whitelist his emails are much less likely to trigger a false alarm.

romancescams@wahoogroups.com—This email address is a newsgroup where many people send email and it is then distributed to a set of newsgroup subscribers. By adding this single email address to the Whitelist, it is given a negative Rule Score so that discussions about scam are not errantly detected for anyone receiving emails from this newsgroup address.

scamcrushers.org—All emails from this domain are Whitelisted by adding a negative Message Score, because domain has a negative Rule Score. This helps ensure that discussions about scam are not errantly detected on emails from scambusters.org. For example, both sam@scamcrushers.org and susan@scamcrushers.org would be treated as Whitelist senders because they have the same ‘scamcrushers.org’ domain that is on the Whitelist.

evil_intent.org—All emails from this domain are Blacklisted by giving them a high positive Message Score because previous scam was connected to the domain which has a high Rule Score. The high positive Message Score ensures that the messages are detected and disposed as described below. For example, both evil@evil_intent.org and evil_twin@evil_intent.org would be treated as Blacklisted email addresses because they use the domain ‘evil_intent.org’ is on the Blacklist.

In embodiments of the described system, good entries have negative Rule Scores since the resulting Message ScamScore indicates how likely it is to be a scam. Blacklist entries have a positive Rule Scores because they are sources of scam.

Region Filter (203)

In some message systems like email, voicemail or SMS, the sender's geographic location can be identified by the IP address found in the message header. Latitude and longitude coordinates can be calculated for IP addresses, for example, using commercial geolocation services such as the Google Geocoding API. These latitude and longitude values often correlate to the scammer's physical location. Geographic coordinates can then be mapped to larger geographic regions, such as countries, for example, thus mapping the scammer's location to a geographic region.

In one embodiment of the described system, a Rule Score can be calculated for regions based on the past scam activity of the region. When a message sender's location falls within a region, the Rule Score for the region is associated with the message.

This Rule Score can be determined in a variety of ways including but not limited to:

By dividing number of scam messages by the number of good messages within a region to determine a scam rate for the region;

The score of all messages for a region can be averaged to create an overall average for the region;

The rate of scam phone messages originating from an area code such as 408, or a phone number exchange like 512-750-XXXX, or a phone number thousand-block such as 408-313-7000 through 408-313-7999 range, can be created by dividing the scam volume by the non-scam volume of messages over a time period—For example, if there were 100 scam attempts detected and 10000 valid phone messages in the 408-313-7XXX range in the past 24 hours, then the scam attempt rate is 1%. Note: Due to number portability and VOIP numbers being available for many cities, in many cases phone numbers represent a logical region rather than a physical region; and

The scam rates of all regions are ordered from highest to lowest, and the highest are assigned score based on their scam rate—The score assignment can include, but is not limited to, one or more of following approaches:

The top N highest are assigned a high score—For example, the five worst offending regions are given a score of 100 which ensures that all messages are disposed as described below;

The top P % are assigned a high score—For example, the 10% worst offending regions are given a score of 100 which ensures that all messages are disposed as described below; and

Any region that exceeds a selected threshold is assigned a high score—The threshold can be fixed or adjusted in response to the performance of the threshold. For example, if messages in any region are more than 0.5% scams then the region is assigned a high score, but if subsequent analysis shows that too many scams are missed then the threshold can be raised to 1% of all messages being scam.

The rate of scams can be mapped into a score using a simple linear formula. For example:

if(scam_rate−threshold>0)score=(scam_rate*scaleFactor)+C;

else score=0;

where threshold is an offset to eliminate low scam rates, C is a constant offset, and scale factor is a real number. For example, if threshold=0.09%, scaleFactor=10000, and C=10, then a non-zero score will be at least 10. For a scam rate of 0.1%, score=20.

The Rule Score can also be further determined in a variety of ways including but not limited to:

The rate of scams can be mapped into a score using a non-linear formula. For example:

if(scam_rate−threshold>0)score=(scam_rate\hat{ }M*scaleFactor)+C;

else score=0;

where threshold is an offset to eliminate low scam rates, M is real number exponent, C is a constant offset and scaleFactor is a real number. For example score=(scam_rate\hat{ }1.5*2)+30; and

In one embodiment, the score is used to assign negative values to regions with very low scam rates. For example, if the Vatican City region has never sent a scam message, it can be assigned a score of −100 to ensure that its messages are less likely to be blocked

In some embodiments, each region is defined in Region Rule that includes the location boundaries and the Rule Score for the location. This Rule Score indicates the likelihood of a scam in a message based on its region.

In one embodiment, the same type of score can be computed for sets of users (e.g., elderly people in Canada, middle-aged women in New York State, a subscriber of a particular online service, or an individual); each such geographic risk score takes into consideration the historical scam rate for the selected demographic. The demographic of a user can be determined by his/her IP address and associated zip-code (using IP-to-geolocation conversion tools); the contents of filtered emails received by the user; and based on invitation code (e.g., all ARPA members may register with invitation codes associated with ARPA); based on discount coupons associated with various ad publication venues (each one of which will have an associated demographics); based on the user's observed social network (as expressed by who sends email to the user); and based on the user name (e.g., the user “JohnDoe1987@aol.com” is likely to be a male born in the late eighties). With respect to demographic detection based on user contents, this can be performed using filters with a similar structure as the scam blocking filters. For example, a rule using equivalent classes corresponding to terms in which purchases of baby diapers are confirmed is used to determine likely parents; whereas a rule using an equivalence class comprising expressions like “Hello Granma,” “active retirement newsletter” and diseases associated with elderly is used to determine that the user is likely elderly; whereas rules relating to rock concerts, parasailing and college exams are likely to correspond to teenagers of affluent families. These demographics can also be used for selection of advertisements. The inclusion of advertisements is described in further detail below.

In some embodiments, the Rule Score for each region is considered by one or more Rules which are used by the Region Filter when processing messages.

Regions can be arbitrarily large or small, but can be constrained by the limits of precision in determining a sender's location from available information. Regions can include but are not limited to:

Planets—For example, in addition to Earth, interplanetary scams can be potentially received, such as “I am a very hot and decent Venusian girl” at any time, or interstellar scams, such as “low low prices on wormholes near Alpha Centuri” may be received any day at listening posts such as Arecibo;

Continents—For example, Africa sends scam messages at a higher rate than other continents, while Antarctica has a low scam rate;

Countries—For example, Nigeria sends scam emails and SMS messages at a higher rate than most countries;

States or Provinces—For example, one state sends scam messages at a higher rate than another state (i.e., the rate of scam originating from one state exceeds another).

Counties—For example, one county sends scam messages at a higher rate than another county;

Cities—For example, one city sends scam messages at a higher rate than another city;

ZipCodes—IP addresses can be mapped to a set of Zipcodes based on geolocation information. Thus, a Zipcode can be used to define a region;

Area Codes—Telephone area codes, such as (408) in the United States, or a city code, like 39-02 for Milan, Italy that can be gathered from the phone calls or text message define a region; and

Phone Exchanges—Telephone exchanges such as (512)-258-XXXX serve a local area for landlines so they are associated with a geographic area, but due to number portability and VOIP numbers, which can be requested for many locations around the world regardless of the requester's location, phone numbers can also be used to specify/define logical regions in addition to physical regions.

In one embodiment, regions can contain other regions. For example, 77084 is a Zipcode in Houston, which is a city in Harris County which is located in Texas, which is a state in the United States which is found in North America on Earth. If multiple Rules trigger due to overlapping regions, or regions contained within regions, the Rule Scores can be combined, for example, in one or more of the following ways:

All Rule Scores are included in the message evaluation—For example, the Rule Scores of Houston, Harris County and Texas are all included in the scoring of the message;

The highest Rule Score within a Rule Family is selected as described below in the discussion of Rule Families;

Only the highest Rule Score across all matching regions is used—For example, if Houston has a higher Rule Score than Harris County or Texas, then only the Houston Rule Score is applied;

Only the lowest Rule Score across all matching regions is used—For example, if Houston has a lower Rule Score than Harris County or Texas, then only the Houston Rule Score is applied;

Only the Rule Score from the largest region that contains all other regions is applied—For example, Texas would be applied rather than Houston;

Only the Rule Score from the smallest region is applied—For example, 77084 would be applied rather than Houston or Texas; and

All matching regions are included using a weighted average where the weighted average is based on one or more of the following factors:

The size of the region—For example, smaller regions based on geographic area or population are given a different weighting;

The size of the data sample for a region—For example, a region with only a small historical data set is not weighted as strongly as a region with a richer data set; and

Larger containing regions, based on area or population or number of previous messages, are weighted less. For example,

score=W1*Rate(Zipcode)+W2*Rate(City)+W3*Rate(County)

Where W1,W2,W3 are weighted values that are calculated and tuned based on past efficacy of Rules in determining the likelihood of scam from those regions.

In one embodiment, the Rule Score for each region is re-calculated periodically based on recently arriving data or the entire data set available. For example, all regions are recalculated every twenty-four hours, and the associated Rules' scores are updated.

In one embodiment, regions are recalculated periodically but at different rates. For example, the 77084 Zipcode region is recalculated weekly, Houston region is recalculated daily, and the Texas region is recalculated hourly.

In one embodiment, the Rule Score for each region is re-calculated each time a new message arrives, whether it is scam or not scam. For example, when a new message arrives from Lagos, Nigeria, the Rule Scores for one or all of Lagos, Nigeria, and Africa are immediately re-calculated and the score of the associated Rules are updated.

In another embodiment, the Rule Score for each region is re-calculated when a scam message is found from that region.

Rule Families

In various embodiments of the described system, plots/storylines are used to identify scams. However, Filters and Rules may overlap in detecting a story element. For example, Filters like “your aunt, death, large sum, contact us” could potentially overlap with “inherited, money, please contact” in detecting an inheritance scam. To eliminate the impact of triggering multiple similar Rules, these examples can be logically grouped into “inheritance Scams”.

In some embodiments, counting contributions from multiple Rules in the same Family can otherwise unduly inflate the Message Score for a given message. To prevent this, Rules can be grouped into a ‘Family’. Within a Family only the highest Rule Score of any matching Rule can be applied to communication.

For example, consider another example scenario in which a message triggers the following three example Rules:

1. a Rule matching (“urgent”, “western union”), assigned to Family “Crises”, with a Message Score of 70

2. a Rule matching (“urgent”, “donate”, “wire transfer”), assigned to Family “Crises”, with a Message Score of 50

3. a Rule matching (“urgent”, “charity”, “to whom it concerns”), assigned to Family “Crises”, with a Message Score of 44

If the families were not to be considered, then a message that triggers all three of these Rules would receive a Message Score of 70+50+44=164, which would be above the example threshold Message Score of 100, and therefore cause the message to be blocked. However, this would be a mistake in this case, due to multiple counting of similar Rules. Instead, the maximum Rule Score of a triggering Rule within each Family can be taken and combined. In this second example, the Family Rule Score would be only 70, since all the three Rules belong to the same Family. This would not lead to the blocking of the example message. Therefore, the clustering of Rules into families as described above helps avoid false positives (i.e., blocking that should not have taken place) due to many very similar Rules triggering on one and the same message. In contrast, in the previous example, the example message triggered Rules from three distinct families (“Crises”, “URL”, “Countries”), and the combined Message Score would be 70+20+20 in an embodiment where addition is used to combine Family Rule Scores.

In some embodiments, instead of blocking a bad message, it is modified. For example, a message containing a dangerous URL (such as a phishing URL or URL associated with malware) can be allowed to be delivered, but only after the URL has been replaced with another URL, where the new URL leads to a webpage that alerts the user to the risk, provides an explanation of the risk, or similar. These URLs can be personalized on a per-recipient basis, allowing granular collection of statistics of who clicks on high-risk URLs. Similarly, reply-to addresses can be introduced in scam messages before they are delivered, causing any responses from the recipient to go to a service that in turn responds with an explanation or alert, and which allows the collection of statistics.

As another alternative to blocking high-risk messages, the messages can be placed in a special folder, or modified to contain warnings. This can be useful in contexts where the system has a reasonably high but not very high certainty of the message being risky.

In one embodiment, high-risk messages are quarantined, and the sender notified that he or she needs to confirm that the message is not scam by clicking on a link. As the sender clicks on the link, IP address information, machine identity information and other data is collected, after which the message is delivered (assuming none of this information is indicative of high risk); if the link is not clicked on, on the other hand, then the quarantined message is erased after a certain time period has elapsed, such as one week.

Additional information regarding classifying Rules into families are as follows:

1. It facilitates the generation of detailed statistics showing the threat picture for a selected set of users, for a selected time period, for a selected locality of the scammers, etc; where the threat picture can include information about the increase or decrease of scams within each Family of Rules. This can be used to determine trends in fraud, which may be valuable to many organizations, and which can also be useful for an organization deploying filters like those described in this application, as it provides guidance to the system or its operators as to what problems are trending.

2. It allows a per-person determination of what kind of scams are the greatest threat, which allows the system to fine-tune thresholds for that person to improve the protection. For example, a person who is getting a large number of romance scam messages is assumed to be more vulnerable to these (where this increased vulnerability is the reason for the higher number of messages); accordingly, the thresholds associated with such families of Rules are adjusted to reduce the risk of a scam message coming through the system and being delivered to the user.

3. It allows two overlapping Rules to be tested in the system at the same time. Since two Rules can coexist without adversely impacting the outcome, ongoing evaluation and improvement of new Rules is possible. This allows continuous A versus B testing of new possible Rules without turning off Rules that work well but require adjustment.

4. It supports the detection of scams based on concepts or stories rather than specific phrases, because creation of Rule Families aggregate phrases into concepts. In some embodiments, the higher level of abstraction provided by Rule Families enables greater flexibility and complexity in Rule definition as described below in Compound Filters.

In the described system, logical grouping of Rules are referred to herein as a Family. Rules are typically within a single Filter type, but since they are logical they are not required to have the same Filter type. For example, a Phrase Rule that detects phrases such as “Lagos, Nigeria, Nigerian” and a Region Rule that detects IP address from Nigeria can both be grouped into the Nigerian Family.

Example Families include, but are not limited to:

suspectAfrican is a group of IP address ranges for African countries like {Nigeria, Ghana} that are known for originating scams;

easternEU is a group of IP address ranges for eastern Europe that are known for originating scams;

AdvanceFee is a group of Filters used to identify advance fee fraud;

Mugged which is a group of Filters used to identify variations on the “mugged in London” scam;

Introduction which is a group of Filters used to detect when the sender is making initial contact with a potential victim;

MoneyRequest which is a group of Filters used to detect when the sender is asking the potential victim to send money;

BadSenders which is a group of sender ids that have been previously associated with scam; and

LotteryWinner which is a group of phrase Filters such as:

congratulations,cash,full details,claims;

your email,prize,pounds,contact; and

my name,million,came across,“,000.”

Rule families can be identified in various ways including, but not limited to:

A system operator can define families based on their perception of the scam being targeted by the Rules;

An automated evaluation, described herein, can be used to determine the overlap of Rules and automatically group them into a Family. For example, if a large number of messages commonly trigger the same two Rules, then these two Rules are considered related, and are placed in a cluster. A Rule can be placed in multiple clusters. For example, one cluster can include Rules that have religious content, whereas another cluster can include Rules relating to inheritance scams. There may potentially be overlap between these two clusters, as some inheritance scams invoke religion. In this way, it is sufficient that some Rules initially belong to a cluster; by determining large overlaps between what Rules are triggered by messages, a new Rule can be associated with the same cluster, or Rule Family, as another Rule that had already been placed in one cluster/Rule Family; and

Filters can be tested against message sets that have been previously classified into categories. Filters that trigger against the messages in the category can be grouped into a Family associated with that category.

Families can be used in combination with Compound Filters as described in further detail below.

Compound Filters (205)

Embodiments of the described system identify story elements using Filters and Rules. The Filters and Rules can be used to detect elements such as disease, urgency, Blacklisted sender, newsletters, money or many others. These Filter and Filter Family results can be selectively combined into compound Filters using Boolean logic to refine the detection of scams.

For example:

(NOT(newsletter) and (disease AND money))—If a message hits the Rules in the disease Family AND Rules in money Family, it would typically receive a high Message Score and be treated as scam, but if the message also hits Rules in the newsletter Family then it should not be treated as a scam message. Thus, the higher Message Score should only be applied if the message is NOT a newsletter.

(NOT(whitelist) and (romance AND scamdiscussion))—If a message is about romance and the discussion of scam, it is given a higher Message Score if it is NOT on a Whitelist.

(easternEU AND romance)—If a message hits both the Eastern Europe Family and the romance Family it should receive a different Message Score than simply summing the individual Message Scores.

Rules can also be combined, as applicable. Combining many single Rules can become increasingly complex and difficult to manage as the number of Rules grows. Thus, in some embodiments of the described system, Compound Filters are defined using Rule Families.

In one embodiment, Rule Families are combined into Compound Filters using Boolean expressions such as:

(a or b)

(a and b)

(a & !b)

(a xor b)

((a|b) & & !d))

((a or b) or ! (c and d))

where “or” and “|” denote logical OR, and “and” and “&” denote logical AND, and “!” denotes logical NOT. XOR denotes Exclusive OR, which indicates A ORB, but not A AND B. The logical operators such as &,|, and ! can also be provided, as they are commonly used in programming languages, may be more succinct, and may be more readable for complex expressions.

In embodiments of the described system, the use of Compound Filters permits refinement of how Rule hits are processed and scored. Rule Families can be combined to define a different Message Score than addition of the Family Rule Scores as described above. In one embodiment, when a Compound Filter Rule evaluates to TRUE, the Compound Filter Rule Score is applied and the Family Rule Scores for Families in the TRUE Compound Rule are ignored.

The following are examples of Compound Rules where Rule Families are combined with Boolean logic and a score is assigned to the combination:

### Example 1; (Romance & ScamDiscussions) RuleScore=−20

In this example the romance Family is AND-ed with the ScamDiscussions Family and the message is assigned a Message Score of negative 20, and the individual values for the romance and ScamDiscussions Families are ignored in the scoring. A negative Rule Score is used because the ScamDiscussions Family is a list of known good messages and domains. The romance Family contains Rules related to phrases such as “a woman like you, many kisses,one true love” found in scam messages that focus on romance. All of the romance Rules are grouped into the “romance” Family and all groups and newsletters dedicated to scam discussions are in the ScamDiscussions Family. For groups where subscribers often discuss romance scams, blocking such discussions is prevented by combining these Families in a Compound Rule and setting RuleScore=−20.

### Example 2: (Romance & (EasternEU|WorstAfrican)) RuleScore=100

In this example the romance Family is AND-ed with the EasternEU Family OR the WorstAfrican Family, and if the condition is met the message is assigned a Message Score of 100 and the individual values for the romance, EasternEU and WorstAfrican Families are ignored. Many romance scams originate from a few countries in Eastern Europe or a few African countries. The EasternEU Family is a list of countries including Russia, Romania or Ukraine and WorstAfrican includes Nigeria and Ghana. In this example, if a romance Family Rule is hit and the message is from a country in the EasternEU or WorstAfrican Family, the Message Score is raised to 100, to ensure that the message is properly disposed.

In some embodiments, if a new Rule is added to one of these Families, this Compound Rule does not need to be modified because it operates at the higher level of abstraction. For example, if the scam rate in Liberia goes up, it is added to the WorstAfrican Family and this Compound Rule applies immediately without any change to it.

In some embodiments, the Compound Filter Rule Scores are summed with other Family Rule Scores not covered by a Compound Rule to create the final score for the message and compared with the Thresholds described above. For example, if the both the Compound Rule (romance & (EasternEU|WorstAfrican)) with a Rule Score of 100 and the scamDiscussions Family Rule with a Rule Score of −200 match a message, the resulting Message Score is −100 because the values are summed.

In one embodiment, if a Compound Rule matches a message, the Compound Rule Score is used for the message and all other individual Rule Scores are ignored.

In one embodiment, if multiple Compound Rules match a message, the highest Compound Rule Score is used for the message.

In one embodiment, if no Compound Rules match a message, then the highest value within each Rule Family that matched the message are summed to calculate the Message Score.

In one embodiment the complete Message Score is calculated use arithmetic operations instead of Boolean logic. For example

score=(2*romance+3*worstAfrican)+newsletter

where the Message Score is a weighted combination of the highest scoring Rule in the romance Family and the highest scoring Rule in the worstAfrican Family plus the highest Rule Score from the newsletter Family. Note that the newsletter Rule Scores are typically negative values, and thus adding it makes newsletters less likely to be blocked. Various examples of arithmetic operators include addition, subtraction, multiplication, division and exponentiation.

Tuning and Improving Filters

Filter Evolution

Scammers may change their tactics to avoid detection by the disclosed techniques for blocking scam. In various embodiments, the techniques described herein are able to adapt to evolving scams.

In some embodiments, Filters are continuously evaluated to determine their ongoing effectiveness. This evaluation can include false negative (missed scam) and false positives (marked good communication as scam). As scammers evolve their approaches, the Filters are similarly evolved. As described above regarding dynamic filter updating, and as will be described in further detail below, the system is configured to allow Filters to be continuously tuned and improved to address scam evolution.

Examples techniques for tuning filters are described above. Further details regarding tuning of filters are described below.

Dominant Rule Ranking

In some embodiments, the overlap of Rule effectiveness can be evaluated per dataset by counting the intersection of scam communications identified by multiple Rules. For example, if one Rule catches 80% of another Rule and nothing else, it is determined to be not effective and should be retired. As another example, if one Rule catches 40% of another Rule but also catches several other scam communications without overlap, the Rule can be revised to focus on the unique scams that it captures.

In embodiments of the described system, the Rule that caught the most scam communications within a selected dataset is termed the Dominant Rule. All scam communications that were detected by the Dominant Rule are removed from the dataset and the analysis is re-run on the reduced set to determine the next most dominant Filter.

This process is repeated until there are no remaining Rules that catch scam communications. The following example pseudo code demonstrates one mechanism for ranking Rules:

```
  // Dataset is the set of messages containing scams
  // Rules is the set of Rules used to detect scams in the dataset
  Print (“Rank : Rule Id)“;
  for (r = 1 to count(Rules)
{
    // Find the Rule that hits the most emails in the remaining dataset
    dominantRule = getDominant(dataset);
    EliminateMessage(dominantRule);
    Print (r + “ : “ + dominanRule.id);
  }
  Rule getDominant(dataset)
  {
    int hits[count(Rule)] = 0; // array to count the number of hits
per Rule indexed by Rule id
    foreach (r in Rule)
    {
      foreach(d in dataset)
      {
        if (r.Rulehits(d)) hits[r] = hits[r] + 1; // count the hits per
Rule
      }
    }
    // Now get the index of the max value in the array
    int dominant = −1;
    int maxhit = −1;
  foreach (r in Rule)
  {
  if (hits[r] > maxhit)
  {
  maxhit = hits[r]; // save the new high value
  dominant = r; // save the index
  }
  }
    return dominant;
  }
  void EliminateMessage(Rule r)
  {
  foreach(d in dataset)
    {
      if (r.Rulehits(d)) delete d;  // remove the message from future
consideration
    // because it was found by a Rule already
    }
  }
  Boolean Rule::Rulehits(dataset)
  {
    if the Rule matches something in the message return true;
    else return false;
  }
```

This approach provides a ranking of Rules based on their ability to uniquely detect scams in communications without overlapping other Filters. The ranking of Rules shows the relative effectiveness of Rules because Rules that only catch messages caught by other Rules or only catch a few distinct messages are easily identified in the ranking. Rules that catch no messages that are not caught by other Rules can be retired or modified to catch more distinct messages.

In some embodiments, this analysis is regularly re-run to determine the ongoing effectiveness and intersection of various Filters. Filters with low or no hits can be revised for broader or different coverage, or culled based on this analysis to keep the system tuned in response to changing scams.

The ranking of Rules can be performed across all Rules or only within a selected subset. For example, ranking Rules only within a Family can quickly show the overlap between two similar Rules.

In one approach, the Dominant Rule approach is modified to exclude Rules that make too many incorrect hits, which are called False Positive results. A False Positive is a hit on a message that was not actually a scam message. In some embodiments, a tunable threshold is selected that indicates the acceptable rate of False Positives. For example, a Rule is only allowed to incorrectly mark 2% of messages as potential scam. This threshold is applied when the analysis is run against the dataset. Only Filters that meet this threshold are considered for further analysis and any Filter that falls below the threshold is eliminated or revised to meet the threshold.

In some embodiments, the False Positive thresholds are determined experimentally through iteration and varying across datasets. In one embodiment, all Rules are run against a large set of good messages to detect the rate at which each Rule hits good messages and the Rules are then ordered by the most False Positives. For example, Rules in the top 5% of False Positive hits are evaluated against their Dominant Ranking as described above, by determining the ratio of False Positives to distinct hits for each Rule. Rules with a high (False Positive)/(distinct hit) ratio should be deleted. For example, those Ranked in the top 10% of False Positive are deleted if the Rule is also in the top 5% of the (False Positive)/(distinct hit) ratio, since these Rules are catching too many good things. This process can be repeated each time new Rules are added to the system such that there is a constant culling of the weakest Rules.

Automated Collection of Filter Configuration Data

Overview

In some embodiments, offline analysis of collected suspect or scam message bodies yields insights for new Filters and new configuration data. In some embodiments, the offline analysis is automated. One example type of analysis looks at term or phrase frequency in both good (ham) and bad (scam) messages.

One such method of analysis uses term frequency, inverse document frequency (TFIDF) analysis of input messages.

In TFIDF and similar approaches, known scam messages are compared with the phrase frequencies of known good messages. In some embodiments, phrases that are found more frequently in the scam set than are found in the good messages are added as components of Phrase Filter Rules. For example, if the phrase “I am the cheerful and decent girl’ is found in 1 of 10,000 scam messages, but only found in 1 of 1,000,000 good messages, then the phrase is very likely a scam phrase.

In some embodiments, salient scam phrases are determined for each possible phrase by dividing the rate of scam for the phrase with its rate in the good message set. Any phrase with a ratio above a selected threshold can be identified as a scam phrase that should be included in a Phrase Filter Rule. In addition, the score for the Rules can be automatically determined based on the scam/good ratio. In some embodiments, this score is a direct conversion from the ratio, or a non-linear weighting could be applied. For example, phrases that are only twice as frequent in scam messages may warrant only a small score but phrases that at 10,000 times more likely to be scam are given a stronger score (but not necessarily 10,000 higher).

In addition to single scam phrases, in some embodiments, the relative frequency of two or more phrases are evaluated in the same manner as described above. For example, if the individual phrases “esophageal cancer,” “large sum,” and “Western Union” are found in combination in scam messages at a much higher rate than they are found in good messages, the combination of phrases are used as a phrase Filter Rule.

TFIDF or variants can be used to return a quantitative judgment as to the likelihood that a newly arrived and heretofore unclassified message is scam or ham. Here, the TFIDF value assigned to a phrase correlates to the likelihood that a message containing it is a scam.

TFIDF tables can be used also to automatically generate new configuration data such as phrase Rules.

In one embodiment, a body of ham such as the archived email of the late Enron corporation, or the COCA Corpus (http://www.wordfrequency.info/), is used in conjunction with a known body of scam to inform the creation of new phrase Rules. The former is more typical of business email and in some embodiments, is processed into a table of phrases and frequencies. The latter is available as a lookup service but may be more representative of literature of all types than email correspondence. The latter may also only have short n-grams, and not allow the determination of the frequencies for longer phrases.

As another example, large numbers of actual user messages can be included in the ham body. As another example, novels, product reviews, newsletters, and other natural language texts that are not predominantly scam can be used. If a small portion of the believed ham messages are in fact scam messages, this can be tolerated, so long as this number is lower than a relatively small percentage, such as 1%. Similarly, it can be acceptable if the scam message body contains mostly scam messages and some non-scam messages; for example, if the scam body of messages contain no more than a modest fraction of ham messages, such as 8%, then this is considered acceptable. The exact thresholds used here can affect the quality of the newly derived configuration. The lower percentage of misclassified messages there are in the scam and ham sets, the greater the efficacy of the new configuration changes.

In various embodiments, the table is static, or it is built from, and/or improved upon by, the flow of newly received and classified messages. As another example, newly arrived messages can be both classified by, and incorporated into, the table.

Automated Phrase Rule Generation

In one implementation of automated Rule generation, the scam messages are used to create a TFIDF table which is referred to herein as the “S table.” In this example, suppose that the S table has a fixed number of entries; for example, 2000.

In this example, suppose that there exists a term frequency database for ham messages “H” (for example, a service containing the COCA Corpus) containing records such as the one shown here:

TABLE 10

| Phrase | count in H |
|---|---|
| God bless | 245,886 |
| Western Union | 331 |

Shown in table 10 is an example of the H table.

The S is constructed as follows. First, all scam messages are tokenized into words and concatenated into a single text document S. Next, all phrases p of length l in S, where l=1 to n, are added to the S table if

1. there is an empty table slot

2. or their calculated TFIDF value is greater than an existing entry, in which case, it displaces that entry.

The TFIDF ratio is calculated as the count of the occurrences of a phrase p in all scam messages S, divided by the count of the occurrences of p in all ham messages H:

count(p,S)/count(p,H)

Below are two example records in the S table (n=2). Assume “God bless” is found 5 times in H, and “Western Union”, 7.

TABLE 11

| Phrase | TFIDF ratio |
|---|---|
| . . . | . . . |
| God bless | 0.000 (5/245,886) |
| Western Union | 0.021 (7/331) |
| . . . | . . . |

A list of phrases sorted by TFIDF ratio yields candidate new phrase Rules. In the example S table above, the top phrase (n=1), “Western Union” can be selected. Top-ranked phrases can be used to create new phrase Rules as follows.

For each of the n top-ranked phrases in the TFIDF table, each Rule is compared, for example, using the steps below.

1. first, the Rule phrase is compared to the phrase. If the Rule phrase matches the phrase, a suitable Rule exists; the next phrase is processed in step (1); otherwise:

2. each equivalent for each term is substituted in the Rule's phrase, and the result is compared to the phrase

3. if no matching Rule is found, a new phrase Rule is created for the term

4. the next highest-ranked phrase is processed using step (1)

In another embodiment of automated phrase Rule generation, the equivalent-substituted Rules may potentially exist in an Aho-Corasick graph. In this case, the candidate phrase is run through the graph; if there is output, a suitable Rule already exists and it is not necessary to create a new one.

In other embodiments, a different or additional calculated quantity is recorded in the S table. For example, instead of TFIDF(p), the inverse of the quantity that is the count of p in H times the count of words in the message s is stored:

1/(count(p,H)*|s|)

As one example, if the scam corpus contains 100% scams, then a moderately large value for this quantity is determined to be a good signature/indicator for future scam messages, even if this is the first time the system has encountered the phrase. This can be useful for incremental TFIDF, as described below. One example way to “purify” a corpus is to run checks on it using already developed Rules, weeding out any messages that hit Rules of specified kinds. For example, taking a large body of mostly-ham messages, referred to in this example as “H1,” this body is curated by removing any messages or selections that trigger Rules associated with scam, resulting in a new body H that consists of the messages or components of H1 that did not trigger any scam Rules. Similarly, a large body of mostly-scam messages S1 can be curated by running Rules identifying ham messages (such as newsletters), removing such messages or segments, resulting in a new body S only containing text that does not trigger ham Rules. In one embodiment, the curation is performed by removing messages or text that trigger Rules of some specified type in a manner that results in at least a threshold score, such as 75; this threshold can be different from the scam blocking threshold for regular traffic scanning in one embodiment, and can, for example, be set lower, as the impact of an incorrect classification in the context of curation is typically much lesser than in the context of filtering of subscriber messages. Curation of scam and ham bodies can be beneficial to avoid mistakes in training with “dirty” data. An additional benefit of curation is that multiple curations of the same body of messages can be performed, with different curation criteria, thereby creating different training sets. The Rules derived from these different training sets can then be compared and assessed, e.g., by assessing their associated error rates, in order to determine the most favorable curation criteria.

Alternative implementations of TFIDF can also be used, as applicable.

Incremental TFIDF

In some embodiments, the body of collected scam messages may grow too large to store or process, and may become expensive to process frequently. To reduce the impact of this, in some embodiments, the S table is constructed incrementally, as each message arrives, without reference to the existing body of scam messages. This avoids both having to build a document containing the text of all scam messages, and having to re-scan this (potentially large) document to incorporate new scam phrases. Incremental TFIDF avoids overhead associated with the storage and repeated processing of the scam corpus at the expense of potentially unbounded growth of the TFIDF table (incorporation of large numbers of insignificant phrases).

One way to perform incremental TFIDF is to construct the table as before, but without the preliminary step of creating a single document to hold all message bodies. Instead, the S table contains a phrase count column, and every phrase p found in a newly arrived message s is added to the S table, initially, for example, with a count of 1. As existing phrases p are encountered in new scam s, the count and TFIDF columns are updated.

TABLE 12

| Phrase | Count | TFIDF ratio |
|---|---|---|
| . . . | . . . | . . . |
| God bless | 5 | 0.000 (5/245,886) |
| Western Union | 7 | 0.021 (7/331) |
| . . . | . . . | . . . |

Controlling S Table Growth During Incremental TFIDF

As it is no longer limited in size, the S table may grow too large to store with the arrival and processing of new messages. In this case, phrases can be removed from the table periodically (pruning), or criteria can be applied to decide whether or not to add a new phrase (Filtering).

As an example of S table pruning, a new column can be added corresponding to the timestamp at which the message that first contributed the phrase to the S table was processed.

TABLE 13

| Phrase | Timestamp | count | TFIDF ratio |
|---|---|---|---|
| . . . | | . . . | . . . |
| God bless | 123431423 | 5 | 0.000 (5/245,886) |
| Western Union | 123438535 | 7 | 0.021 (7/331) |
| . . . | | . . . | . . . |

After the addition of n messages, for example, n=1000, a pruning algorithm can be run:

start with the phrases sorted first by TFIDF ratio, then by timestamp;

find the lowest ranked, oldest n phrases; and

remove these from the S table.

As an example of new phrase Filtering, for newly arrived scam message s, for every phrase p in s, p is added to the S table if and only if the count of the phrase in the ham phrase frequency table is less than a threshold T, which can be derived from the distribution curve of phrase frequency in H:

count(p,H)<T

If, for example, H contains 4.5 million phrases, T can be the frequency for n standard deviations from the median; for example, n can be 10. For example, if the median phrase occurs 1000 times in H, and the standard deviation is 30 occurrences, then T is 1000−(30*10)=700 occurrences. p must occur in H 700 times or less in order to be added to the S table.

In another embodiment, the system maintains a table where, for each record, there is a phrase p, the value count(p,S), the value count(p,H), and a value TFIDF=count(p,S)/count(p,H)*c, where c is a constant associated with S and H, used to normalize the value TFIDF. For example, c can be set to length(S)/length(H), where length indicates number of characters. As one example, the table contains 1000 records in one embodiment, and 5000 records in another embodiment. In one embodiment, the records are sorted with respect to the value TFIDF, in order of decreasing TFIDF values. When a new message body s is received, where s may be one or more messages combined in some manner, such as concatenated to each other, then for each phrase p in the table contained in s, the value count(p,$) is computed. A new value TFIDF=(count(p,S)+count(p,$))/count(p,H)*c can be computed, where c is, for example, the same value as used above; as another example, a new value c′ can be computed, and all the values TDIDF of the other records multiplied by c′/c. The record can be updated by replacing count(p,S) by the value count(p,S)+count(p,$), and replacing the old value TDIDF with the newly computed value. In some embodiments, the table is again sorted with respect to the values TFIDF of the records in the table. This modification of the table contents can be done a repeated number of times, until a threshold is reached. An example threshold is that one of the top 100 records has been modified as a result of a modification as described above; another example threshold is when the total length of the additions s comprise at least 5% of the length of S; and yet another example threshold is that at least a week has lapsed since the first value s was incorporated as described above. After the threshold has been reached, a new value S can be computed, where the new value S comprises the old value S combined with each of the updates s of each modification that was incorporated; after this, a new value c can be computed based on the new value S and the value H, and the table is recomputed, all records computed, for example, as described for the basic TFIDF algorithm described above.

Message Disposition

As described above, messages can be classified by comparing their Message Score with thresholds. The resulting disposition of a message is determined by its threshold. The disposition of a messages can include but is not limited to:

Message is retained intact;

Message is annotated with general guidance—For example, additional words like “This message is likely scam” can be prepended or appended to an email, SMS or voice message;

Message is annotated with specific guidance—For example, the words “evil_intent.org is a known source of scam” can be prepended or appended to a message;

Message is moved to a separate folder—For example, a message can be moved to a separate Scam folder. This can be done without notifying the user. The user can find the message if they look in the Scam folder;

Message is moved to a separate folder and the user is informed—For example, the message is moved to a Scam folder and the user is provided a message about the moved message in their inbox instead;

Message is deleted—For example, a message is removed from the inbox and the user is not notified about the message deletion;

Message headers are inserted for subsequent processing downstream. For example, an X-Spam-Score or similar header could be inserted and the user's mail client could determine if and how the message is presented based on the user and/or organization's preferences about seeing scams and SPAM.

Message is deleted and the user is told about the removal—For example, a message is removed from the user's inbox and the user is provided a message about the deleted message; and

Messages sent to the Scam Autoresponder Service described herein are retained for future analysis, but no action is taken on a user's account.

In one embodiment of the system, the thresholds and message disposition are configured in variety of ways including but not limited to:

A single set of thresholds and dispositions for all users and all messages;

A distinct set of thresholds and disposition for each user. This can allow users or administrators to select their preferred threshold for scam messages; and

A threshold per class of users, where classes of users can include:

Paying versus free users;

Users that were enrolled for a specific class of protection. For example, a person with early dementia could enroll for a higher level of protection than most users. Lower scam thresholds are used for these users and the system would be more aggressive about detecting and removing potential scam messages; and

Users that have been previous scam victims.

Honeypot Data

In the described system, scam Filters and Rules can be derived manually and/or automatically from known scam data sets. Scam data can be collected from known scam sources through interaction that, in some embodiments, is referred to as “scambaiting.” For scambaiting, attractive looking targets referred to as “honeypots” are created and presented to scammers to contact. These honeypot accounts can be made visible to scammers in a variety of ways including, but not limited to:

Registering on a suspicious dating site that has previously been identified as a source of scam;

Sending a message to an account that has been previously been used by scammers;

Clicking on link(s) found in a scam message;

Posting a classified ad on a system such as a classified advertisements website such as Craigslist, to which a typical person would not be expected respond. For example, by offering to sell a used item for more than similar new item would cost; and

Posting a questionable personal on a dating board to which a typical suitor would not be expected to respond. For example, “Fat 65 year old man with 6 cats and flatulence seeks hot 25 year old woman for romance.”

Direct interaction with scammers through Honeypots provides the following benefits that may be more difficult to achieve in other ways:

When the source of messages is a known scammer, the message content is unambiguously scam. Thus, all their message content can be used for deriving new scam Filters, as described above;

When available, additional information is gathered about the scammers including, but not limited to:

Their IP addresses;

Their Browser User Agent string;

Their geolocation; and

Their normal working hours;

New scams types and scam patterns can be identified more quickly because they are received directly from the scammer into a Honeypot account, rather than waiting for the pattern to be detected in third party email accounts. This allows the earlier creation of new Rules to protect users sooner;

Users can be protected from interaction with specific scammers by means of Rules created to recognize these scammers based on data collected through honeypot dialogs. Examples of how this can be done are described herein;

Honeypot accounts can be used to drive the discussion with scammers to reveal more information including, but not limited to:

Additional scam phrases—That are analyzed and added to Phrase Filter Rules;

Additional fake scenarios—That are incorporated into various Filter Rules including Compound Filter Rules

Additional equivalent terms—Scam traffic can be analyzed to find additional terms to incorporate into the Equivalents, as discussed above. For example, scammers may not always be good at spelling or punctuation or may be avoiding spam filters, so a scammer may spell ‘yours’ as ‘yors’—this can be added to the Equivalents. Alternatively, string matching algorithms such as Jaro-Winkler can be used to detect in common misspellings;

Photos of scammers—For example, scammers can be tricked into sending their photos. Several scambaiting websites use photos of scammers as trophies to show how well they have duped the scammers. Thus. It may be possible to get scammers to send their photos. These images can then be added to the Scam Image Repository and incorporated into Rules used by the Image Filter Rules as described above. These images can be used, for example, for criminal prosecution;

Additional personal information about the scammer including, but not limited to, their phone number, Skype Id, Instant Messenger id, and other email addresses. In one embodiment, this information is used to identify the scammer and used in the scam network analysis described below. In one embodiment, this information is added to BlackList Filter Rules as described above. This information can be used to assist criminal prosecution of scammers; and

Fake documents are added to the Scam Document Repository and to Document Filter Rules as described below.

Turning Real Traffic into Honeypot Traffic

In some cases scammers S may not be detected until several messages have been exchanged with an intended victim V. These interactions can be used as the basis to create message traffic from Honeypot accounts to scammers.

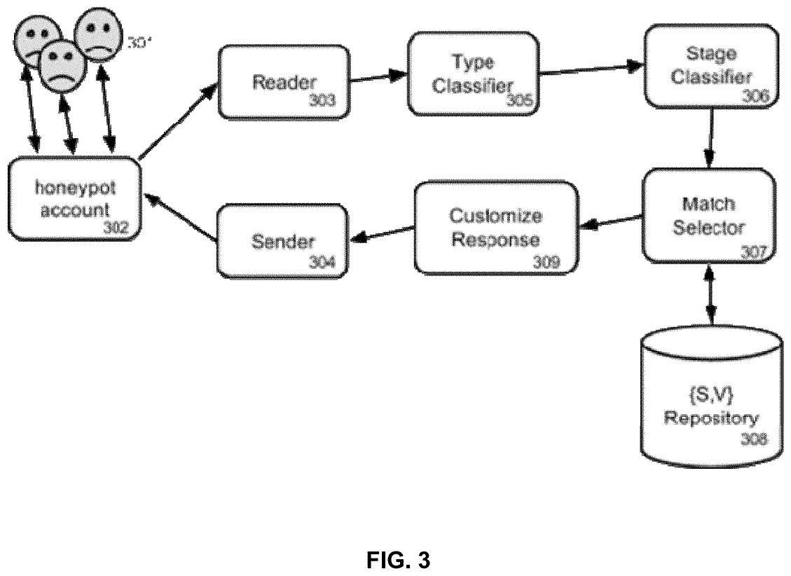

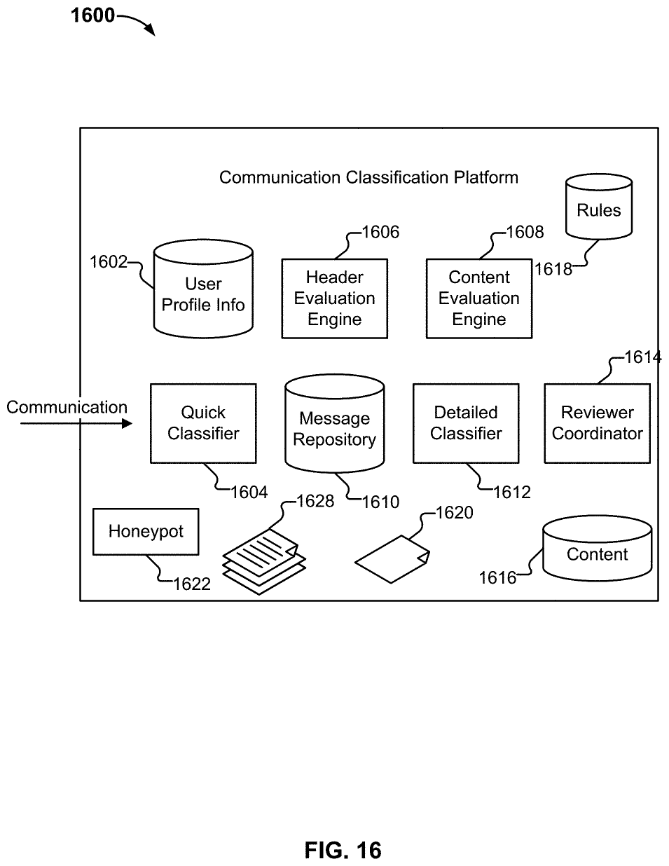

FIG. 3 illustrates an embodiment of a system for turning real traffic into honeypot traffic. In some embodiments, the system of FIG. 3 is an alternative view of scam evaluation system of FIG. 1C. In some embodiments, the system of FIG. 3 is an example of honeypot engine 1622 of platform 1600 of FIG. 16. In this example, honeypot account 302 interacts with users 301, who are scammers. The honeypot account is configured to communicate with known or potential scammers in order to obtain example spam and scam messages. In some embodiments, the honeypot account is configured to initiate contact with scammers (e.g., the account is used to directly email, text message, or otherwise contact a known scammer). The honeypot account can also be set up to be contacted by scammers. For example, the email address of the honeypot account could be made public in order to increase the likelihood that it will be contacted by scammers.

In some embodiments, the honeypot account is an emulation of one or more users. The emulation can be implemented in a variety of ways. For example, as will be described in further detail below, the honeypot account can respond to messages using a contextual response generator such as the Eliza responder, which provides (generic) responses that are relevant to received messages. This allows for automated emulation of a potential victim. The honeypot account can be used to provide responses to attackers to encourage receiving future spam and scam messages. Further details regarding honeypot account 302 will be described below.

In some embodiments, messages are forwarded from the honeypot account to reader 303. For example, the reader extracts messages from the honeypot account. The reader is then configured to send the extracted messages to type classifier 305. In some embodiments, mail reader 303 is an example of mail reader 110 of FIG. 1C.

Type classifier 305 is configured to classify messages. The classification can be performed based on a variety of attributes and indications associated with keywords in a message, the context of the message, etc. For example, if the content of the messages described the theme of love, then this is indicative of a romance scam. In some embodiments, the type classifier is implemented in Java, or any other appropriate language. Further details regarding the type classifier are described below.

Honeypot accounts can be created to collect spam and scam of particular types. Messages received for a particular type of honeypot account can then be classified based on the honeypot account type. For example, if the honeypot account is configured to attract scammers associated with inheritance scams, then messages associated with the honeypot account are more likely to be associated with inheritance scams. As another example, a honeypot account can be created to collect romance scams. For example, a honeypot account can be created by generating a dating profile on a dating site. Responses from potential scammers to the dating profile are then more likely to be romance scams, and are classified as such.

Stage classifier 306 is configured to classify messages based on the stage of a conversation. For example, the honeypot account can be used to maintain back and forth communications with an attacker, forming a thread of conversation (e.g., multi-message scams). Messages can be classified based on which stage in the conversation thread/interplay between the attacker and the honeypot account the messages were received at. Examples of stages include introduction, increasing familiarity, encountering a problem, asking for assistance, etc. In some embodiments, the stage classifier is implemented in Java, or any other appropriate language. Further details regarding the stage classifier are described below.

Match selector 307 is configured to obtain one or more messages in a series of messages and determine to what extent the obtained messages are scam messages. The messages are then communicated to repository 308. In some embodiments, the match selector is implemented in Java, or any other appropriate language. Further details regarding the match selector are described below.

Customize response 309 is configured to generate responses to messages. In some embodiments, the customize response 309 is implemented using a contextual response generator such as Eliza, as described above. For example, based on an analysis of collected messages and their content/context, corresponding responses are created. Responses can also be selected from a set of candidate responses. In some embodiments, the sender is configured to inject generated responses into the honeypot account, which then sends the response back to the attacker. This allows, for example, conversations with attackers to be continued to collect further spam and scam messages

In some embodiments, appropriate response(s) to messages are determined by the customize response 309 based on the results of the type classifier. For example, suppose that a message has been classified as a romance scam by the type classifier, the customize response selects a response from a set of romance responses (e.g., at random, based on a relevance match between the response and context/content of the message, etc.), which is then provided back to the attacker. In some embodiments, contextual information associated with the message is injected into the response. For example, a phrase included in an original message can be extracted and fed back in a response back to the originator of the message.

In some embodiments, customize response 309 is implemented using PHP, Java, or any other appropriate language. For example, customize response 309 can be implemented using Java implemented Eliza. In some embodiments, customize response 309 is implemented using a script that is connected to a database (e.g., that includes candidate responses segmented by classification). Further details regarding customize response 309 are described below.

The responses are then sent, using sender 304 back to scammers. In some embodiments, sender 304 is an example of mail responder 115 of FIG. 1C. Further details regarding sender 304 are described below.

Refer to FIG. 3 for the following description, in which an example of turning real traffic into honeypot traffic is described.

As described above, in some cases, scammers “S” may not be detected until several messages have been exchanged with an intended victim “V.” These interactions can be used as the basis to create message traffic from Honeypot accounts to scammers.

The interactions can be retrieved from message threads in the user's inbox, as described below, and/or by assembling a message thread from the user's inbox and sent folder. For example, for each message to S in the Sent folder, there is usually a received message in the user's Inbox. The order of the S and V messages can be determined by the message timestamps, and thus, specific responses to specific scammer's messages can be established.

A repository (308) of {S,V}, which, in some embodiments, are paired scammer messages and responses from the scammer's intended victim, can be assembled from these interactions and can be augmented over time. In some embodiments, each of the S messages are classified into one or more possible scam types based on the Rules and Rule Families they hit. The scam types include but are not limited to the following:

Romance;

Advance Fee Fraud;

Mugged in London, which corresponds technically to CEO scams, also referred to as business email compromise scams;

Charity; and

Work From Home.

In some embodiments, each of the preceding scam types have Rules or Rule families associated with them.

Each of the S messages can also be classified by the stage of the conversation in the message thread. These classifications can include, but are not limited to:

Introduction—Where a scammer first introduces himself;

Getting Familiar—Where a scammer provides more information about himself;

Problem—Where the scammer introduces a problem;

Ask for Assistance—Where the scammer asks for assistance from the intended victim; and

Introduction and Ask for Assistance—Where the scammer introduces himself and immediately asks for help

After Honeypot accounts (302) H are created, they can be exposed to scammers (301) in a variety of ways, as described herein. In some embodiments, when Scammers (301) send messages to these accounts, these messages are read (303), classified by type (305) and stage (306) based on the Rules and Rule Families they hit. In one embodiment, for each new message that arrives at a H (302), a search (307) for similar S message is made in the repository (308). In various embodiments. messages are matched based on one or more of the following:

Exact wording match—Where the new message matches completely word for word. Messages may be exact matches because scammers use automated systems to generate and send scam messages, or could be a scammer person that cuts and pastes from a standard set of messages;

Near exact wording match—Where the message is mostly an exact word match for a S. For example, the message may be customized for the receiver's name like “Hi Bob” instead of “Hi John”, or the receiver's location like Seattle instead of Dallas; and

Matching Rules—Where message matches are based on the Rules that match both the new message and an S entry.

In some embodiments, the V responses for each matching S in the repository (308) are returned by the match selector (307). A single response is selected from the set of returned V response based on one of the following:

Randomly selected from the set;

A Scam Phrase match score is returned with each V response, and the best match is selected; and

The most effective message, as described herein, is selected.

The V response is customized (309) as needed in one or more of, but not limited to, the following example ways:

Any personally identifiable information including, but not limited to, name, address, account numbers, or contact information in the original V message is replaced with fake information created for the Honeypot account;

Any information related to the scammer is replaced or omitted. For example, if the scammer indicated that his name is Ted in a preceding message and the V message says “Hi Bill”, this is replaced with “Hi Ted” in V′, or the greeting can be omitted in V′;

The customized version of V, called V′, is then sent (304) to the scammer (301) as a response from the Honeypot account (302).

In some embodiments, the system waits before sending the response to the scammer to simulate human interaction. The delay can be one or more but not limited to the following:

A random delay, within some time range. For example the response is sent any time in the next 24 hours; and

Delay until normal peak internet usage hours for the faked location of the Honeypot account. For example, Internet usage statistics by time of day are available on the internet for various regions. For example, if a Honeypot account is supposed to be in London, then in one embodiment, the message is sent around 4 PM London time, but not at 4 AM London time.

The effectiveness of each message sent to a scammer can be tracked over time. In some embodiments, each V in the repository described above includes one or more of the following:

sentMessageCount—which is the number of times V′ message was sent to a scammer from one or more distinct honeypot accounts; and

receivedResponseCount—which is the number of times a scammer replied to the V′ message.

The relative effectiveness of each sent message V is scored, for example, by dividing receivedResponseCount by sentMessageCount. For example, if 20 V′ were sent and only 1 response was received, then V is 5% effective and is therefore determined to not be very effective at fooling scammers.

In one embodiment, ineffective V can be regularly culled by removing the lowest N % (e.g., 5%) of V as long as the sentMessageCount meets a minimum threshold (e.g., 10). For example, a daily process can be configured to scan for all V that have more than 10 attempts and calculates the effectiveness. Any {S,V} entries that have less than 5% response rate are deleted from the repository.

In another embodiment, ineffective V are moved to an “inactive” folder for potential/possible analysis.

As more Scam threads are found by the system, additional entries can be added to the {S,V} repository to keep a refreshed set of what appear to be human interactions.

The system may 1 not always be able to find an appropriate match to S in the repository because it may be something totally new from the scammer that has not been previously observed. In some embodiments, in these cases, the system randomly selects from a set of vague but credible responses that are available. Examples of such responses can include but are not limited to:

I'm not following you;

Why do you say that?;

How do I know that I can trust you?;

How can I be sure about this?;

Could you send me a picture?;

Really?;

Are you sure?;

Tell me more; and

Can you give me more details?

In some embodiments, when the system cannot find a match S in the repository, the scammer's message is recorded for review. A person can manually review the scammer's message, create an appropriate response and record the scammer message and response as a new entry in the repository. For example, if there is no existing appropriate match to Scammer: “Will you meet me?” the answer “I'm not sure yet” can be inserted into the repository for future use. In some embodiments, the manual review can be used to resolve inconclusive results of filtering and/or be used to facilitate dynamic filter updating, as described above.

Targeted Honeypot Account Identifiers

In one embodiment, the system uses a pool of pre-created honeypot accounts to host interactions with scammers. In another embodiment, honeypot accounts are created on demand. In either case, if the scam type can be identified, the honeypot account identifier can be customized. For example, if the channel is email and the scam is determined to be a romance scam, then the account identifier can be generated by suffixing a pattern chosen from a table of romance-scam-specific patterns with an integer, for example, “shy_one57”.

In one embodiment, the integer is selected, and then the name is tested for availability with the service provider. As a further example of what can be performed, if the modality for the majority of romance scams is men impersonating women to men, then more specific choices for the account identifier can be selected that would appear more authentic to the scammer; for example, “realman1942,” “greatwhitehunter52,” “yourmotherwilllikeme,” “bestlocksmith93,” etc.

In some embodiments, if the name is unavailable, the integer is incremented and substituted into the pattern again. In some embodiments, this is facilitated using a suitably supportive interface from a cooperating mail service provider.

In some embodiments, the choice of the integer substituted into the pattern is used to suggest a user's vulnerability to the scammer. Users often integrate personal information, such as age, year of birth, or year of high school graduation, into their identifiers. Thus, as one example, “realman1942” suggests that the user who created the account was a male born in 1942.

In some embodiments, blocks of email addresses are reserved or obtained from cooperating mail service providers. In this case, account identifiers enhancing the victim's role in a particular type of scam plot can be selected, and appropriate identifier selected from the pool of identifiers so reserved.

For example, identifiers reserved or previously obtained from a mail service provider can be represented in a table of honeypot identifiers, where a ‘_’ indicates that the pattern can, for example, be used (once) without a numeric suffix:

TABLE 14

| Pattern | Scam Type | Available suffixes |
|---|---|---|
| distinguishedgent | Romance | 1948, 1951, 1952 |
| saltofearth | Romance | 55, 74, 88 |
| econotow | Advance Fee | _, 00, 44 |
| handymanny | Advance Fee | _, 0, 00 |

Example pseudo code for an algorithm to select an identifier for a message, m, from such a table (EmailIDs) can be as follows:

available_ids=EmailIDs.where(EmailIDS.scam_type==m.scam_type);

id=available_ids.first( );

suffix=id.available_sufficies.first( ).seserve( );

return (id.pattern+suffix);

Using Honeypot Data

Suppose that in the following example, Alice and Bob correspond to email accounts, where Alice is a potential scammer and Bob is a registered user of ZapFraud's protection service. Cindy and Dave are another two email accounts, which are honeypot accounts controlled by the system, as described above, to gather scam email messages.

Consider a message M sent from Alice to Bob. The system described herein evaluates the message and assigns a scam score S=ScamScore(M), which exceeds some threshold. The Message Score can be computed in various embodiments based on the message content, headers, and on information relating to whether this or a similar message was also received by another account (Eve) associated with ZapFraud. Here, Eve can either be a good user or a honeypot account.

The scam evaluation system can be configured to be able to determine if one or more of the following its true:

Alice is overwhelmingly likely to be a scammer;

Alice is a scammer performing scams of a type T (e.g., romance, lottery, etc);

Whether Alice shares victim email addresses with other scammers, and if so, to what scam accounts. This information can be used for the scam network analysis described below;

Alice's IP address has been previously associated with scam; and

Alice is actually a legitimate user, and it was a mistake to determine that she is a scammer. If a mistake is indicated, then the associated Filter Rules can be marked for review.

In reaction to computing the scam score S and finding that it exceeds the threshold, the following example actions can be done:

1. Prepare two messages M1 and M2, such that M1 and M2 are different from each other, but are related to the original message M. In some embodiments, the messages are generated to be sufficiently different from each other to avoid detection by Alice as originating from the same source. The efficacy of the message differentiation can be quantified by the subsequent response rate from Alice.

2. Send M1 from Cindy to Alice, send M2 from Dave to Alice. In some embodiments, the messages are not sent at exactly the same time, but with some random delay between so that Alice will not easily correlate them based on time of arrival.

2.1 Messages M1/M2 contains one or more tracker components such as a unique image hyperlinks that, when rendered, allows a determination of the IP address of the user rendering M1/M2. The system can gather additional information that can be used for device fingerprinting when it is available. This information can include but is not limited to user agent, Flash cookie, and browser cookie detection. A detailed fingerprinting of the machine, can be used to detect if the same machine is also used to control another potential scammer account Alice′.

2.2. Messages M1/M2 are used to determine the use of a proxy by sending multiple images hosted at different locations based on the delay in the requests for the images. The delay characteristics provide additional location information. For example, when the scammer opens a message that autoloads three linked image from synchronized hosting sites in San Jose, Calif., Lagos, Nigeria and Moscow, the request delays can be compared to determine which servers are closest to the scammer.

2.3. In one embodiment, the use of multiple hosting services for detection as described above is masked from the scammer by using techniques such as HTTP redirection, which prevents a scammer from seeing the different hosting sites.

2.4. In one embodiment, synchronized servers are able to detect the time delay for requests to different servers by measuring the delay between the server providing a redirect, and the time for the request to arrive at the redirected link, rather than assuming all images were loaded at the same time by the image autoload of the email client.

2.5. In one embodiment, the delay characteristics per image link or other content server is compared with previous delay characteristics to identify scammer systems that are at the same location but are different system.

2.6. The geolocation information can be used for the following:

2.6.1. The geolocation information is used to confirm that Alice's actual location matches her expected location. Her expected location is gathered from explicit statements in a message such as “I am in Toronto”, or from context such as responding to an online classified ad in Topeka. If her expected location differs from her actual location, this is used as further confirmation that she is a scammer. For example, if Honeypot account is receiving messages resulting from a post on a dating board for Portland, then messages from Lagos are very likely scam.

2.6.2. Geolocation information is used to connect Alice to other scammers. Since multiple scammers often work at the same location, any other suspect message addresses from the location are linked to Alice as likely scammers too.

Once it is determined whether a person is a scammer or not, additional Rules can be produced, e.g., retraining Rules to incorporate messages sent by a party determined to be a scammer; inclusion of the scammer account on blacklists. Unusual text components and sequences can also be compared to previously recorded text components and sequences in order to determine whether two scammer accounts are associated (e.g., correspond to one and the same user/organization).

3. Wait for some time period for responses from Alice. If Alice does not respond to the messages, then, in some embodiments:

3.1. Record the failure to obtain a response to the message content

3.2. Revisit whether Alice has been misclassified as a scammer

3.3. Adjust the message content for the next Alice to achieve a better response rate.

4. Make a first security decision based on the potential responses from Alice to Cindy and Dave:

4.1. If Cindy and Dave receive the same message from Alice, then this is determined to be an indicator that Alice is a scammer, because many scammers use automated scripts or cut & paste from previous message contents. Example exceptions include an obvious vacation response received automatically, as well other responses such as canned responses, which can be accumulated and catalogued by the system over time.

4.2. If Cindy or Dave receives a response from Alice, then this is determined to be an indicator that Alice is a scammer.

4.2.1. Note: in some cases, this is because typical users do not respond to messages from strangers, especially if they do not have interesting content.

4.2.2. Mark the message derivation algorithm used to create M1 and M2 as successful because it received a response from Alice the scammer.

4.3. If Cindy or Dave receive a response R from Alice where ScamScore(R)>ScamScore(M), where M is the original message and R is the subsequent response, then this increases the likelihood/certainty that Alice is a scammer.

4.3.1. In one embodiment, Alice's account is added to the Blacklist and/or her score is increased on the Blacklist.

4.3.2. In one embodiment accounts that have been connected to Alice via network analysis (described in further detail below) are Blacklisted and/or have their scam score increased.

4.3.3. In one embodiment, accounts for all previous messages from Alice are incorporated into the scam set for additional re-analysis of Filters and Rules.

4.3.4. In one embodiment, message folders for accounts of enrolled users are reviewed for past messages from Alice and linked messages are reviewed for scam. These scam messages are then incorporated into the scam data set.

5. Make a second security decision based on the potential messages from a new user Fred to Cindy/Dave:

5.1. If a new user Fred contacts Cindy/Dave and there is some linkage to Alice via available information like domain, IP address, message content, then in can be determined that there is high probability that Fred is affiliated with Alice. In this case, Fred can be linked to Alice and treated as Alice′.

5.2. In some embodiments, the ability to distinctly determine the association between Fred and Alice is dependent at least in part on the extent of reuse of the accounts for Cindy/Dave. For example, if honeypot accounts are too broadly used there will be overlap between the scammers that are communicating with each. Dynamic creation of honeypot accounts is used to ensure that the overlap between scammers is minimized.

6. A third security decision is made based on the tracking components of M1/M2 to further confirm or refute the likelihood of scam. For example, if the IP is in Nigeria, or using a known proxy or VPN, or if the user agent has been connected to prior scams.

7. Based on the security decisions, it is determined whether to place Alice on a blacklist, so that all traffic from her is Filtered and scored for all users. If Alice is added to the blacklist, when a new account Alice′ is investigated, and is found to correspond to Alice (e.g., same IP, same computer, etc), then Alice′ is also placed on the blacklist, assuming Alice′ exhibits some minimum threshold level of scaminess.

8. In some cases, it may not be possible to determine whether Alice is a scammer based on one interaction, and it may be difficult/not be possible to determine the likely type of scam based on one interaction. The above can be performed over multiple interactions.

Thus, as described above, real scam traffic is harvested, the sender information extracted, and used in a honeypot that proactively contacts the harvested senders, thereby responding to believed scammers from accounts that are honeypot accounts. The response from these believed scammers can be used for a multiplicity of reasons. A first reason is to determine with some certainty/likelihood that the suspected scammers are indeed scammers, based on the additional material obtained from communicating with them. A second reason is that the believed scammers can be tracked and classified in order to determine patterns of behavior over time and within a particular scam category like romance scams. A third reason is that additional information received from the believed scammers can be fed to the Rule training algorithms described in this disclosure, thereby generating new Rules from the traffic generated by the honeypots. The above described features include additional capabilities not available to traditional honeypots for a variety of reasons. One is that they are proactive as opposed to reactive; another is that they are configured and instantiated based on real user traffic; and a third is that they can be interactive (i.e., generates messages sent to believed scammers, where these messages mimic messages sent by real users).

Partitioning Message Threads

In various embodiments of the described system, in some cases traffic is comprised of a series of messages between two or more parties on a similar topic over time. For example, a response to a message may receive another response. This series of messages is called a Message Thread. A Message Thread can easily have many responses and the likelihood of more responses grows as more people are on the thread.

In addition to responses, messages can be forwarded. For example, a suspicious message can be sent to a third user with a simple message such as “Check this out”, or “do you think this is a scam?”, which can be followed by the original message.

In some communication channels, multiple messages are appended to the beginning or end of the message thread. Each sub-message has a “boundary” which is a separation between two parts to be independently scanned.

For example, boundary detection can include, but is not limited to, the following examples:

A message line starting with a date string such as “On Sat, Nov. 29, 2014 at 1:50 PM”, containing an email address and ending with “wrote:” indicates the inclusion of a message into the current message;

The occurrence of the word “date:” followed (not necessarily directly) by the word “from:” followed (not necessarily directly) by the word “subject:” followed (not necessarily directly) by the word “to:”
This corresponds to the header of an email that is being responded to or forwarded; and

The beginning and the end of a message thread correspond to boundaries.

A Message Thread can be processed in one or more ways which include, but are not limited to, the following:

The entire Message Thread is processed independently/with no consideration to any of the messages;

A selected message in the Message Thread is processed and the remainder ignored. For example, only the latest additional message to the Message Thread is considered and the remaining messages are ignored;

Each message is processed separately and a different scam weighting are applied to each section. For example, the older messages in the Message Thread are considered as weaker factors in evaluating the potential for scam;

Messages from selected parties are omitted from consideration. For example, if a user has enrolled with the system for protection, then their messages in the Message Thread are not used in scoring the message; and

Messages from the Message Thread are paired into scammer and intended victim pairs to be used in {S,V} repository (308) as described above.

Detecting Account Takeovers

Some scams may be more effective if they originate from an account that has been taken over. For example, “I've been mugged in London . . . ” or “Grandad, I've been arrested in Mexico and I don't want my parents to know . . . ” look much more credible if the sender's account is already known to the receiver. Scammers, knowing this, may takeover accounts or buy stolen accounts to use for specific targeted scams.

Because these are stolen accounts, messages prior to the takeover sent from these accounts are valid, and any past history is misleading after the theft. It may be challenging or not possible to immediately mark all prior messages from this account as scams. In some embodiments, the described system can review the message folders of registered users to determine if the sender's address was always bad, or if this is the first time a scam has been detected from this source.

In one embodiment, when a scam is detected, all previous messages sent from the scam source in the user's Inbox folder and sent to the scam source in the user's Sent folders, are re-analyzed. In some embodiments, this analysis evaluates:

Was there was a prior existing relationship with the sender or is this the first message from the sender? For example, if there are 10 messages from the sender in the past 6 months, then this is indicative of a prior relationship; and

If there were any prior indications of scams by re-applying Rules, but omitting any Whitelist entries that would have let scams pass. In one embodiment, a lower detection threshold is used for this re-review than is typically used for processing. For example, if the scam threshold is normally 90, the re-review threshold could be set to 45.

In one embodiment, if it is determined that there was a prior relationship with a previously legitimate account, one or more of the following can be notified that an account was likely compromised:

The receiver of the scam message is informed that their associate's account was likely compromised and any messages should be viewed with suspicion until the account is re-confirmed. For example, the system sends a message such as “It appears that ‘account@wherever.com’ has been compromised. You should be very careful about any messages from this account until the problem is resolved. You should contact the sender through another account or by phone to inform them that there may be a problem with their account”;

The system sends a message to account that sent the scam warning them that their account is being used to send scam messages; and

The system sends notifications to third parties as described herein in third party notifications.

Re-Review Due to New Information

Some scams evolve across multiple messages, where the first interactions appear harmless, but later information triggers a re-evaluation of prior scam decisions.

In one embodiment of the described system, when a message is identified as suspicious, prior messages from the sender are evaluated to build a more complete understanding of the interaction. Where prior messages are available, the system searches based on various items including, but not limited to, the sender, the subject, the message content, or the timeframe.

As one example, the trigger for the search can be a suspect message that was sent to the same individual or another individual. For example, if badguy@evil.com sends a scam message to Alice, then badguy@evil.com or evil.com is added to the Blacklist and all of Alice's prior messages from badguy are reviewed and disposed if needed as described below. In addition, all messages to Carl from the same sender or on the same topic can also be reviewed and disposed if needed as described below.

Message Attachments

In the described system, some messages may contain attachments. Example attachments include, but are not limited to:

Images in various formats including but not limited to PNG, JPEG, GIF;

Documents in various formats including but not limited to text, PDF, Word, ODF; and

Spreadsheets in various formats including but not limited to XLS.

In one embodiment, these documents are analyzed for scam using the techniques described below. In addition, Filters and Rules that are specific to the file format are applied and a separate scam repository that is specific to the attachment type is utilized for analysis.

Image Filter (207)

In the described system, some messages contain embedded or attached images that can be used to detect scammers. Examples of such images include, but are not limited to:

Fake or stolen financial documents;

Fake or stolen identity information including passports and driver's licenses; and

Images of attractive people

The Image Filter is configured to detect images that have been previously detected in scam messages. In some embodiments, there is an Image Filter Rule for each image, which contains an image identifier, such as a filename, digest, or simplified/vector representation of the image, and a ScamScore for the image. When a matching image is found in, or attached to, a message, the corresponding ScamScore is applied to the message.

Images in new messages can be checked against previously detected scam images by the Image Filter using various methods including, but not limited to the following examples:

Image name;

Reading any metadata available for the images. This can include but is not limited to timestamp, geolocation information, or who took the picture;

Performing a checksum on the entire image or a selected subset. This comparison can be performed iteratively. For example, if the first 1024 bytes of two images are not the same, then the comparison is stopped, but if they are the same then the entire image is compared. In some embodiments, the initial checksum is used to determine potential matches across a set of known scam images;

Images are processed to determine if they contain text through optical character recognition (OCR) or if they contain an image of an object or person. Text recognized in images are compared with text found in previous scam images and checked using various text Filters; and

Images are processed to determine if they contain faces and then processed to determine if those faces match previous scam images.

Scammers often use valid images stolen from dating sites. In some embodiments, the system can be trained using legitimate images from dating sites in addition to images from previously detected scam messages.

In one embodiment, each scam image is stored in a Scam Image Repository, SIR, and a ScamScore is assigned to the image. The initial ScamScore is assigned from the Message Score when the image was initially found. As subsequent messages find/detect the same images, the corresponding Rule Score can be adjusted in one or more of, but not limited to, the following example ways:

An average of all scores for messages that contained the image can be applied;

An average of the last N score for message that contained the image can be applied. For example, only average the last 5 messages that contained this image;

An average of the scores for messages received within a time window that contained this message. For example, only messages that were received in the past 30 days are included in the average;

If a new message score is higher than the existing imageScore, the imageScore is increased to the new value;

The average can be a weighted average that gives more consideration based on when the image was received. For example, the last 3 images could be summed as score=W1*ImageScore1+W2*ImageScore2+W3ImageScore3 where the weights increase for the most recent images; and

In one embodiment, the image matching system returns a confidence about the quality of the match. The system records the confidence, C, of each previous match and uses this confidence as a weighting in the average. For example, a new image is matched against three previous images with distinct C, then the score=C1*ImageScore1+C2*ImageScore2+C3ImageScore3 to reflect the relative confidence in the matches.

In some embodiments Image Filter Rules configure how images are handled. This includes but is not limited to the following examples:

When an image that has been previously connected to a scam message is found, a high score is assigned to the message through the Rule associated with the image. This ensures that the message is disposed so that it does not reach the user. For example, if the face recognition determines that HappyGirl.jpeg matches Oksana.png, which was used in prior scams, then the message is given a scam score of 100;

When a new image is found in a message that has a high Scam score, the image is added to the image repository with the Scam Score of the message; and

When a new image is found in a message with a low Scam score it is discarded.

In one embodiment, images found in messages with a low Scam score are retained as good images for future messages and for training as Ham images.

Document Filter (208)

In one embodiment of the described system, documents that are attached to messages are processed by the Document Filter (DF) to detect scam by checking a repository of documents that have been linked to prior scam messages. When the system detects a document attached to scam message, it can be added to the Scam Document Repository (SDR) both in its original form and as pure text with all formatting removed. For example, Microsoft Word and Adobe PDF documents may include extensive formatting information that is usually much larger than the actual text in the document. In some embodiments, this can be removed to simplify subsequent processing. The Scam Score for the message is assigned to the new document in the repository.

When each new message arrives with document attachments, each attached document can be checked for scam in one or more ways including, but not limited to, the following examples:

for an exact match of the original document in SDR—If a match is found, the ScamScore for the matching document is applied to the message by the DF;

for an exact match of the document text in SDR—If a match is found, the ScamScore for the matching document is applied to the message by the DF;

against the SDR based on the document metadata contained in the original document—For example, metadata typically contains author information and creation date information, and can also contain revision history and other information depending on the document type; and

using the String Filter and Phrase Filter described above—The ScamScore returned by the filters is applied to the message.

Networking Scams and Scammer

In one embodiment of the described system, a repository of scam messages is analyzed using various Filters. These Filters are configured to identify common components of each scam and create a network of scam information from the repository. The messages can be linked by one or more of the following but not limited to only these:

senderID;

receiverID;

Sender channel ID, like IP address; and

Filters that the message triggered.

This linking can be used to assist in creating logical grouping of messages, senders, and Filter families.

In one embodiment, the results of the network analysis are graphically presented to assist in interpretation of complex data sets, by showing nodes as messages, senders or receivers and the links between the nodes to identify the relationship between the nodes.

The graphic presentation, can be used to group messages, senders, receivers, or Filters into logical groups (e.g., by clicking on the graphic presentation).

Third Party Interaction

Third Party Notification

In one embodiment of the described system, information is correlated across messages to determine the source of suspect messages including but not limited to the following examples:

A specific sender id such as an email address is used to send one or more scam emails—For example, when badguy@root_of_all_evil.org sends scam emails to Homer, Carl, and Lenny the system determines that the email address is a scam source;

A phone number sends multiple scam SMS messages to one or more users—For example, when 512-123-4567 sends scam text messages to Dave and/or Buster, the system determines that the number is a scam source;

A specific device such as a particular computer or mobile device is used to send one or more scams—For example, when one or more scam messages are connected to a device by Browser User Agent settings and/or IP information, as described above, the system is configured to be able to identify this device as a scam source;

A specific internet domain such as root_of_all_evil.org is identified as a scam source when multiple email addresses are identified as sending scam—For example, when Bud@evil_intent.org and Lou@evil_intent.org are both identified as scammers then evil_intent.org is identified as a domain that sends scam;

A hosting service is identified as a scam source by the Internet IP address information in email message headers. Similar scam messages originating from the same hosting service are connected by looking up the hosting service for each offending domain, and where the underlying hosting service is common, the hosting service is designated the source of scams, not only the individual domains. For example, a Hosting Service may host evil_intent.org and notsobad.org, and when both domains are identified as scam sources, the service is also identified as a scam source because they have poor security policies and/or do not vet their customers; and

In one embodiment the rate of scam is calculated based on the number of bad versus good messages that were sent from the identified email address, domain, device or hosting service and compared to a threshold before determining that it is a source of scam. For example, if Bud@evil_intent.org and Lou@evil_intent.org send 10 scam messages before their accounts are shut down by the administrator at evil_intent.org, but there are 1000 other accounts that send 100 message each day, then the domain is not a scam source, but the individual accounts are a source.

In one embodiment the system notifies individuals or services about the source of scams. The notification can contain one or more of the following:

The account, domain, device, etc. that has been identified as a scam source;

All or a portion of the message that was detected that triggered the notification. For example, the receiving account email address and any personal information can be redacted from the email before it is sent to a third party to ensure a user's privacy; and

A quantitative or qualitative estimation of how likely the message is scam.

The receivers of these notifications can include but are not limited to the following example receivers:

Law enforcement—Information is sent to a suitable law enforcement entity that is able to assist in the immediate termination of scam attempts or in legal prosecution of scammers. For example, local, state federal and international law enforcement are provided available information;

Mail Service Providers—Mail service providers are informed that one or more of their users are sending scam emails. This could include accounts that were created for scam purposes or legitimate accounts that were compromised by scammers. Responsible Mail service providers may use this information to shut down or limit the use of the suspect accounts;

Domain Administrators—Domains or accounts at a domain may be compromised by scammers to send emails without the administrators being aware. This can include incorrectly configured systems that can result in an “open relay” or simply compromised accounts. The domain administrator is informed that their system is a source of scam messages and responsible domains will address the issue;

Hosting Service—A hosting service hosts multiple domains. Some domain owners may lack the technical ability to understand that their domain was compromised. The hosting service is informed about compromised accounts and responsible hosting services will shut down the offending accounts;

IP Blocklist Services—Internet services such as Spamhaus.org distribute Blocklists of bad IP addresses that are used by many internet sites to block bad traffic. These blocklist services are informed of the source of scam messages so that they can be added to the blocklists;

Email Account—A response is sent to the source of the scam. This indicates to the scammer to that the account is protected. This can also be used to inform victims that have had their account stolen and that it is being used by scammers.

In various embodiments, the notifications can be sent to all these receivers at the same time or the notifications can be sent in a prioritized order, for example, with a delay between notifications. For example, a domain administrator can be informed, and if the scam source is not shut down within an hour, the hosting service for the domain can also be notified, and if the scam source is not shut down within 4 hours, the information can be provided to IP Blocklist Services. This allows responsible administrators a period of time to respond before their IP addresses get blocked.

In one embodiment, the system determines if a scam source has been shutdown by monitoring the traffic from the source. The expected resolution time, TR[ScamSource], is recorded when each notification is sent. If a scam message arrives from the ScamSource after TR[ScamSource], then the receiver of the notification has failed to remedy the problem and additional notifications can be sent.

In one embodiment, the described system provides an interface where individuals or services register to receive notifications.

Third Party Status Updates

In one embodiment, registered third parties can provide information to the scam evaluation system described herein and the information is validated and is dynamically incorporated into Filters and Rules. This information can include but is not limited to the following:

Cured Email Accounts—For example, email accounts that are reported as described above including mail service providers, domains and hosting administrators, can be reported as ‘cured’ when the account holder has performed appropriate steps to regain control of the account and eliminate it as a source of scam. The system can validate that the account is cured, as described herein, and remove any negative scoring associated with the account in the future;

Cured domains—For example, Internet domains that have been identified as scam sources such as open relays described above can be reported as ‘cured’ by registered third parties. The system is configured to validate that the account is cured, as described below, and remove any negative scoring associated with the account in the future;

Bad Domains—For example, registered third parties can provide Internet domains and IP addresses that they have detected as bad for incorporation into Filters and Rules used by the described system;

Bad Email Addresses—For example, registered third parties can provide email addresses that they have detected as bad for incorporation into Filters and Rules used by the described system. For example, an online payment service “PayBuddy” can receive a steady stream of messages into spam@paybuddy.com which could be analyzed to extract bad email addresses that are then provided to the system.

Bad Message Content—For example, registered third parties can provide suspect content that they have observed. For example, a bank can detect the phrases “your Bank of the US has been locked” and “please resolve this problem immediately by clicking here” or a link to a bad site like bofUS.evil_intent.org and report them to the service for incorporation.

In one embodiment of the described system, individuals and organizations must be previously known to the system and able to authenticate their identity before the information can be submitted. In some embodiments, individuals and organizations can enroll and register their identity and receive an account, and password or token to access the interface. In some embodiments secure tokens such as OAuth are used to automate access, and two-factor authentication such as FIDO or Google Authenticator can be used for any web page access.

In some embodiments, in the preceding description, it may not be sufficient for an individual, a mail service or even a hosting service to declare that an email address, or domain is cured of past behavior. When a report of a ‘cure’ is received, in some embodiments, the score of associated Rules and Filters is ramped down over time to protect against a recurrence of source as a scammer.

In one embodiment, the efficacy and veracity of the reporting individuals and services is scored over time to determine how well the ‘cure’ of their accounts are performed and how accurate their reporting is. In cases of scam recurrence after the report of a cure, the quality of the reporter can be downgraded and the period of the score ramp down is extended. Upon each subsequent failure, the reporter is downgraded again, and the delay period extended further. Reliable reporters can have their score improved over time to reflect their accuracy and the associated delay for Rule score reduction can also be reduced.

Creating Templates to Detect Synonym Scripts

In some embodiments, at least some spammers and scammers are expected to respond to more stringent Filtering used by the described system. One example approach that scammers may potentially use is to create scripts that take an input, such as a manually generated spam or scam email, and determine what words and phrases can be replaced by equivalent words or phrases without changing the meaning, after which a second script generates a multiplicity of equivalent spam or scam messages with identical or near-identical meanings. The expected intention of doing this is to avoid traditional spam Filters. If these generated messages correspond to a storyline that matches one or more of the Rules described above, then these messages will be blocked. The following techniques describes an approach to address spam and scam of this type when the previously described Rules are not matched.

By way of an example, assume that the initial message is as follows:

TABLE 15
I have no idea what's going on with this place, what's with all the blocking when people respond? I had a post here
some time ago but even that is impossible to do here. Not really looking for anything complicated, just someone
down to earth, nice, not a nut.....lol.contact me here please lillylarson1991 at gmail dot com

While this may seem innocuous, if a user responds to this (real) scam message, then he is asked to sign up for a service that screens people—presumably for the safety of online daters—but which has a fee. In this example scenario, the scammer simply wants to cause signups to this service to get commission and/or steal credit card information. As can be seen from the sample message above, this does not clearly match a scam storyline, and could even be legitimate. However, if a large number of identical or near-identical messages like the above messages are detected within a short period of time, then it can be concluded to be spam or scam. In some embodiments, one or more automated honeypot accounts are able to interact with the scammer to detect this behavior and determine that it, in fact, is scam.

After a message such as the above is determined to be part of a scam, then it is determined what collection of equivalent messages can be generated, for example, using substitution, as described above. Continuing with the above example, this is determined to result in the following message:

TABLE 16
I {have no idea, do not know, am clueless} what's {going on, happening} with this {place, site, stuff}, {what's,
what's up} with all the blocking {when, as} {people, I, dudes} {respond, reply}? I had {a post, an ad, a message}
here {some time, a while} ago but even that is {impossible, not possible, pointless} to do here. Not really looking
for anything {complicated, complex, confusing}. just someone down to earth, {nice, pleasant, cool}, not a {nut,
creep, walnut} .....lol.contact me here please lillylarson1991 at gmail dot com

In the above, the curly brackets enclose sets of alternatives, as determined using an example database of synonyms and similar phrases. This step mimics the expected strategy of the spammer/scammer. Next, a Rule is generated that identifies an email as belonging to this set of scammer emails if it contains a sufficiently long sequence of words contained in the synonym-expanded message. For example, for a sequence length of at least 12 words, the following segment would be identified as belonging to the same set of messages as the original scam message:

“Not really looking for anything {complicated, complex, confusing}. just someone down to earth, {nice, pleasant, cool}”

Two examples of such sequences include:

Not really looking for anything complicated. just someone down to earth, cool

and

Not really looking for anything complex. just someone down to earth, pleasant

In one embodiment, the system identifies the differences in these similar sentences and automatically turns them into Equivalent terms as described above. By masking one sentence with another, the resulting difference shows the matches, such as “complex:complicated” and “pleasant:cool”.

In one embodiment, the system identifies and removes the varying phrases, such as {“complex”, “complicated”} and {“pleasant”, “cool”} to create a new Phrase Filter Rule such as:

Not really looking for anything, just someone down to earth

which matches both the observed variations and potential new variations such as:

Not really looking for anything in particular, just someone down to earth, peace out

where the scammer uses new words with these phrases.

In another embodiment, the system determines that “not really looking for anything” is a phrase associated with many scam messages, but also with some ham messages. The system also determines that “what's with all the blocking” is associated with many scam messages, but also with some ham messages. The system further determines that almost all the scam messages containing the first phrase also contains the second phrase, whereas no observed ham messages contain both. As a result, a Rule is generated in which “not really looking for anything” and “what's with all the blocking” are the two terms that are scanned for in messages. In one embodiment, since there were no ham messages matching this Rule, the score associated with the Rule is set, for example, to 90. In another example, wherein at least one of the one or more phrases is not grammatically correct, contains spelling errors or unique identifiers such as email addresses, or contains uncommon URLs, it is determined that the associated Rule is associated with, for example, a score 100. In yet another example, where there is a small number of hits of the associated Rule against the ham dataset, the associated score is lower (e.g., set to 60). Thus, if only this Rule triggers on a message, the message will not be blocked for a blocking threshold of 70; however, if another Rule of another Family also hits, and this Rule is associated with a score 25, then the accumulated score for the message is 60+25=85, which is above the threshold, and the message is blocked.

Deployment Configuration

The described system is deployable in a variety of ways to enhance performance, or security.

In one embodiment, the entire processing of messages is performed by a single remote service that is securely isolated and protected from viewing. All system components including Filters, Rules, message repositories, etc. are collocated.

In one embodiment, the processing of messages is performed by multiple remote servers at one or more locations to enhance the availability and performance. Some example implementations include the following:

One dedicated server per country or city to minimize the network latency;

Globally distributed servers that use a “follow the sun model” to maximize the use of processing resources, as message rates may depend on the time of day (e.g., since people typically send less email while sleeping);

Multiple servers can handle failover when a server is unavailable or under heavy load; and

Multiple servers can withstand internet denial of service attacks much better than a single server, for example, because more resources are required to compromise more servers. If a server comes under attack, additional servers can be brought online at previously undisclosed locations and IP addresses.

The multiple remote servers can replicate stored information including, but not limited to, scam message repositories, user information, Rule and Filter performance histories to reduce the possibility of a single point of failure.

In one embodiment, the described system executes on a user's personal device and only uses Rules and Filters that are needed by that user. For example, a user's smartphone can be configured to run the described system, but only receive Rules specific to that user, such as a personalized whitelist of friend's email addresses.

In one embodiment of the described system, all messages are forwarded automatically by the user's mail service provider to the system for analysis, rather than (or in addition to) the system polling or waiting for a message notification. This approach can reduce the latency and overhead of polling. Forwarded messages are processed when they are received, and can be disposed of as described above.

In one embodiment of the described system, the processing, Filters and Rules are collocated at a Mail Service Provider. One example implementation is the use of Milters, an example of a standard approach for incorporating mail Filters.

In one embodiment, a protected domain sets its mail exchanger records (MX Records) in its Domain Name Service (DNS) to point to a ZapFraud service that processes all incoming emails before forwarding the messages to the actual mail server for the domain.

In one embodiment, copies or subsets of the described system are deployed across a peer to peer network of user devices, such as smartphones, where each device runs a complete copy or a subset of the system. Each peer node can access an assigned subset of accounts to be protected and the account subset can be re-assigned dynamically based on a variety of device factors including but not limited to device communication bandwidth, device battery life remaining, device strength, user preferences and device location. For example, Alice's device could be assigned to monitor Alice's email accounts, but when Bob's device is turned off or low on battery, Alice's device could monitor Bob's accounts too.

The preceding approaches can be combined in a variety of ways. As one example, the described system partitions and distributes the Filters and Rules across the available devices for processing of messages. For example, a preliminary analysis of messages can be performed using a whitelist. If all new messages are from accounts on the user's whitelist, no further processing is required, but if the message is not from a whitelisted source then a notification can be sent to a server-based component for additional analysis. In another example implementation, general Rules that apply to all users are processed at the mail service provider, and user specific Rules such as whitelists are performed on a user's device, such as a smartphone.

Protecting System Programs, Data and Configuration

In some embodiments, when the described system or portions of the system are deployed, as discussed above, in environments where the device security cannot be ensured, components of the system are protected from attackers. Since scammers may be able to access a copy of the system, various component can be hardened against attack, including but not limited to Filters, user data, Rules, equivalent phrases and thresholds.

In some embodiments, the protection is implemented in one or more of the following example ways, for example, depending on the potential threat and what security hardware support is available, or in other appropriate ways:

Communication of Filters, Rules, Equivalents to remote devices is done through secured channels such as SSL;

Words and phrases in Rules and equivalents are distributed as encrypted values. In one embodiment, the words and phrases are encrypted using a unique seed value that is specific to each device and is known only to the device and the service that provides the Rules and equivalents; and

Trusted Execution Environments (TEE) including, but not limited to, Arm TrustZone, Intel Trusted Execution Technology, and Apple Secure Enclave, which provide additional security support for data and code. In one embodiment of the system, this security is used to protect the system including but not limited to:

Executable implementations of the described system are security deployed via wireless networks, (e.g., Over The Air (OTA) Update), so that an attacker is not able to capture and decode the executable, configuration information, Rules, Filters or user information. For example, someone would not be able to capture and decode the radio signals sending the program to a user's smartphone because the program is sent via a secured channel such SSL, is distinctly encrypted and signed in the TEE using a shared secret or public key so that only the intended user's device can decode and run it;

Executable programs are Encrypted & Signed and validated each time before they are run. For example, before an implementation of the system called monitor.exe is run, the operating system verifies that the executable has not been modified and is signed by an appropriate authority to ensure that it is the correct program;

Configuration updates, including but not limited to Filters, Rules, Image Repository, Document Repository and thresholds, are securely deployed via wireless networks, (e.g., as Over The Air (OTA) Updates), so that an attacker is not able to capture and decode any configuration information;

Configuration information including but not limited to Filters, Rules, Image Repository, Document Repository and thresholds, are stored securely in encrypted form and are only readable by the application and only readable within the TEE, for example;

In one embodiment, the described system reports information back to a server for additional analysis. Reporting information including, but not limited to, new scam messages, new scam email addresses, gathered statistics, scam documents, and scam images is sent via a secured channel like SSL, is distinctly encrypted and signed in the TEE using a shared secret or public key so that only the intended user's device can decode and run it.

Detecting Scam Phrase Reuse

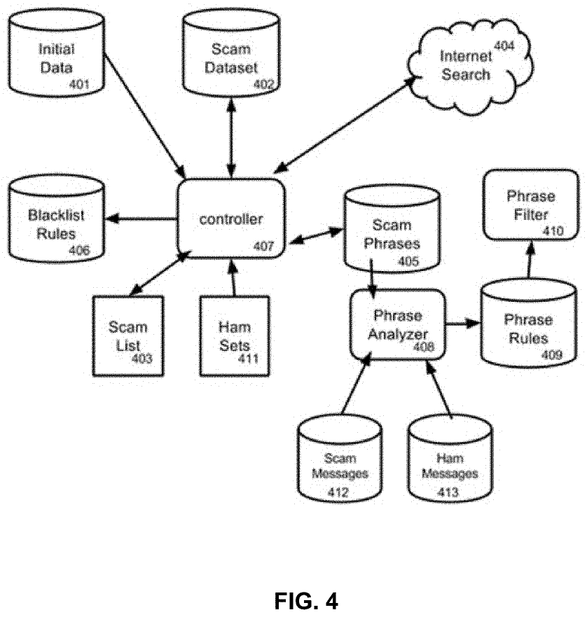

Scammers tend to reuse phrases. This is both in order to save work and to benefit from formulations that are convincing and succeed in getting past spam filters. Some reuse may be cut and paste, others use scripts. For example, one message may contain one or more reused phrases, which sometimes are pasted together with transitions that are either automatically generated by a script or manually introduced. Scammers can be identifiable by these reused phrases and unusual word usage, such as “constantly reactive” or “and decent girl”, but these phrases may change over time, and thus the list of possible scammer phrases requires constant culling and refreshing. The automated system to continuously refresh a list of scammer phrases is described below and in conjunction with FIG. 4.

FIG. 4 illustrates an example embodiment of a system for detecting scam phrase reuse. In some embodiments, the system of FIG. 4 is an alternative view of system 160 of FIG. 1A and the scam evaluation system of FIG. 1C. An example process/steps for detecting scam phrase reuse is described below. In some embodiments, the process is executed using the system described in FIG. 4.

Step 1. The controller (407) initially reads scam content from an initial dataset (401). The controller can be implemented as a Java process running on a Linux system. The initial content can be from one or more of, but not limited to, the following example sources:

a. Internet forums such as stop-scammers.com or reportcraigslistscams.com, where users report scam

b. Dating sites that are known to be hosted by or heavily used by scammers

c. Previously received messages that were determined to be scam by the system described above, whether the system used for autoresponse or to filter messages and block scam messages.

d. Messages that are received into a honeypot account, such as honeypot account 302 of FIG. 3.

Step 2. The controller (407) checks the previously found scam data in the Scam DataSet (402) to avoid running checks that have already been performed. Previously found scam phrases can be omitted from the following steps.

Step 3. The controller (407) performs an internet search (404) for each phrase in the initial dataset (401) to find page content that contains the same phrase. An Internet search engine such as Google, Bing, etc., or a web crawler can be used to perform this search. The controller finds all the 2 through N word phrases that are found in the Internet search results, and counts and records the number of occurrences (e.g., the Scam Frequency (SF) of each phrase). The resulting phrases are ordered based on highest frequency into the Scam List (403).

Step 4. The controller (407) then checks each phrase in SL (403) against available good datasets, “Ham” (411) to determine the relative frequency of these phrases in non-scam contexts. The system records the good frequency, GF, for every phrase in SL (403). These good datasets (411) include one or more of, but not limited to, the following:

a. Previously received emails that were not associated with scam

b. Internet searches using search engines, such as bing.com or google.com, where the number of matches for an exact phrase is returned.

c. Emails from the late Enron corporation dataset, the Jeb Bush dataset, the Hillary Clinton dataset, or other user-generated content that represent benevolent messages, such as Amazon® product reviews.

d. COCA Corpus (http://www.wordfrequency.info/)

e. n-gram databases, such as the n-gram database provided by Microsoft, or in-house n-gram databases generated from one or more of the above described data sources.

In one embodiment, a combination of these data sources is used to determine an estimated frequency of the phrases in good datasets, where the estimated frequency is a weighted combination of the frequencies reported by the two or more components determining likely frequency, as described in a-e above; here, the weight indicates the importance of each such component. For example, in one embodiment, a first frequency f1 is generated by determining the frequency of a phrase in previously received emails that were not associated with scam, a second frequency f2 is generated by determining the frequency of a phrase using emails from the Enron dataset, and a third frequency f3 is generated by determining the frequency of a phrase in the Microsoft n-gram database. A combined estimate f is computed, for example, by computing f=f1*w1+f2*w2+f3*w3, where w1=0.5, w2=0.3, and w3=0.2.

Step 5. The controller (407) then calculates the value SF/GF for each entry in SL (403), and orders them. The larger this value, the more does the corresponding phrase stand out from the other phrases as being the most indicative of scam messages. A score can be generated based on the value SF/GF, and associated with the phrase to which this value belongs. This score indicates the likelihood that the message is scam. For example, score=min(SF/GF*35,25), where min is a function that selects the minimum of its arguments.

Step 6. The controller (407) retains the top N %, for example 20%, of the Scam List (403) and discards the remainder. The controller adds the phrases from the Scam List (403) to the Scam Dataset. These retained phrases will be scanned for in all processed messages, and the score associated with each phrase is assigned to a message that is matched. In one embodiment, two or more phrases that are commonly found in the same scam message are associated with a higher score. For example, if phrase p1 is found in a message m, then this results in a score 30; if phrase p2 is found in m then this results in score 40, but if both p1 and p2 are found in m then this results in a score 85. This can be represented as three different Rules—one for p1, one for p2, and one for both p1 and p2. In contrast, if p1 and p2 are not commonly found in one and the same scam message, but both are found in a scanned message m, then the maximum of the scores is output if p1 and p2 belongs to the same Family, and the sum is output if p1 and p2 belong to different families. In some embodiments, the Family membership is determined based on correlation between when the different Rules are activated on typical scam and ham messages, as described previously.

Step 7. The Controller puts the new scam phrases from the Scam List into the Scam Phrases (405). The Phrase Analyzer (408) can pick up the new scam phrases and process all previously seen Scam (411) and good “Ham” (412) messages to create new Phrase Rules (409). The Phrase Analyzer can be implemented in Java and run as a Linux process. Scam Phrases, Scam Messages, and Ham Messages can be stored as Linux files or as records in a MySql database. The Phrase Rules (409) are later used to configure the Phrase Filter (410) to process messages (not shown) in the production system (not shown).

Step 8. The Controller returns to step #2 but uses the new entries in SD (402) instead of the Initial Data to repeat the process. This process can be run for a limited number of cycles or configured to run continuously to constantly seek the scammiest phrases to be found from available data sources.

In some embodiments, a Phrase Analyzer (408) evaluates the phrase in SP(405) and identifies new scam phrases or variants on existing scam phrases. The analyzer creates new Rules or modifies existing Rules that are read by the Phrase Filter (410 and 201). For example, the phrases “only one honest man” and “live in harmonious together” are found overwhelming in scam messages, so a new Phrase Filter Rule is created with a score of 60, such as:

“only one honest man,live in harmonious together” RuleScore=60

In one embodiment, the Internet domains names where the scam phrases are found in step #7 are recorded and how frequently each matches scam phrases is recorded with the name. This frequency is used to weight phrases per Internet site when they are found by the system above. For example, if the site scamdating.co.ru has many SP (405) matches then it is determined to more likely be a scam site and that any other phrases found on the same site should be treated as more likely to be scam.

In one embodiment, the top Internet domains where SP (405) are most found are automatically or manually incorporated into the Rules (406) used by the Blacklist Filter described above. For example, if scamdating.co.ru consistently appears at the top of the list ordered by descending frequency of sites where SP (405) are found then it is added to the Blacklist Filter Rules.

Automated Training and Evaluation of Filters to Detect and Classify Scam

Overview

As described above, a filtering paradigm can be used for limiting the dangerous messages to which a user is exposed. Filters can work serially or in parallel to identify harmful messages for which the system should take action, such as removing the harmful message from the user's system, sanitizing them (e.g., removing harmful features such as web links for phone numbers or reply email addresses), and/or moving the harmful message to a specially designated folder.

Different filters, such as those described above and below, can be used to identify different scammer behaviors. In some embodiments, the example filters below are configured/implemented using analytics engine 200 of FIG. 2.

Described below are several techniques that can be used (in addition to, or instead of the techniques described above) to identify scam or other unwanted messages from a large collection of input messages. The techniques can be implemented using a system (referred to as “the system,” the “training system,” and the “training and analysis system”) such as system 160 of FIG. 1A, the scam evaluation system described in conjunction with FIG. 1C and throughout, platform 1600 of FIG. 16, etc. The following are several example techniques:

Vector Filter

In some embodiments, a Vector Filter is configured to identify previously seen scam messages or close variations. For example, in a training phase (e.g., the training described above), the Vector Filter processes a set of known scam message as input to create a vector of the salient, scammiest (those that are most indicative of scam) phrases in each message. These can be identified by comparing phrase frequencies in scam data sets with phrase frequencies in non-scam data sets. An ordered list or vector of the scammiest phrases is stored for each previously seen scam message during a training pass. Subsequently, the Vector Filter processes new messages by creating a scam vector and comparing it to the previously stored scam message vectors to find a suitable match. If a match is found then the new message is marked as scam. The Vector Filter is not tricked if a scammer re-orders the component of a scam message, because the phrases are ordered by their determined scamminess, rather than their order in the message. Scam can be detected and classified using this approach, in a manner similar to movies can be identified from classic phrases, such as:

“i shot marvin in the face”, “burger royale”

“i love the smell of napalm in the morning”, “Charlie don't surf!”

“we'll always have Paris”, “play it sam”

“inconceivable”, “mawage is what bwings us together today”.

Storyline Filter

In some embodiments, a Storyline Filter is configured to identify storylines. Email scams include confidence schemes. As confidence schemes have existed in various forms throughout time, the introduction of new scam storylines, or plots, has slowed. Thus new scams are most often fresh formulations of old plots. In some embodiments, the storyline filter is configured to reduce the body of a message to the underlying plot, where it is matched against a database of such plots.

One example of how the storyline filter determines the underlying plot of a message is as follows: First it reduces the body of a message to a vocabulary comprising words or phrases (also referred to herein as “symbols”) found frequently in scam messages and infrequently in non-scam (also referred to as “ham”) messages. At this stage, equivalents can be substituted (i.e., words or phrases that convey similar narrative meaning), such as:
please allow me to introduce myself
i am called
my name is

are replaced with a single word or phrase.

The storyline filter then looks for the sequences of these words or phrases and matches them to identical sequences found previously in scam training messages. To do this, it relies, for example, on a vocabulary, or symbol set.

For example, a vocabulary of scam words comprising:

immediately, contact, hospital, live, diagnosed, cancer, rich

can be used to generate a sequence for the following training message (vocabulary words underlined):

TABLE 17
Dear Beloved,
I am presently writing this mail from the Hospital, I don't know what may happen next to me that is why I have to
immediately contact you, As you read this, I don't want you to feel sorry for me, because, I Believe everyone will
die someday. My name is William Simon a merchant in Dubai, in the U.A.E.I have been diagnosed with
Esophageal cancer, It has defiled all forms of medical treatment, and right now I have only about a few months to
live, according to medical experts. I have not particularly lived my life so well, as...
I never really cared for anyone (not even myself) but my business. Though I am very rich, I was never generous, I
was a always hostile to people and only focused on my business as that was the only thing I care for, But now I
regret all this as I...

This results in a sequence of identifiers:

hospital.immediately.contact.diagnosed.cancer.live.rich

Suppose the detection algorithm encounters a similar scam message in the future:

TABLE 18
Dear Beloved,
My name is Joseph Smith, and I write from a hospital bed. I am a businessman in the UAE and I have been
diagnosed with cancer of the colon. It has defied all forms of medical treatment, and they now give me only 7
months to live. I have not lived my life very well...
I am afraid my business has been my love. However, I am very rich I would like to atone for my single-minded
focus on money and do one good deed before I pass on...

The representation of this message is:

hospital. diagnosed.cancer.live.rich

The storyline found by the storyline filter, diagnosed.cancer.live.rich, is that of a wealthy dying person who wishes to disburse money to the user. A scam score can be computed by comparing the symbol representation of the scanned messages against a stored set of storylines, each one comprising a sequence of symbols. The greater the overlap, the higher the score. In one example instance, a score of 100 is generated when the match is perfect/exact, and a score of 80 when only 8 out of 10, or 4 out of 5 symbols are matched. In one embodiment, the order of the elements is taken into account when the comparison is made (i.e., the comparison is dependent on the ordering of the elements), and in another one, it is not.

String Filter

In some embodiments, the String Filter is configured to identify replication (e.g., copy and paste). In some embodiments, the string filter is a supervised machine learning counterpart to the vector filter described above. Alternatively, as described further below, automated methods are used to select and prune strings. The string filter is used to detect common text segments indicative of scam, and text segments associated with ham messages that may otherwise trigger the detection by other filters. In some embodiments, the string rules are partitioned into two or more segments, where a first segment of string rules are evaluated on all messages that are screened; and another segment of string rules are evaluated conditional of some filter triggering them. For example, if a large portion of string rules are associated with romance scam, these rules may be evaluated conditionally, based on finding one or more words in the body of the email, where these one or more words are indicative of romance scam. For example, such romance-related string rules can, in one example embodiment, be evaluated only if one or more of the following words are found in the text: single, girl, mother, man, married, divorced, love, meet. Another segment of string rules are evaluated conditionally on another condition being met.

Different kinds of scams can have different amounts of scam phrases, story lines, and copy and paste.

For example:
Romance scams certainly may have less storyline than others, but more copy and paste.
The complete-pitch-from-a-stranger scam (i.e., typical 419 scam) may commonly have both salient scam phrases and a story line.

In various embodiments, training of filters use, among other techniques:
Supervised learning based on curated examples: This takes place, for example, while a system such as system 160 of FIG. 1A, the scam evaluation system of FIG. 1C, and a platform such as platform 1600, is processing a live stream of message traffic. In some embodiments, the system learns by submitting some small subset of messages it encounters to humans for review. For example, human reviewers can identify whether messages are scam or not scam, for example, when the automated system is uncertain, and instruct the system to generate corresponding new rules.
Batch training: In batch training, a corpus of previously classified messages is fed through the system so that it can create new rules.
Programming: In programming, human insights can be captured and deployed as human readable and maintainable rules.

Scam messages used for training can be compiled in a variety of manners, including:
Collection of reported messages: In collection of reported messages, end-users, system administrators, spam filters, and scam filters submit inputs, and the system determine which ones to select based on one or more filters. One such filter is to not accept a report from a user previously associated with the sending of unwanted messages; another is to only accept reports that are corroborated by a sufficient number of users, such as at least 100 users that have not been associated with unwanted behavior.
Scraping of reporting websites: One component of the systems described herein is a crawler that visits websites used for reporting of scam messages and scrapes the scam messages from these sites. In one embodiment, the sites are identified and located in an automatic manner, based on using a search engine such as Bing or Google to search for known, submitted, suspected, or likely scam messages, and scrape the contents of sites with such messages. The scraping can be selectively performed to avoid advertisements and site navigation.

Filters—Scam messages can also be identified by the filters described herein. If at least one such filter identifies a message as a likely scam message, then this message is added to the scam repository and can be used to train all the other filters as well.

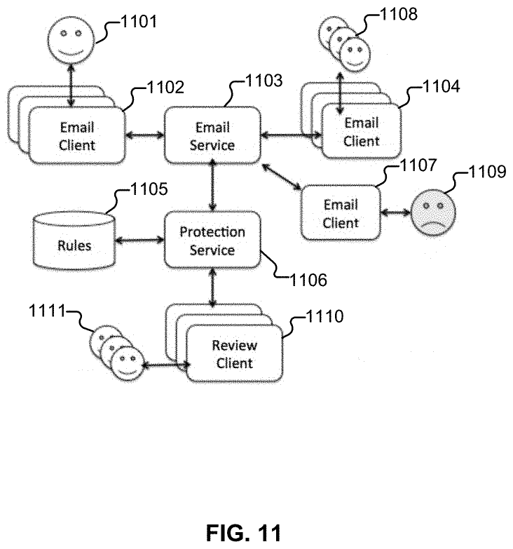

FIG. 11 illustrates an embodiment of a system for performing automated training and evaluation of filters to detect and classify scam. In some embodiments, the system of FIG. 11 is an alternate view of system 160 of FIG. 1A, the scam evaluation system of FIG. 1C, and platform 1600 of FIG. 16. In the example of FIG. 11, the logical components of one embodiment of this system are shown where a protected user (1101) reads, sends and manages email messages through one or more email clients (1102), including webmail interfaces, desktop clients or smartphone clients, that access an email service (1103). One or more “good” email senders (1108) have their own email clients (1104) that communicate with the email service (1103). Scammers (1109) send scams from their email clients (1107) to the email service (1103). The protection service (1106) reads messages from the email service (1103) and filters out the scam messages based on the rules (1105) (such as those described above) that configure the filters. In cases where manual review is needed, messages are presented to one or more reviewers (1111) in a review client (1110) to collect their feedback, for the protection service (1106).

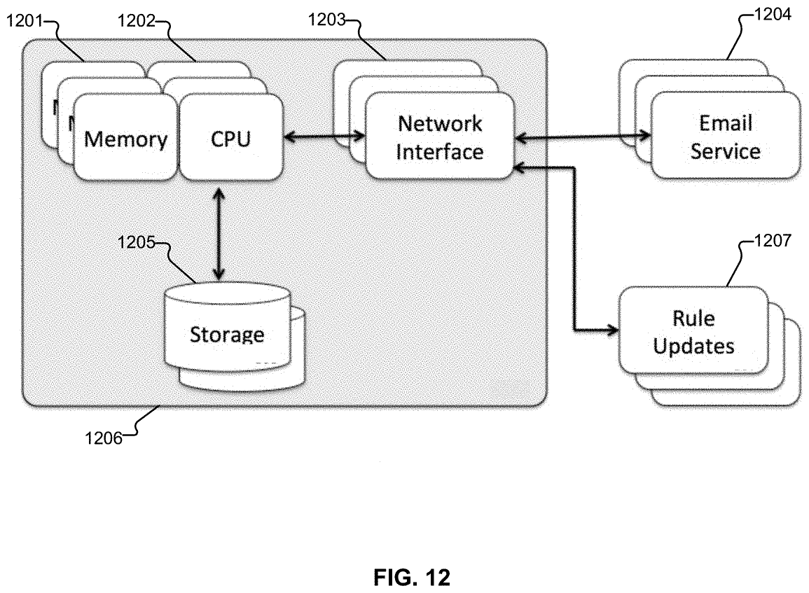

FIG. 12 illustrates an embodiment of a system for automated training and evaluation of filters to detect and classify scam. The example system of FIG. 12, which, in some embodiments, is an alternate view of the system of FIG. 11, shows the physical components of one embodiment of this system where one or more pairings of memory (1201) and a central processing unit (1202) communicate with one or more email services (1204) through one or more network interfaces (1203). As one example embodiment, the memory (1201) and CPU (1202) can be implemented using a blade such as a Dell PowerEdge M420 blade, or the memory (1201) and CPU (1202) can be implemented as a server connected to other servers using an interconnect such as InfiniBand. Each CPU (1202) can have a dedicated network interface (1203) or access to multiple network interfaces in a cluster (1206). Each CPU (1202) and Memory (1203) pair can have dedicated storage (1205) or storage can be common within cluster (1206). A minimal cluster (1206) can have a single CPU, single memory, single storage unit, and single network interface, but a cluster can be arbitrarily large by using a scalable cluster interconnect like InfiniBand. Rules can be provisioned manually into storage (1205) or can be securely pulled from one or more Internet sources for Rule Updates (1207) on a regular basis or when an event occurs. Events can include a manual trigger or an out-of-band message.

Clusters (1206) can be located at a cloud hosting service such as Amazon Web Services, hosted by the service provider like zapfraud.com, co-located at a mail service provider or at a corporation, or some combination of these, to manage security and performance tradeoffs. For example, a corporation can maintain its own cluster (1206) to ensure availability and email privacy, and only pull Rule Updates (1207) as needed. Multiple clusters can be geographically distributed to minimize network latency. For example, a cluster dedicated to processing German messages can be located in Germany since that is where the most German speakers are found. Geographically distributing clusters also makes the entire system more resilient against Distributed Denial of Service (DDOS) attacks.

Storyline Filter

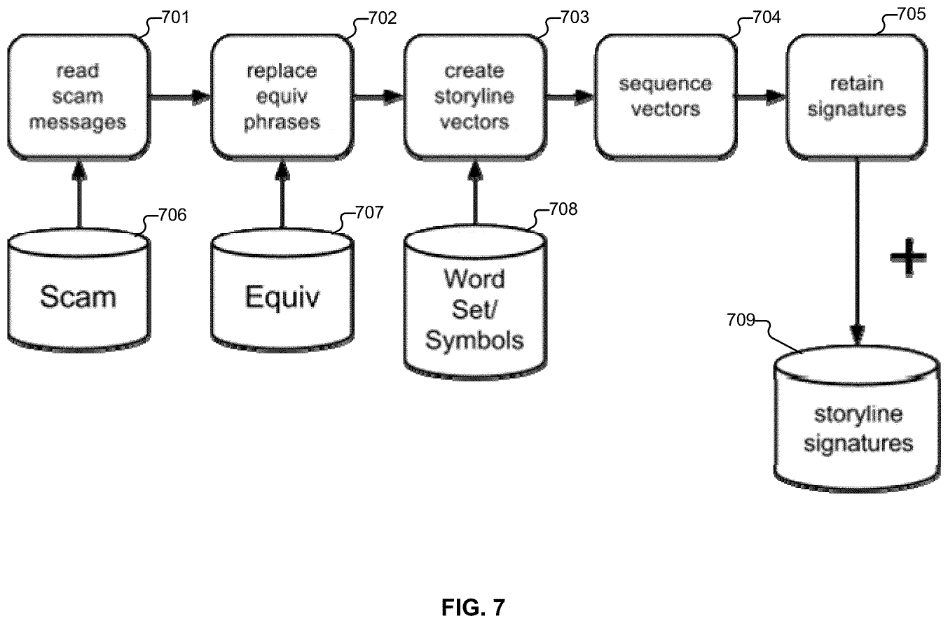

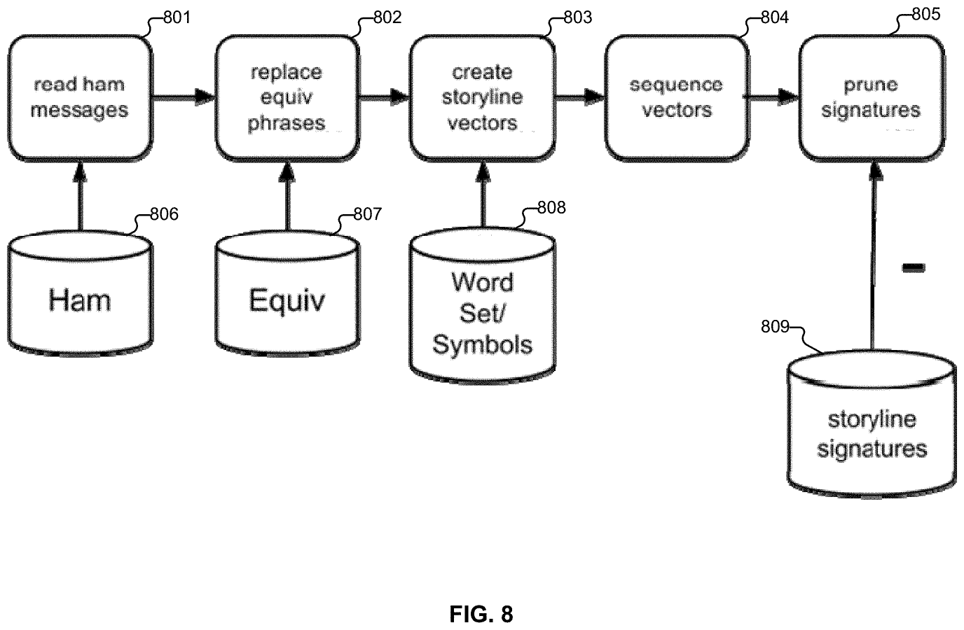

In some embodiments, storyline vectorization is a technique for matching email messages against a vectorized corpus of scam email messages. It can be used to determine whether a test message is scam or “not scam”. In some embodiments, the technique uses vectors of symbols, where each symbol represents one or more equivalent terms, and each term comprises one or more words. For example, a scam evaluation system (such as described in conjunction with FIGS. 7 and 8) identifies an ordered list of scammy phrases and encodes them into a vector. The vector is then sequenced into subvectors (signatures). By storing substantially less information while capturing some of the message's structure, the system achieves search performance and storage efficiency.

In one embodiment, Ham is used to “prune” the vectorized representation of the corpus to reduce false positives (e.g., ham identified as scam). In another embodiment, vector representations for both ham and scam messages are retained and so designated.

Equivalent phrases can be substituted in message bodies prior to vectorization. For example,
funds, the amount, in the amount of

can be replaced with the single word ‘funds’.

A storyline can be represented as one or more sequences of symbols (signatures) found in a scam training message. In some embodiments, it identifies storylines by recognizing signatures of length greater than or equal to a specified threshold. The length and number of matching signatures found in a message is used as a measure of the likelihood that the message is scam.

In some embodiments, signatures are the sequential subvectors that can be formed from a vector. A given vector can have a finite set of signatures. For example, if for the vector formed from a message is:
hospital.immediately.contact.diagnosed.cancer.live.rich

There exist the following possible unique signatures of length four or greater:
hospital.immediately.contact.diagnosed.cancer.live.rich
immediately.contact.diagnosed.cancer.live.rich
contact.diagnosed.cancer.live.rich
diagnosed.cancer.live.rich
hospital.immediately.contact.diagnosed.cancer.live
immediately.contact.diagnosed.cancer.live
hospital.immediately.contact.diagnosed.cancer
immediately.contact.diagnosed.cancer

Signatures inform the decision as to whether a message is scam or ham. For example, the absolute number and length of signatures, irrespective of their relationship to the original training messages, can determine a match. Alternatively, the vectors for the training messages are retained and signatures map back to them. During matching, for a given test message, a score is generated relative to each training message.

The storyline filter can be used to detect the appearance of scam words or phrases that were found in training messages. This can be done with- or without respect to (and/or to varying degrees) symbol order of appearance, through the choice of configuration parameters as described in further detail below. For example, if the parameter M is set 1, then the storyline filter ignores ordering of symbols. This functionality can overlap with that of the Vector Filter, and also the string filter.

In some embodiments, the system is trained to recognize ham messages, or a particular type of ham messages, such as messages that have indications of being urgent; written by a person who is worried; etc.

Symbol Set

The first step, in some embodiments, in configuring the storyline filter is to map search words or phrases to a set of symbols. Via, for example, manual or automated means, a vocabulary can be created using words or phrases found frequently in scam and infrequently in ham. For example, scam messages are manually inspected to identify salient words such as “urgent”, and “risk-free”. Alternatively, words or short phrases (e.g., Ngrams) are found by processing a corpus of scam messages, and ranking these words or phrases. These Ngrams are ranked by the ratio of frequency of their appearance in the scam corpus divided by the relative of their appearance in a ham corpus. This ham corpus can be, for example, the Corpus of Contemporary American English (COCA). In one embodiment, words or phrases for which this value is highest are selected. This corresponds to words that are the most common in the scam messages, relative to their relative infrequency in ham messages, where the latter is represented by COCA, or another database listing the frequency of word sequences. Scanning large numbers of ham messages and computing the commonality of word sequences is another example of a metric to determine where candidate words or phrases are common in ham.

One embodiment uses the top ranked words or phrases as described above. Another embodiment selects phrases by means described for the String Filter (described in further detail below). In another embodiment, the list of candidate words or phrases is selected as above, but the number of words or phrases is increased when analyzing a longer message, and reduced when analyzing a shorter message. For example, analysis begins with a base of 500 words or phrases for a short message, but one then adds 250 additional words or phrases for each 250 additional words in the message above 500. Another option is to use all words for which the ratio described above is above a threshold value that is a system parameter, and which may be set to 10. This corresponds to all phrases being at least ten times as common in scam messages as in ham messages.

In one embodiment, one or more of these words or phrases are mapped to a smaller set of symbols to generalize the approach across a larger word set. In the example that follows, the symbols correspond to words that were identified by manual inspection. This symbol set will be referenced later via the designation EQUIVs.

Subset of EQUIVs:

TABLE 19

| ord | Symbol | Equivalents |
|---|---|---|
| 1 | Nigeria | Nigeria, Ghana, Lagos, Accra, west africa, |
| | | Sierra Leone, Burkina Faso, Senegal, Niger, |
| | | Nigerian, Ghanan, Senegalese Coast, Cote, |
| | | west african |
| 2 | death | death, dead, died, late, murdered, killed, |
| | | not live, die, passed away, dying, deceased, |
| | | no longer living, no longer with us |
| 3 | usd | usd, $usd, us$, dollar, dollars, pound, |
| | | sterling, pounds, euro, euros, $ |
| 4 | million | million, millions, billion, billions |
| 5 | foreign | foreign, foreigner, overseas, oversea, offshore |
| 6 | i am | I am, my name is, introduce myself, introducing |
| | | myself |
| 7 | funds | funds, money, fund, assets |
| 8 | contact | contact, contacting, contacted, reply, |
| | | response, respond, answer, get back, |
| 9 | assoonas | as soon as, immediately, prompt, promptly, |
| | | immediately, urgent, urgently, hurry, |
| | | fast, quickly, urgency |
| 10 | personal | personal, private |

Note that each symbol is mapped to one or more words or phrases.

The Storyline Filter approach looks for these scammy words in a scam message such as the one shown below. In the below example message, the scammy words are underlined and italicized, and followed by their corresponding symbol in parentheses.

BROWN WALTERS CHAMBER, SOLICITORS, ADVOCATES, ARBITRATORS & LEGAL CONSULTANTS
No: 22 JAMES TOWN, ACCRA GHANA ATTN
Dear Sir/Ma, Compliments of the day to you.? It is my humble wish to solicit and crave your indulgence to make
this project request for a joint business transaction which I hope will not come to you as a surprise, hence I plead for
your pardon. | I am (iam) | Barrister Brown Walters, the Legal Adviser and counsel to Mr Norman Mcgivern, a
deceased expatriate contractor who used to work with Mobil Oil and Gas Company here in Ghana
(Nigeria). Thereafter, shall be referred as my late client. On Dec. 26th, 2003, my client and his entire family
died (death) in a plane crash in a Beirut-bound charter jet, Boeing 727 that crashed in cotonou, Benin Republic.
You will get more details about the crash on visiting this
website:www.cnn.com/2003/WORLD/africa/12/26/benin.crash/. He was a well known philanthropist before he died
(death), he made a Will stating that $ (usd) 12.8m (Twelve Million (million) Eight Hundred thousand US
Dollars (usd) (Only) should be donated to any charity organization of our choice overseas (foreign). And due
to the economic and political instability of our country, that is why we have decided to search for a beneficiary to
come forward for the fund to be release. I am (iam) interested in securing this money (funds) from the Bank.
because they have issued my law firm a notice instructing us to produce the beneficiary of this Will within two
weeks or else the money (funds) will be Confiscated and credited to the Government treasury according to the law
here. It is my utmost desire to execute the Will of our late client in your favor and therefore, you are required to
contact (contact) me immediately (assoonas) to start the process of sending this money (funds) to any or
your designated bank account. I urge you to contact (contact) me immediately (assoonas) for further details
bearing in mind that the Bank has given us a date limit. Please contact me via my private (personal) email
address, (bwalterlegalaid4us@live.com). Regards, Brown Walters (ESQ).

For this text, using the reduced EQUIVs symbol table and the parser described next, a vector is generated from these symbols:

Nigeria.death.death.usd.million.usd.foreign.iam.iam.funds.funds.contact.assoonas.funds.contact.assoonas.personal

Storyline Parser

As a scam message is processed, a text parser, for example, an Aho Corasick (A-C) tree, is used to extract an ordered list of the scammy words. The parser can be configured to detect whole words, rather than partial ones; for example, “im” should not be recognized in “immediately”. Also, in some embodiments, all words are converted to lowercase, and matched against lowercase scam words in the message, as capitalization in media such as email can be highly variable.

In some embodiments, parsing of message headers is avoided, as these are often far more variable than message bodies.

The example message shown in Table 20 provides the following sequence of scam words and (short) phrases.

I am.Ghana.died.died.$.Million.Dollars.overseas.I am.money.money.contact.immediately.money.immediately.private

These words or phrases are substituted for the symbols
iam.Nigeria.death.death.usd.million.usd.foreign.iam.iam.funds.funds.contact.assoonas.funds.assoonas.personal

For convenience, these symbols are shown in a human readable format. In deployment, the symbols can be ordinal values for efficiency of search and storage. The generated vector is then a bit field.

In the example of table 19 shown above, the first column assigns each symbol an ordinal value. For example, to represent only the ten symbols shown above, 4 bits (23<10 decimal<24) is used. The vector would then appear as:
4.0.1.1.2.3.2.4.5.5.6.6.7.8.7.8.9 (period delimited), or
40112324556678789 decimal

Producing this final vector result from a message is referred to herein as “vectorization” of the message. In some embodiments, a message vector is the condensed representation of one whole message. Vectors can be terminated as some maximum length, or rejected if they fail to meet a minimum length.

The storyline does not need to attempt to match only whole vectors; instead it can match any sub-sequence of the vector of some minimum length. To do this, in one embodiment, it sequences the training messages to produce signatures. The possible signatures of minimum length M and maximum length N for the message vector are computed and stored in a data structure optimized for search, for example, an Aho-Corasick tree, or a deterministic-lookup array, or a bloom filter (used in conjunction with a secondary, deterministic lookup data structure, such as a B-Tree). In one embodiment, they are stored in a Java HashMap data structure. In some embodiments, M and N are chosen experimentally, searching for values that minimize both false positives and false negatives.

Note: the Java HashMap integrates one or more hash functions with a secondary data structure to store and resolve hash collisions. Its design gives the desirable combination of lookup speed, determinism (no wrong answers), and small memory footprint. Other storage structures can also be used.

In this example, M=8, and N=10. This will generate signatures for this message that look like:

4.0.1.1.2.3.2.4.5.5.6.6.7.8.9

4.0.1.1.2.3.2.4.5.5.6.6.7.8

4.0.1.1.2.3.2.4.5.5.6.6.7

4.0.1.1.2.3.2.4.5.5.6.6

4.0.1.1.2.3.2.4.5.5.6

4.0.1.1.2.3.2.4.5.5

4.0.1.1.2.3.2.4.5

4.0.1.1.2.3.2.4

0.1.1.2.3.2.4.5.5.6.6.7.8.7.8.9

0.1.1.2.3.2.4.5.5.6.6.7.8.7.8

0.1.1.2.3.2.4.5.5.6.6.7.8.7

0.1.1.2.3.2.4.5.5.6.6.7.8

0.1.1.2.3.2.4.5.5.6.6.7

0.1.1.2.3.2.4.5.5.6.6

0.1.1.2.3.2.4.5.5.6

0.1.1.2.3.2.4.5.5

0.1.1.2.3.2.4.5

<etc>

A short value for M—for example, 3—increases the success rate for the vectorization at the expense of generating a huge number of signatures. In various embodiments, both vectors and signatures are stored. Signatures participate in search, and corresponding vectors are looked up in order to associate the signatures with training messages.

If M=1, matching is performed with or without regard to ordering of the symbols. This is an example of a scenario in which the Storyline Filter and Vector Filter overlap in behavior.

In some embodiments, vectorization is said to fail for a message when the resulting vector has a length of <M. Such a vector is referred to herein as a short vector.

N, on the other hand, need only be as long as the longest signature that is desirable to match. With a symbol set such as the Equivs symbolset (part of which was shown above) and M=8, some datasets yield no false negatives.

As described above, a manually created list of terms can be used, which can be arranged into equivalence classes, where an identifier for such an equivalence class makes up a part of the storyline that is identified. The list of terms can also be automatically derived from a small set of seed terms. For example, if “dollar” is a seed term, then the equivalence class is derived, in one embodiment, as all words and word sequences with a matching usage as “dollar”. This can be done using standard linguistic methods. A third example derivation of the set of identifiers and their associated terms is to use machine learning methods that identify phrases that are common in scam but uncommon in ham. Example methods for generating such phrases are described herein. A fourth approach is a hybrid of the three above-described approaches.

Training the Storyline Filter

The design requirements for batch training and subsequently testing the storyline filter can differ from those of deploying it. For example, if the matching algorithm does not attempt to relate match scores to training messages, then the training vectors need not be stored. (however, in both cases, their corresponding set of signatures can be stored)

In training and testing, the automated, adaptive scam evaluation system described herein is asked to process and learn from pre-classified messages. Its performance can be evaluated through standard machine learning techniques. In some embodiments, the system can capture sufficient information for it to be able to describe how the message was processed (for example, what filters processed it, and what they decided), and ultimately, what processing decision was reached (if any).

In some embodiments, the production (scam evaluation) system reaches decisions (such as classifying messages rapidly as scam, or “not scam”, or indeterminate) using the smallest amount of system resources possible. To achieve greater performance, it may collect less data. For example, when a signature is matched in a test message, the system may not have collected or stored sufficient data to determine which training message(s) contributed the signature.

In one embodiment, the system is trained with one or more datasets containing scam messages, pruned with datasets containing one or more ham messages, and tested with datasets containing one or more scam messages. Here, training corresponds to adding signatures generated from vectors representing phrases that occur in scam messages. These signatures are added to a data structure in memory, or to a database, and pruning corresponds to removing signatures from this data structure or database if they occur in a ham message.

As described in more detail below, a dataset is a collection of messages.

In another embodiment, no ham messages are used for pruning, but instead a database representing ham messages is used. The COCA database, described in more detail below, is one such example. In that example, pruning includes removing signatures corresponding to phrases that are sufficiently likely in ham, according to estimates based on the product of the frequencies of substrings in these phrases. For example, the system may process a message containing the phrase “raid at this warehouse”. Suppose that the COCA 3-gram database contains 2 instances of the 3-gram phrase “raid at this”, and 2 instances of “raid at this warehouse”. Using a technique for estimating phrase probabilities using pairs of Ngram tables such as one described in further detail below, and another technique for calculating an acceptable probability value for retaining phrases, the system can remove (prune) the phrase from a memory-resident data structure, or a database, preventing the system from generating a rule for the phrase. Pruning reduces false positive rates (identifying ham as scam) for the system.

In one embodiment, the efficacy of the storyline vector filter is evaluated as follows. Messages are vectorized as described above, and then signatures for both training and test messages are mapped back to all the datasets (and optionally, vectors and messages) to which they correspond. These duly mapped vectors are loaded into a suitable data structure.

For example, assume the system contains a symbol set with the following symbols:

TABLE 21

| Symbol | Phrase |
|---|---|
| S1 | We are pleased |
| S2 | inform you |

And assume the system will be trained using message message1.txt containing the following text:

TABLE 21
We are pleased to inform you of the result of the just concluded annual final draws held on the 1ST OF
January,2011 by Toyota Motor Company in conjunction with the Japan International Email Lottery Worldwide
Promotion,your email address was among the 20 Lucky winners who won US$1,000,000.00 each on the Toyota
Motors Company Email Promotion programme dated as stated above.

The vectorization for this training message includes the signature S1.S2.

The system records an association between signature S1.S2 and message1 (e.g., through the corresponding vector):

TABLE 22

| Signature | Filename |
|---|---|
| S1.S2 | message1.txt |

Subsequently, message2.txt is introduced to the system and contains:

We are pleased to write to you to inform you of the release of the long awaited results of the 2011 BMW CAR PROMOTION PROGRAM.

Now there is one signature associated with the messages.

TABLE 23

| Signature | Filename |
|---|---|
| S1.S2 | message1.txt |
| S1.S2 | message2.txt |

If the system is instructed to train with message1 and test with message2, the result will be the signature S1.S2.

In some embodiments, the system accepts “batches” (subsets of datasets). An example dataset comprises input files listed in a file, for example, one file system path per line; or the data set can be identified by a file system directory, or a file containing a list of directories. In some embodiments, a batch is a dataset coupled with a desired maximum number of messages to be processed.

Batches can be used for training and testing. For example, when a batch is identified, 90% of the messages are reserved for training, and 10% for testing in one embodiment. Other breakdowns, such as 50/50 or 95/5, can also be configured.

Batches can be designated as scam or ham.

In one embodiment, a training operation using a training dataset adds the messages' signatures to a working set. An indicator, such as a Boolean flag, is set to indicate that the signature is “in” the working set.

In a pruning operation, the system visits the pruning data set of ham message signatures. If there is a corresponding signature in the “in” set, it is removed (so marked). For efficiency, the set operations (the Boolean AND of the pruning set and the “in” set) are batch operations performed in parallel rather than serially.

In a test operation, signatures associated with a scam dataset are tested to see if they are present in the working set. Those that are not present are returned as false negatives (scam messages identified as “not scam”). In some embodiments, the result returned is subjected to matching criteria, which are described in further detail below. Signatures associated with a ham dataset are tested to see if they are present in the working set. Those that are present in the working set are returned as false negatives (ham identified as scam). Here also, the results can be subject to matching criteria (discussed below).

In addition to tuning the system by altering parameters that impact vectorization, a system user may tune the system (to minimize both false positives and false negatives) through matching criteria. This can be accomplished, for example, by calculating a score for a training message based on the number and length of the returned matching signatures. This will be described in the example below.

As an example of how the system is trained and tested, assume that three datasets are introduced to the system. In this example, each data set contains a single message.

Note: Previously the vectors were represented as period-delimited lists of terms (e.g, “I am.Ghana.died.died.$.Million.Dollars.overseas.I”), and then decimal numbers (e.g, 40112324556678789). The discussion below uses letters to represent symbols in the vectors below. This provides a compact representation.

The three datasets, each containing a single message, have been processed by the system resulting in the following message vectors (where each letter represents a symbol):

(1) ABCCFGA is a (vectorization for a) scam message to be used to train the system (a training message)

(2) ABFGAQN is a (vectorization for a) ham message to be used to prune insufficiently scammy signatures from the system (a ham training/pruning message)

(3) ABCCNLP is a (vectorization for a) test scam message to be used in evaluating system performance

Note that in this example, N is 7 (the maximum length of the message vectorizations); and M is 2. This is another way of indicating that signatures of length greater than or equal to 2, but less than or equal to 7 are generated and tested.

When the training scam message (1) is input to the system, the system generates and catalogs these signatures:

ABCCFGA, ABCCFG, ABCCF, ABCC, ABC, AB

BCCFGA, BCCFG, BCCF, BCC, BC

CCFGA, CCFG, CCF, CC

CFGA, CFG, CF

FGA, FG

During the pruning phrase, ham vectors are identified by the system, generating the following vectors in the example:

ABFGAQN, ABFGAQ, ABFGA, ABFG, ABF, AB*

BFGAQN, BFGAQ, BFGA, BFG, BF

FGAQN, FGAQ, FGA, FG

GAQN, GAQ, GA

AQN, AQ

When a scam test message vector (3) is introduced to the system, these new signatures are cataloged:

ABCCNLP, ABCCNL, ABCCN, ABCC, ABC*, AB*

BCCNLP, BCCNL, BCCN, BCC, BC

CCNLP, CCNL, CCN, CC*

CNLP, CNL, CN

Items marked with (*) already exist in the tree, so only their new context (association with the newest data set) needs to be recorded. For example, AB is present in datasets (1), (2), and (3).

In this embodiment of a training and analysis system for the storyline vector, in the training step, the signatures identified for message vector (1) are marked “in” the working set by means of a Boolean flag. These are (shown here in underline):

ABCCFGA, ABCCFG, ABCCF, ABCC, ABC, AB

BCCFGA, BCCFG, BCCF, BCC, BC

CCFGA, CCFG, CCF, CC

CFGA, CFG, CF

FGA FG

In a pruning stage, the signatures generated by (2) are marked “out” of the working set (indicated here with strikethrough). Thus, AB is removed from the working set, as indicated in the example below by this having a strike-through:

ABCCFGA, ABCCFG, ABCCF, ABCC, ABC,

BCCFGA, BCCFG, BCCF, BCC, BC

CCFGA, CCFG, CCF, CC

CFGA, CFG, CF

FGA, FG

Finally, test with the signatures from (3). CC matches (indicated with asterisks and underline).

ABCCFGA, ABCCFG, ABCCF, ABCC, ABC,

BCCFGA, BCCFG, BCCF, BCC, BC,

CCFGA, CCFG, CCF, ***CC***

CFGA, CFG, CF

FGA, FG

To summarize: testing of message (3) searched the signature space for the signatures associated with message (3). One was found (CC). Subsequent matching criteria (described in further detail below) will determine the classification of message (3) (scam or “not scam”). For example, if the match criterion is “one signature of length>=M”, then the system will classify message (3) (correctly) as scam. On the other hand, if the criterion is “at least three signatures of length>=M”, then message (3) will be (erroneously) classified as “not scam”.

When evaluating the tuning of the matching algorithm, false positive rates and false negative rates are assessed. The false positive rate corresponds to how commonly ham messages would be identified by one or more of the scam detection rules, thereby being classified as scam by mistake. The false negative rate corresponds to how commonly scam messages would not be identified by the scam detection rules, and therefore not be classified scam.

For example, if the matching criterion is “one or more signatures of >=M”, then any matched signature will become a false positive (if the message is ham), or a correct classification (if the message is scam). So in this example, with the match criterion of “one or more signatures>=M”, the system would correctly classify the test message as scam, since the length of the returned signature CC (2) is >=M (2). If, however, the matching criterion was “one or more signatures of length 3 or greater”, this check would return a false negative for this message: the test scam message would be incorrectly classified as “not scam” (since, as this is an example, it is known to be scam).

In another embodiment, the system is trained to recognize “not scam” messages. The symbol set is chosen for prevalence in ham and infrequency in scam. In this scenario, a test ham message that doesn't match (or matches too few signatures, or signatures that are too short) is a false negative. A scam message that matches (again, subject to matching criteria) is a false positive. The ability to detect and classify “not scam” messages can be useful for identifying threats to loved ones. For example, the message may be a call for help issued by a loved one.

Most system tuning parameters influence the rate of both false positives and false negatives. However, sometimes it is desirable to optimize one at the expense of the other. For example, another filter, such as the vector filter, may have an acceptable false positive rate. By ignoring false positives (ham identified as scam) and focusing on reducing the false negative rate (messages that are scam, but were not detected) with the storyline filter, the system can be made to catch additional scams when the two filters are used together (serially).

As will be shown further below, optimizing for specific classification objectives can be accomplished by tuning the vectorization process and/or the matching criteria. This can be done manually or automatically. In the automated version, the tuning of the match criteria is done by, for example, using a symbol set to categorize a message as being of a particular type, for example, “advanced fee fraud”. The symbol table(s) appropriate to advanced fee fraud can then be:
used to vectorize the message (vectorization tuning through symbol table selection)
used to weigh signature matches: matches associated with messages with additional classifications (such as “romance”) can then be used to multiply or discount the weight of such signature matches (match tuning)
used to provide appropriate matching thresholds (match tuning)

This is explained in greater detail in the below section on “Tuning”.

In the diagrams described below, the term “word” refers to what has been previously described as a symbol set.

FIG. 7 illustrates an embodiment of a system for training a storyline filter. In some embodiments, the system of FIG. 7 is an alternate view of system 160 of FIG. 1A. In the example of FIG. 7, the Storyline Filter is trained by reading (701) the Scam message training set (706). The process of reading corresponds to the automated processing of input datasets, which can be stored on a disc, using RAM, or other common storage media. In some embodiments, equivalent phrases (707) are then replaced (702). They can either be replaced by a unique identifier representing the equivalence class, or by one member of the class that comes to represent all other members. Storyline Vectors are created (703) based on the Word Set (708). The storyline vector is sequenced (704) to create shorter vector signatures which are retained (705) in the signature repository (709).

FIG. 8 illustrates an embodiment of a system for pruning or removing signature matches. In some embodiments, the system of FIG. 8 is an alternate view of the system of FIG. 7. In the example of FIG. 8, ham messages (806) are read (801) and equivalent (807) phrases are replaced (802). Then test Storyline Vectors are created (803) using the selected word set (808). The vectors are sequenced (804) and used to prune (805), or remove signature matches from, the storyline signature repository (809) that was created during the scam signature generation phase shown in FIG. 7. In an alternate embodiment, the equivalent (807) replacement (802) is omitted.

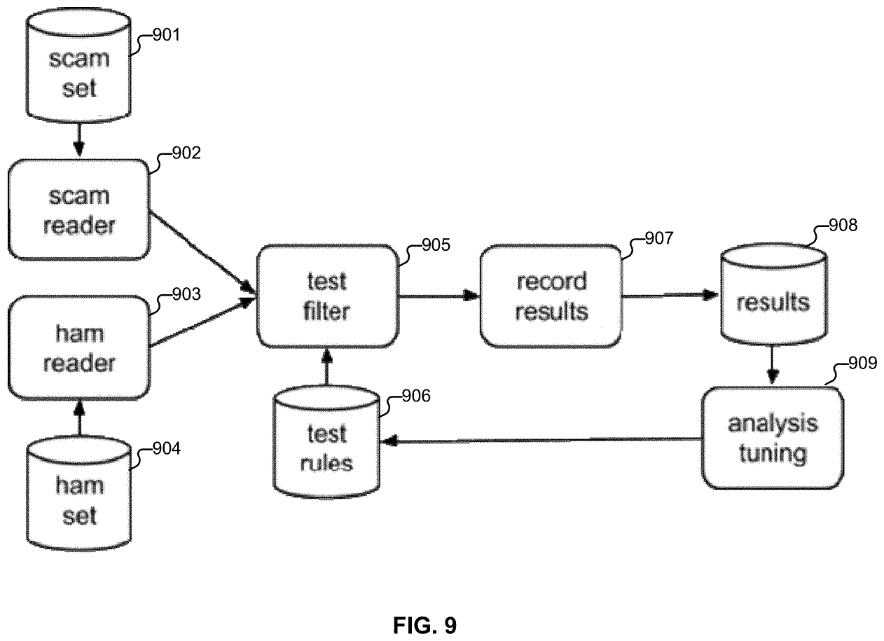

FIG. 9 illustrates an embodiment of a system for testing vectors. In some embodiments, the system of FIG. 9 is an alternate view of the system of FIGS. 7 and 8. In the example of FIG. 9, messages to be classified (901) are read (902), and, in some embodiments, their equivalents (907) replaced (903). Next, the word set (908) is used to replace words or phrases with corresponding symbols to create test vectors (904). The vectors are sequenced (905) to generate signatures which are then matched (906) against the signature repository (909), and results (910) are recorded.

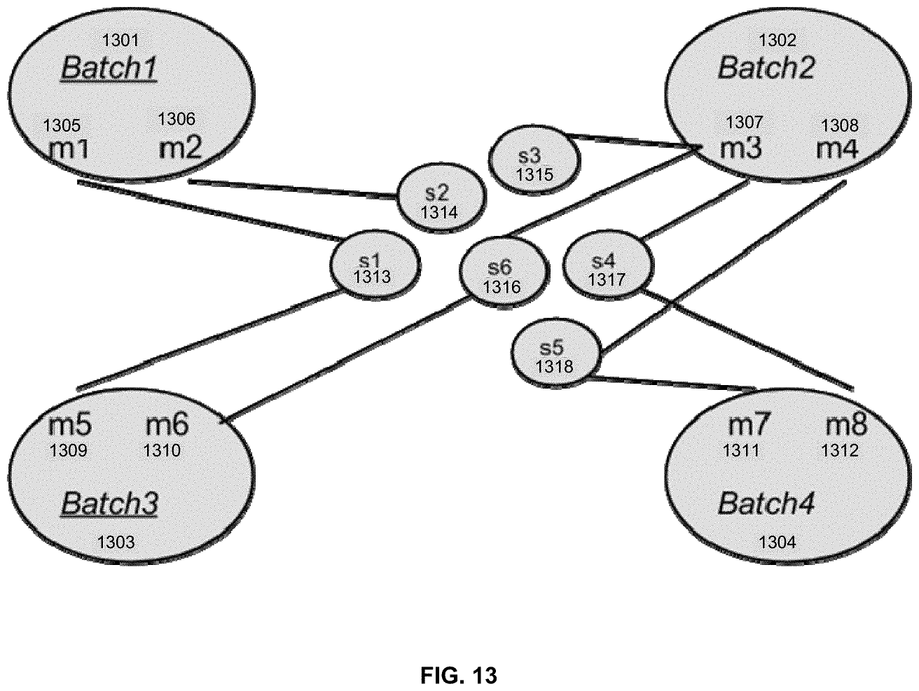

FIG. 13 illustrates an example of a walk-through demonstrating how test messages are matched in a training environment. Subsequently, differences are noted for a production environment (e.g., where incoming messages are processed to determine whether they are spam or scam, or neither). In this example, messages are introduced to a training and analysis system in 4 batches. Scam batches (1301, 1303) are denoted with underline.

Assume that each message has a corresponding vector (not shown) that produces the indicated signatures. Initially, the working set is empty.

Scam Batch1 (1301) is used to train the system. The vectorization and subsequent sequencing of messages m1 (1305) and m2 (1306) create signatures s1 (1313) and s2 (1314). As a result of training, signatures s1 (1313) and s2 (1314) are marked, representing that they belong to the working set. Thus, after training with Batch1 (1301), the working set contains signatures s1 (1313) and s2 (1314).

Next, ham Batch2 (1302) is used to prune the system. The vectorization and sequencing of messages m3 (1307) and m4 (1308) produce signatures s3 (1315), s4 (1317), and s5 (1318). As these signatures are not present in the working set, no signatures are removed (pruned) from the working set.

Next, scam Batch3 (1303) is tested. Signature s1 (1313) has already been added by the introduction of message m1 (1305) through Batch1 (1301), so it is matched, and therefore correctly identified (as scam). However, symbol s6 (1316) is not present in the working set, and is therefore returned as a false negative (it is classified as a “not scam” message).

Finally, ham Batch4 (1304) is tested. Messages m7 (1311) and m8 (1312) produce signatures s4 (1317) and s5 (1318). These are not found in the working set. Recall that the working set contains signatures s1 (1313) and s2 (1314). Because signatures s4 (1317) and s5 (1318) are not found in the working set, the system correctly classifies messages m7 (1311) and m8 (1312) as “not scam”.

In a production environment, messages such as message m1 (1305) are not pre-classified and enter the system as part of a live message stream.

Tuning

In some embodiments, system tuning can be performed in the vectorization phase, or later in the matching phase. As an example of vectorization tuning, choosing too large a value for M (the minimum signature length)—for example, if M=N=20—will produce many short vectors. On the other hand, a matching criterion that prescribes “at least 10 signatures of length 3” to achieve a match can have a dramatically low false positive rate (i.e, “not scam” is classified as scam), but an unacceptably high false negative rate (i.e, scam is not classified as scam). Tuning at the vectorization phase and matching phase offers various choices and tradeoffs.

Vectorization Tuning

Symbol set selection is one example technique for tuning vectorization. How the symbol set is created or chosen is used to determine vector length as well as vectorization rate. Depending on the symbol set, some messages produce vectors shorter than M, or no vector at all. Undersized or nil vectors are referred to herein as short vectors. In production, short vectors can be considered non-matches, but in testing and tuning, they can be recorded to provide further feedback to the tuning process. For example, if it is determined during training that 30% of messages become short vectors, the symbol set can be modified by adding or reducing symbols, more aggressive equivalents substitution, or using other means to multiplex many different words or phrases to a single symbol. This can be automated so that if a portion of the messages become short vectors, and this portion exceeds a threshold, such as 22%, then an action is automatically taken, such as modifying the symbol set to an optional setting and determining whether this improves the situation by reducing the ratio.

Symbols used to represent words or phrases can be selected manually, or in some embodiments, by using automated string, phrase, or word selection technique such as one described in further detail below.

For example, candidate phrases can be identified from a scam message body such as this one:

You are advised to immediately contact the BMW company online accredited agent (Rev Eric Ludd) with bmwoffice@consultant.com for the quick receipt of your awarded prize (1,000 000.00).

Here, “quick receipt” and “your awarded prize” sound unusual and potentially unique to scam. The process of pruning with ham, or testing for frequency in Ngrams (discussed in more detail below), if applied, will remove these phrases should the assumptions prove incorrect.

In one embodiment, many symbol sets exist, and one or more are chosen and used for message vectorization and signature generation (sequencing) based on frequencies of words or phrases found in one or more symbol sets. Vectorization of training messages can be performed using a larger or smaller set of symbol tables than that used by vectorization of test messages. In some embodiments, training signatures should be vectorized using a superset of symbols used to vectorize test messages, or there will be fewer matches.

Regardless of the selection technique, words or phrases should be common in scam and rare in ham. Pruning is one way of eliminating signatures that are common in ham. A technique for calculating an estimated probability of finding an arbitrary string in ham will be presented in more detail below.

Prior to identifying words or phrases to be reduced to symbols, in some embodiments, words or phrases are substituted with similar meaning with a single representative word. For example, any of the phrases “I am, my name is, introduce myself” are replaced by the term “introduce” in the message. This simplifies the definition of signature because the single term can be used to match multiple expressions.

For example, if a scammer introduces himself in one message as:
Allow me to introduce myself. I am Ishmael.

and in another message with
Allow me to introduce myself: My name is Ishmael.

(where underlined phrases either are represented by symbols in the symbol table, or as equivalents mapping to symbols in the symbol table). Thus without equivalent substitution, the first message would be seen as
introduce myself.i am

and the second as
introduce myself.my name is

Through equivalent substitution, the system will see both messages as
introduce myself.introduce myself

This has the effect of increasing vector lengths for messages and further increasing the likelihood of detecting commonality in the same storyline when it uses different language (words). Longer vectors create more opportunity for matching.

In addition to performing equivalent substitution, the length of the phrases in the symbol set can be chosen. Phrases can be single words, or arbitrary length Ngrams. In some embodiments, shorter phrases produce longer vectors.

The number of phrases/symbols can be chosen. As the symbols become more numerous, the amount of whitespace between symbols diminishes. With the loss of white space, the system may be less able to detect cut and paste and other forms of text re-arrangement. This is demonstrated in the following example.

Suppose, in this example, that a message contains three phrases aaa, bb, and c, where aaa is 3 words long, bb is two words long, and c is one word long. The ‘+’ indicates “whitespace” (non-symbols). Assume that the symbol for aaa is A, for bb, B, and for cc, C.

++++++++++aaa+++++++bb++++++++

+++c++++++++++aaa+++++++++++++

++++++++++++++++++++++++++++++

++++++++++++++++++++++++++c+++

++++++++++++++++++++++++++++++

This message is vectorized as ABCAC.

Further assume the scammer rearranges the text and sends it to a second recipient. He swaps the first and last 22 words, resulting in

++++++++++++++++++++bb++++++++

+++c++++++++++aaa+++++++++++++

++++++++++++++++++++++++++++++

++++++++++++++++++++++++++c+++

+++++++++++++++++++++++++aaa++

(BCACA)

A grid can be used to measure whitespace and track the magnitude of change when a message is rearranged, and also when the symbol set is changed. In this example, a grid representing the example messages contains 150 cells, of which 140 are empty, and 10 occupied.

If the first version of the message is a training message, and the second version is a test message, the longest common signature is BCA (bold in both diagrams). Depending on matching criteria (described later), the signature BCA might be sufficient to classify the message as scam.

Now assume the symbol set contained the phrases dd and e, with corresponding symbols D and E. Now only 135 grid cells remain empty, and the vector length has grown to 8:

e++dd++++aaa+++++++bb+++++++++

+++c++++dd++aaa+++++++++++++++

++++++++++++++++++++++++++++++

++++++++++++++++++++++++++c+++

++++++++++++++++++++++++++++++

(EDABCDAC)

With the same swap of the first fifteen words again, the result is:

++++bb++++++++++++++++++++++++

+++c++++dd++aaa+++++++++++++++

++++++++++++++++++++++++++++++

++++++++++++++++++++++++++c+++

+++++++++++++++e++dd++++aaa+++

(BCDACDEA)

Following the swap of portions of the message, BCA is lost, and only BC from the original BCA are matched. (Coincidentally, a vector of length 3, DAC, appears in the new message.) In some embodiments, as symbol set size increases, the amount of whitespace decreases, and the probability of matching signatures of a fixed length decreases.

To counteract the sensitivity to sequencing changes when there are many symbols, M can be reduced. Note that if M=2,

BC, DA, and AC match in the swapped message using the larger symbol set.

Increasing M decreases the number of matches, which may decrease (improve) the false positive rate, or rate at which ham is misclassified as scam (fewer messages of any type match). But it also increases the false negative rate, or rate at which scam is misclassified as not scam (again, because fewer things match).

Increasing N, the maximum vector length retained, can increase the storage needs in a training and test environment, assuming that other vectorization parameters are such that sufficiently long vectors are produced. (In some embodiments, in a training and test environment the entire vector is stored.) Regardless, very long messages can produce very long vectors. In some embodiments, long vectors are truncated, potentially reducing the voluminous number of signatures they produce.

In an example production environment, both the vectors and their signatures are stored. In other words, if the message vector is ABCCFGA, and if M=2, N=6, the system will associate all of the signatures below with vector ABCCFGA and store them:

ABCCFG, ABCCF, ABCC, ABC, AB

BCCFGA, BCCFG, BCCF, BCC, BC

CCFGA, CCFG, CCF, CC

CFGA, CFG, CF

FGA, FG

Match Tuning

If the production system stores sufficient information to map signatures back to the vectors that reference them, a score can be calculated for each corresponding vector. Here, “reference” indicates that sequencing the vector for a message generates the signature in question. For example, suppose the system has been trained with the following two example vectors:

ABCCFGA

ABCCFHH

After training (M=2, N=6), the signature repository would contain:

ABCCFG, ABCCF, ABCC, ABC, AB

BCCFGA, BCCFG, BCCF, BCC, BC

CCFGA, CCFG, CCF, CC

CFGA, CFG, CF

FGA, FG

ABCCFH

BCCFHH, BCCFH

CCFHH, CCFH

CFHH, CFH

FHH, FH

HH

Now suppose a scam message is tested with vector:

ABCCFAA

The following signatures from the first message match:

ABCC, ABC, AB

BCCF, BCC, BC

CCF,CC

And the following (same) signatures from the second message match:

ABCC,ABC,AB

BCCF,BCC,BC

CCF,CC

To determine whether the test message is scam or not scam, the message is scored.

Scalar Scoring

The system can generate a scalar score for the match of the first message by summing the lengths of the matching signatures: 4+3+2+4+3+2+3+2=23. If this is greater than a pre-determined threshold (e.g., 20) then the test message is classified as scam.

Alternatively, matching signatures can be weighted with weighting factors according to their length, such as:

TABLE 24

| Signature Length | Weighting Factor |
|---|---|
| 4 | 4 |
| 3 | 3 |
| 2 | 1 |

Using these new weighting factors, the score is 16+9+2+16+9+2+9+2=65.

In one embodiment, the matching algorithm uses the largest score corresponding to any message and compares it to a pre-determined threshold. Here, for example, suppose that the threshold is 25. In this example, as both messages score 65, and 65>25, the message is classified as scam.

In another embodiment, if the scam training messages have a confidence factor associated with them (e.g, if the first message is classified scam with 90% probability, and the second with 50% probability), then this score can be considered when determining the outcome; for example, the system can return 0.90*55+0.50*55=522.5 as the score.

In one embodiment, messages are assigned categories based on the words and phrases they contain, and the prevalence of those words or phrases in one or more symbol tables.

In one embodiment, the threshold can be looked up and/or calculated from values associated with the category(ies) assigned to the message.

Signatures associated with messages of a category different from the category(ies) assigned to the test message can be punished (for example, with a weighting factor of less than 1), or disregarded entirely.

Single Largest Signature

In one embodiment, if the system does not record enough information to map signatures back to message vectors, the length of the single longest signature is considered. In this example, this length is 4. The value 4 can be compared to a threshold, for example, 3. Since 3<4, the test message is classified as scam.

Fitting a Predicted Distribution

In another embodiment, the distribution of signatures can be compared to a predicted distribution. For example, the system may predict the following distribution:

TABLE 25

| Signature Length | Predicted Frequency | Actual Frequency | Deltas |
|---|---|---|---|
| 4 | 2 | 2 | 0 |
| 3 | 3 | 3 | 0 |
| 2 | 4 | 3 | −1 |

The score can be calculated by a formula, for example COUNT( )−RMS([deltas])=9−SQRT(1)=8 (where RMS is root-mean-square, and COUNT is a count of the total signatures matched). The score is then compared to a threshold to classify it as scam. For example, the threshold may be 5, classifying the test message as scam.

In a further embodiment, the curve can be scaled by the length of a message's vector, or by a value associated with the symbol table applied to create the message vector.

Matching Scam or Ham

If the system signature repository contains both designated scam and ham signatures, then the classification returned would reflect this; for example, if our three messages above were all ham messages instead of scam, the classification returned for the third message would be “not scam” rather than scam.

Testing Storyline Vectors

In one embodiment, only signatures of length between M and N are stored. In another embodiment, the system maps the signatures back to the messages (both scam and ham, training and test) that contain them. This can be useful for debugging, testing, and tuning the system.

Batches

In one embodiment, messages are introduced to the system as datasets (batches). Each batch record is assigned a unique ID and designated either scam or ham. As an optimization, a Boolean value associated with the batch can be used to indicate whether or not the batch has been used to train (scam) or prune (ham) the tree.

Message Assimilation

In a research and training environment, in some embodiments, batches of messages are assimilated before performing training or pruning operations. Assimilation reads each message, vectorizes it, sequences it to produce signatures, and adds the signatures to a database, preserving their association with the original vector and message body.

Before actually reading the messages, in some embodiments, all the file paths are read and shuffled. (Most programming languages implement a “shuffle” function that randomizes the elements of an array.) This ensures that a batch selected from a dataset shows no bias towards the original ordering of the list. For example, if the files in a directory are read by order of creation, then small batches drawn from this dataset would otherwise only select the earliest messages.

Once shuffled, some or all messages are read. Further, at this stage, a percentage can be allocated for training, and the remainder for testing; as one example, this ratio is 90% and 10%.

Messages

The allocation between training and testing can be accomplished, for example, by loading each file path into a data record that contains a path sufficient to find it in the file system, a field indicating whether it is to be used for training or testing, the batch that created it (and therefore whether it is scam or ham), and the vector representation for the message.

Signatures

In some embodiments, when the message is processed, for each signature:

1. either a new signature record is created—if no such signature exists

2. or a reference counter is incremented in the signature record

The reference counters can be used to remove batches from the tree (for example, if a ham batch is mis-introduced as scam, or vice versa.) If a message belonging to a bad batch is removed from the system, any signatures it touches will have their reference counter reduced by 1. If the reference counter goes to zero, the signature is removed or in some way marked so that it is no longer used by matching operations.

Signature Hits

A signature association (hit) record is created for each signature sequenced from the message vector. The hit record records an association between the email message record and the signature record to capture a many-to-many association. The signature hit record is a traversal aid, allowing the linking of signatures to email messages and batches.

In one embodiment, information sufficient to link signatures back to messages is recorded and used by matching algorithms in the production system.

Training/Untraining

In one example, to train with a batch of ham messages, all the signatures associated with the batch are selected and marked as “in” the virtualized tree. In one embodiment, the signatures are stored in an SQL database. An example SQL query to fetch the required signatures is as follows:

```
  SELECT * FROM signatures
  INNER JOIN(
    SELECT DISTINCT signatures.uuid FROM signatures
    INNER JOIN signature_hits ON signatures.uuid =
      signature_hits.signature_uuid ″
    INNER JOIN emailmsg2 ON signature_hits.msg_uuid =
      emailmsg2.uuid
    WHERE signature_hits.batch_id = <batch ID>
      AND emailmsg2.test = true
  ) thru_hits ON thru_hits.uuid = signatures.uuid
)
```

where <batch ID> is an identifier for a data set. When training with a scam batch, corresponding signatures are marked as IN (if it is not already). If this is a ham batch being pruned; the signatures are marked as OUT (if they are not already).

If more scam messages are added to the tree after pruning, the pruning steps must be run again using all ham pruning messages.

Test Results

Scam messages can be tested for false negatives (scams not detected) and ham messages for false positives (“not scam” misclassified as scam). To diagnose false positives and false negatives, the tree is traversed by iterating through the signatures for each email message, looking to see whether it is IN the tree (for a ham message, a false positive) or out of the tree (for a scam message, a false negative). For aggregate results, the signatures are counted for the batch that are IN or OUT directly by modifying the WHERE clause of the test signatures query shown above to add:
AND signatures.in_tree=true
Deploying the Storyline Filter

A training system such as embodiments of the one described herein may not, due to storage limitations, be practical for use in a production system: incoming messages to be classified can be tested against hundreds of thousands, or even millions, of signatures. A system designed to answer questions about false positive and false negative rates may not be sufficiently optimized for search.

For deployment, the signatures can be loaded into data structures that are optimized for search, such as bloom filters and deterministic bit arrays. Collisions can then be handled by secondary data structures, such as B-trees. In one embodiment, a composite data structure with fast and reliable search characteristics is used; one example of such a tool is the Java HashMap.

In one embodiment, the increased need for memory and search speed on large datasets is addressed by using a deterministic bit array (in conjunction with a secondary data structure to resolve a probable hit, or true positive) to contain and facilitate search of the signature space with a less severe memory consumption penalty.

For a bloom filter or deterministic array implementation, the contents of the array cell (memory address) can be as small as a single bit. The single bit indicates whether the signature is present in the tree (when not choosing to capture and search ham signatures). Or, in another embodiment, two bits are used to tell whether the signature has never been seen (0), is ham (1), or scam (2). The array may be very, very sparse, but the worst case speed of a lookup is one disk hit (virtual memory block fetch) for every signature to check. In one embodiment, this virtual memory is backed by solid state storage. In another embodiment, M=1 is set, facilitating the scoring of messages both by frequency of symbol appearance, and their ordering. This is a hybridization of the Storyline filter and the vector filter described below.

Vector Filter

In some embodiments, the Vector Filter matches previously identified scam messages or close copies of those messages by identifying the scammiest phrases in a test message and comparing them with the known scam set.

The scammiest phrases, which are those that are most indicative of scam, are determined by analyzing the frequency of all phrases found in a large known scam set by comparing them with frequency of the same phrases found in known good messages (Term Frequency—Inverse Document Frequency). These phrases are ordered by their relative scaminess (e.g., high to low) and each is given a numeric scam rank (1=most scammy to N=least scammy). Some of the phrases may not be inherently scammy at all but they are useful in identifying messages in combination with the phrases that are scammy.

In some embodiments, the set of phrases is processed to remove anything relating to headers, as the scamminess in the headers may be more transient.

To train the system, in one embodiment, all scam messages are processed using an algorithm, such as Aho-Corasick (A-C), or similar dictionary-matching algorithm that locates elements of a finite set of strings (the “dictionary”) within an input text, or other suitable data structures to store, process and detect the matching scam phrases. A numeric vector is created for each using the numeric scam rank assigned above for all matching scam phrases. In one embodiment, the vector is ordered low to high. This indicates that the scammiest phrase identifiers are at the start of the vector and the phrases are less scammy at the end.

For example, the scam phrases in the following example message are wrapped with # and their numeric scam rank value is shown:

I am the # widow #⁹³ of the # Nigerian Minister #²⁷ of roads and i am # seeking your assistance #⁵⁴ in # an important matter¹⁰³. Please # see the attached #⁴⁷³ document # describing the incident #²⁹³.

contains the following phrases that each have a numeric scam rank

| | |
|---|---|
| widow | 93 |
| Nigerian Minister | 27 |
| seeking your assistance | 54 |
| an important matter | 103 |
| see the attached | 473 |
| describing the incident | 293 |

The numeric scam rank was previously computed as described above. The numeric scam rank indicates the relative scamminess of each phrase that is identified where a lower number indicates higher likelihood of scam.

The numeric scam rank values are then ordered to create the vector [27,54,93,103,293,473] which is used to identify the message or messages that are sufficiently similar to it.

The set of Scam Vectors is trained with a set of scam messages, and then pruned with a set of known good ‘Ham’ messages. Each Ham message is processed using a trained Aho-Corasick(A-C) graph, or a similar data structure used to identify phrases in a body of text. An ordered numeric vector, comprised of numeric scam rank values, is created for this Ham message, similar as to the training messages. This ordered numeric vector is then checked against the known Scam vectors for matching vector entries. If a good message matches a Scam vector, then the Scam vector is eliminated from the set of Scam Vectors. The accuracy of the system should improve as more scam messages are used to train the system and more Ham message are used to prune it.

The approach is tuned by selecting the required minimum number of matches per vector. For example, if there are 8 entries in a vector then a match of any 7 (or 6 or 5) of the entries could be sufficient to declare that two messages are sufficiently similar. The selection of “N choose K” is tuned through testing to determine the correct threshold to get satisfactory False Positive and False Negative rates.

One example process to achieve this is:

1. Automatically identify the most salient scam Ngrams from a scam repository containing millions of messages using processing technology to:
identify all phrases from all messages using automated parsing
count the most frequent phrases in the scam messages using processing technology
compare with the relative frequency of the phrases with non-scam English text corpora using, for example, a Term Frequency-Inverse Document Frequency(TD-IDF) approach with processing technology. For example, the relative frequency of the terms in the scam set is divided by the relative frequency of the same phrases in a “good” corpus to create a relative scamminess value.

These corpora of normal English phrases include but are not limited to one or more of these sources:
Google Ngram datasets
Corpus of Contemporary American English
Ham messages
Gutenburg project
Amazon reviews
etc

For example, the phrase “how are you” is found frequently in scam messages, but is also very common in non-scam messages so it is unsuitable as a scam phrase, but “decent and cheerful girl” is a common scam phrase that is not common in non-scam message sets so it is a good scam phrase.

In some embodiments, each language such as English, Spanish, etc. is trained separately for better accuracy within a language, but if it is likely scams will contain multiple languages then the languages can be trained in selected combinations. The training of each language can be automated using processing technology.

2. The common ham phrases are removed to obtain only the most salient phrases. This can be done by checking the frequency of each Ngram in a data set like the Corpus of Common American English(COCA) and/or from the Ngram frequency in a large set of known good “ham” messages. The top remaining phrases are then picked based on the frequency in the scam set. The number of scam phrases depends on the number of scam messages in the training set and the variation in the scams within the set.

3. Order the phrases by scaminess and assign a value 1=high scam to N=low scam to each phrase

4. Reprocess each scam message again and obtain the matching phrases for each and convert to the matching numeric rank value. Put each value into a vector for the message and order the vector (low number to high), such as [2,7,19,23,29,33,42,54,67,89] where 2 is the most scammy. The number of matches are can be limited to a number such as 10 for simplicity if needed.

5. Select a minimum match rate required. For example, if each message has a vector with 10 entries, then a minimum of 7 matching entries could be required to declare a message match.

6. Since there are many possible combinations of Scam Vector values when matching only K of N, a hash table is used for efficient look up. The Scam Vector hash table contains an entry for each scam message that resulted from the training and pruning.

As one example, this table includes N!/K!(N−K)! entries where:
N is the total number of values in each message vector
K is the number of values that are required to be matched.

The table below shows the number of checks (e.g., Hash entries/vector) required to look up a message match. One example sensitivity is in allowing less precise matches against Scam messages. This approach can potentially be more efficient as the size of the scam repository increases because the gap is closed by requiring tighter matching on “N of K” since many scam examples have potentially already been used for training. Looking for more exact matches of many scam messages in a large set works can be more effective than looking for weaker matches against a smaller representative subset.

TABLE 26

| # scam vector | 20,000 | 100,000 | 1,000,000 |
|---|---|---|---|
| #phrases/vector | 12 | 12 | 10 |
| #matches required | 10 | 8 | 8 |
| Hash entries/vector | 66 | 495 | 45 |
| Bytes/Hash entry | 2 | 4 | 4 |
| Memory Required(MB) | 3 | 189 | 172 |

For example, this indicates that 1 million scam vectors, which match 1 million previously seen scam, can be stored in ˜172 Mbytes of memory if the requirement that 8 of 10 vector entries must match. This small memory footprint means that the entire hash table can remain in RAM memory, rather than requiring look up on much slower disk storage. This illustrates that the system is both fast and scalable. For example, using 8 of 10 matches with 32 Gigabytes of RAM available, it is possible to match more than 180 million previously seen scam messages and close copies with a small number of hash table lookups, where the hash table remains in memory.

A second example, where only 8 of 12 vector entries are needed to match a previous scam message, illustrates that the matching criteria can be relaxed but potentially much more memory is required, and the system may not scale up as well. This illustrates that it may be more scalable to more closely match a large number of scam messages more precisely, than to weakly match a smaller number of message. This illustrates that the system becomes more memory and processing efficient as the system is trained with more scam examples. The Vector Filter not only scales up efficiently in memory and CPU resources, but it also becomes more accurate as more scams are added.

Note that in the preceding table the bytes/hash entries jump to 4 bytes once past 64K since more than 16 bits/entry is needed.

Note that the memory required ignores the hash table overhead, but even if these numbers are doubled, it all would still fit in memory.

The table above illustrates that the approaches scales easily to more scam messages by adding memory to the system and keeping the # matches required value close to the # phrases/vectors.

7. Process a test message using the same set of scam phrases, grab the matching phrases and convert them to their numeric values. Sort the numeric values low to high and truncate the vector if needed for space considerations at the maximum length (like 10).

8. Test the possible K of N permutations of the vector against the hash table until a match is found or the possibilities are exhausted. The table above illustrates how many cache checks are required and summarizes some possible memory sizes for different numbers of scam vectors.

9. The Ham message set is used to test for false positives. If a Vector Rule matches a Ham message, the vector rule should be (and is) disabled. Iterative passes against the Ham messages can be performed to remove all false positives in tuning the system.

10. Regularly or incrementally(as described below under Incremental Vector Rule Updates) rebuild the Scam message vectors when more scam messages are acquired into the repo or when new Ham data is available for testing.

New scam vectors for new scam examples can be added incrementally using existing scam phrase rankings to create the vector. If a new scam phrase is needed to create a new vector, it is added to the end of the scam and assigned a new high rank value without fully rerunning the ranking. This can be acceptable because the new phrase was not previously identified as a scam phrase so it implicitly has a high value, even if its exact value is not known. Occasional re-rankings of all scam phrases and recreation of all vectors with the new values can be performed to ensure that incremental updates have not caused the matching based on these assumed values to drift too far from the correct calculated values.

One optional enhancement to this approach is to allow Ngrams to be skip-grams where appropriate. For example, “widow #4# minister” could be a representation of a rule that allows up to 4 words between widow and minister, a broader set of phrases such as “widow to a minister” or “widow of the prime minister” could be detected, but this will potentially require more human tuning and subjective evaluation, and less automation.

In one embodiment, the Vector Filter uses an Aho-Corasick(AC) tree trained with the scammiest phrases. Messages are then checked against this tree. AC tree performance tends to bog down as the number of trained phrases increases, so a series of N AC trees with different scam phrases are used to detect different scam phrases. For example, a first AC tree is trained with the scammiest 20% of phrases and a second slower tree is trained with the remaining 80% of scam phrases. The first tree is likely to catch the majority of the most common scam messages. This smaller tree runs more quickly due to its smaller size. The results for messages that did not match against the first tree are automatically evaluated to determine if processing by a second tree is worth attempting. For example, if the first tree found 4 scam phrases where a total of 6 is required, then processing by subsequent trees is warranted, but if the first tree found zero scam phrases there is likely little value in further processing. The efficacy versus speed trade-offs for the partitioning scam phrases between multiple AC trees and the threshold values to determine if more processing is warranted is determined automatically through iteration. One alternative is to use N stages where the number of stages is dynamically selected based on the currently available resources like memory or CPU.

In most cases the majority (>99%) of messages are not scam. The use of a subset to determine if more processing is required allows the rapid processing of a large volume of messages in the fast path, while only a small fraction that are not immediately identified as clearly not or clearly scam by the first tree, receive additional processing.

In one embodiment, a subset of processing is performed to find the scammiest matches on one processing system, and if sufficient matches are found then the processing can be completed on a different system. For example, initial checking could be performed on an appliance with limited memory and processing power using only 10% of the scammiest phrases, and if 2 or more scam phrases are found the message can be passed to a processing system in the cloud with more memory and processing power. This can allow the large volume of messages to proceed quickly, while the suspect messages receive complete analysis.

In a multi-process/multi-threaded computational environment, a fast small tree and the larger slower tree can be launched speculatively at the same time in separate threads. If the small tree returns a clear result quickly, the slower thread is culled because the result in not needed.

In an environment with hardware support, such as a GPU, for the AC processing the small fast processing can be handled with faster dedicated hardware while the larger slower processing, if needed, is handled by a more general purpose processor with access to a larger memory space.

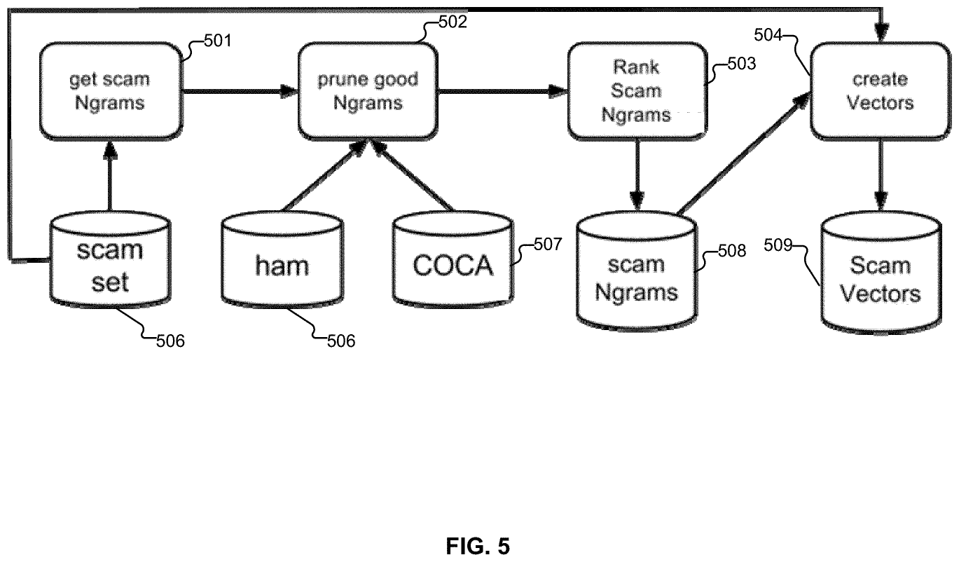

FIG. 5 illustrates an example embodiment of the creation of Vector Filter rules. In this example, the Ngrams are prioritized (501) based on their frequency, in a Scam Set (505). These Ngrams are then pruned (502) using a good “ham” message set (506) and/or the Ngram frequencies in a data set for common phrase usage such as COCA (507). The remaining Ngrams are then ranked (503) based on their relative frequency in the scam set (505) and recorded (508) with their rank. The Scam Vector rules (509) are then created (504) by reprocessing the scam set (505) again but using only the scammiest (lowest number rank) Ngrams from Scam Ngrams (508).

FIG. 6 illustrates an example embodiment in which messages are processed. In the example of FIG. 6, Messages (601) are then processed (602) to identify and order by rank the previously identified Scam Ngrams (508, 605). The ranked list of Ngrams is matched (603) against the previously created Scam Vectors (509,606) to identify scam messages. The matching or non-matching results are recorded (604) for analysis and tuning.

Short Vector Messages

Some messages may be too short or otherwise do not contain enough phrases to make a sufficiently long vector for comparison with the known scam set. These are referred to as Short Vector Messages. These may occur for both training messages and test messages.

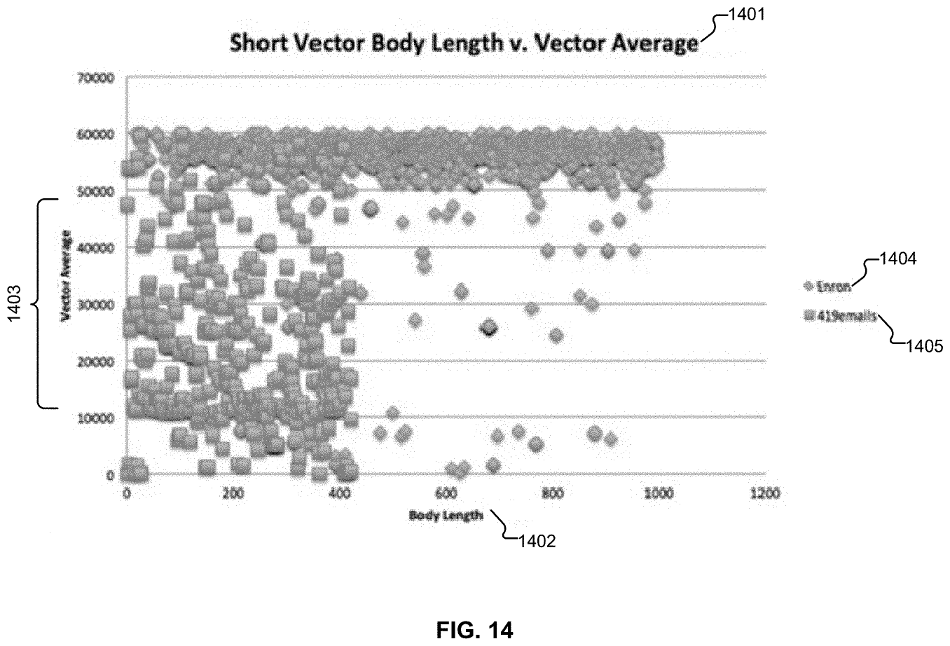

FIG. 14 illustrates an example embodiment of plot. FIG. 14 shows a plot of the message body length versus the average of the Vector values (1401) for messages with Short Vectors. The X axis is the Body Length (1402) which is the number of characters in the message. The Y axis is the Vector Average (1403) which is the average of the numeric scam rank values that were found to match the message. Enron messages (1404), which are non-scam messages, are denoted in the plot and the legend as diamonds. 419 Scam (1405) messages are denoted in the plot and in the legend as squares. The plot of FIG. 14 illustrates that the scam messages have different characteristics that distinguish them from non-scam messages and this can be used in processing messages with Short Vectors.

For these Short Vector cases, shown in FIG. 14, the average of the vector values and message body length appear to be good indicators of scam potential. FIG. 14 compares the 419 (scam) messages in red with the Enron (ham) messages, where Enron is a set of mostly scam-free emails sent to Enron employees. This dataset was made public after the Enron scandal, and is commonly used by researchers and practitioners to assess what “typical language” is. In this context, it is used to represent ham messages. Based on analysis and comparison of the Enron messages versus scam messages, the scam messages were found to have a lower Vector Average and shorter message bodies. These characteristics are likely due to the intrinsic nature of scam messages versus business messages where longer messages are more likely, but it provides additional factors to further sort scam from ham.

For these Short Vector messages it may not be possible to definitively match a message with a previously known scam, so instead of returning a binary decision on whether a test message is scam, in some embodiments, a scam score is returned. This score indicates the likelihood of scam and is used with other information about the message such as the sender's reputation or attachment information to make a decision.

The scam score for messages with a Short Vector can be based on a variety of individual factors or in combination including:
Message body length
average rank of vector values—(where lower average the more likely to be scam)
number of entries in the vector—(wheremore entries more likely to be scam)

Through experimentation and data analysis, a function can be constructed that calculates an appropriate score indicating the likelihood of scam using these input values.

For example, a message with 50 words that matches 3 scam phrases all with a rank below 2000, is much more likely to be a scam message and receive a higher scam score, than a message with a single scam phrase match that has a rank over 50,000.

For example, by programmatically testing the data bounds for the image above, the following values are identified ˜50% of the scam messages with zero False Positives.
Vector Average<32000
Body Length<700 character
Vector Length>1

The Vector Average and Body Length defines a box in the picture above around the red dots and the minimum vector length allows removal of the blue dots from the box. These values are dependent upon the training set—other variables, such as the number of entries in the vector, or more refined combinations of these values should yield better discrimination between ham and scam.

### An Example

In the following scam messages 5 grams are highlighted and their associated Ngram Rank is noted with it:

TABLE 27
This is to notify you about this²³⁴⁷ said fund. After due vetting and evaluation²⁶⁶⁶ of your file that was sent to us
by the Ministry of Finance and Central⁹³⁷ Bank of the Federal Republic of Nigeria⁵⁸⁴. Under the direct
authorization of the Government of Nigeria²⁹⁷ in Conjunction with the United Nations⁷⁸⁷. This bank has an
instruction⁶⁴⁴ to see to the immediate release of the sum of ( SEVEN MILLION FIVE HUNDRED THOUSAND
UNITED STATE DOLLARS⁸¹⁹(US$7.5Million) of your claim that has been³¹¹³ pending since its transfer into
our floating Account from their Domiciliary Account with this Bank³⁹². We were meant to understand from our
findings³⁴⁰⁹ that you have had a hard time collecting this claim⁹¹⁹ and still having difficulties in seeing to the
release²⁸³³ of the said fund which amounts to (SEVEN MILLION FIVE HUNDRED THOUSAND UNITED
STATE DOLLARS⁸¹⁹) (US$ 7,500.000.00) This has been the handwork of some dubious elements¹⁹¹⁴ from that
Country. We advice that you stop further¹¹¹⁵ correspondence with anyone anywhere concerning¹⁷¹⁹ this funds,
you won't find it difficult to receive your fund¹⁴⁷⁷, as you have met up¹⁵²³ with the whole requirements. We know
your contacts in Nigeria⁴¹⁷ or anywhere else will want you to maintain the former status of this transaction¹²¹³,
but that will be at your own risk²¹²³.Do get back to us with²⁷¹⁹ the following required information³¹¹⁹ to
proceed. We will be happy to³⁴¹⁷ assist you.

This message matches all these 5 grams: [2347, 2666, 937, 584, 297, 787, 644, 819, 3113, 392, 3409, 919, 2833, 819, 1914, 1115, 1719, 1417, 1213, 2123, 2719, 3119, 3417].

This list is ordered by rank, duplicates removed and truncated to a length of K=6, to get [297, 392, 584, 644, 787,819]. This is the vector associated with this message. Any new message with a vector that matches any 5 of these (using 5 of 6 matches) would be considered a match.

Consider another message

TABLE 28
We will be happy to³⁴¹⁷ assist you but after due vetting and evaluation²⁶⁶⁶ of the situation it is clear that this is the
handwork of some dubious elements¹⁹¹⁴. We recommend that you not⁴¹⁹¹ reply to their messages and cease all
further contact with them. It is an unfortunate situation but you are unlikely to recover anything from them.

This has the message vector: [1914, 2666, 3417, 4191, -, -] which has a length of 4 which means that it is a “short vector” for K=6. This means that it does not match any previously found scam message, but average rank of 3407 is calculated. 3407 is a relatively low score that could be used in conjunction with other filters.

In one embodiment the values for K and N in “K of N” are selected based on the message length. For example, short messages are less likely to match a large number of scam phrases so instead of matching “6 of 7” a message with only 20 words could match “3 of 4”. Similarly very long messages are much more likely to contain more phrases so they can be required to match “7 of 9”. The correct/appropriate value of K and N as a function of message length can be determined experimentally by iteratively processing Ham and Scam datasets for different values of K and N.

Incremental Vector Rule Updates

Initial creation of vector rules, as discussed above, takes increasing amounts of time as new scam messages are added to the training set. One approach is to quickly incorporate new messages into Vector Rule as soon as they are identified, so that if a scammer tries to use the same message a few minutes later, they are identified. For example, if it takes 15 minutes to re-rank all phrases, the system will always be 15 minutes behind new scam reports.

In some embodiments, incremental updates to the VectorFilter rules are made as new scam messages are found. New Ngrams are added incrementally to the set to be included in the new rules. In some cases, any new Ngrams that are found in new messages are relatively infrequent (or they would have already been seen) and they are added to the end of the Ngram file with a high value. New VectorFilter rules are created using a previous Ngrams, new Ngrams, or a combination.

String Filter

Many scammers reuse text segments, such as “I am the decent and cheerful girl” or “contacting you in confidence to help us in collecting”, from previous scams. This means that identifying such text strings in incoming messages is useful to determine whether these messages are scam. Identifying strings is also useful to identify known good messages. In both of these contexts, it is beneficial if the text segments (or “strings”) are relatively uncommon in other types of messages—e.g., that scammy strings are uncommon in non-scam messages, and that non-scam strings are uncommon in scam messages. It is also beneficial to select the strings so that they are commonly detected for the message category they belong to for example, it is beneficial to choose a scam detecting string so that it matches as many scam messages as possible, without matching many non-scam messages.

String detection is beneficial for a variety of reasons. For example, it:

1. identifies scam messages
a. independently of whether other filters identify them;
   This reduces false negatives.
b. because other filters do not (always) identify them;
   This reduces false negatives and/or reduces the need for manual (human) curation.

2. identifies ham messages
a. because other filters misclassify it as scam
   This reduces false positives.
b. because other filters misclassify it as potential scam
   This reduces false positives and/or reduces the need for manual curation.

1a and 2a described above provide an improvement of accuracy, and 1b+2b provide an efficiency improvement. Improvements in efficiency translates to improvement in accuracy, because other methods such as manual review may be too costly to broadly implement.

In one example approach the selection of String Filter rules is based on the following:
Rules of type 1a as described above are run either on the manual queue (the queue of messages that could filters classified as neither scam nor ham), or on all messages, depending on performance impact.
Rules of type 1b and 2b are preferably run only on messages in the manual queue.
Rules of type 2a are applied to messages that have already been classified as scam, to undo that classification.

The selection of a “good string” is dependent upon the reason the string filter is being used:

Rules of type 1 are configured to:
avoid false positives (i.e., should not trigger on ham)
   One such approach, described below, makes use of an estimate of the probability of a candidate string occurring frequently in ham calculated from two or more tables of Ngrams.
minimize false negatives (i.e., trigger on as many scam messages as possible)
   Recognizing that scam messages often use cut and paste, ensure that the string does not straddle the boundaries between two cut-and-paste areas.

Rules of type 2 are configured to:
avoid false positives (i.e., should not trigger on scam)
   To reduce the likelihood that the selected type 2 strings appear in ham, those found in the corpus of scam messages are removed from consideration.

To ensure scam detection, straddling cut-and-paste boundaries is avoided in some embodiments. A cut and paste boundary is defined herein as the boundary between two text segments that are commonly copied and pasted independently of the other. Consider the following two messages included in tables 29 and 30:

TABLE 29
hello miss cute lady. how are you doing baby?i hope you are doing well better as i am also doing my
dear..honestly you really made me impress about you allot n i am willing to meet you online for us to
have a date online to talk n got to know each other well better if you don't mine dear..plz you can add me
on my yahoo idrobby_4ubaby@yahoo.com n i will be looking forward to meet you online soon as
now...plz kindly take good care of yourself n have a wonderful lovely day my dear...hugs to you n stat
blessed.. yours honest Robert good luck baby kiss..

TABLE 30
hello cute lady.how are you doing my dear?well i hope you are donig well n better as i am also doing my
dear..honestly i am robert n i am willnig to meet you online for us to have a date for us to talk to know
each other well n better if you don't mine dear..honestly you can contact me on my yahoo
id,robby_4ubaby@yahoo.com any time you want..n i will be looking forward to meet you online as
well..kindly take good care of yourself n have a wonderful lovely day..hugs to you n stay blessed...
yours honest robed good luck byeee...

If “hello miss cute lady how are you doing baby” is selected from the first message, the string in the second message will not be found. (Note that punctuation and spaces are ignored.) The string that matches both messages is “cute lady how are you doing”. The cut-and-paste boundary follows the word “doing”.

Technique 1: One approach is to select a small number of strings from each target message, and then let these strings “compete” by running them on an entire scam set. The winner is the one with the most hits against the scam set; if there are ties (which may potentially occur) then the candidate least likely to match false negatives is selected. For example, if strings of varying lengths are used, then the longest among candidates with the same number of hits is selected, since a longer message is less likely to match any message than a shorter one.

Technique 2: A second approach is to use a search engine such as Bing, Google, etc. to determine how often a string is found in a corpus of scam appears on the internet. The search engine is used to find all the strings and pick the ones for which the search engine returns the largest number of responses. All of these are assumed to correspond to scam, and thus the largest number corresponds to the most reported.

### Example

For a string such as the following:
How has the weekend been and just need to sort this out today

the likelihood that this is ham can be determined.

If it were a much shorter string, such as:
the weekend been

then ham documents are searched to determine how common it is. Results may be different for a longer string.

The following is an example approach that uses a repository of Ngrams:

1. Determine the probability of “How has the weekend”—that is a 4-gram, which is looked up in known set up 4 grams like the Corpus of Common American English. Convert this count to a probability, and call this probability P1 . . . 4 (it is for words 1 to 4)

2. Then determine the probability of “has the weekend”—and “the weekend been and”. Call this P2 . . . 4 and P2 . . . 5.

3. Compute the conditional probability of P5|2 . . . 4=P2 . . . 5/P2 . . . 4

4. Compute a probability for P1 . . . 5=P1 . . . 4*P5|2 . . . 4

5. Repeat the steps 2-4 until the probability of the entire string has been computed.

The above is an estimated probability, based on its observed frequency. A threshold for what is acceptable is selected, and then each candidate string is compared with this measure. If the candidate string does not meet the threshold it is not included. Two candidate strings are compared and the best is selected.

Note that Ngram data sets such as COCA or Google return a frequency value (number of times that the Ngram appears in the corresponding corpus), not a probability. In some embodiments, the probability is calculated by dividing the frequency value by the corresponding Ngram set size.

In one embodiment, a short-circuit evaluation is used to optimize the probability calculation. The frequency of the string in the relevant ham corpus cannot be greater than any shorter sub-string. For example, if the 3-gram table contains 30M entries, and “cute lady how” has a frequency of 2 in this table, and the probability threshold for false positives is 10\hat{ }-6, then the probability for “cute lady how are you doing” does not need to be calculated since it has a probability lower than the required maximum.

### Example Embodiment

VARIABLES: Set zero_count=0. This is a counter of how many times COCA says 0 in response to a query, where COCA represents an Ngram service or an Ngram database that contains a frequency value for a large number of Ngrams. Here, p is the probability (estimate) of a string. p3, p4, pnew are working space, which are computed from an occurrence count associated with COCA, and a sampling size associated with COCA.

INPUT: The input message is M which has a length N+n−1, where n is a constant representing the string length being matched. By M\hat{ }i, we mean: Take M, remove the i−1 first words, keep the rest. So M\hat{ }i is the message starting by its i'th word.

QUERIES: COCAx(y) indicates that “COCA is asked for the frequency of the x-gram of the x first words of the phrase y”. The frequency refers to the occurrence count divided by how many x-grams were considered.

Pseudo Code for Example Process A1:

(Used when the Starting Point is Selected Arbitrarily)

Phase A: Find the Best Starting Point.

For j:=1 . . . N, find the location i=j that minimizes COCA4(M\hat{ }j). Alternative approaches can be used to find this location, such as trying many locations, computing the probability associated with each.

Alternatively, in another embodiment, the starting point for string is identified by looking up the word frequency in a database such as the COCA lexicon, since the probability of a multi-word phrase is no higher than the probability for the first word.

PHASE B: COMPUTE PROBABILITY.

| | |
|---|---|
| 1. | Set p to COCA4(M\hat{ }i). |
| 2. | If p=0 then set p=1; zero_count=1 |
| 3. | For j=1 to n-4 |
| | { |
| 4. | p3:=COCA3(M\hat{ }(i+j)) |
| 5. | p4:=COCA4(M\hat{ }{i+j)) |
| 6. | If p3 =/= 0 then pnew:=p4/p3 else pnew:=0 |
| | % \hat{ }\hat{ } note that if p3=0 then p4=0 as well. pnew is set to 0 either |

if that happens, or if just p4=0.

| | |
|---|---|
| 7. | If pnew =/= 0 then p=p*pnew else zero_count++ |
| } | |
| 8. | Output (p,zero_count,string), where string is the n first words |
| | of M\hat{ }i |

Using the Output:

If zero_count=0 then p is the probability, otherwise 0 is the probability and zero_count is a goodness measure that indicates how many times a zero probability was obtained in step 7 above.

When two strings are compared to see which one is best, then the one with the largest value for zero_count is selected, with a tie-breaker of selecting the one with the smallest value p.

Pseudo Code for Example Process A2:

This is used, for example, when the starting point cannot be selected arbitrarily, e.g., in cases where there are cut-and-paste boundaries, as described above. In some cases, a string from certain segments is selected, that correspond to observed or believed cut-and-paste units. For example, a message M may contain k such (non-overlapping) segments; these segments are called M1, M2 . . . Mk.

To select the “best” output:

1. Run A1 on each of the segments M1, M2 . . . Mk

2. Select and output the “best” output from step 1, where “best” is described in “USING THE OUTPUT” above.

Note: in some embodiments, the language or languages in the messages to be processed must match the language or languages of the Ngram database. The treatment of whitespace and punctuation is required, in one embodiments, to also match between the Ngram database and the message processor. In another embodiment, the text is normalized prior to the processing described here, causing whitespace and punctuation differences to be ignored.

Suppose that all strings have ham-probability of no more than p, and in a set of n strings. The likelihood of encountering a false positive can be determined as described below (Note that p is a value that relates to all strings—it is the minimum requirement on the unlikelihood of each string.)

Assume that the strings are independent, etc. Then the false positive rate can be approximated as 1−(1−p)\hat{ }n.

The Taylor expansion of (1+x)\hat{ }n=1+n*x+n(n−1)/2! x\hat{ }2+ . . . .

Therefore, (1−p)\hat{ }n=1−n*p+n(n−1)/2*p\hat{ }2+ . . . .

Thus 1−(1−p)\hat{ }n˜n*p−n\hat{ }2 p\hat{ }2/2

If the probability were bounded at p in the set of n strings, then the false positive is approximately fp=n*p−(n*p)\hat{ }2/2. For simplicity, set fp=n*p; that indicates that the target is for p<fp/n. In other words, for n=10M strings, and fp<0.005, then the target is for p<0.005/10\hat{ }{7}=5*10\hat{ }{−10}. Here, fp denotes false positives.

This value can be used in a variety of ways:

1. It is a guide to the selection of long strings so that these are unlikely to produce false positives

2. This value is used experimentally to determine how long the strings need to be

3. It indicates how many strings are safely collected, given one set of lengths (see #2 above) and maximum string likelihood in ham messages (see #1 above).

This can be beneficial for copy and paste detection. It can also be beneficial for identifying messages that have already been manually reviewed. For example, if there is one message that is mislabeled and therefore cause an exception leading to a manual review, or if there is a message that is reported by several end-users to be mis-classified, then a text sequence is extracted from this and used to identify reoccurrences of the message and correctly classify it. The above assessment of probabilities can be used to make sure that the estimate of false positive is acceptably low, where this is determined by comparison to preconfigured value, such as fp=0.0001.

Once strings are selected, according to the above process or a variant thereof, they are detected in incoming messages. In one embodiment, strings are matched by using an Aho-Corasick tree, a bloom filter, a deterministic bit array, a binary tree, a hash, or a composite of these data structures, such as implemented by a Java HashMap.

Finding Bogus URL Links

Scam emails commonly contain URLs that are disguised. This is commonly done by displaying one URL to the user (such as “www.goodlink.com”) but to associate the clicking of that hyperlink with the opening of another, very different, webpage, such as a webpage at www.badlink.com. While there are legitimate situations in which the URLs differ, this is typically a matter of the two URLs being associated with the same domain, but the “actual” URL (as opposed to the displayed URL) having additional information—such as www.goodlink.com/campaign=GH65&age=28.

One approach to detecting scam emails is to identify what may be referred to as “substantial discrepancies” between the display URL and the actual URL. Examples of substantial discrepancies are:

TABLE 31

| Displayed URL | Actual URL |
|---|---|
| A financial institution, | Recently registered domain, not belonging |
| such as “Bank of | to a recognized legitimate organization |
| America” | |
| A well-known company, | A URL that is associated with high risk, e.g., |
| such as “Amazon” | “www.amazon.com-specialoffer5624.br”, |
| | since this URL is an example of a deceptive |
| | URL (the domain is “com-specialoffer5624.br”, |
| | not “amazon.com”. |
| In a scammy email, any | where the actual URL is not associated with the |
| displayed URL, | same domain as the displayed domain. |
| Any URL | A URL associated with phishing or malware. |
| URLs for resources | where the content delivery network (CDN) is |
| (such as images), | not one used by the “primary brand” (as |
| | described below) |

A spoofed communication appearing to come from a well-known brand such as Amazon.com™ may contain content copied from a legitimate communication sent by that brand. For example, the content may be identical except for a single link that a scammer wishes the user to click.

The brand in question can be identified by means such as parsing the ALT html directive for the images in the communication. The ALT directive specifies the text to be shown to the user if the image is unavailable; for example, “Amazon” in the following example:

<img alt=“Amazon” border=“0” height=“31” src=“https://ci5.googleusercontent.com/proxy/h-StrJrHH9UBu5WhlxRAag2W701nkKWpDnMEakTcCUO4wiEIQErHNu1gWs1mGJiVTQU2ni1Zm7VyKF_G1F39b6xEldURmYVV3OexLyCLRCVHgvKe6anD8eanNyvLReQMTN5M=s0-d-e1-ft#http://www.silvaretailsurveys.com/hobnails_chrysanthemums-2100_inveteracy.gif”>

In an example approach, the system maintains a database of CDN providers utilized by each brand. The system recognizes that the content delivery network, “http://www.silvaretailsurveys.com” is not a CDN used by Amazon.

A real link for Amazon.com may look like the following:

<img alt=“Amazon.com” src=“https://ci4.googleusercontent.com/proxy/k6_2griTXIHQ7TgiP8eIMeBBPqxvbR_tp://g-ecx.images-amazon.com/images/G/01/x-locale/cs/te/logo.png style=”border: 0;width: 115px” class=“CtoWUd”>

Here the system finds g-ecx.images-amazon.com in its CDN database entry for the Amazon brand.

Once a substantial discrepancy in a link is found, several actions are potentially taken in response, including but not limited to:

1. Delete the email containing the substantial discrepancy from the inbox of the recipient.

2. Replace the email containing the substantial discrepancy with an email in which the actual URL is removed.

3. Replace the email containing the substantial discrepancy with an email in which the actual URL is replaced by the displayed URL.

4. Replace the email containing the substantial discrepancy with an email in which the actual URL is replaced by a URL that leads to a website that displays a warning to the visitor, and potentially an explanation of the reason the user is warned, and potentially a copy of the actual URL along with a warning not to visit that site unless the user is absolutely certain that it is safe.

5. Replace the email containing the substantial discrepancy with an email containing fragments of the original email, along with educational material explaining why this is a scam.

6. Replace the email containing the substantial discrepancy with an email that identifies the danger of the link in place using a text message like “THIS IS A SUSPICIOUS LINK”, different font, different text color, icons or a combination of these.

7. Insert a message header such as X-SPAM-SCORE or X-SCAM_SCORE to indicate to downstream email processing components that the message likely scam and they can process according to user preferences or an organization's policy. For example, a mail reader can be configured to automatically route messages marked as SCAM to a Scam Folder in the user's mail reader.

A related technique involves detection of risky contact information, whether phone numbers, email addresses, IM addresses, or physical mailing addresses. We will refer to this as “risky contact information” onwards. Risky contact information can be detected in a variety of ways:

(a) the contact information is already known to be risky, from having been previously associated with scam messages;

(b) the contact information is contained in messages that are found to be scammy using one or more filtering methods, such as those described in this disclosure.

(c) an email Reply-To address domain could be different from the apparent From address. For example, the from address could be “chris@good.com” but the Reply to address could be “chris@evil.com” or even more subtle “chris@goodtwo.com” which is potentially more difficult to detect.

Risky contact information could either be part of the headers (i.e., be the sender of an email, the reply-to address of an email, or one of the recipients of an email); or it could be part of the content portion of the email. Risky contact information in the content portion is, in some embodiments, redacted or replaced by a hyperlink that contains information about the risky contact information, and which takes a user to a landing page where the risks are explained, the user educated, and (potentially) the risky contact information is provided to a user insisting she wants it. The risky contact information and its type is, in some embodiments, conveyed in the URL that is replacing the risky contact information in the content portion of the email.

Similarly, risky contact information in headers is, in some embodiments, replaced with an email address to an autoresponder, and the original risky contact information added to or conveyed in the display name of this email address. If a user sends an email to this email address, the autoresponder generates a response with information explaining that the site is likely to be a scam site; the contact information likely to be risky; and (potentially) containing the contact information and a warning.

An example flow of bad URL detection is provided below.

```
// each url has a display string and the real link
struct url
{
  string display
  string real
}
// a set of brands to be monitored such as paypal.com or wellsfargo.com
map brand<name,exists>;
// a map of content delivery networks to brand domains that use them
map cdnToBrand<cdn,brandDomain>;
string getDomain(string s)
{
    // extract the domain from the string s
}
boolean isBlacklisted(string domain)
{
    // return true if the domain is found on a blacklist
    // else return false
}
boolean hasBadUrl(message)
{
  while (Url = message.getNextUrl( ))
  {
      string[ ] parts = Url.display.split(“.”);
      for (i=0; i < parts.length; i++)
      {
        // check for any parts of the display URL that match a protected brand
        if (brand.get(parts[i]) == TRUE)
        {
          // we have a monitored brand
          if (getdomain(Url.display) != getdomain(Url.real))
              {
              // the real and display domain don't match so potential spoof
              if (cdnToBrand.get(getdomain(Url.real)) == getDomain(Url.display))
              {
                        return FALSE; // good content delivery network
                      }
                    }
                    else return TRUE; // wrong domain
                  }
                  else
                  {
                    // not a monitored brand, so just check for a blacklisted domain
                    if (isBlacklisted(getDomain(Url.real)) return TRUE;
                    else return FALSE;
                  }
                } // for loop
              } // while loop
            } // hasBadUrl( )
```

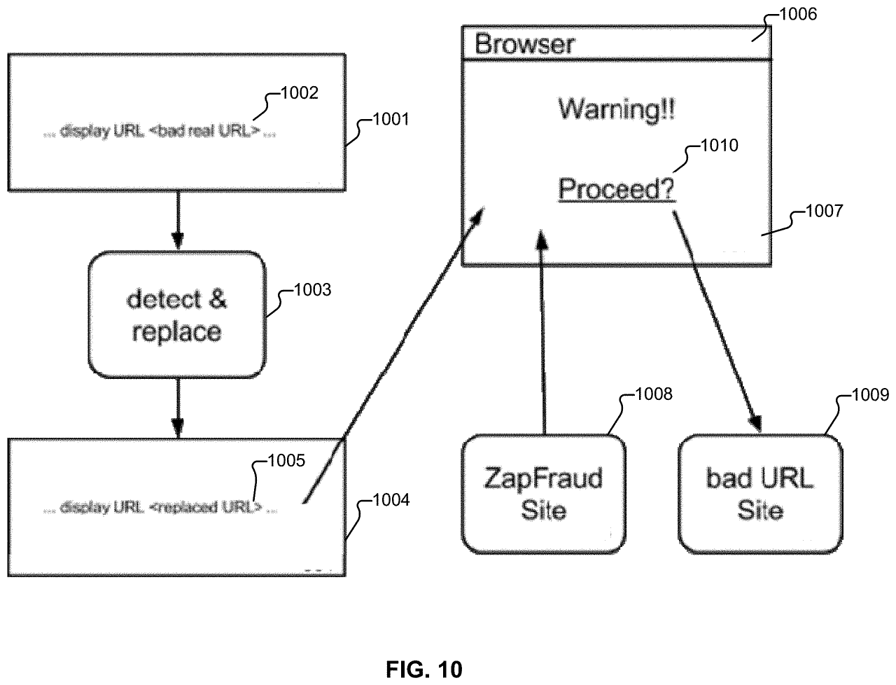

FIG. 10 illustrates an example embodiment of a message. The example of FIG. 10 shows a message (1001) that contains a bad URL (1002) that is processed to detect and replace (1003) bad URLs. A copy (1004) of the original message (1001) is made and the bad URL (1002) is replaced with a different link (1005). The copy (1004) is sent to the users instead of the original message (1001). If the person reading the copy (1004) clicks on the link (1005), their browser (1006) reads a warning page (1007) that is loaded from a safe site like ZapFraud.com (1008). The warning page (1007) explains to the user that the site is likely scam, but can give the user the option to proceed (1010). Thus, even if the user clicks the proceed (1010) link, despite the warnings, and the browser (1006) loads the suspicious page, the user is warned.

Image Analysis

To avoid scam and spam detectors that process email text bodies, scammers often put their scam messages into images. Processing images to detect scam may be much more difficult than simple body text analysis, as image to text and image analysis are usually needed to detect scam, and image analysis may require substantially more computation than text processing. Scammers may attempt to thwart image analysis in a variety of ways including using text interspersed with or overlaid upon graphics, unusual fonts are used to thwart image to text processing, or text is moved around within images.

To avoid excessive computational effort associated with large quantities of image analysis, several example policies are as follows:

(a) Always process all images in honeypot accounts. The honeypot accounts are seeded by legitimate traffic, and thus when a subscriber receives an email that is determined to be scam, then a honeypot account is created and used to send an email to the sender of the scam email, where the contents of the email, in some embodiments, are selected based on the assessed contents of the scam email. For example, if the received scam emails relate to vehicle scams, the honeypot account can be configured to send an email containing the text “What about the car? Interested? Please let me know soon.”

(b) Always process all images in emails reported by end-users, such as emails sent to an autoresponder that determines whether the emails are scam; and all emails sent to a system collecting user complaints relating to scams. In some cases, it is beneficial to avoid processing images in emails sent by senders that have been blacklisted, or senders associated with blacklisted IP ranges, or senders of large quantities of scam messages to avoid a denial of service attack intended to consume scam processing resources. An account can be blacklisted for sending large quantities of scam messages, and an IP range can be blacklisted if used for sending large quantities of scam messages.

(c) Never process images for other accounts, unless the received email exceeds a minimum scamminess, where the scamminess is indicated by a score determined by applying one or more scam filters.

(d) Always process image attachments when the message body has zero length or a very short body indicating that the content is in the attachment. For example, “see attached” or “i thought you would like this” and no other text indicate that the attachment contains the true content.

(e) Always process the image attachments when the message body has Spam Filter poison such as “urgently nonsense may prevail under the sea and dogs with fleas may fly” or contains content from an RSS feed.

Other conditions and frequencies can also be used. For example, instead of “always” performing an action, this can be performed as long as the system load is below a threshold that is a system parameter, such that all processors are, for example, working at 90% of more of their capacity. Similarly, instead of “never”, the process can perform the action with a very low probability, e.g., by drawing a random number between 1 and 10,000 and only performing the action if the number is less than 4. Alternatively, other conditions can be used, such as the IP address of the sender, so that an action is performed conditionally on the IP address corresponding to a pre-set geolocation area or conditional to the IP address being a known VPN proxy or botnet IP address.

Moving Scam Messages to Another Folder

Scam Messages are put into a particular folder referred to herein as a “ZapFraud” folder, or another folder associated with scam messages. In some embodiments, these are folders in the mailbox of the subscriber. The ZapFraud Folder exists at the mail service provider and the user's mail client shows the contents of the folder so that changes to the ZapFraud Folder appear at the client when the client updates its view of the user's emails. The messages moved to the ZapFraud Folder are modified to reduce the risk to a user that might view and act upon the message. These modifications include one or more of the following:
Visible links in messages are redacted, such as www.evil.com is replaced by www.*******.***
HTML references are removed. For example “<a href=‘www.evil.com’>www.good.com</a>” is replaced by “www.good.com”
HTML references are replaced by links to an intermediate warning page where the user is warned about the danger of proceeding. For example “<a href=‘www.evil.com’>www.good.com</a>” is replaced by <a href=‘www.zapfraud.com/badlink=www.evil.com>www.good.com</a>”
Suspect information in Scam messages including email addresses, phone numbers, street addresses, and instant message identifiers such as Skype ids, in Scam messages are fully or partially redacted. For example, 512-705-1234 could be replaced by 512-***-**** or [SUSPECT PHONE NUMBER].
Suspect information in Scam messages including email addresses, phone numbers, street addresses, and instant message identifiers such as Skype ids, in Scam messages are replaced by links that redirect to a web warning page before the user is shown the actual phone numbers. For example, a the message text “512-705-1234” can be replaced by <a href=‘www.zapfraud.com/badphone=512-705-1234>[SUSPECT PHONE NUMBER]</a>”
To ensure that user does not read the hidden information above by mouseover or viewing the raw HTML source, information are given a unique identifier and then only viewed through the web server. For example, the message text “512-705-1234” can be replaced by <a href=‘www.zapfraud.com/badphone=9E21E312-4FF4-4C28-A604-6F5F4731E2E3>[ SUSPECT PHONE NUMBER]</a>”. If the user clicks on such a link they will be shown a web page warning them about the suspect phone number or destination link but can also be shown the phone number or destination link if they choose to proceed.
Policy is applied per user or group at the web server that limits who is permitted to view suspect information. For example, only security administrators can be allowed to proceed to suspicious links.

Machine Learning Filters

In various embodiments, high-cost machine learning techniques are combined with one or more of the techniques described above. One way this can be done is to limit false positives by running a machine learning based classifier on all messages that are identified as being likely scam messages, or all messages prior to being entered into a queue for manual review. Alternatively, a high-cost machine learning classifier is used conditional to one or more steps of processing have been performed and a processed message has not yet been identified as coming from a likely safe source. This avoids excessive computational burden associated with computationally expensive machine learning based classifiers, while benefiting from one additional step of review. There can also be machine learning filters, such as the Vector Filter and Storyline Filter, that are not high-cost, based on a configuration that creates a representation that fits in cache, for example. Any low-cost classifier can, in some embodiments, be run on all input messages if it is likely to generate hits with a large enough probability that the cost per expected hit is sufficiently low. Based on such considerations, a selection of classifiers is selected, pipelined, and organized based on conditions relating to the results of previously executed classifiers.

Examples of machine learning (ML) classifiers and associated building blocks that can be used in the described architecture of classifiers and filters are as follows:

TFIDF Feature Extraction

In some embodiments, this process inputs text files containing at least one of scam messages and ham messages, and outputs TFIDF feature vectors. One way to implement the generation of TFIDF is in the Python programming language. The process first divides the given data into train and test datasets, and then builds an n-gram feature list of training and test sets using an n-gram feature extractor. Then it builds TFIDF feature vectors from n-gram feature vectors of a training set. For TF weighting, this example version uses “double normalization K” scheme with the K value of 0.4; other configurations are also possible.

Since the number of samples and the size of TFIDF features is extremely large, principal component analysis (PCA) is applied in one embodiment. In another embodiment, a Truncated SVM method is used.

The n-gram feature extraction, in one embodiment, obtains text and the value n as inputs and outputs a list of n-gram tokens. In some embodiments, it uses “nitk” and “sklearn” libraries (see more detail below) to stem the text or remove stop-words from the text.

The TFIDF feature extraction, in one embodiment, obtains text files of a particular data format (referred to herein as the “ZapFraud” data format) and outputs TFIDF feature vectors. It first divides the given data into train and test datasets, and then builds n-gram feature list of train and test sets using n-gram feature extractor described above. Then it builds TFIDF feature vectors from n-gram feature vectors of train set. For TF weighting, it uses “double normalization K” scheme with the K value of 0.4.

Since the number of samples and the size of TFIDF features is extremely large, PCA can be applied. In one embodiment, this program uses Truncated SVM method included in sklearn library.

Machine Learning Classifier

This example process implements machine learning classifiers, such as: Logistic regression, random forest, SVM and naïve Bayes, respectively. The processes receive as input TFIDF training and test sets along with their labels as inputs and outputs predicted labels upon the given test set. It first trains the classifier using the given test set and its label, and then predicts the labels of the test set. Once the classifiers have been tested, they are connected to classify the input messages pipelined to the applicable ML classifiers. The email classifier, in one embodiment, uses the NLTK library written in Python and made by NLTK project (http://www.nitk.org/) and scikit-learn library written in Python and made by scikit-learn developers (http://scikit-learn.org/).

The machine learning classifier, in one embodiment, implements the following machine learning classifiers: Logistic regression, random forest, SVM and naïve Bayes, respectively. Each method corresponds to a single library included in sklearn library. The programs gets TFIDF train and test sets along with their labels as inputs and outputs predicted labels upon the given test set. It first trains the classifier using the given test set and its label, and then predicts the labels of the test set. The classifier can be used to verify selections made by other filters, such as the storyline filter, or can be used in addition to and independently of such filters.

Manual Review Process

In some embodiments, messages are forwarded to manual reviewers, for them to make a classification. The classification can be used to create a new rule, or to train the system. It can also be used to generate a classification decision for the manually reviewed message, and for closely related such messages in the manual review queue. The messages placed in the manual review queue can be selected based on one or more of the following:
Selected as random samples to confirm the automated processing results. For example, 0.1% of all messages are reviewed by one or more human reviewers to verify that the automated system is performing as expected.
Based on automated scam score. For example, messages that are not clearly scam nor clearly safe are sent to one or more human reviewers to decide.
All scam or not scam messages could be reviewed to confirm the automated result.
Message from selected sender email addresses or sender domains. For example, a particular sending email address may have been taken over by a scammer, but the true account owner is still using it so additional human scrutiny can be applied before the sending account should be blacklisted.
Messages to selected receiver email addresses can be subjected to manual review. For example, users that pay for additional review would get a double check by human reviewers.
Messages in a selected classification. For example, Romance scams could be subjected to manual review.
Based on the current system load, load and availability of reviewers, external events such as occurrence of large-scale breaches, data leaks, etc.

In one embodiment, incoming messages that are selected for review are forwarded as email messages to reviewer with one or more links or buttons at the bottom of the message for the reviewer to select. These links can include the following options:
This is SCAM
This is NOT SCAM
Don't know
Not Now—leave me alone for an hour. A reviewer selects this option so that they are temporarily removed from the set of reviewers.

In an alternative embodiment, the messages are made available to the reviewers using a web interface, on a website that is used for manual review, and which, e.g., is password protected. In one embodiment, the messages to be manually reviewed are processed prior to being displayed, to remove identifying information and information deemed irrelevant to the decision. In one embodiment, some of the information in the message is marked up or modified to draw the attention of the reviewers to this portion. For example, one portion may be displayed in red, whereas the remainder is displayed in black, independently of how it was originally intended by the sender to be displayed. An example of this is that a suspected spam poisoning component is changed to make the text highly visible, whereas the original sender had selected a display color or display size that made it very difficult to see.

When the reviewer selects a result at the bottom of the message, the result is recorded at a server and an appropriate disposition is applied. For example, the links in the message could be displayed in an email viewer to connect to a web page that records the reviewer's response and applies the disposition based on policy. Another approach is to present the messages in a mobile application that allows reviewers to submit responses.

In one alternate implementation, a reviewer provides additional comments for their response.

The messages to be reviewed are sent to a single reviewer or a list of reviewers. The number of reviewers or quality of could depend on the score determined by the automated system.

In one embodiment, each reviewer may have a different overall ranking or ranking within a scam category. For example, a reviewer may know more about advance fee fraud than extortions. Messages are assigned based on each reviewer's ranking.

In one example embodiment, the number of reviewers required is set based on configurable policy. The policy can require that M of N reviewer agree before a result is confirmed, like 2 of 3 reviewers say it is scam. The policy can require that the rankings of the reviewers sum to a minimum score to get an agreement. For example, where three reviewers could have associated rankings (A=55, B=35, C=30) and a minimum score of 50 is required to get a result, then A alone can decide or B and C in agreement can decide. In a scoring based policy such as this, the reviewers that select NOT SCAM can be subtracted from the scores from reviewers that selected SCAM. In a scoring based policy, the reviewer's rankings can be combined with the score assigned by the automated process to read the required minimum.

In one embodiment, messages are assigned to reviewers, but if they do not respond within a time window, the messages are sent to one or more alternate reviewers. In turn these alternative reviewers are associated with their own time windows and alternative backup reviewers, etc.

In one example version, the system is configured to default to a response if a sufficient number of reviewers have not responded within a time window. For example, if the message does not receive enough “SCAM” responses within an hour, it is assumed to be NOT SCAM.

In one example version, reviewer's rankings improve over time as they review more messages. Reviewers rankings are automatically calculated based on the number of times they agree or disagree with higher ranked reviewers and/or the automated scoring system. Rankings can be calculated across all scam categories and per category.

In one example version, reviewers are assigned subsections to review. For example, one reviewer is given the body while another reviews attachments and yet another reviews only header information.

In one example version, reviewers are paid for reviewing messages which includes getting paid per message. Reviewers could be paid at different rates depending on a variety of factors including, but not limited to, their experience/rank, and how quickly they perform a review.

In one example version, personally identifiable information in a message is redacted before it is presented to the reviewer to ensure that a user's privacy is protected. This information includes but is not limited to first name, last name, address, financial account information, dollar amounts, and email addresses.

Combining Filters

In some embodiments, multiple filters are run in succession. For testing purposes it can be useful to run all filters with all rules to evaluate the overlap of the filters and rules. For example, if two rules consistently identify exactly the same scam messages, there is no need to run both. Similarly, if one filter detects a large number of scam messages, and another filter detects only a subset of these, or mostly just a subset of these, then the second filter is less beneficial than the first, assuming their computational requirements are comparable. However, if the second filter requires substantially less computational resources, this may be more beneficial, and the first filter only run if the second filter does not generate a hit. The determination of what filters to run, in what order, and on what conditions is, in some embodiments, automated to minimize the average system resources required; minimize the error rate; minimize the time to make a classification; minimize the amount of manual review requirement; where all of these are for the expected distributions and behaviors. To the extent that not all can be minimized at the same time, a beneficial balance is generated where the total deviation from a goodness measure is minimized.

In one embodiment, at least two filters are executed in parallel, for one input message, and their results are combined to generate a classification or a decision what other filter(s) to execute next.

Some filter and rule combinations can be performed for statistical data collection. For example, it may always be desirable to collect the sending domains to understand email volume trends. Some such filters are only run in batch mode, i.e., not as part of the assessment of whether to deliver a message or not, but in order to generate statistics and training data to be used independently of the decision of whether to deliver the message in question in the inbox, or to take another action on this message or associated account.

Due to the potential high volume of messages in production execution, minimizing the computation per message is beneficial to enhance throughput. Thus, for example, in one embodiment, the most effective and computationally least expensive rules is typically run first. For example, a check of the message sender's reputation is a fast table lookup that returns a binary answer, while analysis of an attached image may potentially take much longer and provides a less definite result. In this case the reputation can be checked first because the result may be sufficient to omit the processing of images. A very good or very bad sender reputation can cause the image analysis to be skipped.

In one example approach, filter and rule combinations are run in succession. After each execution, a cumulative scam score is evaluated against a first scam threshold, such as a score of 50 out of 100. Once the threshold has been reached, some scam checks are skipped to reduce the computational cost. In one embodiment, additional filters are only run if the cumulative scam score exceeds a second scam threshold after a fixed collection of filters have been run. For example, if ten filters have been run, and produces a scam score that does not exceed 8, then no additional filters are run.

Specific rules can be run when other rules hit or miss. In one embodiment, these rule combinations are defined using combinatorial logic and boolean expressions. For example, in the expression:
if (msg.Rule(FromNigeria) and msg.Rule(Inheritance)) msg.IsScam=TRUE

The Inheritance rule check would only be performed if the first check FromNigeria returned TRUE, otherwise it would be skipped.

Scores are used in the evaluation of expressions like
if (msg.Rule(SenderReputation)<50 and msg.Rule(Inheritance)) msg.IsScam=TRUE

where the Inheritance rule is only run if the SenderReputation returns a score below a threshold. Similarly, subsequent rules could be skipped if a first rule determines that the message is a valid newsletter.

In one example approach, where speed is more important than computational efficiency, filters are speculatively started in parallel across multiple processors or threads. If a fast filter returns a clear negative or positive result, the slower processing is culled, but if the fast filter does not provide a clear answer, the slower filter was started earlier than it would have been in a serial evaluation, so a result is produced sooner.

In one example approach, filter rules are run on one or more dedicated processors in parallel or sequentially with execution of other filters on other processors. For example, image analysis or a neural net filter are run on dedicated hardware, while the Vector filter is run on a general purpose processor.

In one example approach, the processing of a filter type is partitioned by running a subset of rules first and subsequently the remainder of the rules. For example, 20% of the Vector rules are run, followed by running all String rules. If no clear result is found, only then are the remaining 80% of the Vector rules run.

Measuring False Positives without Impacting Subscriber Privacy

Assessing error rates is beneficial to the overall tuning and improvement of the system. In some embodiments, this is done without affecting the privacy of users (i.e. exposing any information about them), whether individual subscribers or enterprise customers.

There are multiple ways to use customer data without violating the trust of users. For example:

1. For each recipient account (the “good” honeypot accounts not excepted, since they, for example, receive newsletters):
a. Determine what senders have sent at least two emails to the recipient account, where these two emails are separated in time by at least M months. These determined senders are referred to as “good senders”. Other parameters can be used here as well, such as “at least three emails separated by at least four months per pair of emails”, or similar. Alternative variations on this approach include:
   1. Only includes the messages that were opened by the recipient because these have at least been somewhat recognized by the receiver
   2. Only include messages that were not deleted by the receiver
   3. Instead of reviewing the received messages, the user's outbox is reviewed to determine associations where the recipient has sent some messages.
b. For all good senders, and the associated recipient accounts, download all emails received and run the rules for detecting scam. As an optional approach, it is first determined that the emails processed are in a supported language. This can be done, for example, by determining that they contain some minimum number of common words in a supported language. For example, for an email that is at least 100 words long, in one embodiment, it needs to contain at least two out of “am”, “is”, “yes”, “no”, “when”, “how”, “will”, “do”, “did”, please” for it to be considered to be in English for the purposes of this processing. If not, then consider the corresponding sender “not good” and ignore all the emails from him.
c. Save the following information only: How many emails are processed (call this N), and—for each filtering rule used—how many of the emails triggered the rule (where this is referred to as hit i, where the i indicates the rule number), and hit (which tracks the number of emails that were hit by at least one rule.)
   Note that N, hit i and hit are all “global” in the sense that they are not relative to the recipient account.
d. Do not save the emails that triggered.

Determine, for all rules, what the false positive rate is. For rule i, the false positive is hit i/N, and for the system as such, the false positive is hit/N.

A variant approach is as follows:

For each member—who is called “good sender”, consider the emails he/she sent, and use 1b-d, 2 above to determine the false positives. Again, no emails are saved, except for temporary processing.

URL Scoring

Given a URL comprising a subdomain and a domain, a scamminess score can be generated using the following example approach:
Assign a score, such as a value between 0-50 points, based on the length of the subdomain, such as one point per character.
Assign a score, such as a value between 0-50 points, based on the deceptiveness of the subdomain. For example, containing a “whitelisted” corporate reference, like http://betabank.evil.com or http://www.verify.z89q14.com/betabank, would contribute a high score, such as 40 points, while containing a “whitelisted” generic term, like http://bank.evil.com or http:http://www.verify.z89q14.com/bank, would contribute a medium score, such as 18 points, and containing a term characteristic of scammers (such as ‘hdgdjfg6ehdkhddg73hh’ or similarly illegible material) would contribute a medium score, such as 16 points. Common and general subdomains, such as ‘documents’ may not contribute any score at all. Legitimately used domains such as http://www.betabank.com would not contribute any score at all. These would be determined by looking up the domain in a whitelist of domains that have large traffic and which have not been associated with generating scam messages. For example, Alexa 1000 can be used to identify domains with large amounts of traffic; and the results of scam filters used to identify which ones of these have not sent scam messages within a time interval that is a configuration parameter, and which can be set to 30 days. Those sites can be considered whitelisted. Additionally, the most common sites identified in processed messages can be scrutinized to determine which ones are not associated with scam, and included in the whitelist. This can be done automatically (e.g., every ten days or any other appropriate frequency), or when the system load is low.
Assign a score, based on the domain, similar to how the subdomain score is computed.
Assign a score, based on the recency of having seen a request for or reference to the domain or combination of subdomain and domain together; for example, the score may be 60 if the domain or combination has never been seen; 20 if the domain has not been seen within 10 days; and 10 if the combination has not been seen within 10 days.
Assign a score to a domain based on the age of the domain. Recently created domains are often set up to commit fraud and quickly shut down, so newer domains are more suspect.
Assign a score to a domain based on the hosting service that is hosting the domain. Scammers tend to use less reputable hosting services for their phishing sites where they are slower to be taken down, so the hosting service may correlate as an indicator of scam.
Assign a score to a domain based on the number of times that is has been previously seen in a scammy message. For example, the scam score of a domain could be the average scam score of all messages that previously referenced the domain and/or the score of all messages that came from that domain.

Attachment Processing Policy

This section describes example options relating to how to optimize when image analysis should be performed.

Scammers may attempt to avoid detection by systems that use text processing by embedding their scam message into an image attachment to a message. For example, a common scam phrase such as “100% guaranteed weight loss” is easily detected in a text message body, but the same text in an image requires the extraction of the text from image before it can be processed.

Since image processing is potentially 100˜100000× slower than processing message text, in various embodiments, images are processed only when needed. Omitting unnecessary image processing optimizes message throughput and overall system performance. Images can be processed to detect text if:

The message body
is shorter than N words, or
the message body only contains spam filter poison
the message body contains words from an RSS feed

and the image does not match previous messages (e.g., by checksum or metadata)

Data Recording and Analysis

In embodiments of the system described throughout, a variety of filter types are used to detect scam in messages and each filter is configured with a variety of rules. The efficacy of each rule can be measured and tuned over time by recording the hit rate for each rule in testing with good (ham) messages and scam messages, and in production use.

For example, for each message that a rule matched, the message identifier is recorded.

This information can be used for a variety of purposes, such as to:
Determine the false positive and false negative rates for each rule.
Determine the correlation between two or more rules. This is used to determine if a rule is redundant. This is used to group rules into families for scoring purposes.
Determine rules that are hitting few or no messages and therefore are candidates to be culled or modified.
Determine how rules perform as a function of time and how scammers vary their approaches over time.
Determine how well each rule performs within a scam category. For example, if a rule detects a romance scam, then other romance rules are dynamically selected over other possible rules.
Determine which rules find the most scam. For example, if 20% of the rules typically find 80% of the scam, these rules are run first to optimize throughput, but if scam is not found with the first group of rules the next most effective tranche is run.

Testing and Tuning with Ham and Scam

In one example embodiment, many filters in the system including Vector, Storyline, Phrase and String filters, are trained by first processing messages from a scam set and then pruned with good “ham” messages. FIG. 9 shows the details of an example approach where messages are read from the scam set (901) are read by the scam reader (902) and passed to one or more test filters (905) which are configured with test rules (906). The test filters (905) process the messages to detect scam. Messages that are not caught by filters and rules are recorded (907) into the results (908) data as False Negatives and messages that are caught are recorded as True Positives into the results (908). Good messages are read from the ham set (904) by the ham reader (903) and passed to one or more test filters (905) that are configured with test rules (906). The test filters (905) process the messages to detect scam. Messages that are not caught by filters and rules are recorded (907) into the results (908) data as True Negatives and messages that are caught are recorded as False Positives into the results (908). After running the ham and scam messages, the results (908) are automatically analyzed (909) and the rules are tuned. In various embodiments, the analysis and tuning (909) is performed manually, automatically through iterative adjustments to the rules, or a combination of manually and automatically.

In one example approach, a fraction of the ham set (904) and scam set (901) is omitted from the training set, but is used later for testing. For example, 90% of ham and scam are used for tuning and when tuning is complete, the remaining 10% of each are used for testing.

Detecting Phishing Attempts

Disclosed herein are techniques for detecting a large class of phishing-attempt communications (e.g., emails, SMSes, and other messages) that incorporate human-readable content indications of association of a message with an authoritative entity (such as a bank or other financial services provider, shipping/postal carrier, cellular or other utility provider, etc.) to appear to be legitimate/trustworthy to a recipient. Examples of such human-readable content indications include content that is displayed to a user, such as the sender email address, the sender name, the message text, and any graphics or audio associated with the message (whether incorporated into or linked to by the message). Suppose “ACME Bank” is a legitimate bank. A phishing-attempt communication (also referred to herein as a “message”) might incorporate any/combinations of the following into the communication: the term “ACME Bank” (or similar) in the sender name or email, images with likenesses of text or logos associated with ACME Bank, text segments or images with contents matching to a large extent messaging used by ACME Bank (e.g., “ACME Bank of America”) but not by any other actual legitimate entity, and/or references to web addresses containing material that renders to any such information.

As will be described in more detail below, techniques disclosed herein can be used to combine an assessment of the likely end-user interpretation of the message (including the apparent sender email address, friendly/display name, and message content) with an assessment of whether the apparent sender matches the actual sender, and to take actions in response, such as filtering actions or reporting actions. This approach incorporates what end-users will interpret a message as being with system information about the message, determining discrepancies, determining matches with unwanted descriptions, and initiating actions to remedy the problem.

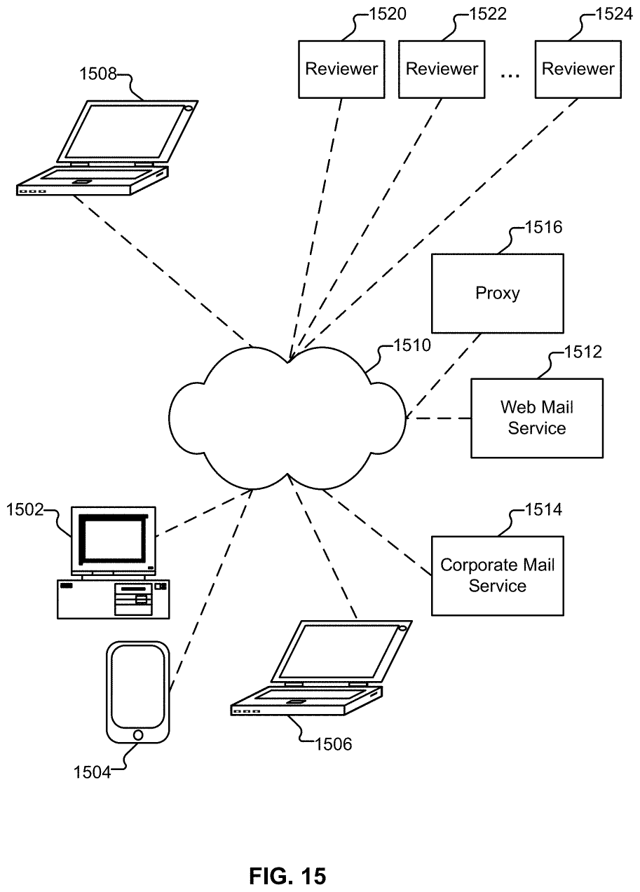

FIG. 15 illustrates an embodiment of an environment in which users of computer and other devices are protected from communications (also referred to herein as “messages”) sent by unscrupulous entities. In the environment shown, a user of client device 1502 (hereinafter referred to as “Alice”) has an email account provided by web mail service provider 1512. Alice visits provider 1512's website with her computer (via one or more networks/network types, depicted collectively in FIG. 15 as a single network cloud 1510) to read and write email. Alice also accesses her email account via mobile phone 1504. A user of client device 1506 (hereinafter referred to as “Bob”) has an email account provided by his employer (i.e., hosted by corporate mail server 1514) and also has an account with provider 1512.

A nefarious individual (hereinafter referred to as “Charlie”) uses client device 1508 to perpetrate fraud on unsuspecting victims. In particular, Charlie is a member of a criminal organization that engages in a variety of email scams. One example scam is a phishing scam, in which criminals contact unsuspecting Internet users using messages that appear to be authored by legitimate entities such as banks, with the goal of tricking the victims into clicking on links in the messages and providing banking credentials (e.g., usernames and passwords) or other sensitive information. In addition to, or instead of collecting sensitive information from victims, nefarious individuals can use phishing-attempt communications to trick victims into clicking on links that result in drive-by-downloads or other harmful consequences. Phishing messages can be particularly problematic because they often contain text, logos, or other symbols that users associate with legitimate messages. Further, such messages often include statements that are successful at encouraging users to interact with them, such as “you need to change your password,” or “please confirm your account information is correct,” or “you've received a payment, click here to log into your account and confirm receipt.”

Another example scam is a “Nigerian scam” (also referred to herein as a “419 scam”), in which criminals contact unsuspecting Internet users with offers, requests, or opportunities for relationships, with the goal of requesting money from the victims—whether within the initial contact email, but also potentially at a future point (e.g., after multiple communications have been exchanged). Nigerian scams are believed to have originated in Nigeria (hence the name), but are now practiced from many places in the world. While in principle anybody could fall victim to a 419 scam, some Internet users are more prone to such scams than others, and many are repeat victims. A particular individual may be the victim of such a scam due to having a personality or needs that make him/her particularly vulnerable to the scam (e.g., an older person living alone). The individual may also be the victim of the scam due to poor security practices by which these users unwittingly invite abuse by sharing their contact information in a way that allows scammers to find it. Furthermore, the names and contact information of these victims may be sold to other scammers, or reused by a successful scammer, due to the high probability of re-victimization. A 419 scam tends to rely to a larger extent than other scams on social engineering.

In contrast to typical SPAM messages which may contain readily blacklistable terms like “porn,” one of the reasons that a 419 scam message is successful at tricking victims is because it appears to be a legitimate conversational message. Similarly, one of the reasons a phishing scam message is successful at tricking victims is because it appears to be a legitimate message from a trustworthy entity. Terms frequently present in a 419 scam or phishing message, such as “dollars,” “bank,” or “account” are also very prevalent in legitimate email. Further, people who are about to fall for a 419 scam may be unwilling to believe that they are being tricked, because they want to believe in the message that the scammer provides them. This makes it difficult for friends and family to help protect victims, as the victims to not believe that they are being victimized. As another example, a phishing message might appear to a recipient to contain, verbatim, the text of a legitimate message sent by a legitimate entity (but, e.g., contain one or more different URLs or mailto links to harmful resources instead of legitimate ones). The degree of possible customization of scam messages makes it particularly difficult for existing email filters to provide sufficient protection, as evidenced by the ongoing success of such scams.

Described herein are techniques for protecting vulnerable users from malicious entities such as Charlie. In particular, as will be described in more detail below, communications are examined and classified by a classification platform 1600, which can be operated as a single, standalone device, and can also be at least partially incorporated into a variety of the components shown in FIG. 15, or other components (e.g., not shown in FIG. 15) as applicable.

In addition to protecting against 419 scams/phishing attempts, other abuses, such as forms of cyber bullying, abuse by sexual predators, and in general, receipt of inappropriate or threatening information or messages, can be protected against using techniques described herein. For example, potential misuse of trademarked terms or logos can be flagged, where such terms/logos appear in messages not transmitted by the rights holder. Further, different configurations can be selected from in implementing the techniques described herein. As one example, platform 1600 can determine the extent to which different abuses are covered by different parameter choices for a given user after reviewing some email traffic to and from the user in question, by running for a period of time, and/or by statistical methods that compare the user to similar users using the technology. It is possible to start with one configuration and change to another configuration if the first one is not appropriate, whether, e.g., because it is believed to remove desired communications or because it fails to remove communication that is a risk to the vulnerable user. This can be determined among other things from direct feedback from the protected vulnerable user; by manual or automatic scrutiny of quarantined messages, where it is determined what portion of this traffic was legitimate; and/or by scrutiny of the contents and quantity of the mail that is identified as bad. This provides an opportunity to change the settings over time to make them more appropriate for a given protected user (or group of users, such as an enterprise organization), or to adopt the protection features to a changing problem, as the circumstances and exposure of the protected user change.

The techniques described herein can be incorporated into a variety of systems, in a variety of ways, and in various combinations. For example, Alice's web browser (e.g., on client 1502 or client 1504) can be configured to use a plugin whenever she accesses mail service 1512. The plugin can be configured to perform at least some of the techniques described herein as being performed by platform 1600. As another example, a client-side filter can be included on client device 1506 and configured to scan/filter all, or a portion of the incoming/outgoing traffic of the device (e.g., traffic between corporate mail service 1514 and/or web mail service 1512, irrespective of what type of mail client is used by Bob to access his mail). In yet other embodiments, a regular mail client (e.g., Microsoft Outlook) is modified to support at least some of the techniques described herein. Accordingly, it is to be understood that, while some techniques are described herein as being performed by platform 1600, such techniques can be performed in a variety of environments, by a variety of devices, whether working standalone or in cooperation with other devices.

The techniques herein can also be provided by service providers (e.g., operating embodiments of platform 1600 or configuring their infrastructure to cooperate with embodiments of platform 1600). For example, Alice's ISP, web mail service 1512, and corporate mail service 1514 can each/all provide services in accordance with the techniques described herein. In particular, existing infrastructure provided by the service provider(s) can be adapted to provide at least some of the services described herein, or such services can be provided by one or more separate modules. For example, at least a portion of the functionality of platform 1600 can be provided as a gateway (e.g., such that all of the mail of an enterprise is filtered by such a gateway as it arrives/is downloaded). As another example, the functionality of platform 1600 can be provided at least partially by a milter (e.g., such that some portion of message processing is performed for free on behalf of an ISP, and any usage above that portion is charged to the ISP based on a contractual agreement). As yet another example, such services can be provided by proxies. The proxies can be controlled by the service providers (e.g., on premises), and can also be provided by a third party as an external service to the service provider. Service providers may opt to provide the services described herein to all users, and can also provide the services on a per-user basis. As one example, Alice could choose to “opt-in” to having web mail service 1512 provide her with protections, while Bob could choose to forgo having web mail service 1512 provide him with protection. As another example, Alice's ISP might automatically enroll her in protection services (e.g., based on her age or other demographic information indicative of her being particularly vulnerable, or based on any prior history of Alice having been victimized in an email scam). Bob, having different characteristics, would not automatically be enrolled (but could nonetheless be offered the ability to opt-in).

In some embodiments, a proxy 1516 performs scanning/filtering services on behalf of users as a third party subscription service. For example, Alice's daughter “Eve” can purchase a subscription on behalf of her mother, Alice, or Alice might purchase a subscription for herself. As another example, Bob can purchase a subscription for himself, or his employer might subsidize the subscription on his behalf. As yet another example, customers of an entity, such as ACME Bank, or a particular credit card, or other company, can be offered a subscription (whether complementary, at a discounted rate, etc.) by the entity. The proxy is configured with the user name(s) and password(s) or other credentials for the email accounts to be protected as needed. The usernames/credentials can be collected in a variety of ways. As one example, the user (e.g., Alice) can be explicitly asked to provide them. As another example, the information can be automatically collected on her behalf. The proxy can then access the account(s) periodically, or screen and filter traffic as it is being sent to and from the subscribed user.

In situations such as where services are provided by a third party (e.g., protections for Alice's account with web mail service 1512 are provided by third party proxy 1516), a filter can be used in order to avoid polling the email service provider (e.g., service 1512) too often, which could be considered abusive/disruptive to the operation of service 1512. One way to provide such filter services is by changing the DNS lookup tables associated with the client device, and thereby causing all traffic to be filtered by the proxy as it is being downloaded from web mail service 1512 to the client device. Another approach is to augment the access functionality on the client device so that proxy 1516 is notified when the client device attempts to access the account. As it is being notified, it performs the filtering activity. In yet other embodiments, proxy 1516 provides a middleware component to device 1502, where the middleware component catches calls made by the mail reader program (or browser) residing on the client device and then initiates a call to the web mail service 1512. In yet other embodiments, the proxy mimics a client device that is constantly logged in and is polling for updates at a frequent but reasonable rate, such as once every minute.

In various embodiments, combinations of the components described above are used. For example, Alice can be protected both by a plugin or executable installed on client device 1502, and one or more external protection services (e.g., offered by her ISP, by proxy 1516, or by web mail service 1512). In this scenario, Alice will be protected both when she uses her client computer 1502 to read her mail, and also when she checks her mail in other places, such as at a library terminal or hotel kiosk. Finally, while the techniques described herein are generally described in conjunction with evaluating email communications, other forms of communications can also be monitored/filtered as applicable. For example, instant messaging clients can monitored (whether at the client, via a proxy, or at a server), and messages being sent to/from the protected user on such services treated in a similar way as is described for the emails, as applicable. SMS/MMS messages are another example of communications that can be screened/managed using the techniques described herein. Other communication technologies can also be monitored and filtered, as applicable. For example, automated voice recognition techniques can be used in conjunction with the screening of voicemail messages (e.g., in conjunction with a service such as Google Voice) or calls, and escalation involving human review could be performed (e.g., with the consent of the callee).

—Communication Classification Platform—

FIG. 16 depicts an embodiment of a communication classification platform. As shown in FIG. 16, platform 1600 can comprise a single device, such as standard commercially available server hardware (e.g., with a multi-core processor, 4+ Gigabytes of RAM, and one or more Gigabit network interface adapters) and run a typical server-class operating system (e.g., Linux). Platform 1600 can also be implemented using a scalable, elastic architecture and may comprise several distributed components, including components provided by one or more third parties. As explained above, platform 1600 (or portions thereof) can be incorporated into a variety of different components depicted in the environment of FIG. 15. As one example, all or portions of platform 1600 may be provided by web mail service 1512. As another example, portions of platform 1600 may be located on client (or other) devices, such as client device 1502 and portions not located on the client device may be omitted, or provided by a third party, as applicable.

In some embodiments, platform 1600 includes a database 1602 of user profile information. As one example, where proxy 1516 implements platform 1600, database 1602 could include, for each user of the proxy, the user's username/password information for sites that are proxied. Database 1602 can also include information such as the user's credit card information (where the proxy is run as a paid service), contact information, and any user-specific customizations. Examples of such customizations include user-specific whitelists (and any contextual information used to construct those lists, such as temporal information associated with message exchange), scoring thresholds, etc., described in more detail below. As another example, where client device 1502 implements platform 1600, database 1602 can be implemented as one or more configuration files specific to the user(s) of the device. Further, in some embodiments communications for all users are handled the same way, and database 1602 (and/or user-specific profile information) is omitted, or reduced in scope, as applicable.

In some embodiments, when platform 1600 receives a communication for processing, the communication is provided to quick classifier 1604. Header evaluation engine 1606 evaluates any headers associated with the communication. Examples of information evaluated by engine 1606 include: the sender/originator of the communication (including email address and friendly/display name), the apparent location and IP address of the sender, and the type of domain used by the sender. The header evaluation engine can also evaluate circumstances associated with the communication transmission, such as the time of day it was received, and whether it appears to be a first contact with the user, or a subsequent communication. Content evaluation engine 1608 evaluates the content of the communication. As will be described in more detail below, examples of content analysis include analysis based on a “collection of terms” 1628 (e.g., a set of terms which, when occurring in a single communication are indicative of a particular scam story), and/or analysis based on “indicating terms” 1620 (e.g., individual terms whose presence in a communication are highly indicative of scams). In some embodiments (e.g., with respect to phishing scams), two types of evaluation are performed. The first type of evaluation is an evaluation of the likelihood a potential viewer of the content would conclude that the content was sent on behalf of an authoritative entity (e.g., whether a text segment, a corresponding image, or combination thereof matches, to a threshold extent, messaging used by a given authoritative entity). As will be described in more detail below, “collection of terms”-based evaluation is one way that a determination can be made about whether message content would appear to have been sent by an authoritative entity. In various embodiments, platform 1600 includes a content database 1616 (or other appropriate data storage or set of data storages) that includes collections of terms associated with various authoritative entities (e.g., national banks, payment services, etc.) as well as graphical and/or other media associated with those entities (e.g., logos, fonts, and style sheets). The contents of database 1616 can be provided by a single provider (e.g., tasked with creating collections of terms and collecting logos/trademarks/etc. of legitimate authoritative entities) and can also be provided by (and/or managed by) multiple providers (e.g., authoritative entities can make use of APIs or other mechanisms to submit collections of terms and/or media associated with their respective brands/identities) to platform 1600. Techniques described herein can also be overlayed on or combined with other content-matching techniques.

The second type of evaluation is an evaluation of the likelihood the content was in fact sent on behalf of that authoritative entity.

In some embodiments, platform 1600 includes a honeypot engine 1622 configured to collect fraudulent messages, along with their sender information, by generating traffic from one or more honeypot accounts; and collecting and evaluating traffic to such accounts. The indications of fraudulent activity derived from these actions can be used to help improve the filtering of messages received by real users.

In some embodiments, a tertiary classification (e.g., “bad,” “good,” and “undetermined”) is made based on the performed evaluations (and, if applicable, taking into account any user-specific information). Where the result of the evaluation is “undetermined,” the communication is optionally stored in repository 1610 and provided to detailed classifier 1612 for enhanced processing. In some embodiments, quick classifier 1604 is provided by one entity (e.g., is located on device 102 or provided by an entity such as corporate mail service 1514), and detailed classifier 1612 is provided by another entity (e.g., is provided by a third party operator of platform 1600, proxy 1516, an ISP, or other applicable entity).

In various embodiments, quick classifier 1604 and detailed classifier 1612 employ different classification techniques. For example, quick classifier 1604 may rely solely on white/blacklists (e.g., requiring less than one second to process a message), while detailed classifier 1612 may employ machine learning or other more sophisticated/resource-intensive automated review techniques (e.g., requiring two minutes of processing per message). In some embodiments, detailed classifier 1612 makes use of one or more human reviewers (1520-1524) instead of or in addition to performing automated analysis. For example, review coordination engine 1614 can make available a copy of the communication to one or more human reviewers, who determine whether the communication should be classified as “bad” or “good,” or whether it appears to have been sent on behalf of an authoritative entity. Examples of such communications include banks statements/notices from banks, online merchants, and others, instructing a user to take an action. An example of a kind of communication a reviewer would not classify as appearing to have been sent on behalf of an authoritative entity is a typical human-human message (e.g., a message sent by Bob to Alice. The reviewer feedback is provided back to detailed classifier 1612, which uses the information to determine a final disposition/classification of the message. In some embodiments, when a message is sent out for human review, the conclusion of the human review decides the disposition of the message. In other embodiments, the human classification is treated as one factor of a score (e.g., worth 50 points), discussed in more detail below.

In some embodiments, the reviewers are assigned reputation information (e.g., by coordinator 1614), which is stored in database 1616 or another appropriate place (e.g., a separate reviewer database). The reviewers can also be compensated for their reviewing efforts, with associated book-keeping being performed by coordinator 1614 or another appropriate module. As will be described in more detail below). The reviewers may comprise a variety of individuals, including paid employees of the operator of platform 1600, other users of platform 1600 (e.g., who perform reviews in exchange for a discount/rebate on services), a family member (e.g. Eva on behalf of Alice), and/or members of a third party outsourcing platform, such as Amazon Mechanical Turk. In some cases, such as where the human analysis is performed by a trusted entity within an organization (e.g., a member of the IT department reviewing an email sent to Bob at his work address), the full text of the message may be provided to the reviewer. In other embodiments, the message is partially redacted prior to being provided to a reviewer, also as described in more detail below.

—Tertiary Classification of Communications—

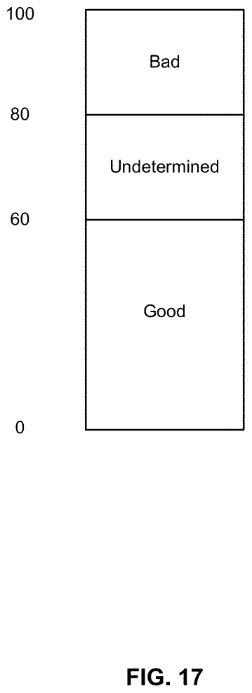

FIG. 17 depicts an example of a set of score thresholds used in an embodiment of a tertiary communication classification system. In some embodiments the set of thresholds is used for all users of a classification system (e.g., where corporate mail service 1514 uses the same settings for all users). In other embodiments, the set of thresholds is adjustable on a per-user or per-user-group basis, either at the request of the user(s) or based on factors such as an assessment of the vulnerability of the user/user-group to various communication-based scams/threats.

In the example shown, a communication that receives a score (e.g., from quick classifier 1604) of less than 60 is determined to be “good.” A communication that receives a score of greater than 80 is determined to be “bad.” A communication that receives a score between those values is determined to be “undetermined” and flagged for further analysis (e.g., by detailed classifier 1612). In various embodiments, the thresholds are set such that there are no false positives: all emails for which there is a risk for false positives (i.e., a “bad” email being classified as a “good” email) are instead classified as “undetermined” and subjected to additional processing. The determination of how to set the thresholds is a risk assessment wherein the risks of false positives are weighted against the risk of false negatives.

Communications that are determined to be “good” (also referred to herein as “green”) are delivered to their intended recipient. For example, an email intended for Alice that receives a score of “10” is ultimately delivered to Alice's inbox on web mail service 1512. The display of good messages may also be modified, e.g., so that “good” messages are colored green or include green elements when rendered.

Communications that are determined to be “bad” (also referred to herein as “red”) are not delivered, in some embodiments. One reason to not deliver the message at all, if determined to be bad, is that an unsophisticated user may unwittingly believe the message has been misclassified and fall for the scam represented by the message. Other handling of “bad” communications can also be configured. For example, “bad” messages can be delivered to a special folder, or are marked as being highly suspicious (e.g., colored bright red when displayed). In some embodiments, “bad” messages are delivered to a separate account associated with the user. As one example, a “bad” message sent by Charlie to alice@examplewebmail.com (Alice's email address on service 1512) could be redirected to alice.screened@examplewebmail.com. Alice could authorize Eve to access the secondary account (but not her primary account) to review and permanently delete any “bad” messages, and to make sure no false negatives (i.e., “good” communications erroneously classified as “bad”) occur.

As mentioned above, messages that are neither “good” nor “bad” are flagged as “undetermined” (also referred to as “yellow”) and subjected to additional processing prior to final disposition. As needed, the communication is held (e.g., in repository 1610) until a determination is made as to whether the communication is “good” or “bad.” Additional detail regarding the additional processing of “undetermined” messages is provided below.

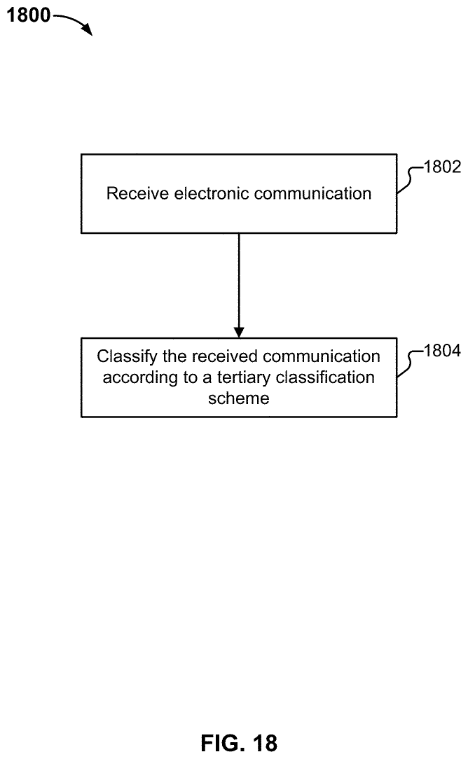

FIG. 18 illustrates an embodiment of a process for classifying communications. In some embodiments process 1800 is performed by platform 1600. The process begins at 1802 when an electronic communication is received. As one example, a communication is received at 1802 when web mail service 1512 (which includes at least some components of platform 1600) receives a message from Charlie addressed to Alice. As another example, where at least some of the functionality performed by platform 1600 is incorporated into a mail client installed on Bob's laptop 1506, the mail client could receive a communication at 1802 when Bob's mail client contacts corporate mail service 1514 to retrieve new mail (e.g., via POP).

At 1804, the communication is classified according to a tertiary classification scheme. As explained above, in some embodiments, the communication might be definitively classified as “good” or “bad” by a quick classifier 1604. If the communication is instead determined to be “undetermined” by the quick classifier, it is provided to detailed classifier 1612 for heightened review. In some embodiments, the quick classifier and the detailed classifier are collocated on a single platform (e.g., as depicted in FIG. 16). In other embodiments, the classifiers reside on separate devices and/or may be configured by or under the control of distinct entities. As one example, a quick classifier could be included in a mail client resident on phone 1504. As the phone has limited computing and other resources, and messages received on the phone could be handled by a remote detailed classifier (e.g., provided by proxy 1516). Further, in some embodiments multiple detailed classifiers are employed, and/or multiple rounds of enhanced scrutiny are applied to messages that are not clearly “good” or “bad.” As one example, where detailed classifier cannot definitively determine whether a message is “good” or “bad,” the message can be provided to one or more amateur human reviewers (e.g., members of the public who have agreed to help review messages). If the amateur reviewers are similarly unable to determine/agree that a given message is “good” or “bad,” the message can be provided to professional reviewers (e.g., employees of the owner of platform 1600 or paid contractors). Protected users/subscribers can also potentially act as reviewers (whether for themselves or others). For example, if a sufficient number of protected users report a received message as “spam,” the message would be considered “bad,” and/or would cause the message to be provided to be given to amateur or professional reviewers to classify.

The classification performed at 1804 can be based on a numerical score (e.g., using numerical thresholds such as are depicted in FIG. 17). The classification performed at 1804 can also be based on a set of rules. Examples of both approaches to classification are given below, and will draw from the following list of example considerations:

1. “collection of terms”—(described in more detail below)

2. “indicating terms”—(also described in more detail below)

3. “friendly email”—A user-specific whitelist of email addresses. In some embodiments, the user or an administrator provides the whitelist. In other embodiments, the whitelist is constructed based on an observation (e.g., by platform 1600) of communications. As one example, once a protected user has exchanged more than a threshold number of emails with someone at a given email address, over a threshold period of time (e.g., ten emails over the course of two weeks), then the address could be designated as a friendly email.

4. “friendly location”—A user-specific geolocation of friendly emails (or other identifier of a communication's origin). In some embodiments, the geolocations associated with email addresses that are considered to be friendly (e.g., per above) are designated as “friendly” after threshold requirements are met. As one example, if Alice has a friend in Paris, France, with whom she routinely communicates, that friend would eventually be added to the “friendly email list.” The geolocation of “Paris, France” could then be added as a friendly location (e.g., after Alice has exchanged more than twenty messages with her Parisian friend, over a period of at least one month). In some embodiments, a freshness test is employed, so that a location only remains friendly so long as the threshold amount of communication continues to be exchanged (or some other “maintenance” level of communication). An example of a way the likely approximate location of the sender can be determined is by review of the routing path, which is always available to a receiving ISP, and commonly available to the final recipient.

The geolocations designated as “friendly” can take a variety of forms, ranging from specific IP blocks/subnets (e.g., indicative of the particular French ISP used by Alice's friend), to political boundaries such as neighborhoods/ZIP codes/cities/counties/states/countries, or arbitrary designations such as “within a 20 mile radius” of a given location. The classification can also be performed by determining if the IP is not in a given range, e.g., “any not originating in Denmark” is not friendly.

Alice might visit her friend (and make new friends) or otherwise legitimately begin communicating with others in Paris. Such communications are much less likely to be fraudulent/take advantage of Alice than communications originating from a geolocation with which she's not previously had contact (e.g., Spain or Ghana). A variety of rules can be used to govern whether/when a friendly location is added. For example, if Alice's Parisian friend visits China for a week, and sends a handful of emails to Alice, platform 1600 will not automatically add the country of China to Alice's friendly location list. One way to ensure China is not added is to require a threshold number of additional “friendly email” addresses in a given region before adding a region, and/or connecting the number of friendly emails to the footprint of the associated geolocation (e.g., requiring Alice to receive mail on a regular basis from three people in a given state or country before adding the entire state/country).

In some embodiments, friendly languages are determined, and may, for example, correspond to the languages spoken in the friendly locations. Thus, if a language used in the message is either on a particular list of languages, or is not on a list of on a list of particular languages, then this can be used as a factor to cause the email to be identified as good, suspect, or bad. Rules can also be combined, describing scenarios such as: “All email from outside Scandinavia is considered suspect, except email from Britain if the language is Swedish and there are no indicating terms in the email.” A variety of approaches can be used to assess messages according to such rules. For example, services such as Google translate can be used; comparisons of message contents to word lists of different languages can be performed; and/or the encoding of the message and the associated language character table can be identified. Most computers use UTF (8,16) to display contents. In the case of HTML pages, the page typically has a metatag that indicates the encoding of the page, and if the characters are from a certain part of the coding table that shows the language of the page.

While it may seem unnecessarily restrictive to block traffic from entire subnets, countries or even continents, or likewise to block traffic in certain languages, there are many users to whom the Internet poses greater threats than benefits unless drastic limitations of freedom are made. Thus, to such users, or to concerned family members, it may be desirable/reasonable to block traffic from all countries where the protected user does not have any friends, family or business partners, or conversely, to only admit traffic from whitelisted locations. The importance of a given factor, including friendly location, can be determined by weights associated with the rules; also, for some users, only a subset of the rules need be active or configured.

5. “suspect location”—A listing of VPN proxy addresses, Tor exit nodes, zombie/bot nodes, and other known-bad sending locations that is not user-specific. As one example, if a particular ISP in Ghana is known for originating a great deal of scam messages, that ISP could be designated as a “suspect location.” And, paths can also be used, e.g., any web email originating in Ghana, or originating in Spain.

6. “undisclosed location”—A listing of webmail providers that is not user-specific, and a location that resolves to a VPN, known bot node, or similar problematic location.

7. “global friendly senders”—A listing of well-known, benign electronic commerce and other service providers that is not user-specific.

8. “spoof”—Messages sent to “undisclosed recipients” and/or other indicators of sender spoofing. Additional examples include: (1) comparing the originating IP address with the domain; (2) identifying suspect IP addresses on the path of the message; (3) identifying an unusual number of hops; (4) identifying previously identified bad IP addresses in long headers; (5) email contents being misaligned with the domain appearing to have originated the message; (6) email contents being misaligned with the IP addresses on the path of the message; and/or (7) the email has a sufficiently different reply-to address from the apparent sender address, or (8) the email has a sufficiently different reply-address from both the apparent sender address and the originating domain.

### Example—Numerical Scoring

Each of the above eight example considerations is associated with a number of points. The following is one example of how points could be assigned:

(collection of terms fires): 65 points

(indicating terms fires): 10 points

not (friendly email): 25 points

not (friendly location): 25 points

(suspect location): 30 points

(undisclosed location): 10 points

(global friendly sender): −20 points (this value is negative, indicating that the presence of the condition being true is indicative of a “good” message)

(spoof): 50 points

For a given communication, the points are summed, and compared to thresholds. Below are two examples of thresholds, one set for Alice (e.g., by Eve) and one set for Bob (e.g., by his employer):

Alice:
<15 points—green
>50 points—red
otherwise yellow

Bob:
<25 points—green
>60 points—red
otherwise yellow

### Example—Rule-Based

Various rules involving the eight example considerations can be defined and associated with tertiary classifications. The following are two examples of how rules can be specified—again, with Alice's rules being more strict against potential scam, and Bob's being more lax:

Alice:
RED if:
   (Collection of terms fires), or
   Spoof, or
   no color determined and (not friendly location) and (not friendly email) and (not global friendly senders) and (indicating terms), or
   no color determined and ((undisclosed location) or (suspect location)) and (indicating terms fires)
GREEN if:
   no color determined and (friendly email) or (global friendly senders), or
   no color determined and (friendly location) and not (indicating terms fires)
YELLOW otherwise.

Bob:

RED if:
(Collection of terms fires), or
Spoof

GREEN if:
no color determined and (friendly email) or (global friendly senders), or
no color determined and (friendly location) and not (indicating terms fires), or
no color determined and (friendly location), or
no color determined and (friendly location) and not (indicating terms fires)

YELLOW if:
no color determined and (not friendly location) and (not friendly email) and (not global friendly senders) and (indicating terms), or
no color determined and ((undisclosed location) or (suspect location)) and (indicating terms fires), or

[otherwise doesn't match any rules].

The rules for what is red, green, and yellow are configurable on a per-case basis and an administrator can select and configure these rules. Conflict between rules can be managed by a pessimistic approach (if any indicator says it is red, then it is red); using a threshold (if at least X indicators say it is red, then it is red); or with exceptions (it is not red if it is on the whitelist, otherwise if any indicator says it is bad then it is red.) These different approaches carry different risks of false positives, where the risk for false positives would be higher for the pessimistic approach than it would be for the other described approaches. Yet other more flexible policies for determining how to manage conflicts can also be used; such as by having each rule associate a score to each message and each rule being associated with a weight, allowing an aggregated weight to be computed and compared to a threshold value, which can be a scalar or a vector element.

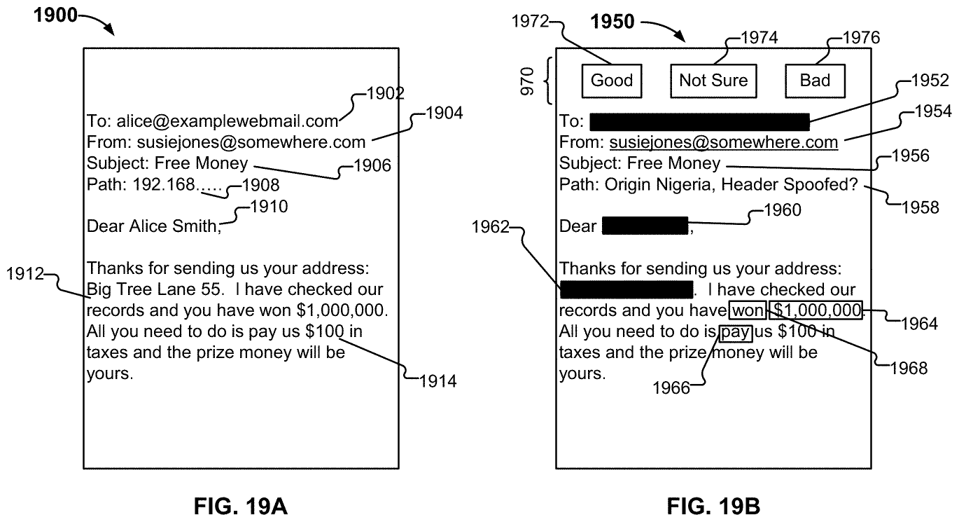

FIG. 19A illustrates an example of an electronic communication. In particular, message 1900 is an example of a fraudulent email message that Charlie has attempted to send to Alice. In this example, Charlie has previously contacted Alice (e.g., letting her know she has won a prize and asking for her address to determine which prize she has won), and Alice has responded (e.g., with her address). In practice, Charlie's original message, and/or the concatenation of the exchanges between Charlie and Alice would have been classified by quick classifier 1604 as “bad” (e.g., based on the “collection of terms” technique described below). However, for purposes of this example, suppose that quick classifier 1604 has classified message 1900 as “undetermined.” The message is provided to detailed classifier 1612 for further analysis. As mentioned above, in some embodiments, detailed classifier 1612 is configured to leverage the assistance of human reviewers in determining whether an undetermined message should be definitively classified as good or bad. Detailed classifier 1612 provides the message to review coordinator 1614 which redacts the message as applicable, and provides the redacted message to one or more human reviewers. In particular, personally identifiable information, such as contact information associated with the protected user (i.e., potential victim recipient) is redacted. In some embodiments, other processing is also performed prior to providing the message to a reviewer for review. For example, terms commonly used by scammers can be highlighted, and path information made easier to understand, as described in more detail below. Such processing can be performed based on parsing of the text (or optical character recognition (OCR) of images, followed by parsing of the resulting text); comparisons to known personally identifiable information (PII) terms/formats (e.g., common first names; recognition of phone numbers; recognition of addresses); and comparison to known terms commonly used by fraudsters, but not as commonly used in non-fraudulent messages (described in more detail below). In some scams, messages are included as attachments, and/or links included in the email (or, e.g., an SMS) direct victims to a website that includes an image of text. Processing can further include examining attachments, and detecting and following such links, and OCR'ing/parsing the obtained content as applicable.

FIG. 19B illustrates an example of an interface for classifying an electronic communication. The example shown is an embodiment of an interface shown to a reviewer, such as reviewer 1520. The interface can be provided in a variety of ways. As one example, platform 1600 may provide a web interface/portal which reviewers can access, log into, and then select an option to “start reviewing.” As another example, e.g., where Eve is reviewing Alice's messages, Eve may receive an email or other alert, letting her know that new mail which requires review has arrived for Alice, and asking Eve to access an interface provided by platform 1600. In yet other embodiments, the interface is provided as a tablet or other mobile device app, allowing reviewers to review messages in a custom interface.

In interface 1950, Alice's email address 1902 has been redacted (1952). The sender's email address 1904 is underlined (1954) to indicate that the sender is involved in other messages, which the reviewer can access by clicking on region 1954. Subject line 1906 is shown in the redacted version of the message (1956). The path of the message 1908 is textually and/or visually clarified/simplified. For example, the IP address information is replaced with a geographic location and an indication that it may be spoofed (1958). Other techniques for simplifying location information can also be provided, such as by showing country information on a map when the reviewer hovers a mouse pointer over region 1958.

Alice's name 1910 is identified as a personal name and removed (1960), as is component 1912 (1962), which is identified as an address. In some embodiments, instead of blacking out the personal information, the information is placed with an indicator of what has been removed, e.g. “NAME” in region 1960 and “ADDRESS” in region 1962. Where reviewer coordinator 1614 is unable to definitively determine whether a portion of the message should be redacted, the label over the redacted portion can indicate as such, e.g., “PROBABLY AN ADDRESS.” Elements of the remaining text commonly associated with scams are highlighted for the reviewer's convenience (1964-1968).

In region 1970, the reviewer is asked to make a determination of how the message should be classified, by clicking on one of buttons 1972, 1974, or 1976. The result of a button press is received by review coordinator 1614, which collects the feedback from any additional reviewers who have been asked to review the message. In some embodiments, a feedback field or other mechanism is included in the interface so that the reviewer can provide feedback on why the message was classified. As one example, the reviewer could explain what reasons led the reviewer to be “not sure” about the message, to help a subsequent reviewer come to a definitive decision.

In some embodiments, the results of other filter rules are indicated in the image shown to the reviewer, to assist the reviewer in assessing the message. For example, where the sender location is friendly, that information could be provided at the top of the interface, or inline (e.g., next to region 1954). As another example, information such as “UK proxy” or “unknown ISP” can be included in region 1958.

In some embodiments, a single definitive (i.e., “good” or “bad” designation, but not “not sure” designation) classification by a reviewer is sufficient to classify the message. This may be the case, for example, where a relative of the protected user is performing the review (i.e., Eve reviewing on behalf of Alice), or a designated employee is performing the review (i.e., a member of Bob's company's IT department reviewing on behalf of Bob). In this scenario, button 1974 may be omitted, if applicable. The number of reviewers assigned to review a message can also be based on a service level associated with the protection. For example, platform 1600 may offer free protection services (where only one human reviewer will resolve undetermined messages) and also offer premium services (where multiple reviewers will vote, and/or where the experience of the reviewers varies based on subscription level).

Where multiple reviewers are asked to review a message (e.g., in parallel, as a group), if a sufficient number of reviewers indicate that a given message is fraudulent by clicking on the “bad” button 1976, then the message is classified as “bad.” If a sufficiently large number of reviewers select the “good” button 1972, then message is considered good. If a sufficient number reviewers select option “not sure” 1974, in some embodiments, the classification task is elevated to more experienced reviewers, e.g., as assessed by the number of cases they have judged, their reputation, and/or the duration that they have provided feedback. A variety of approaches can be used to determine whether the “sufficient” number is reached. As one example, a rule can be specified that the selected group of reviewers must agree unanimously. As another example, a rule can be specified that a threshold percentage of the group must agree. As yet another example, the “votes” of the reviewers can be weighted by their respective reputation scores (e.g., stored in database 1616). Additional information regarding reviewer reputations is provided below.

Reputations can be assigned to reviewers in a variety of ways. As one example, reviewers can be asked to review training materials and then, upon completion, evaluate a set of sample messages. A reviewer's reviewing accuracy with respect to the sample set can be used to assign a reputation to the reviewer. In some embodiments, the reputation is binary (e.g., “trusted” or “not trusted”) or tertiary (e.g., “good reviewer,” “average reviewer,” “novice reviewer). The reputation can also be a score (e.g., 16/20) or percentile (e.g., 75^{th} percentile). In some embodiments, novice reviewers are assigned a starting reputation of 10/100. As they classify messages, their score is increased or decreased based on whether other, more experienced reviewers agree with their assessment. If a novice reviewer's score reaches a low threshold (e.g., 5/100), the reviewer is warned to do a better job, and/or prevented from reviewing any more messages, due to poor performance (e.g., once the reviewer's score dips below 3/100). Where compensation is awarded (whether in the form of monetary payment, or additional reputation/other points), the compensation for a “correct” vote may be evenly distributed across all reviewers voting correctly, and may also be distributed according to a formula, e.g., that takes into account the reviewer's respective reputation scores, history, etc.

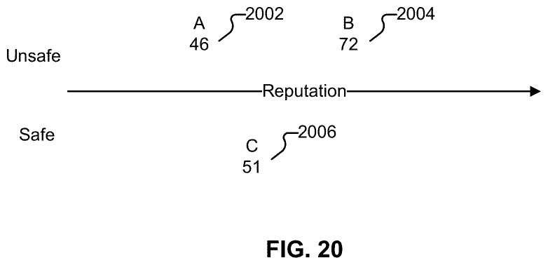

FIG. 20 depicts an example of a review performed by multiple reviewers. In the example shown, reviewer A (2002) has a reputation of 46. Reviewer B (2004) has a reputation of 72. Reviewer C (2006) has a reputation of 51. Reviewers A and B have both flagged the message being reviewed as “unsafe” (i.e., bad). Reviewer C has flagged the message a “safe” (i.e., good). One way to determine an assessment of the message is to sum each of the votes. In the example shown in FIG. 20, such a score could be computed as 46+72−51 (total 67). Another way to determine the assessment is to assign one vote to each reviewer, and then weight the respective votes based on reputation buckets. As one example, a reputation at or above 65 could be accorded a full vote, a reputation between 50 and 65 could be accorded 0.75 votes, and a reputation 50 or below could be accorded 0 votes. Votes determined to be correct are rewarded with heightened reputations, and votes determined to be incorrect are penalized with lowered reputations. In some embodiments, a function is used to determine how much reward or penalty is to be applied. As one example, reputations may be recomputed daily or weekly, and the total number of messages reviewed by a reviewer taken into account considered when adjusting the reputation. As one example, a reviewer who reviews at least 20 messages in a week, and gets no more than ten percent wrong, could be assigned two points of reputation for that week. A reviewer who gets more than ten percent wrong (irrespective of total number reviewed) could be penalized by four points.

In various embodiments, reviewers are made aware of the fact that there are at least some additional reviewers reviewing the message. Information about the other reviewers, such as their number and respective reputations, can selectively be displayed or not displayed (e.g., based on configuration settings made by an administrator). In some embodiments, reviewers are unaware (or are otherwise not informed) about whether or not multiple reviewers are examining the message they are examining.

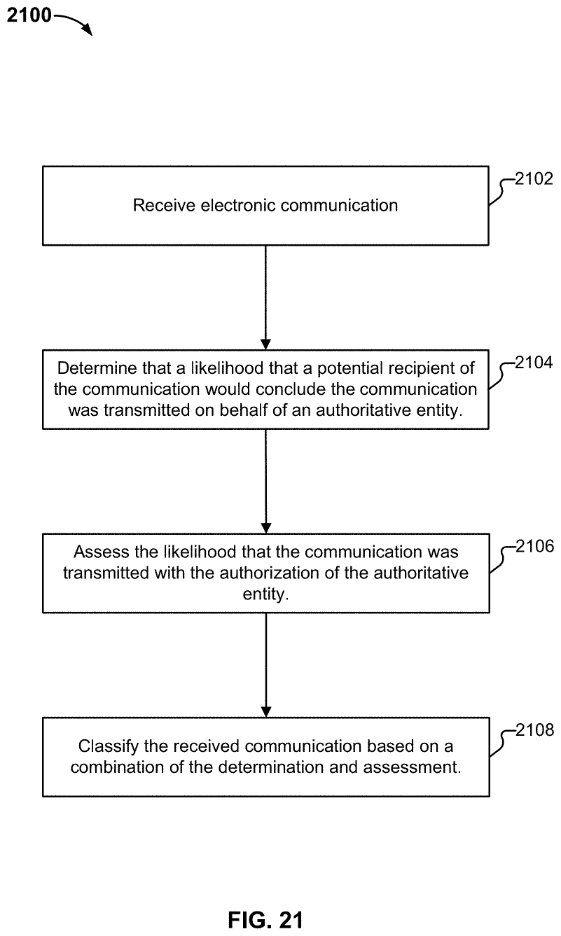

FIG. 21 illustrates an example of a process for classifying communications. In some embodiments, process 2100 is performed by platform 1600. As explained above, other embodiments of platform 1600, and other devices/combinations of devices, as applicable, can also perform process 2100. The process begins at 2102 when an electronic communication is received. As explained above, the communication can be received in a variety of ways, depending on where platform 1600 is located/how it is configured. For example, where platform 1600 is incorporated into corporate mail service 1514, platform 1600 can receive the communication in conjunction with the corporate mail service receiving the message. As another example, where platform 1600 (or portions thereof) are incorporated into a mail client, such an embodiment of platform 1600 can receive the message (along with other messages) when a user of the mail client starts the client. At 2104, a determination is made as to the likelihood that a potential recipient of the communication would conclude that the communication was transmitted on behalf of an authoritative entity. Examples of authoritative entities include specifically named banks and other financial services providers, specifically named shipping/postal entities, and specifically named merchants/marketplace providers. Additional examples include non-specified entities purporting to be authoritative (e.g., a message from “Your Bank” or “Your Accountant” claiming that “your bank account details need updating” without naming a particular bank). One example of processing that can be performed at 2104 is as follows: platform 1600 matches a text component of a message (e.g., the header, content, or both) with a profile indicative of either a phishing attack (or other type of abusive email) or of a legitimate message from a legitimate, authoritative entity, resulting in an output comprising one or more domain names or other identifiers of parties associated with the text component, or an indication that the message does not match any such parties. As described in more detail below, one way the text component can be evaluated is by use of a “collection of terms,” where such a collection is indicative of at least one of a particular type of abuse; the identity of one impersonated authoritative entity or message sender; and the identity of one legitimate authoritative entity or message sender.

At 2106, platform 1600 performs an assessment of the likelihood that the received communication was in fact transmitted with the authorization of the purported authoritative entity (e.g., if the message claims to come from “ACME Bank,” did it in fact come from ACME Bank or one of its associates, or was it sent by Charlie). One example of processing that can be performed at 2106 is to determine whether there is a match of the sender information and the one or more domain names or other identifiers produced at 2104. Technologies such as Domain-based Message Authentication, Reporting, and Conformance (DMARC) or DomainKeys Identified Mail (DKIM) can be used as part of this determination. Another approach is to determine the sender information based on the delivery path associated with the message, where any atypical delivery path is indicative of the message being spoofed. For example, a delivery path is atypical if it involves a node that is believed to be compromised, has a poor reputation (e.g., as recorded in a local or third party provided database of known suspect/malicious IP addresses), or which is not on the expected path between the claimed sender and the message recipient, based on how messages typically are transmitted.

Finally, at 2108, the message is classified based on the outcome of the processing performed at 2104 and 2106. As one example, a security determination is made at 708 based on the processing performed at 2104 and 2106. This security determination can be used to select a course of action, including one or more of delivering the message, filtering out the message, placing the message in a spam folder, notifying a third party of the message or aspects of it, such as from where it was sent, and notifying a third party of statistics relating to one or more messages that have been processed. As explained above, one security determination can be that the message is a phishing attempt (e.g., a malicious individual is trying to trick a target into taking an action under the false belief the message was sent by a legitimate entity). A second security determination can be that the message is inappropriately using text/images associated with a legitimately entity (e.g., a potential trademark or copyright violation). Different actions can be taken based on the outcome of the security determination, as will be described in more detail below.

In addition to matching against words, other context can also be matched against, instead of or in addition to. For example, matching the intention, story associated with, or type of action requested in the message, can all be performed, such as by using equivalence techniques described in more detail in the “collection of terms” section below. As one example, to match a story in which a recipient is told that he or she has to perform an action associated with her account or there would be negative consequences, one can detect words “immediately,” “log in,” and “account.” Instead of “immediately,” one can also detect any word or term with a similar meaning or intent, such as “as soon as possible” or “within” and “hours.” Instead of “log in,” one can detect either “access,” “verify,” or “authenticate.” Similarly, instead of “account,” one can detect “profile” or “information.” If not all of these terms occur in a message, the presence of other indicators, such as logos or URLs that may be deceptive due to containing part of the domain name of the authoritative entity can be used as indicators of sufficient certainty (i.e., above a threshold amount) that a message is likely to give an impression of being associated with a given authoritative entity. An example of a deceptive URL is www.evilhacker.com/acmebank-login since it contains a string that is similar to “ACME Bank.” Another deceptive URL is one where the text URL that is displayed to the end user is significantly different from the URL of the hyperlink, e.g., they are associated with different domains. This is particularly deceptive if the domain of the hyperlink is a domain that is associated with fraudulent behavior, or if the displayed domain is a domain that corresponds to a commonly phished brand. As another example, the sender address of a message is human-readable content to some users who pay attention to the email address of the sender. Thus, if the sending email address is “acmebank@yahoo.com” (which is not an address that officially belongs to ACME Bank, but rather, belongs to whatever Yahoo user who registered it) or “acme@banking.com” can also be used as indications associated with ACME Bank. Similarly, if the “friendly name” (or “display name”) associated with an email address has a strong relationship to an authoritative entity's name, then it can also be considered to be an indication. For example, if the owner of the account, “joe@gmail.com,” sets a friendly name that is “ACME Bill Payment,” then the friendly name is considered to be indicative of content associated with ACME Bank. In some embodiments, automatic parsing of a message is performed by platform 1600 to determine whether the contents sufficiently match a profile associated with a legitimate authoritative entity, such as ACME Bank. Platform 1600 determines whether it is plausible that a potential recipient would believe that the message originated from or was legitimately sent with the permission of the authoritative entity.

In some embodiments, platform 1600 outputs a score associated with an association to an authoritative entity, indicating the probability that the content will appear legitimately related to the authoritative entity to a typical user, according to a selected assessment. As one example, a message with text that closely corresponds to a common ACME Bank email message (e.g., a monthly statement reminder), or an email containing logos closely resembling the ACME Bank logo would result in higher scores than an email message that says “Hi there!” and nothing else, but where the friendly address associated with the sender is “ACME Bank.” One way of determining such a score is by associating a value with each rule in a rule set, and outputting the highest score of the rules that are triggered by a message. In some embodiments, such rules are stored in database 1618 (or any other appropriate store) on platform 1600, and are configurable, such as by an administrator of platform 1600. Another way of determining the score is to use a function of the individual scores, such as a weighed sum of them. In one example, a first rule corresponds to one collection of terms of the message portion; a second rule corresponds to another collection of terms of the message portion; a third rule corresponds to a collection of terms associated with the friendly address. The following are three examples, where the higher the score, the more likely a human recipient would perceive the message as having been sent by an authoritative entity.

Example 1: a first rule states that if a communication contains the terms “log in,” “within XX hours” (where XX represents a number), and one of the words: “alert,” “notification,” or “security,” then the message is assigned a score of 85.

Example 2: a second rule states that if a message contains the terms “security alert” and “log in” then the message is assigned a score of 40.

Example 3: a third rule states that if a message contains the term “ACME Bank” or the friendly address of an email contains the word “ACME,” and the message contains an image component that matches the logo of ACME Bank, then the message is assigned a score of 100. Example ways the image match can be performed include using edge detection techniques, color pattern analysis, optical character recognition, and/or combinations of such techniques, as well as any other image comparison techniques (e.g., which are robust against typical modifications of images, such as cropping, rotating, resizing, adding or removing elements). Note that while a phishing email containing an ACME Bank-related image would cause this rule to be triggered, so would typical legitimate messages sent by ACME Bank that contain ACME logos.

In some embodiments, to prevent attackers from using misspellings to evade detection, each term corresponds to an equivalence class containing common versions of the term. For example, the equivalence class for “ACME Bank” contains “A-C-M-E Bank,” “AKME Bank,” and “ACMAY Banc.” Any such term in a message is therefore mapped to the term “ACME Bank,” and considered equivalent to that term during the evaluation of the rules. Moreover, in some embodiments, the processing of a message by platform 1600 includes performing a normalization preprocessing wherein case is adjusted (e.g., to all lower-case or all upper-case, as applicable), misspellings corrected, and where characters with similar appearance are mapped. An example of the latter is that the digit 0 is mapped to the letter O whenever surrounded by letters. Some characters are also mapped to multiple other characters. For example, the digit 1 is mapped both to a capital i and a lowercase L in the context of other letters, e.g., “F1ash Bank” is replaced by “Flash Bank” and “Fiash Bank.” This replacement can be performed in a local copy of the message being evaluated, and can also be performed implicitly by determining whether either of the two resulting terms is an existing term associated with any rule.

Friendly/display names and email addresses can similarly be parsed to determine matches (e.g., using collection of terms rules, equivalence analysis, etc.). For example, a friendly/display name can be parsed by breaking the string into components, where the components are words and non-word characters, and where these components are compared to the components of a collection of terms rules. For example, one such rule can specify the terms “ACME” and “Bank,” which would cause all of the following friendly/display names to trigger the rule: “ACME BANK,” “AC ME BANK,” “BANK OF ACME,” “aCME BANK,” etc. By including misspellings in the equivalence classes of “Bank,” the following friendly/display names would also trigger the rule: “ACME Banking,” “ACME Bankers,” “ACME Bnk,” etc. In some embodiments, the distance between a target authoritative entity name and a name in an email address or friendly address is computed and compared to a threshold, where the comparison triggers a rule if the difference is smaller than a threshold that may be specific to the authoritative entity. The distance measure can take a variety of forms, including, one of an edit distance, a Hamming distance, or a similar distance metric. In some embodiments, a support vector machine is used to detect friendly addresses and email addresses that are indicative of a given target authoritative entity, such as ACME Bank, after being trained with large numbers of common friendly/display names used by fraudsters to imitate the target authoritative entity. A support vector machine can also be used to identify human-readable content indicators associated with various authoritative entities, and trigger rules if a sufficient similarity (e.g., more than 75%) is detected.

In some embodiments, to parse message content, URL content, email address content, and/or friendly/display name content, a variety of pre-processing is performed on the content. One example is mapping images to text or labels using optical character recognition (OCR) techniques, which would map an image looking like the text “ACME” to the text “ACME,” or a label associated with ACME Bank. This way, attackers would not be able to evade the text parsing methods (e.g., based on identifying a collection of terms) by making some key terms non-detectable. Another example is to identify logos and map them to text or labels corresponding to the logos—such as mapping images bearing a sufficiently strong resemblance to the ACME Bank logo (e.g., using a threshold amount of 75%) to a text “ACME” and to a text “ACME Bank”, or to a label associated with ACME Bank. Another form of parsing is separating content into words or other components, including by identifying separating spaces, characters, change in colorization, and by identifying substrings that are recognized as words. For example, this would cause an input string “A-C-M-E B.a.n.k” to be replaced by “ACME Bank” as the separating characters (in this case - and .) are removed. An another example, consider a text “ARC-MOE! Boa nuke” in which some characters (“R-O ! o u e”) would be colored in the same or a similar color as the background, and the remaining characters (“A C M E Ban k”) would be colored in a substantially different and clearly visible color. In this example, the parsing would replace the characters that are hard to see with spaces or other separating characters, after which these would be parsed and removed, resulting in a text “ACME Bank” or corresponding label. Alternatively, these two processing steps can be performed together, automatically eliminating the separating characters that are not visible to a typical observer. Yet another form of processing is normalizing including case, spelling, and removing or normalizing punctuation.

An additional kind of normalization can further be performed, in which terms that are considered equivalent are mapped to one or more representative of the terms. For example, the term “login” may be considered equivalent to “log in” and “log-in”, and all three represented as “login”, or a label associated with this term. This extends beyond simple spelling variants; for example, the term “log in” may be considered equivalent to “respond,” “reply,” “let us know,” “update,” and “confirm,” even though these words do not have the same meaning. The equivalence would instead be based on how these different terms may be used by a scammer to achieve one and the same general goal, which in this example is to make the user react to the message, performing a action that includes typing her credential. Then, exclusion areas are identified, where these exclusion areas can be configured to include User Generated Content (UGC), headers, and service-provider specific exclusion areas. Anything within these areas is considered separately, or ignored. Then, the normalized terms from the non-excluded areas are processed to identify collections of terms, and the associated scores are computed. Given one or more such scores, an output score is computed. For each type of assessment (e.g., logo-based, collection of terms based, etc), a score is generated. In some embodiments, the result is a vector. For example, the vector can contain three elements, where the first is a logo-based score, the second is a collection of term based score, and the third score indicates the amount of apparent obfuscation was detected, where the latter may include the number of almost-invisible characters that were dropped. In one example, this score vector may be (55, 64, 32), where 55 is the score indicating to what extent the message contains logos that are similar to known logos of authoritative organizations, such as ACME Bank. 55 may correspond to a 55% certainty that there is such a logo. Moreover, 64 is the score from the collection of terms component, and indicates a badness of the message, which may be on another scale than 0 to 100, but in this example case is a number from 0 to 100. 64 is corresponds to the badness of one collection of terms that was found—where each collection corresponds to a number indicative of its perceived risk. Finally, 32 is the score indicating the estimated amount of obfuscation detected, where in this example case, four points is assigned to each character that is found to have been obfuscated, and 8 characters in this example were deemed to be obfuscated. The score vector (55,64,32) is then used to perform a security determination that may depend on user settings, settings by the user's bank, settings set by the system, settings set by the user's employer, and potentially other settings. In this example, the corresponding message is determined to be a scam. Other aspects of the message, such as headers and hyperlinks, can be reflected by elements of the vector. For example, one additional element of the vector may indicate the risk associated with the headers, and yet another the risk of at least one hyperlink. Yet other aspects of the message can be reflected in other parts of the score vector.

In some embodiments, platform 1600 outputs an array of scores, or a score vector, containing identifiers associated with authoritative entities and scores associated with authoritative entities, for scores exceeding a threshold minimum score required to be reached in order for the authoritative entity identifier to be included in the output. In this scenario, the content of the message is the message (i.e., not counting the headers), and human-readable refers to content that is understood by typical human users, such as texts and logos (as contrasted with complicated URLs).

One example of a machine-readable indication that a message is not associated with an authoritative entity (e.g., determined as part of the assessment performed at 2106) is the absence of a digital signature expected to be present in a message from the authoritative entity, and associated with the authoritative entity. For example, if ACME Bank typically authenticates all of its outgoing messages with DKIM (which is an industry standard), but a given message is not authenticated with DKIM, or is authenticated using another organization's DKIM key, or using an expired or revoked or known leaked DKIM key, then this is an indication that the message is not from ACME Bank. Information pertaining to ACME Bank's use of DKIM can be stored in database 1616 or any other appropriate location, and, as with other content stored in database 1616, can be obtained/provided by a third party (e.g., on behalf of multiple authoritative entities) and can also be supplied by a representative of ACME Bank (e.g., a network administrator). As another example, suppose that ACME Bank commonly sends messages that contain hyperlinks to a small set of domains, such as domains that they own or operate, or which are owned or operated by collaborators of or vendors associated with ACME Bank. As with other information associated with ACME Bank, the list of collaborator/vendor domains can be included in database 1616 for use in analysis of messages by platform 1600. If a message has at least one hyperlink that is not associated with such a domain, then this can be indicative of the message not being sent by ACME Bank. Further, platform 1600 can determine degrees of certainty of such a mismatch, e.g., if a message contains a hyperlink to a webpage that is not associated with a given authoritative entity, such as ACME Bank, but where the webpage hosts content indicative or reminiscent of ACME Bank, then this can be used as a sign of abuse. If the hyperlink is associated with a domain that is not a well-known and respected domain in a business that could potentially be associated with ACME Bank, then that can also be used as a strong indication of abuse, albeit less strong than as an obvious phishing page. Platform 1600 can output a score associated with the lack of machine-readable association with one or more authoritative entities (e.g., at 2106 in process 2100), and used as an indicator of the probability that the content is not related to the authoritative entity (e.g., at 2108 in process 2100).

Suppose that if a communication contains the term “ACME Bank” and any hyperlinks, then a risk score is increased by 75 points. Further, if the text associated with the hyperlink contains at least one of the terms “log,” “login,” “log-in,” “access account,” or “my account,” then the score is increased by an additional 20 points. If the message contains an image or hyperlink to an image matching the logo of “ACME Bank,” (e.g., using image matching techniques described above) then the score is increased by another 50 points. Similarly, if a communication contains the term “your bank,” and at least one of the terms “emergency,” “immediately,” or “within 24 hours,” then the score is increased by 25 points. In this scenario, messages start out being assessed a neutral score, such as zero. Depending on the score associated with the scanning of the content of a message, different actions are taken by platform 1600, such as allowing the message to be provided to the recipient, quarantining the message, alerting an administrator, etc. Further, as explained above, the rules, associated scores, and threshold values can be adjusted (e.g., by an administrator of platform 1600), whether on behalf of all users, or individual users, as applicable.

In some embodiments, some URLs are excluded from the scrutiny, such as URLs provided as UGC associated with the message. As one example, payment services, such as ACME Bank, may allow payers to include a message with a payment. Some authoritative entities may allow any form of UGC, including URLs and hyperlinks. The UGC element may always be located in an isolated portion of legitimate messages associated with the authoritative entity, and can be identifiable by being proceeded by a text such as “Message from payer”; have a maximum length; and only contain ASCII characters. In some embodiments, when an area matching such criteria is identified, the content of this area is excluded from the scan for machine-readable indications.

In some embodiments, platform 1600 determines one or more authoritative entities that the human-readable content indication of a message is associated with (e.g., at 2104), and determines whether the machine-readable indication is associated with one of these authoritative entities (e.g., at 2106). If so, then the message is considered legitimate (e.g., at 2108). If this is not so, and one of the authoritative entities that the human-readable content indication of a message is associated with is on a watch-list, then the message is considered high-risk (e.g., at 2108). In some embodiments, the risk is a value that is computed as a function of the scores corresponding to the human-readable content indicators and the scores associated with the machine-readable indicators, thus producing a probability assessment that the message is designed to deceptively appear to come from a sender that it does not come from.

Platform 1600 can also be used for other classification tasks, such as to classify received messages to organizations, e.g., to determine whom to send messages to. For example, some messages that are sent to a general mailbox should be delivered to sales, as indicated by containing terms such as “purchase,” “I would like to,” whereas others should be delivered to customer service, as indicated by containing terms such as “very angry,” and “lost.” In this example, “I would like to” belongs to an equivalence class with other members such as “I want,” and “very angry” belongs to an equivalence class that contains “upset,” “am pissed,” and common bad words. Unclassified messages are delivered to the general mailbox whereas messages classified based on their contents, as described above, are delivered to the proper department or person.

Platform 1600 can also be used to classify risk notification emails, such as the messages that are sent to a spoof@ACMEBank.com email address, which contain large quantities of phishing emails that are forwarded by users to help ACME Bank defend against such threats, and which also contain large quantities of messages with hyperlinks leading to dangerous webpages, and which also contain large numbers of legitimate messages that were misunderstood by end users to be high-risk. These messages can be automatically classified by platform 1600 or embodiments thereof (e.g., one operated by ACME Bank for such purposes). The use of this classification can speed up and improve the quality of the sorting, which might otherwise be performed using other, lesser-quality techniques, or even manual sorting. Depending on customizable factors such as the associated weight or risk probability values of classified messages, automatic actions are taken on some, such as responding to the sender with a message explaining that the message was not high-risk, and that it can be trusted, or escalating review of it inside the receiving organization or an organization receiving a feed of messages from the receiving organization.

Where the content portion of the message is assessed, but where the original sender information may not be available (e.g., if the message does not have long headers and the delivery path, DMARC information and/or other sender or delivery information is unavailable to be assessed), platform 1600 can generate an assessment based on previous and related messages, based on static system parameters, and based on indications that are still present, such as information about the mismatch between domain names used in hyperlinks and one or more institutions associated with the content portion of the message. For example, if the message contains words, logos (whether identical to or substantially similar to official entity logos), or references to either of these (indicating a relationship to ACME Bank), but hyperlinks indicate a relationship to at least one domain that is not associated with ACME Bank or which is not commonly associated with legitimate emails, then the sender assessment engine uses this information to make a classification and a risk assessment, in lieu of information regarding delivery path and DMARC information. Such information is also used in context where full or partial information about delivery path and DMARC data is available.

The following is an example of processing that can be performed by platform 1600. First, an electronic communication is received (e.g., at 2102 of process 2100). The message is normalized, and the evaluation of one or more rules matching the content of the message is performed, where collections of terms are used as well as determinations of images contained in or referenced by the message, as well as variants of such techniques. For each rule that is triggered, a descriptor and a score is generated. For example, suppose a message matches a first rule referred to as the “ACME Bank rule 1” and a score of 80 is assigned as part of the evaluation of the rule. This score depends both on the degree to which the message matches the template associated with the rule, and the severity of the rule being matched. Moreover, the same message matches a second rule, referred to as the “Generic Bank rule 45,” and a score of 40 is assigned. This score, too, depends on the degree to which various components associated with this rule are matched, and the score associated with those components, which in turn designates the severity of the rule being matched. This second rule may be a general version of the first rule, or may be unrelated to the first rule, as applicable.

Next, it is determined (e.g., at 2106) that the message is not sent by ACME Bank. It is also not sent by any whitelisted entity. In various embodiments, the whitelist is stored on platform 1600 or otherwise made accessible to platform 1600.

Next, a security determination is made (e.g., at 2108). Since the “ACME Bank rule 1” was triggered with a score exceeding a first threshold (e.g., which is set to 5), and the message was not sent by ACME Bank, then the message is filtered out and not delivered to any users who have opted in for removal of known bad messages (e.g., as specified in database 1602), and placed in the spam folder of all other users. In some embodiments, in addition, ACME Bank is notified (e.g., using information stored in database 216 along with other information associated with ACME Bank such as collections of terms and logos) once per day of the number of messages that were filtered out pertaining to it, along with the headers describing the delivery path of these messages. Further, since the “Generic Bank rule 45” was matched with an associated score of at least a second threshold set to 25, and the sender was not one of the entities on the whitelist, then the message is designated to be placed in the spam folder of all users (unless it already has a higher designation, which it does for some users due to the matching of the “ACME Bank rule 1” rule), and a regulator is notified of the number of such matches at the end of the month. The time at which the action (e.g., filtering out, notification, inclusion in statistics and notification) is associated with each security determination rule, such as those described above.

Additional examples of message classification using embodiments of platform 1600 are as follows:

A determination is made that a first example message is a phishing message. This is because first example message contains language that is commonly used in phishing emails.

A second example message is also determined to be a phishing message, based on the fact that it mimics a message associated with XYZ Bank, but is found not to have been sent by XYZ Bank. This is determined based on the fact that XYZ Bank supports DMARC (as known and recorded in database 1616), and therefore digitally signs all outgoing messages, but the second example message is not digitally signed by XYZ Bank.

A third example message is also identified as a phishing message, since it contains language and logos indicative of having been sent by ABC Savings, but the message delivery path is inconsistent with the third example message having been sent by ABC Savings. This is knowable since ABC Savings is a regional bank located in Oregon, and all ABC Savings messages are either sent directly by ABC Savings or one of their affiliates in Nebraska, and the delivery path of the third example message indicates that the third example message was originated in Alaska, and moreover, that one of the nodes on the message delivery path has a low reputation, indicating that it is commonly used by fraudsters. Again, information about ABC Savings' (and affiliates) servers/paths can be stored/maintained in database 216 or other appropriate location, as can reputation information about other entities such as about the low reputation node. Such information (e.g., reputation information) can also be obtained from a third party reputation service or other provider, as applicable.

A fourth example message is found not to be a phishing email, in spite of having a content portion that is identical to that of the first example message. The fourth example message, however, was associated with a valid digital signature indicating that it was sent by XYZ Bank.

A fifth example message also contains language associated with XYZ Bank, but it does not have any language indicative of being a phishing email. Instead, it is a message stating that the sender has a new bank, and wishing the recipient a Happy New Year. The fifth example message is not flagged as being a phishing message, but since it contains language specified by XYZ Bank, and associated with potential copyright/trademark infringement, it is flagged to be manually reviewed by an organization receiving flagged messages to review (whether associated with platform 1600, or as a separate service with which platform 1600 or embodiments thereof communicates). This organization determines that the fifth example message is harmless, and simply makes note of having processed the message. At the end of a billing period, XYZ Bank will pay a small amount associated with the review of the fifth example message by the organization.

A sixth example message is largely identical to the fifth example message, both in terms of the content portion and the sender portion, but is not reviewed by the review organization since the fifth example message was already reviewed. Instead, it is just counted so that it is included in the report sent to XYZ Bank. XYZ Bank will not have to pay for manual processing of the sixth example message.

A seventh example message contains language and imagery associated with potential copyright/trademark infringement. This is found by an automatic processing similar to that of the fifth example message, and a manual review by the review organization. After the review is completed, XYZ Bank is notified, and requests that the seventh example message and all identical messages (e.g., similar within a threshold of at least an 85% match) are bounced and not delivered.

For an eighth example message, an automatic review and a manual review determines that the message matches content ABC Savings has specified as problematic (e.g., containing trademarked phrases pertaining to ABC Savings and/or images associated with ABC Savings as stored in database 1616 by ABC Savings or its representative). The review organization notifies ABC Savings, which in turn sends a complaint to the sender of the eighth example message.

A ninth example message is a regular email sent by Alice to Bob, asking Bob if he wants to go to the movies. The ninth example message does not trigger any rules, and is therefore delivered to Bob.

A tenth example message contains an advertisement for a sexually explicit service, and is not allowed to be delivered to any recipients associated with Goody High School, according to rules specified by a representative of Goody High School on an embodiment of platform 1600. The embodiment of platform 1600 reviews the policies of Goody High School, and determines what rules are associated with this entity. A determination is made that the content portion of the tenth message contains language that matches at least one of these rules. Therefore, the tenth example message is not delivered, but bounced to the sender, with an explanation that the recipient does not allow sexually explicit material. A counter is also incremented, associated with the number of messages such as the tenth example message, that have been bounced during the last week, based on match the rule that the tenth example message matched.

An eleventh and twelfth example message contain identical content portions, which are product advertisements. Platform 1600 determines that the stated recipient of the eleventh example message has paid to avoid all commercial email, whereas the stated recipient of the twelfth example message has not. The content portion of the eleventh message is determined to be a commercial message, based on matching at least one rule associated with commercial content, and the eleventh message is not delivered. Since the eleventh and twelfth example messages do not contain spam poison, a hash identifier is computed and associated with this content. When platform 1600 determines that the stated recipient of the twelfth example message has requested not to receive any commercial email, it is verified whether the twelfth example message corresponds to the previously mentioned hash identifier. Since it is, there is no need to evaluate the rules on it, but the twelfth example message is determined to be unwanted, and is therefore not delivered.

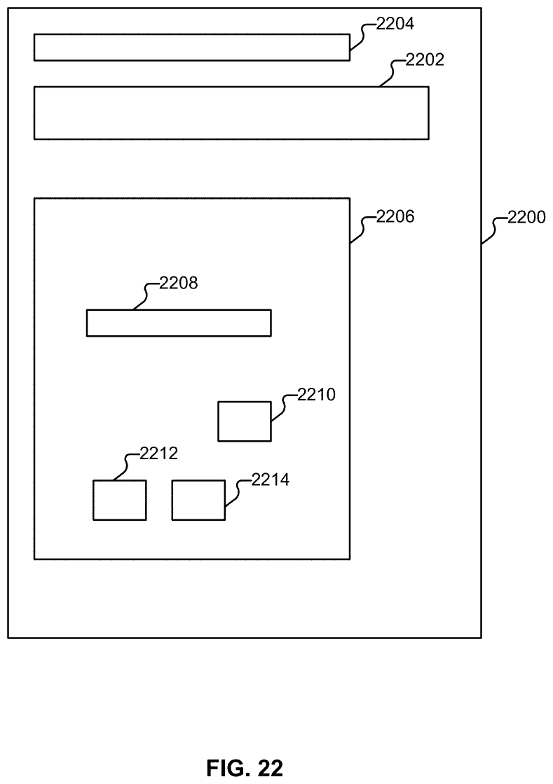

FIG. 22 illustrates an example of a legitimate message 2200 sent by Bank XYZ to a user such as Alice. Bank XYZ uses DMARC, corresponding to a machine-readable indication 2202 and a sender address 2204 associated with its domain. The content portion 2206 has text 2208 indicative of a funds transfer, a logo 2210 corresponding to Bank XYZ, and two hyperlinks 2212 and 2214 that go to a page in Bank XYZ's domain and a page in the domain of a mortgage affiliate of Bank XYZ, respectively. Platform 1600 will determine (e.g., at 2104) that there is a high likelihood (e.g., one exceeding a predetermined threshold, such as 75%) that a potential recipient of message 2200 will conclude the communication was transmitted on behalf of an authoritative entity (namely, Bank XYZ). Platform 1600 will also assess (e.g., at 2106) that there is a high likelihood (e.g., one exceeding a predetermined threshold, such as 65%) that the message was indeed transmitted by (or legitimately on behalf of) the purported entity (i.e., due to factors such as the presence of the DMARC information included in region 2202). Thus, platform 1600 would classify message 2200 (e.g., at 2108) as legitimate (e.g., based on the two likelihood scores).

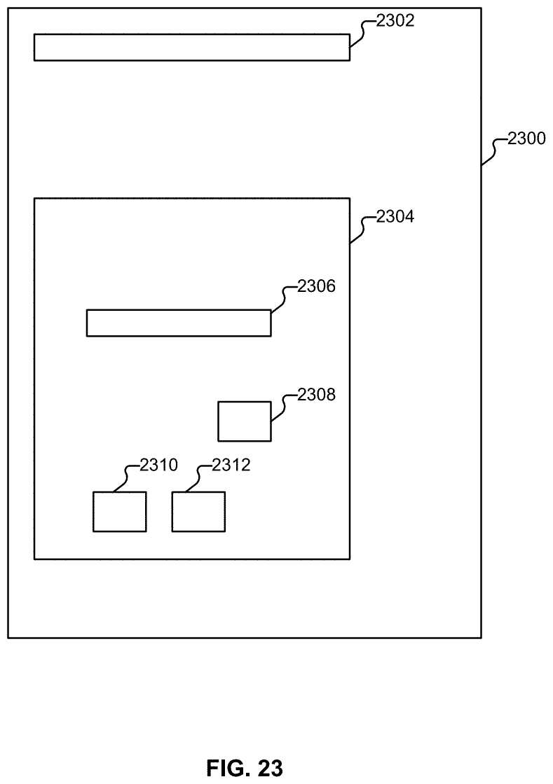

FIG. 23 illustrates an example of a scam message being sent by Hacker A to a user such as Alice. Hacker A does not use DMARC (and thus message 2300 is missing a section similar to section 2202 of message 2200). Hacker A uses a sender address 2302 associated with a domain he controls. The content portion 2304 has text 2306 that is similar to (or identical to it, as applicable) text 2208, indicative of a funds transfer, a logo 2308 closely resembling logo 2210 (or identical to it, as applicable), corresponding to Bank XYZ, and two hyperlinks 2310 and 2312 that lead to pages in Hacker A's domain. The first page (reached by link 2310) bears a strong resemblance to Bank XYZ page 2212. As with message 2200, Platform 1600 will determine (e.g., at 2104) that there is a high likelihood (e.g., one exceeding a predetermined threshold, such as 75%) that a potential recipient of message 2300 will conclude the communication was transmitted on behalf of an authoritative entity (namely, Bank XYZ). However, unlike with message 2200, platform 1600 will assess (e.g., at 2106) that there is a very low likelihood (e.g., 5%) that the message was transmitted by (or legitimately on behalf of) the purported entity (i.e., due to factors such as the lack of the DMARC information, and URLs leading to suspicious domains). Thus, platform 1600 would classify message 2300 (e.g., at 2108) as phishing (e.g., based on the two likelihood scores).

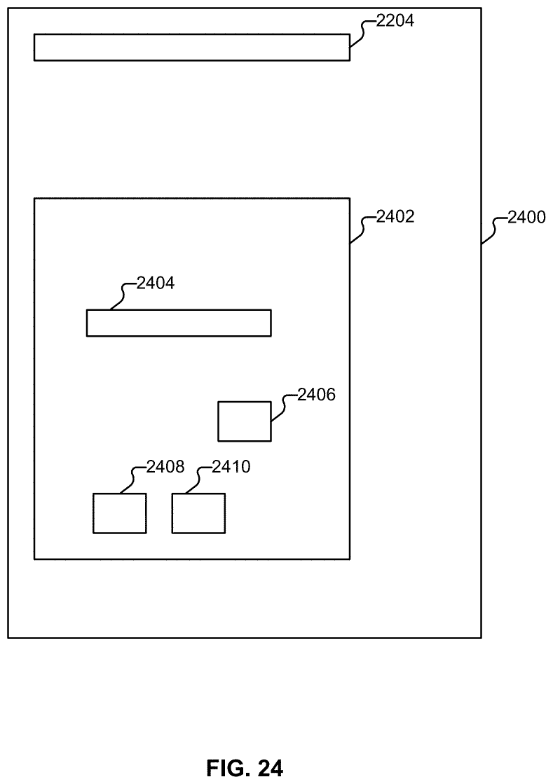

FIG. 24 illustrates an example of a scam message 2400 sent by Hacker B to a user such as Alice. Hacker B does not use DMARC. Hacker B spoofs Bank XYZ's sender address 2204. The content portion 2402 has text 2404 corresponding to text 2208, indicative of a funds transfer, a logo 2406 that maps to XYZ when input to an Optical Character Recognition tool, and two hyperlinks 2408 and 2410 that lead to pages in Hacker B's domain. The first page (reachable by link 2408) bears strong resemblance to Bank XYZ page 2212. As with message 2300, Platform 1600 will determine (e.g., at 2104) that there is a high likelihood (e.g., one exceeding a predetermined threshold, such as 75%) that a potential recipient of message 2400 will conclude the communication was transmitted on behalf of an authoritative entity (namely, Bank XYZ). And, as with message 2300, platform 1600 will assess (e.g., at 2106) that there is a very low likelihood (e.g., 5%) that the message was transmitted by (or legitimately on behalf of) the purported entity (i.e., due to factors such as the lack of the DMARC information, and URLs leading to suspicious domains). Thus, platform 1600 would classify message 2400 (e.g., at 2108) as phishing (e.g., based on the two likelihood scores).

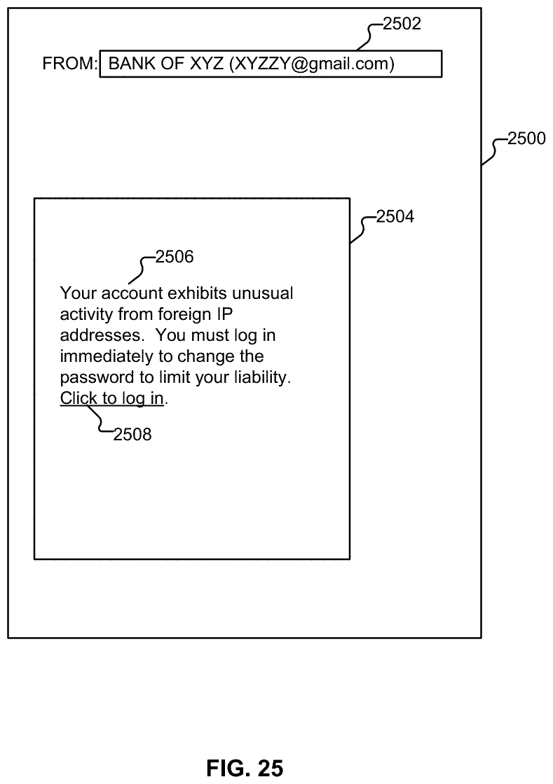

FIG. 25 illustrates an example of a scam message 2500 sent by Hacker C to a user such as Alice. Hacker C uses a friendly address 2502 that reads “Bank of XYZ” (but has an email address of XYZZY@gmail.com, which is not a legitimate email address the bank). The content portion 2504 has text 2506 that does not match any communication from Bank XYZ. The last sentence is hyperlinked (2508) and leads to a page controlled by Hacker C if clicked. As with message 2400, Platform 1600 will determine (e.g., at 2104) that there is a high likelihood (e.g., one exceeding a predetermined threshold, such as 75%) that a potential recipient of message 2500 will conclude the communication was transmitted on behalf of an authoritative entity (namely, Bank XYZ). Here, the determination will be based on factors such as the friendly address, and a collection of terms associated with a general banking story (having to log in to change a password). As with message 2400, platform 1600 will assess (e.g., at 2106) that there is a very low likelihood that the message was transmitted by (or legitimately on behalf of) the purported entity (i.e., due to factors such as the lack of the DMARC information, and URL leading to a suspicious domain). Thus, platform 1600 would classify message 2500 (e.g., at 2108) as phishing (e.g., based on the two likelihood scores).

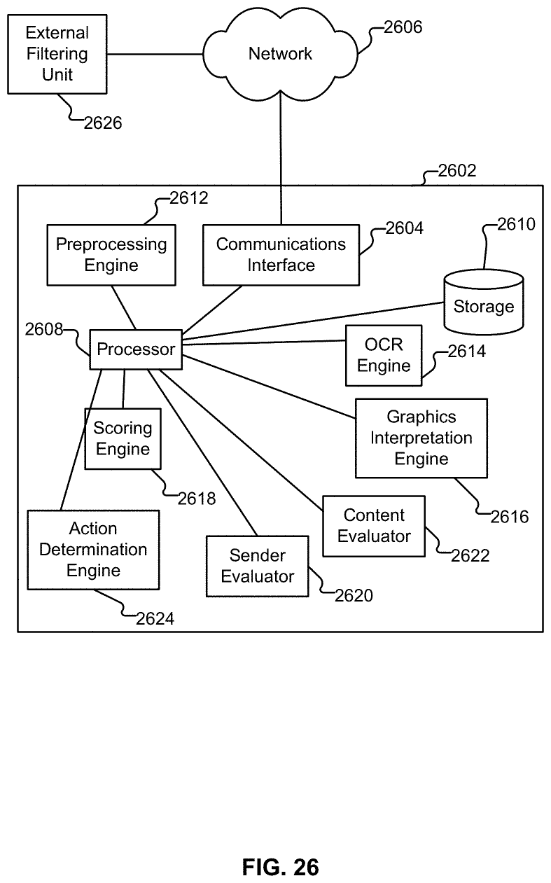

FIG. 26 illustrates an embodiment of platform 1600. Included in platform 2602 is a communications interface 2604, connected to one or more networks (depicted as a single network cloud 2606), and further including at least one processor 2608, a storage 2610, a preprocessing engine 2612, an OCR engine 2614, a graphics interpretation engine 2616 that processes images that contain non-text material and outputs a description, a scoring engine 2618, an engine 2620 that evaluates the sender information associated with messages, a content evaluation engine 2622 that determines matches between messages and rules indicating how portions of the messages would be interpreted by typical users, and an action determination engine 2624 that generates one or more recommendations of what to do with messages, where these recommendations are either consumed by processor 2608 performing a local filtering process, or communicated over network 2606 to an external filtering unit 2626.

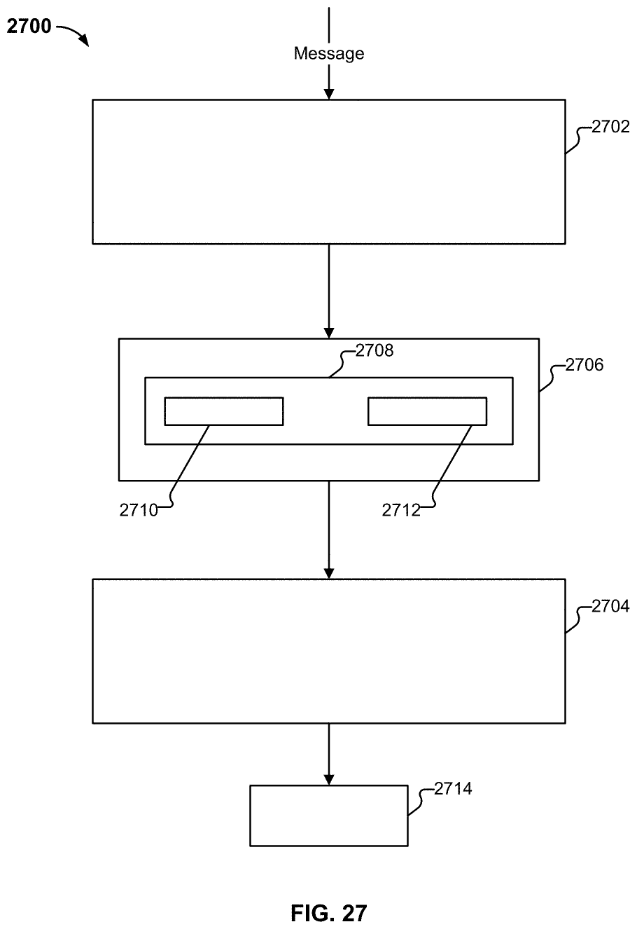

FIG. 27 illustrates an embodiment of portions of platform 1600. Included in platform 2700 are a component 2702 and component 2704. Component 2702 takes as input a message and produces as output a vector 2706 of pairs. Each pair, such as pair 2708, includes a domain indicator 2710 and a score 2712, where the domain indicator 2710 is a domain on a watchlist (e.g., watchlist 2908) and the score 2712 is an assessment of the extent to which the domain indicator 2710 is matched. For example, if the domain indicator corresponds to “ACME Bank” and this is a domain that is perfectly matched by the message, then score 2712 may be 100, where this is a score between 0 and 100. If the domain indicator is “ACME Bank” and the message contains a text “ACNE Dank”, then the score 2712 may be only 80, where 80 indicating the relative similarity with the domain indicator 2710 according to some measure, such as the edit distance, the Hamming distance, or a measure of how many characters were replaced by characters of sufficient similarity, where a list would contain that “M” and “N” are 90% similar, while “M” and “V” are only deemed to be 67% similar, and “M” and “Y” are only 44% similar, and so on. Using these assessments of similarity, a score 2712 is generated, e.g., by multiplying all the similarity measures with each other and outputting the resulting product as the score 2712. Component 2704 takes as input the vector 2706 and outputs a score 2714 indicating whether the email has machine-readable indicators corresponding to any of the domain indicators 2710, and where the score 2714 also has a component that represents score 2712. Here, score 2714 may be the maximum of the scores 2706 for all the different pairs of domain indicators 2710 and associated scores 2712. There would be multiple such pairs when there are multiple domains that are sufficiently similar to the message, where this similarity indicates the perceived risk that a user would believe that the message is associated with the domain. Component 2702 performs processing that corresponds to portion 2104 of process 2100, as described above, while component 2704 performs processing that corresponds to portion 2106 of process 2100.

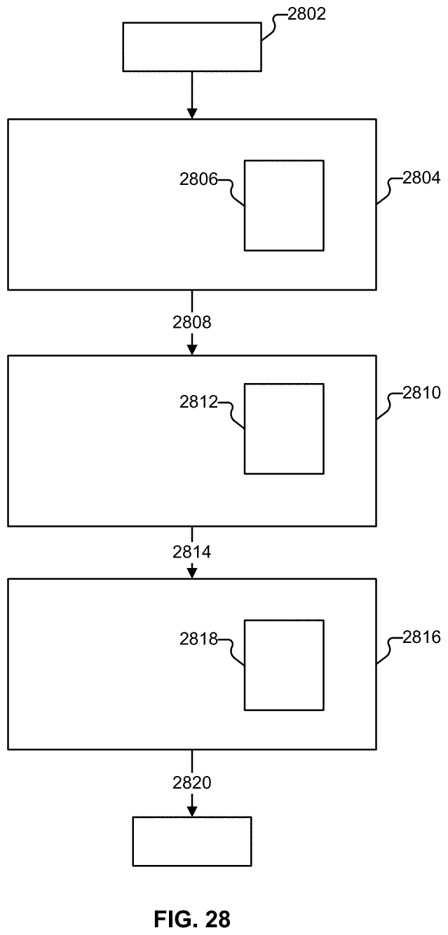

FIG. 28 illustrates an example of processing performed on a communication in some embodiments. A message 2802 is provided to a first component 2804. Component 2804 performs processing corresponding to portion 2104 of process 2100. Component 2804 includes a rule set 2806 that includes at least one of a collection of terms, rules associated with terms of the message content, the sender email address and the friendly address, images, and values used to generate risk scores as content elements are matched. Component 2804 uses (among other elements, as applicable) preprocessing engine 2612, storage 2610, OCR engine 2614, graphics interpretation engine 2616, scoring engine 2618 and content evaluation engine 2622. The output of component 2804 is a value 2808 that represents the result of the computation performed in component 2804, and which includes indicators of which rules were matched, and the associated scores that were computed. Component 2810 performs processing corresponding to portion 2106 of process 2100. Component 2810 includes a rule set 2812 associated with whitelisted authoritative entities, and is used to determine whether a message is sent by the apparent sender or not (e.g., based on a score indicating the likelihood). Component 2810 uses storage 2610, scoring engine 2618 and engine 2620 evaluating the sender information associated with messages. In component 2810, the apparent sender of the message 2802 is determined. In some embodiments, determination of the apparent sender of the message is informed by what rules were matched in component 2804, as indicated by value 2808. The output 2814 of component 2810 is information associated with message 2802, value 2808, and the determination whether the apparent sender is matched with the actual sender. This output 2814 is the input to component 2816, which includes a rule set 2818 that determines, based on the value 2808 and the output 2818 what actions to take. Component 2816 uses among other elements storage 2610, scoring engine 2618 and action determination engine 2624. The actions generated by action determination engine 2624 in component 2816 correspond to output 2820.

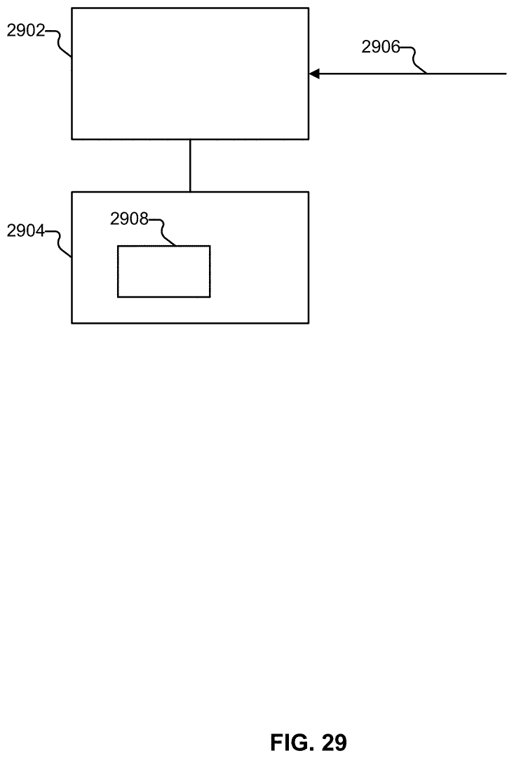

FIG. 29 illustrates components of an embodiment of platform 1600, including a processor 2902, a memory 2904 (which stores a whitelist 2908 and a program that executes an embodiment of process 1100). Also included in FIG. 29 is a communication channel 2906 used to receive messages.

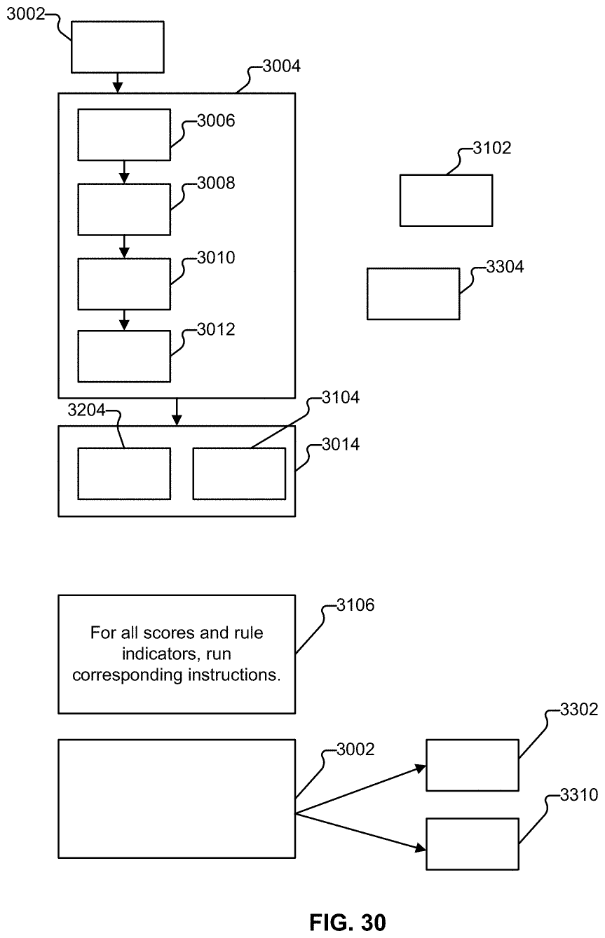

FIG. 30 illustrates an example embodiment of a workflow for processing electronic communications in accordance with various embodiments. An electronic message 3002 is received by platform 3004 (an embodiment of platform 1600). The message 3002 is processed by performing a mapping action 3006 in which graphical components are converted using OCR engine 2614 and graphics interpretation engine 2616. Mapping action 3006 produces descriptors from images such as logos and corporate images. The message 3002 is then processed by performing a normalization action 3008 using preprocessing engine 2612, followed by a replacement of equivalent terms action 3010 using content evaluator 2622. It is determined in an action 3012 whether the message 3002 contains any terms contained on a term watch list 3102 using content evaluation engine 2622. If any rule indicator 3104 is selected as a result of finding a term on the term watch list 3102, then it is determined whether the message 2802 matches the rule 3202 corresponding to the determined rule indicator 3104, using scoring engine 2618 and content evaluation engine 2622. If the message 3002 matches the rule 3202, then a corresponding score 3204 is generated, and output 3014 along with the associated rule indicator 3014. A message 3002 may contain terms matching multiple rule indicators 3104, and be correctly matched by several rules 3202. In some embodiments, a vector of scores and rule indicators is produced. Based on the rule indicators (e.g., 3014) that are produced, the corresponding instructions (e.g., 3106) are executed, using scoring engine 2618 and sender evaluator 2620. If the result of executing the instructions is an indication that the message matches what a legitimate sender associated with rule indicator 2602 transmits, then the corresponding score 2702 and associated rule indicator 3104 are removed from the output 3014. When all instructions have been executed, it is determined whether the output contains any score 3204. If it does, then processing transfers to a warning module 3304 that determines the action for the message 3002, using scoring engine 2618 and action determination engine 2624. Example actions include erasing the message, marking up the message by adding a warning or explanation, flagging the message, forwarding the message to a third party, such as verification service 3310, an ISP, or a repository associated with agent 3302.

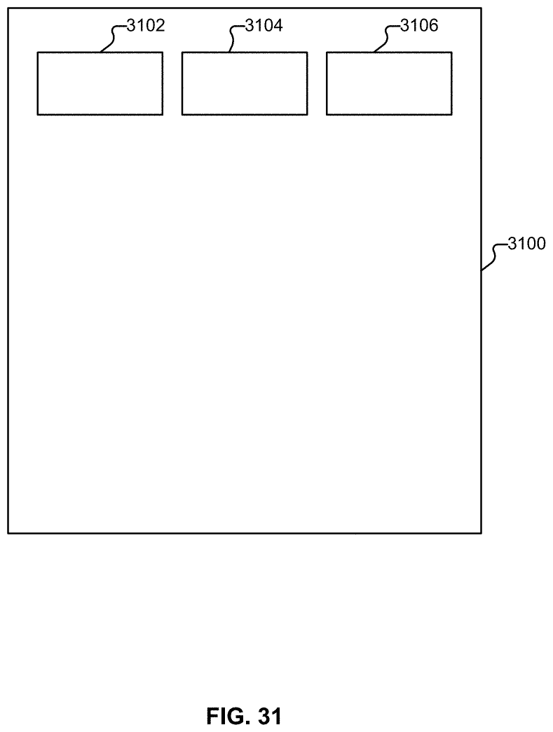

FIG. 31 illustrates an example term watch list 3100, containing at least one entry of a term 3102 and at least one collection of corresponding rule indicators 3104. It also contains instructions 3106 for determining what a proper message from an institution associated with the rule indicator 3104 (e.g., an authoritative entity) should contain. Some instructions 3106 select a DMARC indicator; other instructions 3106 specify from what domain, IP range, or similar the message must be sent; yet other instructions 3106 specify the contents of the message, such as whether they must only contain hyperlinks to some domains, of some formats, or whether there must be no hyperlinks. Yet other instructions 3106 require that the identified message be transmitted to a verification service 3310.

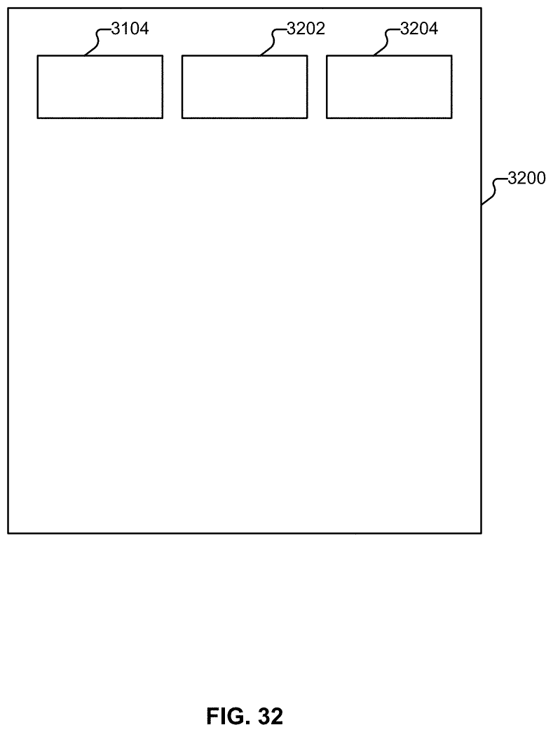

FIG. 32 illustrates an example rule list 3200 that includes a collection of terms 3202, a corresponding score 3204, and indexed by the rule indicator 3104.

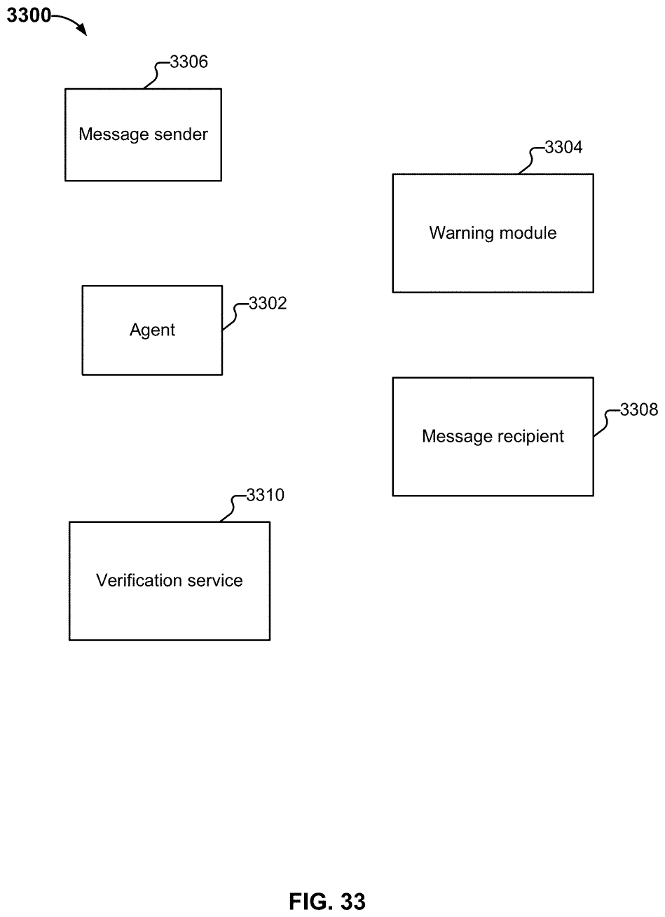

FIG. 33 illustrates an embodiment of an environment in which message classification is coordinated between a verification system and an agent. In particular, environment 3300 includes an agent 3302, which can be associated with a mail transfer agent, a milter, or a computer that processes a message for a user. Agent 3302 can for example reside on an end-user device or on a mail service provider server. Agent 3302 facilitates a verification, such as is described in conjunction with FIG. 30. Agent 3302 forwards at least a portion of at least some messages to verification service 3310, which processes the received information and makes a security determination. The agent may not forward messages from whitelisted senders, for example, and may not forward attachments. The agent may further truncate the messages before forwarding them. In addition, the agent 3302 can report security status information and message statistics to verification service 3310. Examples of message statistics include the number of messages received by the message sender 3306 to all users of the mail system within a set duration, and the time since message sender 3306 sent its first message that was observed by the agent 3302. It can also include statistics relating to what portion of messages sent by message sender 3306 were removed by agent 3302 or associated spam filtering systems due to matching one or more spam or scam filtering rules. The message sender 3306 corresponds to an account that originated the message processed in environment 3300. Sometimes, such as when a message is determined to be spoofed, it is not known what the identity is of the message sender 3306. The message is addressed to a message recipient 3308. This corresponds to an account or mail box where a message will be delivered, unless a decision is made to filter it out and not deliver it. The environment further includes a warning module 3304 and a verification service 3310. The verification service processes the received information (e.g., as described in FIG. 30), and makes a security determination that indicates that the message should be delivered, not delivered, deleted, not deleted, placed in a special folder such as a spam folder, or not, where these actions relate to the mail box associated with message recipient 3308. These actions are taken either by agent 3302 or verification service 3310, as applicable, causing the end-user's mail folder at 3308 to be updated accordingly. The verification service also is connected to the warning module 3304 which sends at least one warning to a user associated with message recipient 3308, a system administrator associated with the user, a user who has been approved to get alerts for this user, a service provider corresponding to a security service provider, law enforcement, an impersonated brand, or an organization that is collecting warnings and sending them to entities needing them, such as those listed above. The warning may be sent by email, by SMS or conveyed in another appropriate electronic manner. The warning can describe an individual email that was filtered out, or a collection or aggregate of such. It may also contain at least portions of the messages, information corresponding to the headers, and statistics related to the message, the message sender 3306, or other information relating to or explaining scam messages.

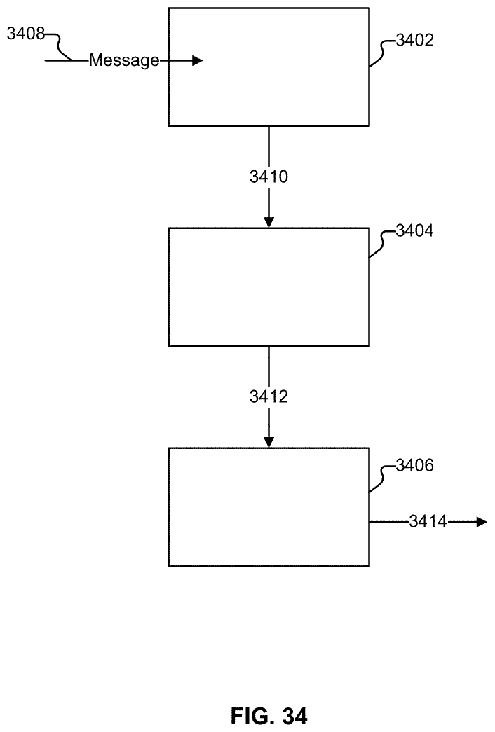

FIG. 34 illustrates an embodiment of a process that includes three tasks. At 3402, an input message 3408 is evaluated in terms of the content portion, generating at least one assessment 3410 of how the content is likely to be interpreted by a human recipient. The subtasks of 3402 correspond to portion 2104 of process 2100. The output 3410 is a list of interpretations and associated weights, where some interpretations are associated with corporate (or other authoritative entity) names, and where weights correspond to assessments of likelihoods that the associated interpretation is correct. At 3404, input message 3408, and interpretations and weights 3410 are used to determine whether the apparent sender of 3408, as indicated by the “from” field of 3408 and the interpretation(s) 3410 are likely to correspond to the actual sender of 3408. This task can be performed by analysis of the path associated with message 3408. It can also performed (in addition to or instead of) by analyzing the digital signature associated with message 3408, e.g., using DMARC, or determining the unexpected absence of a digital signature associated with message 3408, e.g., also using DMARC. The output 3412 of task 3404 is at least one determination based on the computation performed as part of task 3404. Based on output 3412 an action 3414 is taken as part of task 3406.

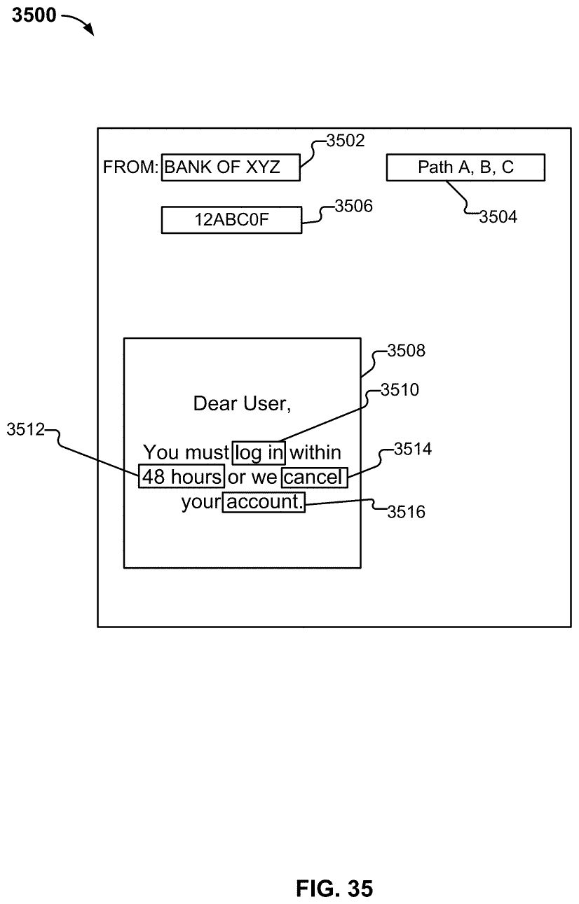

FIG. 35 illustrates an example message 3500. In the example shown in FIG. 35, message 3500 is processed using tasks 3402, 3404, and 3406. The message contains, among other things, a from field 3502, a path 3504, a digital signature 3506, and a message content portion 3508. The message content portion 3508 contains a first term 3510 that is “log in,” a second term 3512 that is “48 hours,” a third term 3514 that is “cancel,” and a fourth term 3516 that is “account.” Based on a rule (e.g., stored in database 1618), if a message content portion contains all of these elements, it is considered 95% likely to be a phishing email. The apparent sender of message 3500 is XYZ Bank, as indicated by from field 3502. The output 3410 of task 3402, when provided message 3500 as input message 3408, is an interpretation stating “phishing email” and “XYZ Bank,” and a likelihood that is 95%. As part of task 3404, it is determined whether message 3500, when provided as input 3408, is sent by XYZ Bank. This is done in some embodiments by determining whether signature field 3506 is present and corresponds to Bank XYZ. One reason this could be done is that occasionally, Bank XYZ may send out legitimate emails to its registered users containing terms matching terms 3510, 3512, 3514, and 3516—for example, when warning users of phishing emails, and providing an example of a common phishing email. In this scenario, the computation in task 3504 determines that the digital signature component 3506 does not correspond to the organization indicated in output 3410, i.e., XYZ Bank. The determination 3412 is that the message 3500, provided as input 3408, is a phishing email targeting potential users of XYZ Bank with a very high probability. The probability reported in this example is 97% since the path 3504 also is indicative of fraud, since one of the nodes in the path is known to have been corrupted by malware in the recent path. The action 3414 taken as part of task 3406 is to filter out message 3500 and place it in the user's spam folder, and to notify Bank XYZ later in the day of the number of emails with content portion matching terms 3510, 3512, 3514, and 3516, of which message 3500 was one.

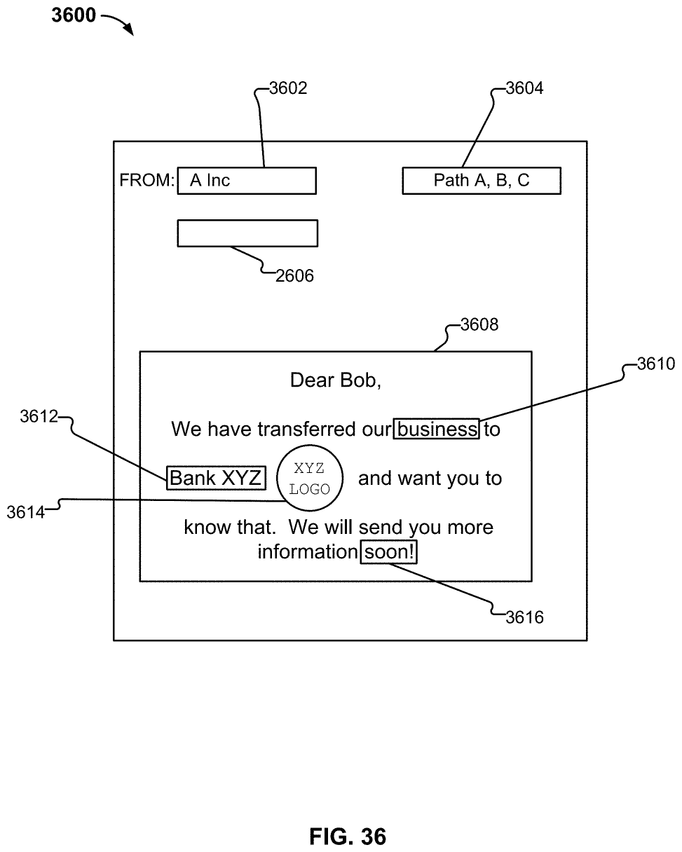

FIG. 36 illustrates another example message 3600. This is a message appearing to be sent by “A Inc,” as shown in from field 3602. The path 3604 is consistent with message 3600 being sent by A Inc, and does not contain any nodes with a bad reputation. The message 3600 has an empty signature field 2206. The message content portion 3608 contains several terms that are indicative of fraud. It contains a first term 3610 that is the word “business,” a second term 3612 that is “Bank XYZ,” a third term 3614 that is an image corresponding to the logo of Bank XYZ, and a term 3616 that is the word “soon.” Suppose, for purposes of this example, that no collection of terms match these four terms. As a result, assessment 3410 of message 3600 (when message 3600 is an example of message 3408) contains “phishing,” “XYZ Bank,” likelihood measure 4%. It also contains “Unauthorized use of corporate logo”, “XYZ Bank”, likelihood measure 50%, based on a rule that states that any mention of Bank XYZ and use of its logo is likely to be unauthorized, except if it is sent by Bank XYZ. Task 3404, when provided message 3600 as input determines that the message 3600 is not likely to be spoofed, in spite of the absence of signature 3606, since the apparent sender 3602 is not known always to digitally sign its outgoing messages. It is also determined not to be likely to be spoofed based on that the path 3604 does not contain any node that is known to be bad. The determination 3412 output from task 3004 when provided message 3600 as input 3408 is “Unauthorized use of corporate logo,” “XYZ Bank,” “A Inc,” likelihood measure 90%. The likelihood is 90% since it is determined that the sender is not XYZ Bank. It is not 100% since XYZ Bank has authorized some entities to use its logo, but (in some embodiments) the embodiment of platform 1600 performing the processing does not have access to this list. The action 3414 generated as part of task 3406 is a notification to Bank XYZ describing how many messages were processed that were sent by A Inc and which used Bank XYZ's logo, along with a copy of one such message, for officers of Bank XYZ to use as evidence if they want to file a complaint with A Inc. However, the actions (in this example) do not contain an order to filter out the message.

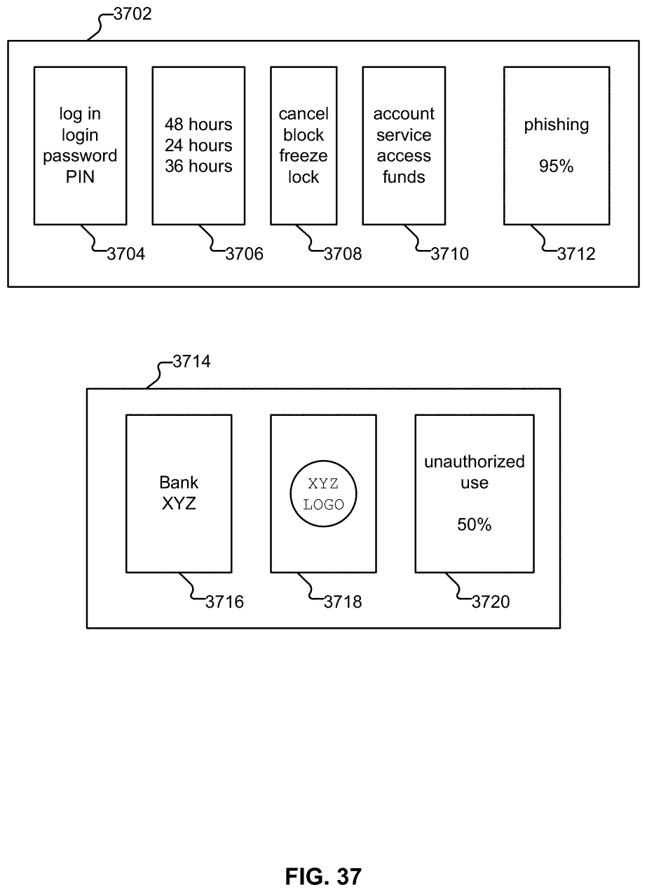

FIG. 37 illustrates two example rules. In various embodiments, the rules are used by content evaluation engine 1608, content evaluator 2622, or other appropriate analysis engine (e.g., using collections of terms) as applicable. The first rule 3702 corresponds to the rule triggered in the example described in FIG. 35. A first list 3704 contains the terms “log in,” “login,” “password,” and “PIN.” In some embodiments, if a message content portion contains any one the words in list 3704, then it is considered to contain the term corresponding to list 3704. A second list 3706 contains the terms “48 hours,” “24 hours,” and “36 hours.” If a message content portion contains any one the words in list 2706, then it is said to contain the term corresponding to list 3706. A third list 3708 contains the terms “cancel,” “block,” “freeze,” and “lock.” If a message content portion contains any one the words in list 3708, then it is said to contain the term corresponding to list 3708. A forth list 3710 contains the terms “account,” “service,” “access,” and “funds.” If a message content portion contains any one the words in list 3710, then it is said to contain the term corresponding to list 3710. If a message content portion contains at least one term included in each one of lists 3704, 3706, 3708, and 3710 then it is determined to be a phishing email with probability 95%, as indicated in item 3712, which corresponds to the interpretation of the rule being matched. The second rule 3714 contains a list 3716 with only one element, which is “Bank XYZ” and a list 3718 that is used to identify the logo of XYZ Bank. List 3718 can contain an image, a reference to an image, and/or a descriptor of an image. If a message content portion has terms containing elements from both lists 3716 and 3718, then the output that is generated is that described in element 3720, which is that the message is 50% likely to be an “unauthorized use” message.

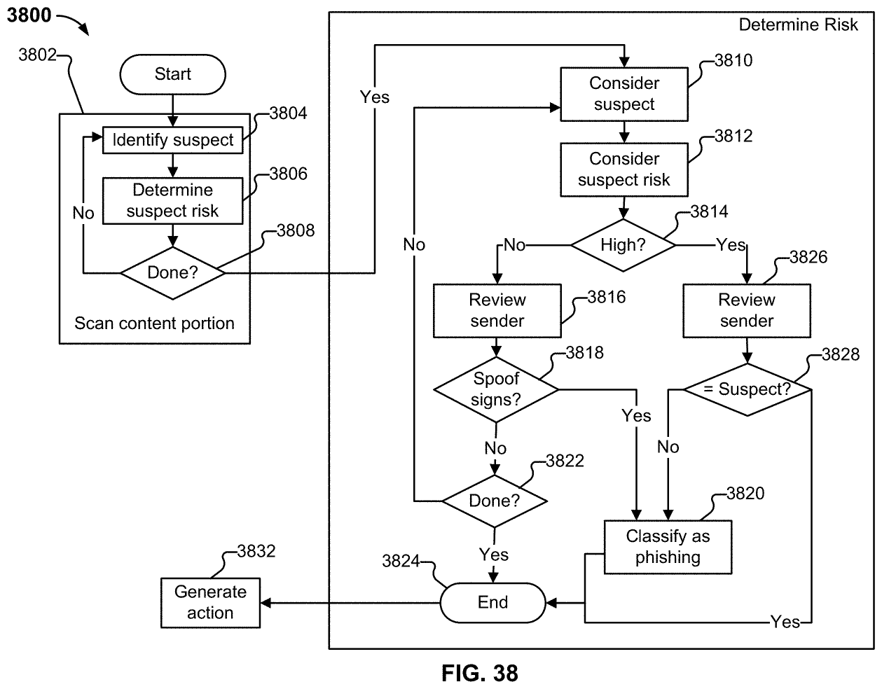

FIG. 38 illustrates an example embodiment of a process for classifying a message. In some embodiments, process 3800 is performed by platform 1600 or portions/embodiments thereof. The process starts at 3802 with the examination of the content portion of the input message. In particular, a first suspect is identified (3804). As one example, if the input message is the message 3500, then the first suspect is XYZ Bank, obtained from field 3502. The suspect risk is also determined (3806). Returning to message 3500, the risk associated with the identified suspect is 95%, based on the example rule described in FIG. 37. It is determined whether there are any more suspects (3808). For example, the input message may contain multiple corporate names (or names of other authoritative entities), or multiple indications that suggest that a message belongs to a particular category of interest. Each one of these generates a suspect and a risk value, corresponding to output 3410. After all suspects have been identified using the available rules, a first suspect is considered at 3810. For this suspect, the associated risk is considered (3812). If the risk is higher than a threshold then the sender is reviewed in 2826, otherwise it is reviewed in 3816. These different reviews differ in scope for some implementations, but are the same in this example. In some embodiments, the threshold used in comparison 3814 is a system parameter, set by a user, set by an authoritative entity, or automatically adjusted based on previous processing. In some embodiments, at 3826, the sender is reviewed using a DMARC verification if the identified suspect supports DMARC, and by determining whether there are inconsistencies in the delivery path otherwise. It is determined at 3828 whether the sender information corresponds to the suspect. If there is a correspondence, then the message is considered valid, and the process concludes. An output is generated indicating that the message is considered valid. On the other hand, if there is no correspondence at 3828 then the input message is considered a phishing message 3820, and an output indicating this conclusion is generated (e.g., at 3828). At 3816, the sender information is reviewed using a DMARC verification if the identified suspect supports DMARC, and by determining whether there are inconsistencies in the delivery path otherwise. In an alternative example, there is no DMARC verification performed at 3816, but only a review of signs of spoofing, including determining whether there are delivery path inconsistencies, use of nodes that are associated with a low security reputation, or a technique such as greylisting, indicates that the message may be spam or spoofed. At 3818, it is determined whether there are any signs of spoofing. If there is then the input message is classified as a phishing message (3820), otherwise it determined (3822) whether all suspects have been processed. If they have not, then the next suspect is selected (3810).

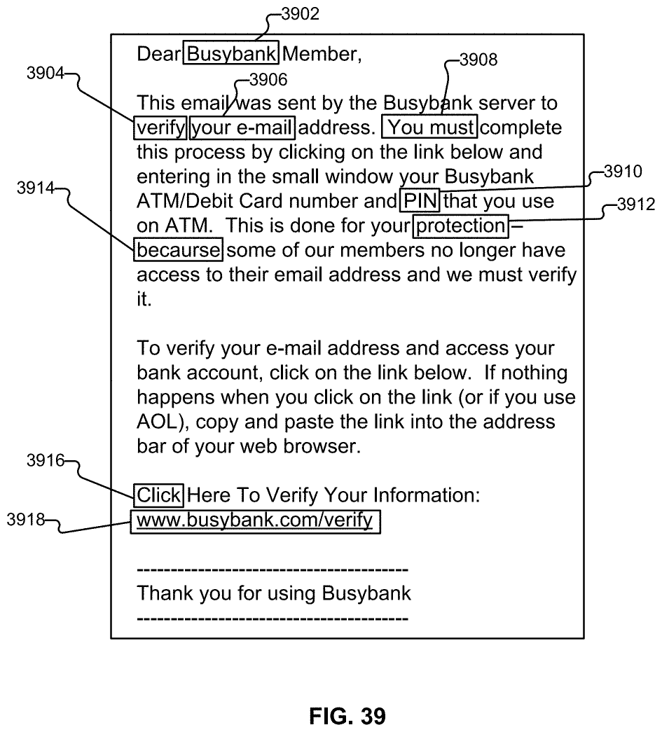

FIG. 39 illustrates an example content portion of an email that is a phishing email. It contains the following terms: Term 3902 is “Busybank,” term 3904 is “verify,” term 3906 is “your e-mail,” term 3908 is “You must,” term 3910 is “PIN,” term 3912 is “protection,” and term 3916 is “Click.” Text 3918 has the format of a link but corresponds to a hyperlink of another domain than indicated as text in term 3408. Element 3914 is an incorrectly spelled word. This message matches a rule that can be described as (“bankname,” “verify,” “your email,” “demand,” “PIN,” “security”). Here, the term “bankname” is a member of an equivalence class containing all bank names tracked by this rule, including “Busybank.” Other bank names, such as ACME Bank (and permutations, as applicable, such as ACMEBANK and ACMBank can also be included). The term “verify” is a member of an equivalence class containing the terms “verify” and “confirm.” The term “your email” is a member of an equivalence class with the terms “your email,” “your information,” “account,” and “your personal.” The term “PIN” is a member of an equivalence class containing “PIN,” “password,” and “credentials.” The term “security” is a member of an equivalence class containing “security,” “safety” and “protection.” In a pre-processing phase of the processing of the message and the rule, all capital letters in the message are replaced with lower case, and normalizations are performed, including replacing “e-mail” with “email.” Therefore, the message shown in FIG. 25 is matched by the rule (“bankname,” “verify,” “your email,” “demand,” “PIN,” “security”). The message is also matched by a second rule that can be described as “contains(bankname) and (contains(mismatchdomain) or contains(spellingmistake),” which means that if the message contains a term that matches an item of the equivalence class containing “bankname” and it either contains a hyperlink and an apparent URL where the domains do not match, or contains a spelling error, as judged by a word being of a format that is not consistent with spelling rules, which corresponds to common misspellings, or which does not match any item from a database of correctly spelled words. This rule is satisfied by terms 3902 and 3918, and also by terms 3902 and 3914. Thus, both of the example rules described herein are triggered. The first one is associated with a risk measure or weight that is 100, which indicates near-certainty, and the second one is associated with a risk measure or weight that is 75, which indicates high probability. As a result of the first rule being matched, an output is produced, where this output is ((“BusyBank,” 100, rule1), (“Busybank,” 75, rule2)). Here, the first item of each triple is an identifier describing what the affected brand is for the rule that was triggered; the second item is the weight that indicates risk, and the third item is the number of the rule, where both rule1 and rule2 belong to a group of rules that track phishing.

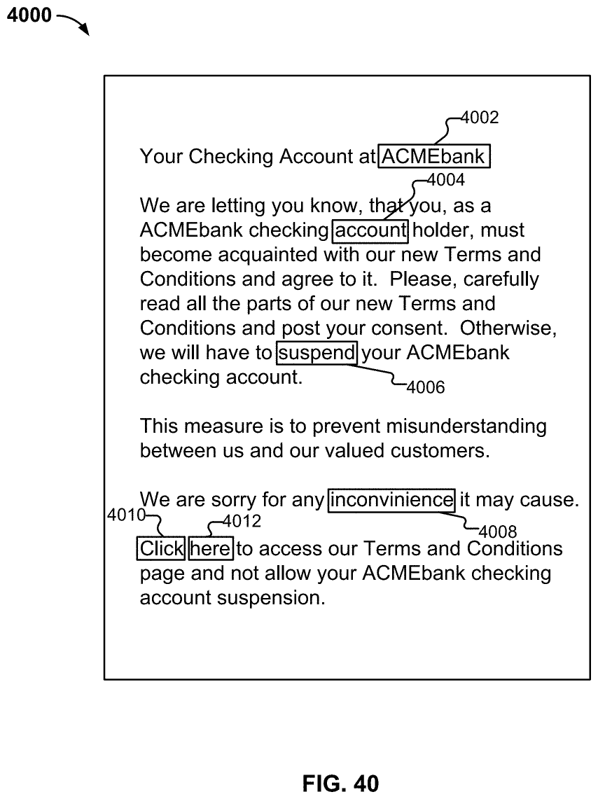

FIG. 40 illustrates a second example content portion of an email that is a phishing email. It contains term 4002 which is a member of the “bankname” equivalence class described in conjunction with FIG. 39. Message 4000 also contains a term 4004 “account” which is a member of the equivalence class containing the term “your email,” also described in conjunction with FIG. 39. It further contains a term 4006 “suspend” which is a member of an equivalence class containing “suspend,” “suspension,” “freeze,” “cancel,” and “block.” It contains a text segment 4008 that is an incorrectly spelled word. It contains a term 4010 that is “Click” and which is not associated with any other terms in an equivalence class. Finally, it contains a clickable text segment 4012 for which the associated domain is not on a whitelist maintained by the filter authoritative entity. The message matches the second rule described in conjunction with FIG. 39, which is the rule “contains(bankname) and (contains(mismatchdomain) or contains(spellingmistake).” This is because it contains a bank name and a spelling error. A third rule that is described by (“account,” “suspend”) is also matched. This third rule corresponds to a risk-associated weight that is 64. As a result, the matching of these rules produces an output that is ((“ACMEbank,” 75, rule2), (“ACMEBank,” 64, rule3)). Thus, in spite of “bankname” not being part of rule 3, it is output in this example. However, if the message were not to contain any term matching a bank name, then only rule three would have triggered, and the output would have been ((empty, 64, rule3)), where empty is an indication that no bank name was identified.

Collection of Terms

Overview

“Collection of Terms”—The co-occurrence of certain terms from separate domains in a message can be indicative of a fraudulent message that corresponds to a particular scam scenario (described in more detail below). As one example, a message that contains the term “MCTN” (a term specific to Western Union) and also the term “Google Wallet” is indicative of fraud. Scammers frequently offer to send fake Google Wallet payments and request money back using Western Union. The two terms are extraordinarily unlikely to co-occur in a legitimate email discussion. However, a term such as “Google Wallet,” by itself, could be prevalent in legitimate emails; a blanket blacklisting of the term is likely to result in far too many false positives (flagging legitimate messages as scam messages) to be tolerated by users being protected. The presence of a collection of terms in a message almost certainly indicates the message is fraudulent. Another example collection of terms is: “Internet Lottery,” “your email has won,” “congratulations,” and “million dollars.” The last term, “million dollars” is also considered present in a message if any so-called equivalent terms are present; such terms may consist of a list “millions dollars”, “million pounds”, and “several millions.”

“Indicating Terms”—Terms that are statistically common in scam communications and uncommon in legitimate communications. “Internet” and “your name” are not indicating terms, as they are very prevalent in legitimate communications. “Abacha,” however, is virtually absent from legitimate communications but prevalent in scam communications. Additional examples of “indicating terms” include “modalities,” “no risk,” “($*,000,000)” where * denotes an arbitrary value. The absence of any indicating terms in a message almost certainly indicates that the message is benign.

The presence of a collection of terms in a message almost certainly indicates the message is fraudulent, and the absence of any indicating terms in a message almost certainly indicates that the message is benign. Accordingly, in some embodiments, evaluation of a communication is performed using a collection of terms, and a classification (e.g., scam or not scam) or score is determined.

In some embodiments, quick classifier 1604 and detailed classifier 1612 cooperate to perform tertiary classification of messages. In other embodiments, at least some portion of the time, the classifiers use a “collection of terms” to classify communications (e.g., as fraudulent or not) and do not perform tertiary classification. In various embodiments, a single classifier is included in platform 1600 (e.g., quick classifier 1604 is omitted, and detailed classifier performs any functionality otherwise provided by quick classifier 1604).

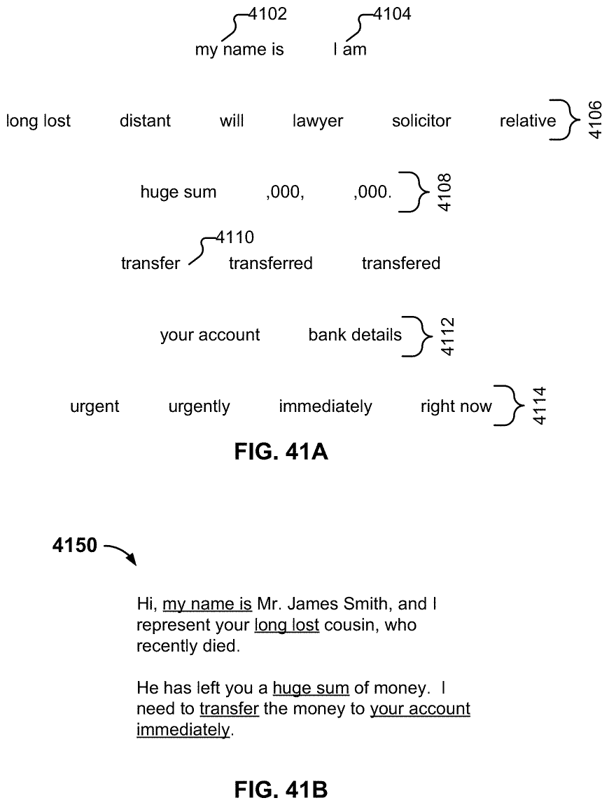

FIG. 41A illustrates an example of a collection of terms. In particular, FIG. 41A provides an outline of a particular form of scam that is perpetrated by 419 scammers—trying to convince the victim that he or she is entitled to a large sum of money as an inheritance, and that the money will be provided as soon as the victim pays a small fee. Although the main points of the message will be common across all such scam messages conforming to the “story” the scammer is trying to trick the victim into believing, the actual wording of the scam message may vary from message to message (e.g., to thwart detection, because the message has a particular author with a distinctive writing style, or because the message was written in a first language and translated to a second). Further, subtle variations may occur due to writing problems such as misspellings.

Each row in the collection of terms depicted in FIG. 41A corresponds to one aspect of the inheritance scam story. Where multiple terms appear on a given row, the terms are collectively referred to as an equivalence class—terms that fulfill the same purpose if used in the story. For example, the particular scam represented by FIG. 41A typically begins with an introduction of either “My name is” (4102) or “I am” (4104). The scam will next invoke a long-lost relative (or their representative). Equivalence class terms for this aspect of the story are shown in region 4106. Next, the scam will describe the large amount of money (in one of three formats shown in region 4108) that can be collected by the victim in one of three formats. The scam then indicates that all that is required for the victim to receive the money (e.g., “transfer” 4110) is for the victim to provide banking details (see region 4112 for terms). The victim is encouraged to provide the banking details right away (see region 4114 for terms), e.g., to minimize the likelihood the victim will tell a friend or relative about the email and be discouraged from providing payment information.

FIG. 41B illustrates an example of a fraudulent message that would be detected based on analysis by a content evaluation engine of the collection of terms depicted in FIG. 41A. The terms in message 4150 that are present in the collection of terms of FIG. 41A are underlined. In some embodiments, which term in an equivalence class is used in a message (e.g., “My name is” vs. “I am”) is not taken into account when evaluating the message. In other embodiments, different terms receive different scores. As one example, “huge sum” might be scored higher (i.e., indicating the message is more likely to be fraudulent) than “,000.”

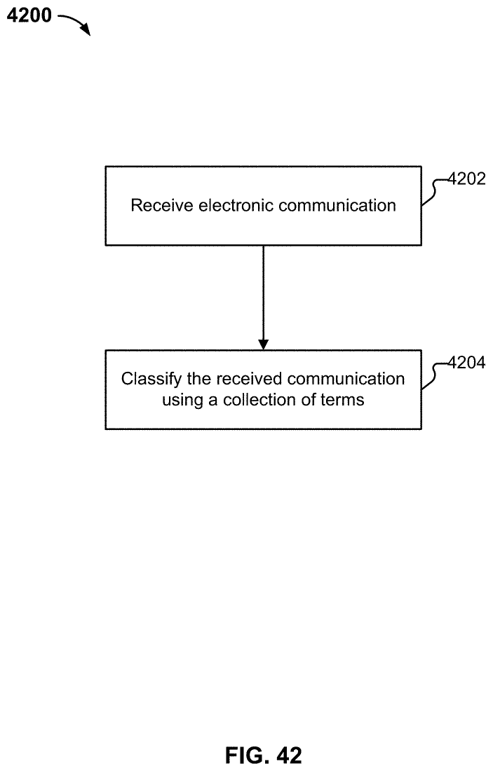

FIG. 42 illustrates an example embodiment of a process for classifying communications. The process begins at 4202 when an electronic communication is received. As one example, a communication is received at 4202 when a web mail service 1512 (e.g., which includes at least some components of platform 1600) receives a message from Charlie addressed to Alice. As another example, where at least some of the functionality performed by platform 1600 is incorporated into a mail client installed on Bob's laptop, the mail client could receive a communication at 4202 when Bob's mail client contacts a corporate mail service 1514 to retrieve new mail (e.g., via IMAP).

At 4204, the communication is classified using a collection of terms. As explained above, in some embodiments the communication might be definitively classified as “good” or “bad” based on the analysis of the message against the set of collections of terms 1628. In other embodiments, the collections of terms analysis is one consideration among multiple considerations (e.g., the additional example considerations listed above). In various embodiments, the distance between at least some terms appearing in the message is taken into account when determining whether the message should be marked as fraudulent based on the presence in the message of a collection of terms. As one example, while presence of the terms, “Nigeria” and “senator” in the same short message may typically indicate that the message is fraudulent, the message is likely not fraudulent where the terms are separated by 5,000 characters.

The classification performed at 4204 can be performed using a variety of techniques. For example, a collection of terms can be evaluated using a rule-based approach (e.g., testing for the presence of words, and/or applying a threshold number of words whose presence are needed for a match to be found); using a support vector machine, where the elements of the support vector corresponds to terms or words; and/or using general artificial intelligence methods, such as neural networks, wherein nodes correspond to terms or words, and wherein the values associated with connectors cause an output corresponding essentially to a rule-based method. In each of the aforementioned embodiments, a value associated with the severity of the collection of terms being identified can be generated and output, where multiple values are generated if multiple collections of terms have been identified.

Additional Information Regarding Collections of Terms

In some embodiments, each term (or its equivalent) must appear in the message in the order it appears in the collection. Thus, using the example of FIG. 41A, in some embodiments, if “transfer” appears before “huge sum” in a message being analyzed, the message will not be flagged as a scam, because the ordering in the collection of terms is reversed. In other embodiments, order of terms does not matter, e.g., so long as at least one term from each line of the collection shown in FIG. 41A is present in the message, the message will be classified as an inheritance scam.

In some embodiments, an analysis platform maintains scores associated with each collection of terms. One such value indicates, for each type of scam, how successful the associated term collection is at matching fraudulent emails making use of that scam. Based on factors such as the concern for various types of scams, and based on computational limitations, a selection of which term collections are to be used can made, e.g., where processing is performed on a device with limited resources, such as a phone.

A second value associated with each collection of terms indicates the risk for false positives associated with the term collection, in the context of a given user. Example ways to determine the value is by scanning the user's inbox; by letting the user identify his or her normal activities; and/or by running the system for some amount of time; and determining the value based on classification of uncertain cases by human reviewers who review messages and classify them. This second value can also be used to select collections of terms, e.g., to avoid term collections that lead to higher false positive rates than a particular user find acceptable.

Both values can be configured based on the preferences of the protected user, and on the service level of the user (e.g., where users with higher service levels are given higher computational effort). In some embodiments, a collection of terms is matched to a portion of an email address, and a determination is made as to whether the email is from a domain associated with the terms; if it is not, then the email is flagged. As one example, an email with terms suggesting that the email is the confirmation of a financial institution payment but which is not sent from the financial institution domain is flagged as scam. In another example, a determination is made as to whether the message is from a particular sender, and if it is not, then the message is flagged as scam. In yet another example, all words are normalized before the comparison is made. This includes performing a consistent capitalization, correcting likely spelling mistakes by replacing words with the most likely candidates from a list of related words, where this list is created to emphasize words commonly used by scammers.

The following is another example of detecting a fraudulent message using a collection of terms. Suppose there are a total of two terms included in the collection (corresponding to a fraud in which victims are asked to send money by Western Union in exchange for a bogus Amazon.com payment). In this example, no equivalence terms are included—just a total of two distinct terms—(“Western Union”,“Amazon payment”). If a document contains both of these terms, whether separated by other words or not, then the document is considered to match. Suppose the message is, “Here is an Amazon payment for $100. Please send me $50 with Western Union.” Such a message would match the collection of terms, as would “Please send your Western Union payment after you receive the Amazon payment.” However, a message of, “Here is an Amazon payment for the Western Digital hard drive I want to purchase. Please send it to my home in Union, N.J.,” would not match since “Western” and “Union” are separated. A message of, “Here is an AMAZON payment for $100, please send the money with western union” would match, where normalization is applied to remove capitalization. In an embodiment where spelling errors are corrected/normalized, “Here is an AmazOn payment. Please send money using western unjon,” would match the collection of terms, since “AmazOn” once corrected would become “Amazon,” and “unjon” would be corrected to “union” before the verification is made.

In some embodiments, a global list of equivalent terms is maintained (e.g., usable across multiple collections of terms), such as “USD,” “us$,” and “euro.” While a Euro is not the same as a USD, the usage of either concept by a scammer is functionally the same. In some embodiments, as a message is evaluated (e.g., by a content evaluation engine), it is first normalized by capitalization and spelling normalization, then the system replaces any terms found in the document matching a term in the list of equivalent terms with a representative term, such as the first term in the equivalence list. After that, the document is verified to determine if it matches any of the rules, such as the (“Amazon”, “Western Union”) rule. In some embodiments, any images included in/attached to/linked to in the message, are interpreted using OCR techniques, and any associated texts combined with ASCII text material before the verification is made.

In some embodiments, each of the non-equivalent terms in a collection of terms (e.g., “long lost” and “huge sum”) are associated with one or more pointers, and ordered alphabetically. The number of pointers associated with each term is the same as the number of rules for which that term is used. Each rule is represented as a vector of Boolean values, where the vector has the same length as the associated rule contains words. All the binary values are set to false before a message is parsed. The message is parsed by reviewing word by word, starting with the first word. If the word being reviewed does not fully or partially match any of the alphabetically ordered terms, then the next word is reviewed instead. If a word matches a term fully, then all Boolean values that are pointed to by the pointers associated with the term that the word matches are set to true. If one or more words matches a term partially by being the first words in the term, then the next word of the message is being added to the comparison and it is determined whether the previously partially matching words now partially of fully match any of the terms that was previously partially matched. If a full match is achieved, then the Boolean values associated with the pointers of this term are set to true. If a partial match is achieved, then the next word is added, and the process repeated. If a sequence of words being matched first partially matches and then does not match, then the system again will consider one word, starting with the second word of the previous sequence. After the entire document has been parsed in this manner, the system determines whether any of the vectors of Boolean values is all true, and if this is so, then the algorithm outputs that there is a match; otherwise it outputs that there is no match. A match means that the message is dangerous. This comparison can also be made each time a Boolean value is set to true by determining if the vector in which this Boolean value is an element is all true, and it so, output “match” and conclude the processing of the message. In a variant implementation, the system determines how many of the vectors are set to all-true; and outputs a counter corresponding to this number. Alternatively, each vector is associated with a weight, and the system determines the sum of all the weights for which the associated vectors are all-true. The message is then identified as having dangerous content, and the sum determines the extent of the danger. In one embodiment, the Boolean vectors are not set to all-false between the scan of two related messages that are part of a thread and sent to the same person. This provides detection capabilities in situations where information is dispersed over multiple related messages, which causes the thread of messages to be considered dangerous.

—Obtaining Collections of Terms—

Collections of terms 1628, an example of which is depicted in FIG. 41A, can be included in a platform in a variety of ways. As one example, a human administrator (or contractor linguist, or other appropriate entity) can manually create a given collection (and optionally assign it a title, as applicable, such as “inheritance scam”), which can be stored for use by the platform. As another example, messages that are flagged (e.g., by human reviewers) as being fraudulent, but are not otherwise flagged by the platform can be examined—either automatically, or in cooperation with humans, such as an administrator or reviewers, and collections of terms formulated to identify such fraudulent messages in the future.

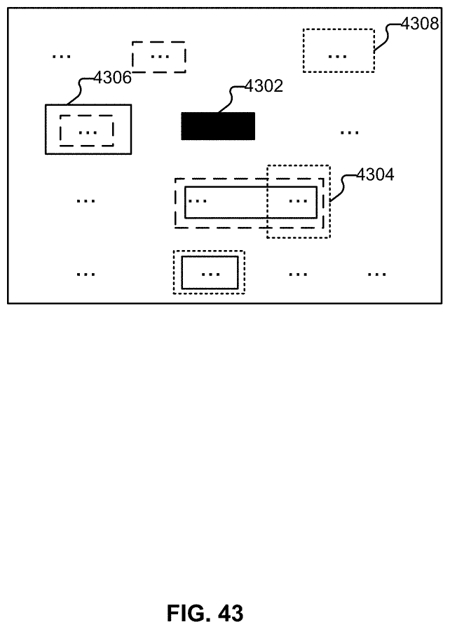

FIG. 43 illustrates an example of an interface configured to receive feedback usable to create collections of terms. In the example shown, an administrator is reviewing feedback provided by three reviewers about why a particular message is believed to be fraudulent. For example, while interacting with an interface such as a modified version of interface 5B, reviewers are asked to indicate which terms they believed were most important in reaching their determination of bad, by highlighting the terms prior to clicking “bad” button 1976.

The terms selected by each of the three reviewers are indicated to the administrator as three types of boxes—sold boxes indicate a selection by a first reviewer; dashed boxes indicate a selection by a second reviewer; and dotted boxes indicate a selection by a third reviewer. In the example shown in FIG. 43, the administrator is not authorized to see the full message, so certain terms (e.g., term 4302) are redacted, even for the administrator. All three reviewers agree that term 4304 is probative of why the message is fraudulent. Other terms have votes from only two (e.g., 4306) or just one (e.g., 4308) of the reviewers. In various embodiments, the administrator can review the selections made by the reviewers, and act, e.g., as a fourth reviewer, to pick which terms should be included in a collection of terms usable to detect the scam represented by the message. The administrator can also set thresholds (e.g., minimum of two votes needed, reviewer reputation score needed, etc.) for automatically selecting terms, and then retain the ability to approve or veto the automatic inclusion of the collection of terms in the collection (1628). In some embodiments, the flagging of terms in the message is presented to users as a CAPTCHA.

In some embodiments, automated techniques are used to generate collections of terms (and/or indicating terms). For example, suppose the classification of a given message is “bad.” An example platform can be configured to identify terms that distinguish it from messages of the good message set, using the TFIDF (term frequency inverse document frequency) principle. A limited number of such terms are selected, where the number is either a system parameter or a function of the TFIDF value, and where the terms are selected in order of decreasing TFIDF values; while selecting at least a threshold number of word terms; at least a threshold number of bigrams; and at least a threshold number of trigrams. These selected terms are stored, and referred to as temporary terms. The platform then computes a modified TFIDF value for the normalized message and messages of the good message set, using constellations of the temporary terms, where a constellation is an unordered list of elements selected from the temporary terms, for different such selections. This identifies collections of elements from the set of temporary terms that are particularly rare in good messages. A threshold number of the resulting terms are kept, selected in order of decreasing modified TFIDF value. The threshold is either a parameter number or a function of the modified TFIDF number. The result are rules that identifies the input message as bad, and the inverse of the modified TFIDF number is an estimate of the false positive rate for classification of messages using the associated rule. These rules are then ordered in terms of decreasing values of a counter measuring how many messages in the collection of known bad messages that each such rule matches. These counters are estimates of how general the associated rule is. One or more rules are selected from the rules, where the selection criteria are low false positive rates and large degree of generality. An example selection picks the rule that maximizes a measure equaling the generality measure divided by the false positive rate, i.e., the associated counter times the associated modified TFIDF value. The selected rules are added to the database of rules. This approach is used to compute new rules to identify bad messages. In one version of the algorithm, the entire set of known good messages is used in place of the at least one message that is part of the input.

As another example, collections of terms can be generated using artificial intelligence techniques configured to identify common words in scam messages, but which are not as common in desirable messages; identify collections of such words that are frequent in scam messages but which are highly infrequent in desirable messages; and identify collections of such terms that are common in scam messages but which are essentially absent in desirable messages.

—Temporal Considerations—

The disclosed techniques can take into consideration temporal relationships between messages when making an assessment. For example, in some embodiments a platform can be configured to scan sequences of messages forming a conversation. It may be that one of the messages in the sequence does not have sufficient evidence of being abusive, whereas a sequence of such messages collectively provides sufficient evidence to be filtered out as being bad. This will cause any future emails of the same type or in the same sequence to also be considered bad.

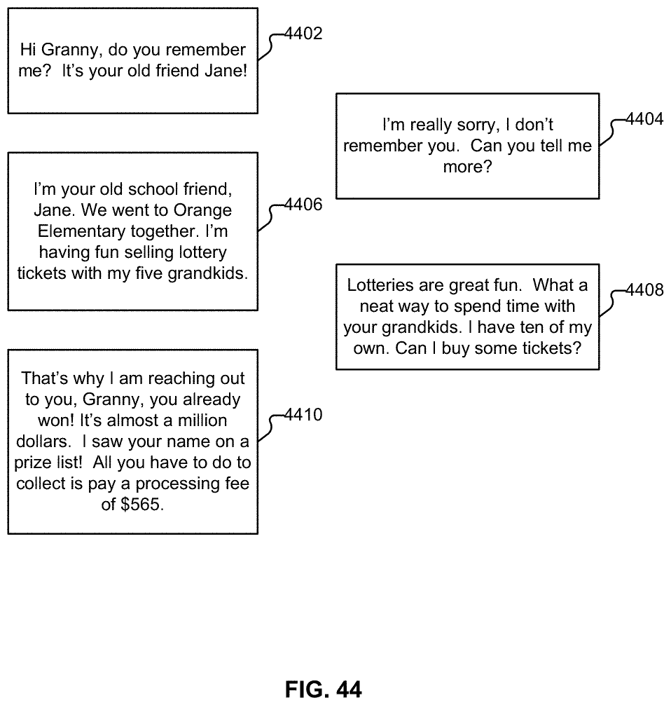

FIG. 44 illustrates an example of such a sequence of messages. In the first message (4402), a user called “Grandma” receives a seemingly benign email from someone claiming to be a long lost friend. It does not mention lotteries. Grandma responds (4404) that she cannot remember her friend, then gets a second email (4406) saying that they were in the same elementary school, and now her friend sells lottery tickets and has five grandchildren. Grandma responds (4408) that this sounds like a fun thing to do, and that she has ten grandchildren. Her “long lost friend” then says (4410) that the reason she contacted Grandma was that she saw her name as one of the lottery winners, and remembered her name from her childhood, then decided to find her to tell her about her winnings. How could she not pick up the money, it is nearly a million dollars, and all she has to do is to pay the processing fee of $565.

Each email in the exchange, by itself, might be seen as innocuous, with the potential exception message 4410. By the time message 4410 is received, however, most existing spam filters would have whitelisted the scammer, given the number of emails sent and received from her by Grandma without incident. In various embodiments, platform 1600 examines the entire sequence of emails (or a moving window of several emails), concatenating the text together and performing analysis on the concatenated text. The concatenated text would readily match a “Lottery Scam” collection of words, and the messages would be classified as “bad,” accordingly.

A second example of temporal processing is as follows. Suppose a user is receiving a sequence of emails over a few weeks time, where the sequence of emails establishes an online friendship or relationship, and then asks for money for some purpose. The initial sequence of emails is purely intended to establish trust, after which the typical request for money arrives. A person who has seen such a scam perpetrated might recognize its making from the early emails. A machine learning component (e.g., of content evaluation engine 1608) can identify a sequence of messages as bad when identifying the request for money, and then identify indications in the trust-establishing emails that are indicative—whether by themselves or as a subsequence—of the request to come. This way, the machine learning component will constitute an early-warning system in which indications of fraud are picked up before there are signs that by themselves correspond to an effort to extract money.

In portions of the above, the description has used as an example how to identify and classify 419 scam messages. The techniques described herein can be used to identify and classify other types of messages based on their content portion; such as phishing messages, messages containing undesirable content; messages containing deceptive content; messages containing requests for information, purchase requests, information requests, and more; and messages that either should or should not be given high priority by another system, such as either a manual or automated second system that is used to process messages.

For illustrative purposes, examples of detection of scam in communication have been described. The disclosed techniques described herein can be adapted to detect other communication patterns. For example, in a business context, discussions of financial matters, insider trading, or special secret projects can be detected. Other examples include protecting juveniles from conversations with online predators, or luring people into joining terrorist organizations. In one embodiment, storylines for any type of communication to be detected are added. For example, a sequence of SMS messages can be determined to contain narrative elements corresponding to a discussion of drugs, followed by a discussion of money, followed by a discussion of geographic location and time. This would be indicative of a likely drug deal between a dealer and a drug user. Similarly, in another embodiment, one or more messages on a social network or over email, containing vector elements seen in bomb making manuals is indicative of a discussion of or descriptive of bomb making. Yet another example of a detection of events of importance uses a series of messages over an extended period of time, such as one year, tracking and quantifying words associated with depression or anger, and identifying storylines, vector filter hits or keywords associated with a sudden change, indicative of a defining moment. In an enterprise setting, sequences of messages can be screened to identify likely unhappy employees, allowing more careful scrutiny of activities or potential risks associated with employees who appear to be unhappy. Example techniques in which filtering of, marking up of, quarantining of, and rewriting of messages have been described herein; in some embodiments, in cases such as those described above, a consequence of a likely hit is to forward select messages and/or quantifications or evidence to a human operator, along with an automatically generated recommendation of next steps.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory, the memory storing a rules database storing multiple rules for a plurality of filters;
one or more processors coupled to the memory; and
a filter engine executing on the one or more processors to filter incoming messages using the plurality of filters to detect generic fraud-related threats including scam and phishing attacks, and to detect specialized attacks including business email compromise (BEC), the filter engine configured to:
obtain a first message from a first user to a recipient;
evaluate the obtained first message using a filter set, the filter set comprising:
a deceptive name filter that detects deceptive addresses, deceptive display names, or deceptive domain names by comparing data in a headers or a content portion of the first message to data associated with trusted brands or trusted headers; and
a trust filter that assigns a trust score to the first message based on whether the recipient has sent, received, and/or opened a sufficient number of messages to/from a sender of the first message within a threshold amount of time;
combine results returned by individual ones of the plurality filters to classify the first message into good, bad and undetermined classifications; and
based on classification of the first message as good or undetermined, deliver the first message;
obtain a second message from a second user;
evaluate, by the filter engine, the obtained second message using at least part of the filter set;
combine results returned by individual ones of the plurality filters to classify the second message into the good, bad and undetermined classifications;
based on the classification of the second message as bad or undetermined, determine there is a relation between the first message and the second message, including determining that the first message and the second message have a same sender; and
based at least in part on the classification of the second message as bad or undetermined and the determination there is a relation between the first message and the second message, dispose of the previously delivered first message.

2. The system recited in claim 1, wherein the first message is determined to have training potential based at least in part on undetermined classification of the evaluation using the filter set, and responsive to training triggered by the first message having been determined to have training potential, updating the filter set.

3. The system recited in claim 2, wherein the first message is classified based at least in part on the evaluation, and wherein the first message is determined to have training potential based at least in part on the classification.

4. The system recited in claim 3, wherein the classification is according to a tertiary classification scheme.

5. The system recited in claim 2, wherein the first message is determined to have training potential based at least in part on a filter disagreement.

6. The system recited in claim 2, wherein updating the filter set includes resolving the undetermined classification.

7. The system recited in claim 6, wherein the undetermined classification is provided to a reviewer for resolution.

8. The system recited in claim 2, wherein updating the filter set includes authoring a rule and updating a filter in the filter set using the authored rule.

9. The system recited in claim 2, wherein the training is performed using training data forwarded by a third user.

10. The system recited in claim 2, wherein the training is performed using training data obtained from a honeypot account.

11. The system recited in claim 2, wherein the training is performed using training data obtained from an autoresponder.

12. The system recited in claim 2, wherein the training is performed using training data obtained at least in part by scraping.

13. The system recited in claim 2, wherein a response is provided to the first user based at least in part on the evaluation of the first message.

14. The system recited in claim 1, wherein the filter set further includes one or more of: a string filter, a region filter, a whitelist filter, a blacklist filter, an image filter, and a document filter.

15. The system recited in claim 14, wherein a compound filter is used to combine results of multiple filters in the filter set.

16. The system recited in claim 1, wherein a filter in the filter set is configured according to one or more rules.

17. The system recited in claim 17, wherein a rule is associated with one or more rule families.

18. The system recited in claim 2, wherein updating the filter set includes performing at least one of a complete retraining or an incremental retraining.

19. A method, comprising:
storing in a memory a rules database storing multiple rules for a plurality of filters;
executing a filter engine on one or more processors, to filter incoming messages using the plurality of filters to detect generic fraud-related threats including scam and phishing attacks, and to detect specialized attacks including business email compromise (BEC), the filter agent configured for:
obtaining a first message from a first user to a recipient;
evaluating, using one or more processors, the obtained first message using a filter set, the filter set comprising;
a deceptive name filter that detects deceptive addresses, deceptive display names, or deceptive domain names by comparing data in a headers or a content portion of the first message to data associated with trusted brands or trusted headers; and
a trust filter that assigns a trust score to the first message based on whether the recipient has sent, received, and/or opened a sufficient number of messages to/from a sender of the first message within a threshold amount of time;
combining results returned by individual ones of the plurality filters to classify the first message into good, bad and undetermined classifications; and
based on classification of the first message as good or undetermined, deliver the first message;
obtaining a second message from a second user;
evaluating by the filter engine, the obtained second message using at least part of the filter set;
combining results returned by individual ones of the plurality filters to classify the second message into the good, bad and undetermined classifications;
based on the classification of the second message as bad or undetermined, determining there is a relation between the first message and the second message, including determining that the first message and the second message have a same sender; and
based at least in part on the classification of the second message as bad or undetermined and the determination there is a relation between the first message and the second message, disposing of the previously delivered first message.

20. A computer program product embodied in a non-transitory computer readable storage medium and comprising computer instructions for:
storing in a memory a rules database storing multiple rules for a plurality of filters;
executing a filter engine on one or more processors, to filter incoming messages using the plurality of filters to detect generic fraud-related threats including scam and phishing attacks, and to detect specialized attacks including business email compromise (BEC), the filter agent configured for:
obtaining a first message from a first user to a recipient;
evaluating the obtained first message using a filter set, the filter set comprising:
a deceptive name filter that detects deceptive addresses, deceptive display names, or deceptive domain names by comparing data in a headers-and a content portion of the first message to data associated with trusted brands or trusted headers; and
a trust filter that assigns a trust score to the first message based on whether the recipient has sent, received, and/or opened a sufficient number of messages to/from a sender of the first message within a threshold amount of time;
combining results returned by individual ones of the plurality filters to classify the first message into good, bad and undetermined classifications; and
based on classification of the first message as good or undetermined, delivering the first message;
obtaining a second message from a second user;
evaluating, by the filter engine, the obtained second message using at least part of the filter set;
combining results returned by individual ones of the plurality filters to classify the second message into the good, bad and undetermined classifications;
based on the classification of the second message as bad or undetermined, determining there is a relation between the first message and the second message, including determining that the first message and the second message have a same sender; and
based at least in part on the classification of the second message as bad or undetermined and the determination there is a relation between the first message and the second message, disposing of the previously delivered first message.

21. The system of claim 1, wherein the first user is the same as the second user.

22. The system of claim 1, wherein a topic of the first message has a same topic as the second message.

23. The system of claim 22 wherein a topic corresponds to at least one of an embedded image, metadata associated with an attachment and a text.

24. The system of claim 19, wherein the first user is the same as the second user.

25. The system of claim 20, wherein the first user is the same as the second user.

26. A system, comprising:
one or more processors configured to:
obtain a first message from a first user;
perform a first security verification of the first message;
determine that the first message is safe to deliver to at least one recipient;
at a later time, perform a second security verification of a second message;
determine that the second message is not safe to deliver, and in response, dispose of the first message; and
a memory coupled to the one or more processors and configured to provide the one or more processors with instructions.

27. The system of claim 1, wherein the first message has the same content as the second message.

28. The system of claim 1, wherein the sender of the first message is the same as the sender of the second message.

29. The system of claim 1, wherein the topic of the first message is the same as the topic of the second message.
